(19) United States
(12) Patent Application Publication
(10) Pub. No.: US 2024/0333501 A1
(43) Pub. Date: Oct. 3, 2024

(54) MULTI-KEY MEMORY ENCRYPTION PROVIDING EFFICIENT ISOLATION FOR MULTITHREADED PROCESSES

(71) Applicant: Intel Corporation, Santa Clara, CA (US)

(72) Inventors: David M. Durham, Beaverton, OR (US); Michael LeMay, Hillsboro, OR (US); Salmin Sultana, Hillsboro, OR (US); Karanvir S. Grewal, Hillsboro, OR (US); Sergej Deutsch, Hillsboro, OR (US)

(73) Assignee: Intel Corporation, Santa Clara, CA (US)

(21) Appl. No.: 18/194,553

(22) Filed: Mar. 31, 2023

(51) Int. Cl. H04L 9/14; G06F 21/60; G06F 21/62; G06F 21/78

(52) U.S. Cl. CPC H04L 9/14; G06F 21/602; G06F 21/6209; G06F 21/6218; G06F 21/78

(57) ABSTRACT

In a technique of hardware thread isolation, a processor comprises a first core including a first hardware thread register. The core is to select a first key identifier stored in the first hardware thread register in response to receiving a first memory access request associated with a first hardware thread of a process. Memory controller circuitry coupled to the first core is to obtain a first encryption key associated with the first key identifier. The first key identifier may be selected from the first hardware thread register based, at least in part, on a first portion of a pointer of the first memory access request. The first key identifier selected from the first hardware thread register is to be appended to a physical address translated from a linear address at least partially included in the pointer.

### TECHNICAL FIELD

The present disclosure relates in general to the field of computer security, and more specifically, to multi-key memory encryption providing efficient isolation for multithreaded processes.

### BACKGROUND

Modern applications are often executed as multithreaded processes that run mutually distrusted contexts. In cloud computing environments, for example, multitenancy architectures permit the use of the same computing resources by different clients. Serverless computing, which is also referred to as Function-as-a-Service (FaaS), is a cloud computing execution model based on a multitenant architecture. As FaaS application is composed of multiple functions that are executed as needed on any server available in the architecture of a provider. The functions of an FaaS application are run separately from other functions of the application in different hardware or software threads, while sharing the same address space. FaaS functions may be provided by third parties and used by clients sharing resources of the same cloud service provider. In another example, multithreaded applications such as web servers and browsers use third party libraries, modules, and plugins, which are executed in the same address space. Similarly, process consolidation takes software running in separate processes and consolidates those into the same process executed in the same address space to save memory and compute resources. The use of varied third party software (e.g., functions, libraries, modules, plugins, etc.) in multithreaded applications creates mutually distrusted contexts in a process and sharing resources with other clients increases the risk of malicious attacks and inadvertent data leakage to unauthorized recipients.

### BRIEF DESCRIPTION OF THE DRAWINGS

FIG. 1 is a block diagram illustrating an example computing system configured to provide multi-key memory encryption to isolate functions of a multithreaded process according to at least one embodiment.

FIG. 2 is a block diagram illustrating an example computing system with a virtualized environment configured to provide multi-key memory encryption to isolate functions in a multithreaded process according to at least one embodiment.

FIG. 3 is a block diagram illustrating an example multithreaded process according to at least one embodiment.

FIG. 4 is a flow diagram of operations that may be related to initializing registers for multi-key memory encryption to provide function isolation according to at least one embodiment.

FIG. 5 is a flow diagram of operations that may be related to reassigning memory when using multi-key memory encryption to provide function isolation according to at least one embodiment.

FIG. 6 is a schematic diagram of an illustrative encoded pointer architecture and related flow diagram according to at least one embodiment.

FIG. 7 is a schematic diagram of another illustrative encoded pointer architecture and related flow diagram according to at least one embodiment.

FIG. 8 is a more detailed flow diagram including schematic elements of a process for providing sub-page cryptographic separation of hardware threads according to at least one embodiment.

FIG. 9 is a flow diagram of an example memory page walk of linear address translation (LAT) paging structures according to at least one embodiment.

FIG. 10 is a flow diagram of an example memory page walk of guest linear address translation (GLAT) paging structures and extended page table paging structures according to at least one embodiment.

FIG. 11 is a block diagram illustrating an example linear page mapped to multi-allocation physical page in an example process having multiple hardware threads.

FIG. 12 is a simplified flow diagram illustrating example operations associated with a memory access request according to at least one embodiment.

FIG. 13 is a simplified flow diagram illustrating example operations associated with initiating a fetch operation for code according to at least one embodiment.

FIG. 14 is a schematic diagram of an example page table entry architecture illustrating memory indicators for implicit policies according to at least one embodiment.

FIG. 15 is a flow diagram of example operations associated with initializing registers for implicit key identifiers according to at least one embodiment.

FIG. 16 is a flow diagram of example operations associated with using memory indicators to implement implicit policies to provide function isolation according to at least one embodiment.

FIG. 17 is a block diagram of an example virtual/linear address space of multiple software threads of a process according to at least one embodiment.

FIG. 18 is a block diagram illustrating an example execution flow that provides cryptographic isolation of software threads in a multithreaded process according to at least one embodiment.

FIG. 19 illustrates an example system architecture using privileged software with a multi-key memory encryption mechanism to provide fine-grained cryptographic isolation in a multithreaded process according to at least one embodiment.

FIG. 20 is a simplified flow diagram illustrating example operations associated with privileged software using a multi-key memory encryption scheme to provide fine-grained cryptographic isolation in a multithreaded process according to at least one embodiment.

FIG. 21 is a simplified flow diagram illustrating example operations associated with securing an encoded pointer to a memory region dynamically allocated during the execution of a software thread in a multithreaded process according to at least one embodiment.

FIG. 22 illustrates a computing system configured to use privileged software to control hardware thread isolation when using a multi-key memory encryption scheme according to at least one embodiment.

FIG. 23A and FIG. 23B are block diagrams illustrating example page table mappings for different hardware threads in a process according to at least one embodiment.

FIGS. 24A and 24B are simplified flow diagrams illustrating example operations associated with using privileged software to control hardware thread isolation according to at least one embodiment.

FIG. 25 illustrates a computing system configured to allow differentiation of memory accesses by different software threads in a multithreaded process using a multi-key memory encryption scheme according to at least one embodiment.

FIG. 26 is a block diagram illustrating example extended page table (EPT) paging structures according to at least one embodiment.

FIG. 27 is a block diagram illustrating an example process running on a computing system with multi-key memory encryption providing differentiation of memory accesses via a modified key identifier according to at least one embodiment.

FIG. 28 is a simplified flow diagram illustrating example operations associated with using a combination identifier in a multi-key memory encryption scheme according to at least one embodiment.

FIG. 29 is a simplified flow diagram illustrating further example operations associated with using a combination identifier in a multi-key memory encryption scheme according to at least one embodiment.

FIG. 30 is a simplified flow diagram illustrating yet further example operations associated with using a combination identifier in a multi-key memory encryption scheme according to at least one embodiment.

FIG. 31 illustrates a computing system configured to use protection keys with a multi-key memory encryption scheme to achieve function isolation according to at least one embodiment.

FIG. 32 is a simplified flow diagram illustrating further example operations associated with using protection keys with a multi-key memory encryption scheme according to at least one embodiment.

FIG. 33 is a block diagram illustrating a hardware platform of a computing system including capability management circuitry and memory having a plurality of compartments according to at least one embodiment.

FIG. 34A illustrates an example format of a capability including a key identifier field and a memory address field according to at least one embodiment.

FIG. 34B illustrates an example format of a capability including a key identifier field, a metadata field, and a memory address field according to at least one embodiment.

FIG. 35 is a block diagram illustrating examples of computing hardware to process an invoke compartment instruction or a call compartment instruction according to at least one embodiment.

FIG. 36 illustrates an example of computing hardware to process a compartment invoke instruction or a call compartment instruction according to at least one embodiment.

FIG. 37 illustrates an example method performed by a processor to process a compartment invoke instruction according to at least one embodiment.

FIG. 38 illustrates operations of a method of processing a call compartment instruction according to at least one embodiment.

FIG. 39 is a block diagram of a processor that may have more than one core, may have an integrated memory controller, and may have integrated graphics according to embodiments of the present disclosure.

FIG. 40 illustrates a block diagram of an example processor and/or System on a Chip (SoC) that may have one or more cores and an integrated memory controller.

FIG. 41A is a block diagram illustrating both an example in-order pipeline and an example register renaming, out-of-order issue/execution pipeline according to examples.

FIG. 41B is a block diagram illustrating both an example in-order architecture core and an example register renaming, out-of-order issue/execution architecture core to be included in a processor according to examples.

FIG. 42 illustrates examples of execution unit(s) circuitry.

FIG. 43 is a block diagram of a register architecture according to some examples.

FIG. 44 illustrates examples of an instruction format.

FIG. 45 illustrates examples of an addressing information field.

FIG. 46 illustrates examples of a first prefix.

FIGS. 47A-D illustrate examples of how the R. X, and B fields of the first prefix in

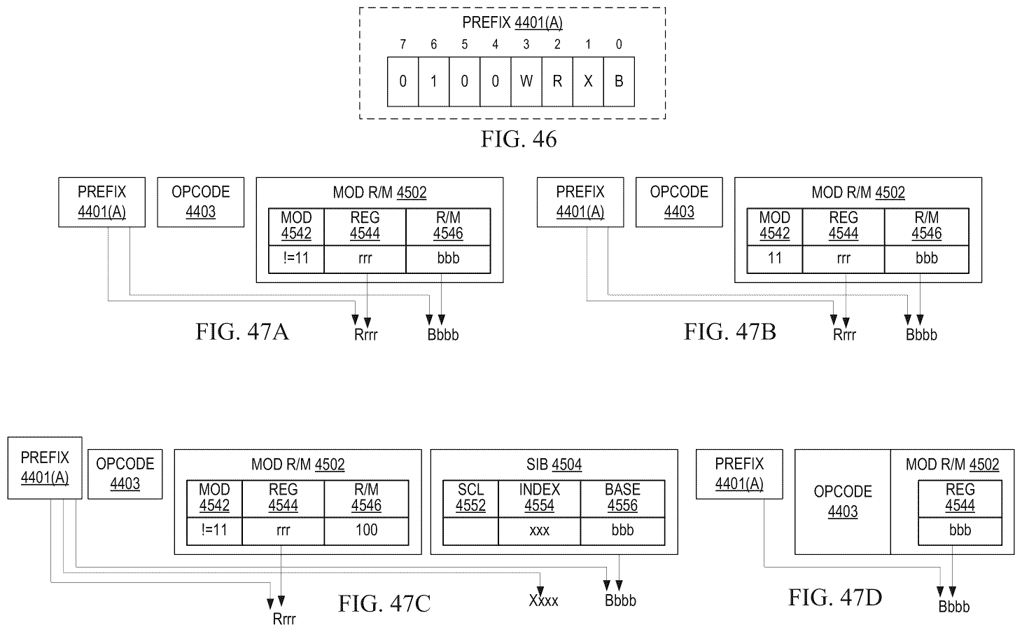

FIG. 46 are used.

FIGS. 48A-B illustrate examples of a second prefix.

FIG. 49 illustrates examples of a third prefix.

FIG. 50 is a block diagram illustrating the use of a software instruction converter to convert binary instructions in a source instruction set architecture to binary instructions in a target instruction set architecture according to examples.

### DETAILED DESCRIPTION

The present disclosure provides various possible embodiments, or examples, of systems, methods, apparatuses, architectures, and machine readable media for multi-key memory encryption that enables efficient isolation for function as a service (FaaS) (also referred to herein as ‘severless applications’) and multi-tenancy applications. Some embodiments disclosed herein provide for hardware thread isolation using a per hardware thread processor register managed by privileged software. A hardware thread register maintains a current key identifier used to cryptographically protect the private memory of the hardware thread. Other key identifiers used to cryptographically protect shared memory among a group of hardware threads may also be maintained in per hardware thread registers for each of the hardware threads in the group. Additional embodiments disclosed herein provide for extensions to the multi-key memory encryption to improve performance and security of the thread isolation. Yet further embodiments disclosed herein provide for domain isolation using multi-key memory encryption with existing hardware.

For purposes of illustrating embodiments that provide for multi-key memory encryption that enables efficient isolation for serverless applications and multi-tenancy applications, it is important to understand the activities that may be occurring in a system using multi-key memory encryption. The following introductory information provides context for understanding embodiments disclosed herein.

Memory encryption is often used to protect data and/or code of an application in the memory of a computing system. Intel® Multi-Key Total Memory Encryption (MKTME) is one example technology offered by Intel Corporation that encrypts a platform's entire memory with multiple cryptographic keys. MKTME uses an Advanced Encryption Standard XEX Tweakable Block Cipher Stealing (AES XTS) with 128-bit keys. The AES XTS encryption/decryption is performed based on a cryptographic key used by an AES block cipher and a tweak that is used to incorporate the logical position of the data block into the encryption/decryption. Typically, a cryptographic key is a random or randomized string of bits, and a tweak is an additional parameter used by the cryptographic algorithm (e.g., AES block cipher, other tweakable block ciphers, etc.). Data in-memory and data on an external memory bus is encrypted. Data inside the processor (e.g., in caches, register, etc.) remains in plaintext.

MKTME provides page granular encryption of memory. Privileged software, such as the operating system (OS) or hypervisor (also known as a virtual machine monitor/manager (VMM)), manages the use of cryptographic keys to perform the cryptographic operations. Each cryptographic key can be used to encrypt (or decrypt) cache lines of a page of memory. The cryptographic keys may be generated by the processor (e.g., central processing unit (CPU)) and therefore, not visible to software. A page table entry of a physical memory page includes lower bits containing lower address bits of the memory address and upper bits containing a key identifier (key ID) for the page. In one example, a key ID may include six (6) bits. The addresses with key IDs are propagated to a translation lookaside buffer (TLB) when the addresses are accessed by a process. The key IDs that are appended to various addresses can be stripped before the memory (e.g., dynamic random access memory (DRAM)) is accessed. An MKTME engine maintains an internal key mapping table that is not accessible to software to store information associated with each key ID. In one example, for a given key ID, a cryptographic key is mapped to the given key ID. The cryptographic key is used to encrypt and decrypt contents of memory to which the given key ID is assigned.

A platform configuration instruction, PCONFIG, ca be used in Intel® 64 and IA-32 processors for example, to program key ID attributes for the MKTME encryption. PCONFIG may be invoked by privileged software for configuring platform features. For example, the privileged software (e.g., OS, VMM/hypervisor, etc.) can use PCONFIG to program a new cryptographic key for a key ID. A data structure used by the PCONFIG instruction may include the following fields: a key control field (e.g., KEYID_CTRL) that contains information identifying an encryption algorithm to be used to encrypt encryption-protected memory. The data structure used by the PCONFIG instruction may further include a first key field (e.g., KEY_FIELD_1) that contains information specifying a software supplied cryptographic key (for directly programming the cryptographic key) or entropy data to be used to generate a random cryptographic key, and a second key field (e.g., KEY_FIELD_2) that contains information specifying a software (or hardware or firmware) supplied tweak key to be used for encryption with a cryptographic key or entropy data to be used to generate a random tweak.

Using the PCONFIG instruction as an example, various information may be used by the instruction to configure the key ID on the hardware platform. For example, a data structure used by the PCONFIG instruction may include the following fields: a key control field (e.g., KEYID_CTRL) that contains information identifying an encryption algorithm to be used to encrypt GLAT-protected pages. The key control field (or another field) may contain an indication (e.g., one or more bits that are set to a particular value) that the integrity protection is to be enabled for the GLAT-protected pages. The data structure used by the PCONFIG instruction may further include a first key field (e.g., KEY_FIELD_1) that contains information specifying a software supplied cryptographic key (for directly programming the cryptographic key) or entropy data to be used to generate a random cryptographic key and possibly a second key field (e.g., KEY_FIELD_2) that contains information specifying a software (or hardware or firmware) supplied tweak key to be used for encryption with a cryptographic key or entropy data to be used to generate a random tweak.

From a usage perspective, FaaS (function as a service) and multi-tenant applications generally operate at a process level or a container level. Typical approaches for protecting FaaS and multi-tenant workloads and microservices use process isolation or virtual machine separation to provide security between isolated services. Other approaches use software runtime separation. Several factors contribute process overhead, however, which can lead to inefficient implementations.

In one example, increased pressure on translation lookaside buffers (TLBs) can have a significant, detrimental impact on process overhead. A translation lookaside buffer (TLB) is a memory cache used in computing systems during the runtime of an application to enable a quick determination of physical memory addresses. A TLB stores recent translations of virtual memory addresses to physical memory addresses of page frames that correspond to linear pages containing the virtual addresses that were translated. The term ‘virtual’ is used interchangeably herein with ‘linear’ with reference to memory addresses. During runtime, a memory access request may prompt pointer decoding. A linear address may be generated based on the pointer of the memory access request. A memory access request corresponds to an instruction that accesses memory including, but not limited to a load, read, write, store, move, etc. and to a fetch operation for data or code. Before searching memory, a TLB may be searched. If the linear address (with a linear-to-physical address translation) is not found in the TLB, this is referred to as a ‘TLB miss.’ If the linear address is found in the TLB, this is referred to as a ‘TLB hit.’ For a TLB hit, a page frame number may be retrieved from the TLB (rather than memory) and used to calculate the physical address corresponding to the linear address in order to fulfill the memory access request. A TLB miss can result in the system translating the linear address to a physical address by performing a resource-intensive memory page walk through one or more paging structure hierarchies. A TLB hit, therefore, is highly desirable.

Maximizing TLB hits during a process can depend, at least in part, on TLB reach. The TLB reach is the amount of memory accessible from the TLB. Many of today's applications have a heavy memory footprint and are run on architectures that accommodate multithreaded processes. For example, modern applications often run in a cloud environment involving FaaS applications, multi-tenancy applications, and/or containers that process significant amounts of data. In the processes of such applications, there may be pressure on the TLBs to have a greater TLB reach to encompass more linear-to-physical address translations.

Other factors may also contribute to process overhead in implementations involving process isolation, virtual machine separation, and other techniques. For example, the inability to allocate data across isolated services from the same page/heap space, page table overhead, and context switching overhead can lead to inefficient implementations. Furthermore, virtual machine (VM) containers with additional nested page tables can result in more expensive context switching. Additionally, in modern systems (e.g., serverless applications, multi-tenancy applications, microservices, container applications, etc.), security may need to be enforced between functions of an application, containers, hardware threads of a process, software threads of a process or hardware thread, etc., rather than simply at the process or virtual machine level.

Threads run within a certain process address space (also referred to herein as ‘address space’ or ‘linear address space’) and memory access is controlled through page tables. An address space generally refers to a range of addresses in memory that are available for use by a process. When all threads of a process share the same address space, one thread can access any memory within that process even if the memory is allocated to another thread. Thread separation is not currently available from memory encryption techniques. Accordingly, to achieve thread separation, the threads typically need to run in separate processes. In this scenario, with the exception of shared memory regions, each thread is assigned unique page tables that do not map the same memory to the other processes. Private memory regions correspond to separate page table entries for whole memory pages that are unique per thread. This page granularity can result in wasted memory for each page that is assigned to a particular thread and that is not fully utilized by that thread. As previously noted, process separation can require significant overhead for the operating system (OS) to configure separate page table mappings for each process and to facilitate switching between processes.

### Hardware Thread Isolation Using Thread-Specific Registers

A system with multi-key memory encryption providing hardware thread isolation in a multithreaded process, as disclosed herein, can resolve many of the aforementioned issues (and more). Embodiments use memory encryption and integrity to provide a sub-page (e.g., cache line granular) cryptographic separation of hardware threads for workloads (e.g., FaaS, multi-tenant, etc.) running in a shared address space. To enable isolation of hardware threads of a process, a processer is provisioned with per hardware thread key ID registers (HTKRs) managed by privileged software (e.g., operating system kernel, virtual machine monitor (VMM), etc.). Each key ID register maintains a respective current key identifier (also referred to herein as a ‘private key ID’) used to cryptographically protect the private memory of the hardware thread associated with that key ID register. Private memory of the hardware thread is memory that is allocated for the hardware thread and that only the hardware thread (e.g., one or more software threads running on the hardware thread) is allowed to access. Private memory is protected by appending the private key ID retrieved from the key ID register associated with the hardware thread to a physical memory address associated with a memory access request from the hardware thread. Hardware threads cannot modify the contents of their key ID registers and therefore, cannot access private data in other thread domains with different key IDs.

Additionally, the processor may be provisioned with a set of one or more group selector registers for each hardware thread. At least one group selector register of a set associated with a particular hardware thread in a process can contain a key ID (also referred to herein as a ‘shared key ID’) for a memory region that is shared by the particular hardware thread and one or more other hardware threads in the process. The shared key ID is mapped to a group selector in a group selector register in each set of group selector registers associated with the hardware threads in the group allowed to access the shared memory region. The group selector is assigned to each hardware thread in the group by storing the group selector-to-shared key ID mapping in group selector registers associated respectively with the hardware threads in the group. The group selector is also encoded in a pointer that is used in memory access requests by the hardware threads in the group to access the shared memory region. The shared memory region can be protected by appending the shared key ID retrieved from a group selector register of the associated with the hardware thread to a physical memory address associated with a memory access request associated with the hardware thread.

In some embodiments, one of the group selector registers in the set may contain a group selector mapped to the private key ID for the hardware thread. In this scenario, the group selector in that group selector register is assigned only to one hardware thread and a hardware thread key ID register containing only the private key ID may be omitted from the hardware. Other group selector registers in the set may contain different group IDs mapped to shared key IDs for accessing shared memory regions.

For clarity, a key ID used to encrypt/decrypt contents (e.g., data and/or code) of private memory of a hardware thread may be referred to herein as a ‘private key ID’ in order to distinguish between other key IDs used to encrypt/decrypt contents of shared memory that the hardware thread is allowed to access. Similarly, these other key IDs used to encrypt/decrypt the contents of shared memory may be referred to herein as ‘shared key IDs’. It should be noted, however, that private key IDs and shared key IDs may have same configuration (e.g., same number of bits, format, etc.). A private key ID is assigned to one hardware thread and can be used to encrypt/decrypt the data or code contained in the private memory of hardware thread. Only that hardware thread is able to access, and successfully decrypt the contents of, the private memory of the hardware thread. The private memory may include a first private memory region for storing data that can be accessed using a data pointer, and a second private memory region for storing code that can be accessed using an instruction pointer. A shared key ID is assigned to multiple hardware threads that are allowed to access a shared memory region. The shared key ID is used by the multiple hardware threads to encrypt and/or decrypt the contents of the shared memory region.

Embodiments providing hardware-based isolation based on multi-key encryption offer several advantages. For example, multiple hardware threads can share the same address space efficiently while maintaining cryptographic separation, without having to run the hardware threads in different processes or virtual machines. Embodiments of multithreaded functions secured with multi-key encryption eliminate the additional page table mappings needed to switch between processes when each thread is secured with a unique key in a separate process. Embodiments also eliminate the overhead required to switch between processes when switching from one thread in one process to another thread in another process.

In another example, by providing cryptographic thread isolation among different functions running on different threads that are hardware based, software cannot be used to circumvent the isolation. One hardware thread cannot physically change a key ID to access another thread's private memory. This is because the key IDs are controlled by privileged software through the hardware thread register mechanism.

In yet another example, because the key ID is retrieved from a new privileged software managed register, the key ID can be appended to the physical address after the TLB is accessed to obtain the physical address. A cryptographic key can then be selected based on the appended key ID. Consequently, there is no additional TLB pressure for managing multiple key IDs across hardware threads, since the key IDs are not maintained in the TLBs. In addition, because the multi-key encryption mechanism (e.g., MKTME) can select a different key for each cache line, thread workloads ca cryptographically separate objects, even if sub-page. Thus, multiple hardware threads with different key IDs are allowed to share the same heap memory from the same pages while maintaining isolation. Therefore, no one thread can access another thread's data/objects even if the threads are sharing the same memory page.

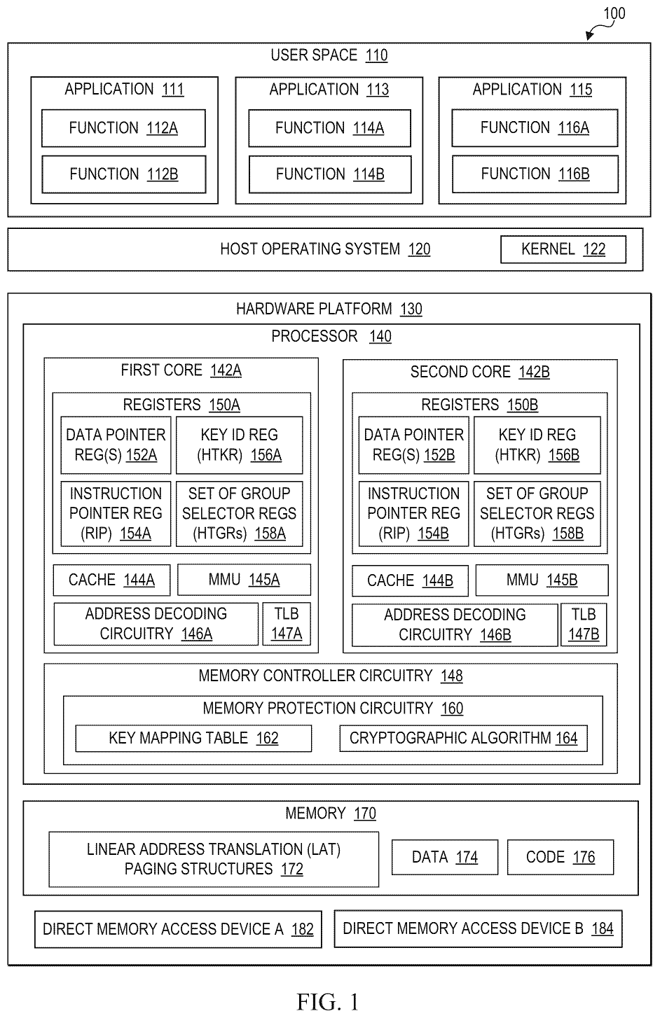

With reference now made to the drawings, FIG. 1 is a block diagram illustrating an example computing system 100 with multi-key memory encryption providing efficient isolation for functions in a multithreaded process according to at least one embodiment. A brief discussion is now provided about some of the possible infrastructure that may be included in computing system 100. Computing system 100 includes a hardware platform 130 and a host operating system 120. Hardware platform 130 includes a processor 140 with multiple cores 142A and 142B communicatively coupled to memory 170 via memory controller circuitry 148. Memory 170 may be communicatively coupled to direct memory access devices (DMAs) 182 and 184. Cores 142A and 142B may also be communicatively coupled to one or more direct memory access (DMA) devices 182 and 184. A user space 110 illustrates the memory space of computing system 100 where application software executes. In computing system 100, three applications 111, 113, and 115 are shown in user space 110. The host operating system 120 may be embodied as privileged system software including a kernel 122 that controls hardware and software in the system. The kernel 122 provides an interface to facilitate interactions between applications (e.g., 111, 113, 115, etc.) and the components of hardware platform 130.

Processor 140 can be a single physical processor provisioned on hardware platform 130, or one of multiple physical processors provisioned on hardware platform 130. A physical processor (or processor socket) typically refers to an integrated circuit, which can include any number of other processing elements, such as one or more cores. In computing system 100, processor 140 may include a central processing unit (CPU), a microprocessor, an embedded processor, a digital signal processor (DSP), a system-on-a-chip (SoC), a co-processor, or any other processing device with one or more cores to execute code. In the example in FIG. 1, processor 140 is a multithreading, multicore processor that includes a physical first core 142A and a physical second core 142B. It should be apparent, however, that embodiments could be implemented in one or more single core processors, one or more multicore processors with two or more cores, or a combination of one or more single core processors and one or more multicore processors.

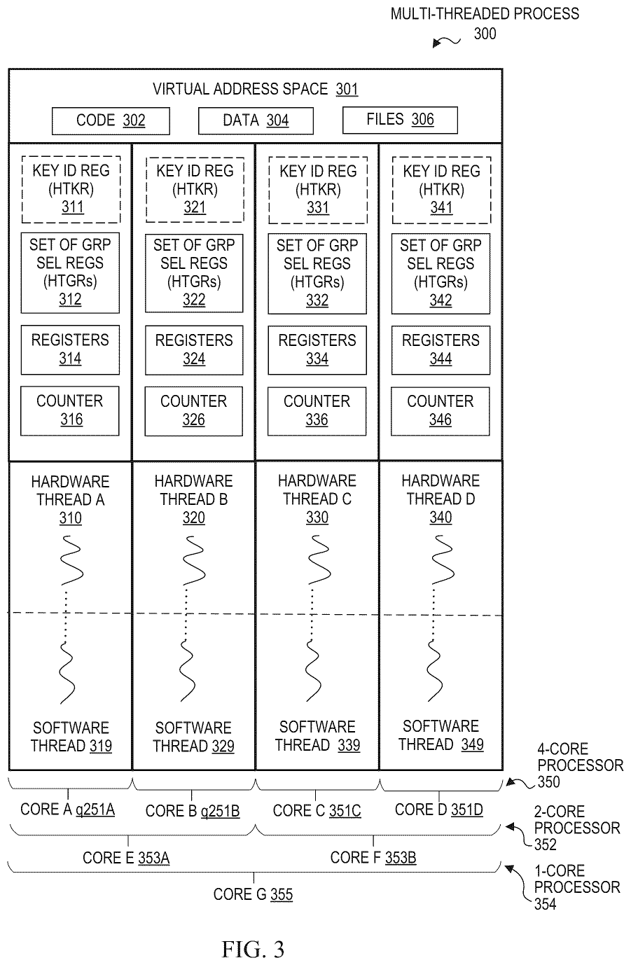

Cores 142A and 142B of processor 140 represent distinct processing units that can run different processes, or different threads of a process, concurrently. In computing system 100, each core supports a single hardware thread (e.g., logical processor). As will be further described at least with respect to FIG. 3, however, some physical cores support symmetric multithreading, such as hyperthreading, which implements multiple hardware thread of control on the same core. With hyperthreading and other symmetric multithreading architectures, one or more hardware threads could be running (or could be idle) on a core at any given time. Thus, multiple independent pieces of software can run simultaneously within the same processor core on different hardware threads. In addition, one or more software threads may run (or be scheduled to run) on the hardware threads of that core.

Memory 170 can include any form of volatile or non-volatile memory including, without limitation, magnetic media (e.g., one or more tape drives), optical media, random access memory (RAM), dynamic random access memory (DRAM), read-only memory (ROM), flash memory, removable media, or any other suitable local or remote memory component or components. Memory 170 may be used for short, medium, and/or long term storage of computing system 100. Memory 170 may store any suitable data or information utilized by other elements of the computing system 100, including software embedded in a machine readable medium, and/or encoded logic incorporated in hardware or otherwise stored (e.g., firmware). Memory 170 may store data 174 that is used by processors, such as processor 140. Memory 170 may also comprise storage for code 176 (e.g., instructions) that may be executed by processor 140 of computing system 100. Memory 170 may also store linear address translation paging structures 172 to enable the translation of linear addresses for memory access requests (e.g., associated with applications 111, 113, 115) to physical addresses in memory. Memory 170 may comprise one or more modules of system memory (e.g., RAM, DRAM) coupled to processor 140 in computing system 100 through memory controllers (which may be external to or integrated with the processors and/or accelerators). In some implementations, one or more particular modules of memory may be dedicated to a particular processor in computing system 100, or may be shared across multiple processors or even multiple computing systems. Memory 170 may further include storage devices that comprise non-volatile memory such as one or more hard disk drives (HDDs), one or more solid state drives (SSDs), one or more removable storage devices, and/or other computer readable media. It should be understood that memory 3370 may be local to the processor 140 as system memory, for example, or may be located in memory that is provisioned separately from the core 142A and 142B, and possibly from the processor 140.

Computing system 100 may also be provisioned with external devices, which can include any type of input/output (I/O) device or peripheral that is external to processor 140. Nonlimiting examples of I/O devices or peripherals may include a keyboard, mouse, trackball, touchpad, digital camera, monitor, touch screen, USB flash drive, network interface (e.g., network interface care (NIC), smart NIC, etc.), hard drive, solid state drive, printer, fax machine, other information storage device, accelerators (e.g., graphics processing unit (GPU), vision processing unit (VPU), deep learning processor (DLP), inference accelerator, application-specific integrated circuit (ASIC), field-programmable gate array (FPGA), etc.). Such external devices may be embodied as a discrete component communicatively coupled to hardware platform 130, as an integrated component of hardware platform 130, as a part of another device or component integrated in hardware platform 130, or as a part of another device or component that is separate from, and communicatively coupled to, hardware platform 130.

One or more of these external devices may be embodied as a direct memory access (DMA) device. Direct memory access is a technology that allows devices to move data directly between the main memory (e.g., 170) and another part of computing system 100 without requiring action by the processor 140. As an example, hardware platform 130 includes first direct memory access device A 182 and second direct memory access device B 184. Nonlimiting examples of DMA devices include graphics cards, network cards, uniform serial bus (USB) controllers, video controllers, Ethernet controllers, and disk drive controllers. It should be apparent that any suitable number of DMA devices may be coupled to a processor depending on the architecture and implementation.

Processor 140 may include additional circuitry and logic. Processor 140 can include all or a part of memory controller circuitry 148, which may include one or more of an integrated memory controller (IMC), a memory management unit (MMU), an address generation unit (AGU), address decoding circuitry, cache(s), TLB(s), load buffer(s), store buffer(s), etc. In addition, memory controller circuitry 148 may also include memory protection circuitry 160 with a key mapping table 162 and a cryptographic algorithm 164, to enable encryption of memory 170 using multiple keys. In some hardware configurations, one or more components of memory controller circuitry 148 may be provided in and coupled to each core 142A and 142B of processor 140, as illustrated in FIG. 1 by MMUs 145A and 145B, address decoding circuitry 146A and 146B, and translation lookaside buffers (TLBs) 147A and 147B in cores 142A and 142B, respectively. In some hardware configurations, one or more components of memory controller circuitry 148 could be communicatively coupled with, but separate from, cores 142A and 142B of processor 140. For example, all or part of the memory controller circuitry may be provisioned in an uncore in processor 140 and closely connected to each core. In some hardware configurations, one or more components of memory controller circuitry 148 could be communicatively coupled with, but separate from, processor 140.

Memory controller circuitry 148 can include any number and/or combination of electrical components, optical components, quantum components, semiconductor devices, and/or logic elements capable of performing read and/or write operations to caches 144A and 144B, TLBs 147A and 147B, and/or the memory 170. For example, cores 142A and 142B of processor 140 may execute memory access instructions for performing memory access operations to store/write data to memory and/or to load/read data or code from memory. It should be apparent, however, that load/read and/or store/write operations may access the requested data or code in cache, for example, if the appropriate cache lines were previously loaded into cache and not yet moved back to memory 170.

Generally, core resources may be duplicated for each core of a processor. For example, a registers, cache (e.g., level 1 (L1), level 2 (L2)), a memory management unit (MMU), and an execution pipeline may be provisioned per processor core. A hardware thread corresponds to a single physical CPU or core. A single process can have one or more hardware threads and, therefore, can run on one or more cores. A hardware thread can hold information about a software thread that is needed for the core to run that software thread. Such information may be stored, for example, in the core registers. Typically, a single hardware thread can also hold information about multiple software threads and run those multiple software threads in parallel (e.g., concurrently). In some processors, two (or possibly more) hardware threads can be provisioned on the same core. In such configurations, certain core resources are duplicated for each hardware thread of the core. For example, data pointers and an instruction pointer may be duplicated for multiple hardware threads of a corc.

For simplicity, first core 142A and second core 142B in computing system 100 are each illustrated with suitable hardware for a single hardware thread. For example, first core 142A includes a cache 144A and registers in first registers 150A. Second core 142B includes a cache 144B and registers in a second registers 150B. The first registers 150A includes, for example, a data pointer register 152A, an instruction pointer register (RIP) 154A, a key identifier register (HTKR) 156A, and a set of group selector registers 158A. The second registers 150B includes, for example, a data pointer register 152B (e.g., for heap or stack memory), an instruction pointer register (RIP) 154B, a key identifier register (HTKR) 156A, and a set of group selector registers (HTGRs) 158A. Additionally, in at least some architectures, other registers (not shown) may be provisioned per core or hardware thread including, for example, other general registers, control registers, and/or segment registers.

In at least some embodiments, one or more components of memory controller circuitry 148 may be provided in each core 142A and 142B. For example, memory management units 145A and 145B include circuitry that may be provided in cores 142A and 142B, respectively. MMUs 145A and 145B can provide control access to the memory. MMUs 145A and 145B can provide paginated (e.g., via 4 KB pages) address translations between linear addresses of a linear address space allocated to a process and physical addresses of memory that correspond to the linear addresses. In addition, TLBs 147A and 147B are caches that are used to store recent translations of linear addresses to physical addresses, which have occurred during memory accesses of a process. TLB 147A can be used to store recent translations performed in response to memory access requests associated with a software thread running in a hardware thread of the first core 142A, and TLB 147B can be used to store recent translations performed in response to memory access requests associated with a software thread running in a hardware thread of the second core 142B in a hardware thread of the second core 142B.

Address encoding/decoding circuitry 146A and 146B may be configured to decode encoded pointers (e.g., in data pointer registers 152A and 152B and in instruction pointer registers 154A and 154B) generated to access code or data of a hardware thread. In addition to generating a linear address from an encoded pointer of a hardware thread, address decoding circuitry (e.g., 146A, 146B) can determine a key identifier, if any, assigned to the hardware thread. The address decoding circuitry can use the key identifier to enable encryption of memory per hardware thread (e.g., for private memory) and/or per group of hardware threads (e.g., for share memory region), as will be further described herein.

When a hardware thread is running, code or data can be accessed from memory using a pointer containing a memory address of the code or data. As used herein, ‘memory access instruction’ may refer to, among other things, a ‘MOV’ or ‘LOAD’ instruction or any other instruction that causes data to be read, copied, or otherwise accessed at one storage location, e.g., memory, and moved into another storage location, e.g., registers (where ‘memory’ may refer to main memory or cache, e.g., a form of random access memory, and ‘register’ may refer to a processor register, e.g., hardware), or any instruction that accesses or manipulates memory. Also as used herein, ‘memory store instruction’ may refer to, among other things, a ‘MOV’ or ‘STORE’ instruction or any other instruction that causes data to be read, copied, or otherwise accessed at one storage location, e.g., register, and moved into another storage location, e.g., memory, or any instruction that accesses or manipulates memory. In addition to memory read and write operations that utilize processor instructions such as ‘MOV’, ‘LOAD’, and ‘STORE’, memory access instructions are also intended to include other instructions that involve the “use” of memory (such as arithmetic instructions with memory operands, e.g., ADD, and control transfer instructions, e.g., CALL/JMP etc.). Such instructions may specify a location in memory that the processor instruction will access to perform its operation. A data memory operand may specify a location in memory of data to be manipulated, whereas a control transfer memory operand may specify a location in memory at which the destination address for the control transfer is stored.

When accessing data, a data pointer register 152A may be used to store a pointer to a linear memory location (e.g., heap, stack) in a process address space that a hardware thread of the first core 142A is allowed to access. Similarly, data pointer register 152B may store a pointer to a linear memory location (e.g., heap, stack) in a process address space that a hardware thread of the second core 142B is allowed to access. If the same process is running on both cores 142A and 142B, then the pointers in data pointer registers 152A and 152B can point to memory locations of the same process address space. In one or more embodiments that will be further explained herein, in addition to specifying the memory address of data to be accessed by a hardware thread, an encoded portion of the data pointer (e.g., 152A, 152B) can specify a memory type and/or a group selector. The encoded portion of data pointer can be used to enable encrypting/decrypting the data in the pointed-to memory location.

A memory access for code can be performed when an instruction is fetched by the processor. An instruction pointer register (RIP) can contain a pointer with a memory address that is incremented (or otherwise changed) to reference a new memory address of the next instruction to be executed. When execution of the prior instruction is finished, the processor fetches the next instruction based on the new memory address.

When accessing code, an instruction pointer register (RIP) (also referred to as ‘program counter’) specifies the memory address of the next instruction to be executed in the hardware thread. The instruction pointer register 154A of the first core 142A can store a code pointer to the next instruction to be executed in code running on the hardware thread of the first core 142A. The instruction pointer register 154B of the second core 142B can store a pointer to the next instruction to be executed in code running on the hardware thread of the second core 142B. In one or more embodiments that will be further explained herein, in addition to specifying the memory address of the next instruction to be executed in a hardware thread, a RIP (e.g., 154A, 154B) can also specify a key ID mapping to be used for encrypting/decrypting the code to be accessed. Thus, in some embodiments, the private key ID assigned to a hardware thread for accessing private memory could be encoded in the RIP. In other embodiments, the code pointer could have a similar format to a data pointer, and an encoded portion of the code pointer could specify a memory type and/or a group selector. The encoded portion of the code pointer can be used to enable decrypting the code in the pointed-to memory location.

Additional circuitry and/or logic is provided in processor 140 to enable multi-key encryption for isolating hardware threads in multithreaded processes. Cryptographic keys (also referred to herein as ‘cryptographic keys’) that are used to encrypt and decrypt the data and/or code of one hardware thread, are different than the cryptographic keys used to encrypt and decrypt the data and/or code of other hardware threads in the same process (e.g., running in the same address space). Thus, each hardware thread of a process may be cryptographically isolated from the other hardware threads of the same process. Embodiments also isolate hardware threads in one process (multithreaded or single-thread) from hardware thread(s) in other processes running on the same hardware. To enable isolation per hardware thread, at least one new register is provisioned for each hardware thread of each core. Three embodiments are now described, which include different combinations of the types of thread-specific registers that may be provisioned for each hardware thread.

In a first embodiment, each core is provided with a hardware thread key ID register (HTKR). An HTKR on a core can be used by a hardware thread on that core to protect private memory of the hardware thread. In this embodiment, the first core 142A of computing system 100 could be include a first HTKR 156A, and the second core 142B could include a second HTKR 156B. The HTKR of a core can store a private key ID (or a pointer to a private key ID) assigned to a hardware thread of the core. The private key ID is used to encrypt/decrypt the hardware thread's private data in a private memory region (e.g., heap or stack memory) of a process address space. The private key ID may also be used to encrypt/decrypt the hardware thread's code in another private memory region (e.g., code segment) in the process address space. Alternatively, code associated with a hardware thread may be unencrypted, or may be encrypted using a different key ID that is stored in a different register (e.g., an HTGR) or in memory (e.g., encrypted and stored in main memory).

A pointer that is used by a hardware thread of a process to access the hardware thread's private memory region(s) (e.g., heap, stack, code) can include an encoded portion that is used to determine whether the memory to be accessed is private or shared. The encoded portion of the pointer can specify a memory type that indicates whether the memory to be accessed is either private (and encrypted) or shared (and unencrypted or encrypted). The memory type could be specified in a single bit that is set to one value (e.g., ‘1’ or ‘0’) to indicate that the memory address referenced by the pointer is shared. The bit could be set to the opposite value (e.g., ‘0’ or ‘1’) to indicate that the memory address referenced by the pointer is private.

If a memory type specified in the pointer indicates that the memory address referenced by the pointer is located in a private region, then only the hardware thread associated with the memory access request is authorized to access that memory address. In this scenario, a key ID can be obtained from the HTKR of the hardware thread associated with the memory access request. If the memory type specified in the pointer indicates that the memory address referenced by the pointer is shared, then each hardware thread in a group of hardware threads is allowed to access the memory address in the pointer. In this scenario, a key ID may be stored in (and obtained from) another hardware thread-specific register (similar to HTKR) designated for shared memory key IDs, or in some other memory (e.g., encrypted and stored in main memory, etc.). Alternatively, a shared memory region may be unencrypted and thus, the memory access operation could proceed without performing any encryption/decryption operations for a request to access the shared memory region.

Although a single bit may be used to specify a memory type, it should be apparent that any suitable number of bits and values could be used to specify a memory type based on the particular architecture and implementation. While a single bit may only convey whether the referenced memory address is located in a private or shared memory region, multiple bits could convey more information about the memory address to be accessed. For example, two bits could provide four different possibilities about the memory address to be accessed: private and encrypted, private and unencrypted, shared and encrypted, or shared and unencrypted.

In one or more embodiments, the private key ID obtained from an HTKR can be appended to a physical address corresponding to a linear address in the pointer used in the memory access request. The private key ID in the physical address can then be used to determine a cryptographic key. The cryptographic key may be mapped to the private key ID in another data structure (e.g., in key mapping table 162 in memory protection circuitry 160, in memory, or any other suitable storage), or any other suitable technique may be used to determine a unique cryptographic key that is associated with the private key ID. It should be appreciated while the key mapping table 162 may be implemented in the processor hardware, in other examples, the key mapping table may be implemented in any other suitable storage including, but not necessarily limited to memory or remote (or otherwise separate) storage from the processor.

In a second embodiment, each core is provided with both an HTKR and a set of one or more hardware thread group selector registers (HTGRs). A set of one or more HTGRS on a core can be used by a hardware thread on that core to protect shared memory that the hardware thread is allowed to access. In this embodiment, the first core 142A could include the first HTKR 156A and a first set of one or more HTGRs 158A, and the second core 142B could include the second HTKR 156B and a second set of one or more HTGRs 158B. The HTKRs 156A and 156B could be used as previously described above. For example, an HTKR of a core stores a private key ID (or pointer to a private key ID) assigned to a hardware thread of the core, and the private key ID is used to encrypt/decrypt the hardware thread's private data in a private memory region (e.g., in heap or stack memory) of a process address space. The private key ID may also be used to encrypt/decrypt the hardware thread's code in a private code region (e.g., in the code segment) of the process address space. In addition, an encoded portion of a pointer to the private data or code associated with the hardware thread may include a memory type that indicates whether the memory being accessed is private or shared.

In this second embodiment, which includes both HTKRs and sets of HTGRs, each HTGR of a set of HTGRs on a core can store a different mapping for a different shared memory region that the hardware thread running on the core is allowed to access. For example, a mapping for an encrypted shared memory region can include a group selector mapped to (or otherwise associated with) a shared key ID that is used to encrypt and decrypt contents (e.g., data or code) of the shared memory region. For an encrypted shared memory region, the group selector may be mapped to a shared key ID that is assigned to each hardware thread in a group of hardware threads of a process, and each hardware thread in the group is allowed to access the encrypted shared memory region. The shared key ID may be assigned to each hardware thread in the group by being mapped to the group selector in a respective HTGR associated with each hardware thread in the group.

In some scenarios, the particular shared memory region being accessed may not be encrypted. In this scenario, the group selector may be mapped to a particular value (e.g., all zeroes, all ones, or any other predetermined value) indicating that no shared key ID has been assigned to any hardware threads for the shared memory region because the shared memory region is not encrypted. Alternatively, the group selector may be mapped to a shared key ID, and the shared key ID may be mapped to a particular value in another data structure (e.g., in key mapping table 162, or any other suitable storage) indicating that the memory associated with the shared key ID is not encrypted. Additionally, if a hardware thread is not authorized to access a particular shared memory region, an HTGR of the hardware thread may include a mapping of a group selector for that shared memory region to a particular value to prevent access to the shared memory region. The value may be different than the value indicating that a shared memory region is unencrypted, and may indicate that the hardware thread is not allowed to access the shared memory region associated with the group selector.

A group selector defines the group of hardware threads of a process that are allowed to access a particular shared memory region. In addition to being stored as part of a mapping in one or more HTGRs, the group selector may also be included in an encoded portion of a pointer used by the hardware threads of the group to access the particular shared memory region. The encoded portion may include unused upper bits of the pointer or any other bits in the pointer suitable for embedding the group selector. When a memory access request associated with one of the hardware threads of a group is initiated, a group selector from a pointer of the memory access request can be used to search the set of HTGRs associated with that hardware thread to find a mapping of the group selector to a shared key ID, to a value indicating that the shared memory region is unencrypted, or to a value indicating that the hardware thread is not allowed to access the shared memory region.

Once the shared key ID is obtained from an HTGR, the shared key ID can be appended to a physical address corresponding to a linear memory address in the pointer used in the memory access request. Similar to a private key ID previously described herein, a shared key ID can be used to determine a cryptographic key for the particular shared memory region. The cryptographic key may be mapped to the shared key ID in another data structure (e.g., in key mapping table 162 in memory protection circuitry 160, in memory, or any other suitable storage) or any other suitable technique may be used to determine a unique cryptographic key that is associated with the shared key ID.

In a third embodiment, the first core 142A includes the first set of one or more HTGRs 158A, and the second core 142B includes the second set of one or more HTGRs 158B. The HTKRs 156A and 156B in which only a private key ID is stored (rather than a mapping of a group selector to a private key ID) may be omitted. In this third embodiment, one HTGR in a set of one or more HTGRs on a core includes a mapping of a group selector to a private key ID assigned to a hardware thread running on the core. The group selector may also be included in an encoded portion of a pointer used by the hardware thread to access the hardware thread's private memory region. The encoded portion may include unused upper bits of the pointer or any other bits in the pointer suitable for embedding the group selector. When a memory access request associated with the hardware thread is made using the pointer containing the group selector for the hardware thread's private memory region, the group selector from the pointer can be used to search the set of HTGRs associated with that hardware thread to find the private key ID. It should be apparent that one HTGR may be used to store a group selector used for code and/or data of the hardware thread, or that a first HTGR may be used for private code associated with the hardware thread and a second HTGR may be used for private data associated with the hardware thread.

One or more other HTGRs may be provided in the set of HTGRs to be used as previously described above with respect to shared key IDs and shared memory regions. For example, each of the other HTGRs can store a different mapping for a different shared memory region that the hardware thread running on the core is allowed to access. It should be apparent that not all HTGRs may be utilized for each hardware thread. For example, if the set of HTGRs of a hardware thread includes 4 HTGRs, a first HTGR in the set may be used to store the mapping to the private key ID. One, two, or three of the remaining HTGRs may be used to store mappings of different group selectors to different shared key IDs used to encrypt/decrypt different shared memory regions that the hardware thread is allowed to access.

Turning to further possible infrastructure of computing system 100, first core 142A and/or second core 142B may be provisioned with suitable hardware to implement hyperthreading where two (or more) hardware threads run on each core. In this scenario, certain hardware may be duplicated per hardware thread, per core. Assuming each core is provisioned for two hardware threads, for example, the first core 142A could be provisioned with two data pointer registers and two instruction pointer registers. Depending on the embodiment as outlined above, each core supporting two hardware threads can be provisioned with HTKRs, HTGRs, or a combination of both. By way of example, and not of limitation, one core that supports two hardware threads may be provisioned with two HTKR registers (where each HTKR holds a key ID for a hardware thread's data and/or code), two sets of one or more HTGR registers, or two HTKR registers and two sets of one or more HTGR registers. In addition to these variations of hardware thread-specific registers provisioned for each hardware thread, other embodiments may include additional HTKRs and/or additional HTGRs being provisioned for each hardware thread. For example, two pairs of HTKR registers (where each pair of HTKR registers coupled to a core stores different key IDs for data and code of one hardware thread on the core), or two pairs of HTKR registers and two sets of one or more HTGR registers.

In at least some examples, the multiple hardware threads of a core may use the same execution pipeline and cache. For example, if the first and second cores support multiple hardware threads, all hardware threads on the first core 142A could use cache 144A, while all hardware threads of the second core 142B could use cache 144B. It should be noted that some caches may be shared by two or more cores (e.g., level 3 (L3) cache, etc.). In architectures in which hyperthreading is not implemented, the registers would be provisioned per core and one hardware thread could run on one core at a time. When the process switches to run a different hardware thread, privileged software such as the operating system updates the HTKR and/or the HTGR registers with the new hardware thread's private key ID (or private key IDs) and shared key IDs, if any.

Processor 140 may include memory protection circuitry 160 to provide multi-key encryption of data 174 and/or code 176 stored in memory 170. Memory protection circuitry 160 may be provisioned in processor 140 in any suitable manner. In one example, memory protection circuitry may be separate from, but closely connected to the cores (e.g., in an uncore). In other examples, encryption/decryption (e.g., cryptographic algorithm 164) could be performed by cryptographic engines at any level in the cache hierarchy (e.g., between Level1 cache and Level2 cache), not just at a memory controller separate from the cores. One advantage for performing encryption/decryption earlier in the cache hierarchy is that the additional key identifier information need not be carried in the physical address for the larger upstream caches. Thus, cache area could be save or more cache data storage could be allowed. In at least some implementations, memory protection circuitry 160 may also enable integrity protection of the data and/or code. For example, memory pages in memory 170 that are mapped to a linear address space allocated for an application (e.g., application 111, 113, or 115) may be protected using multi-key encryption and/or integrity protection. In one or more embodiments, memory protection circuitry 160 may include a key mapping table 162 and a cryptographic algorithm 164. In embodiments in which integrity protection is provided, memory protection circuitry 160 may also include an integrity protection algorithm.

Key mapping table 162 may contain each key ID (e.g., assigned to a single hardware thread for private memory or assigned to multiple hardware threads for shared memory) that has been set by the operating system in the appropriate HTKRs and/or HTGRs of hardware threads on one or more cores. Key mapping table 162 may be configured to map each key ID to a cryptographic key (and/or a tweak for encryption) that is unique within at least the process address space containing the memory to be encrypted. Key mapping table 162 may also be configured to map each key ID to an integrity mode setting that indicates whether the integrity mode is set for the key ID. In one example, when the integrity mode is set for a key ID, integrity protection is enabled for the memory region that is encrypted based on the key ID. Other information may also be map to key IDs including, but not necessarily limited to, an encryption mode (e.g., whether to encrypt or not, type of encryption, etc.).

In one nonlimiting implementation, multi-key encryption provided by the memory protection circuitry 160 and/or memory controller circuitry 148 may be implemented using Intel® MKTME. MKTME operates on a cache line granularity with a key ID being appended to a physical address of a cache line through linear address translation paging (LAT) structures. In typical implementations of MKTME, the key ID is obtained from the page tables and is propagated through the translation lookaside buffer (TLB) with the physical address. The key ID appended to the physical address is used to obtain a cryptographic key, and the cryptographic key is used to encrypt/decrypt the cache line. The key ID appended to the physical address is ignored to load/store the encrypted cache line, but is stored along with the corresponding cache line in the cache of a hardware thread.

In one or more embodiments disclosed herein, key IDs used by MKTME are obtained from per hardware thread registers (e.g., HTKR and/or HTGR) after address translations for memory being accessed are completed. Accordingly, memory within a process address space can be encrypted at sub-page granularity, such as a cache line, based on a hardware thread that is authorized to access that cache line. As a result, cache lines in a single page of memory that belong to different hardware threads in the process, or to different groups of hardware threads in the process (e.g., for shared memory regions), can be encrypted differently (e.g., using different cryptographic keys). For example, injecting a key ID from a hardware thread register (e.g., HTKR or HTGR) into a physical address of a cache line, allows private memory of a hardware thread to be encrypted at a cache line granularity, without other hardware threads in the process being able to successfully decrypt that private memory. Other hardware threads would be unable to successfully decrypt the private memory since the key ID is injected from the hardware thread register of the private memory's hardware thread. Moreover, the private memory of the other threads in the process could be encrypted using key IDs obtained from hardware thread registers (e.g., HTKRs or HTGRs) of those other hardware threads.

Similarly, shared memory can be successfully encrypted/decrypted by a group of hardware threads allowed to access the shared memory. Other hardware threads outside the group would be unable to successfully decrypt the shared memory since the key ID used to encrypt and decrypt the data is obtained from the hardware thread registers (e.g., HTGRs) of the hardware threads in the group. Moreover, the shared memory of other hardware thread groups would be encrypted using key IDs obtained from hardware thread registers (e.g., HTGRs) of the hardware threads in those other hardware thread groups. Thus, injecting a key ID from a hardware thread register (e.g., HTKR or HTGR) can result in cache lines on the same memory page that belong to different hardware threads, or to different hardware thread groups, being encrypted differently and, therefore, isolated from each other.

In computing system 100, applications 111, 113, and 115 are each illustrated with two functions. Application 111 includes functions 112A and 112B, application 113 includes functions 114A and 114B, and application 115 includes functions 116A and 116B. It should be appreciated, however, that the two functions in each application are shown for illustrative purposes only, and that one or more of the applications could include one, two, or more functions. As used herein, a ‘function’ is intended to represent any chunk of code that performs a task and that can be executed, invoked, called, etc. by an application or as part of an application made up of multiple functions (e.g., FaaS application, multi-tenant application, etc.). For example, the term function is intended to include, but is not necessarily limited to, a reusable block of code, libraries, modules, plugins, etc., which can run in its own hardware thread and/or software thread and which may or may not be provided by third parties. The applications 111, 113, and 115 may include multiple functions that run mutually untrusted contexts. One or more of the applications could be instantiated as a Functions-as-a-Service (FaaS) application, a tenant application, a web browser, a web server, or any other application with at least one function running an untrusted context. Additionally, any number of applications (e.g., one, two, three, or more) may run in user space 110 based on the particular architecture and/or implementation. Also, in some scenarios, an application may run in kernel space. For example, in some configurations, a web server may run in kernel space rather than user space.

Memory 170 can store data 174, code 176, and linear address translation paging structures 172 for processes, such as applications 111, 113, and 115 executing in user space. Linear address translation paging structures 172, such as Intel® Architecture (IA) page tables used in Intel® Architecture, 32-bit (IA-32) offered by Intel Corporation, or any other suitable address translation mechanism, may be used to perform translations between linear addresses and physical addresses. In some scenarios, paging structures may be represented as a tree of tables (also referred to herein as a ‘page table tree’) in memory and used as input to the address translation hardware (e.g., memory management unit). The operating system 120 provides a pointer to the root of the tree. The pointer may be stored in a register (e.g., control register 3 (CR3) in the IA-32 architecture) and may contain or indicate (e.g., in the form of a pointer or portion thereof) the physical address of the first table in the tree. Page tables that are used to map virtual addresses of data and code to physical addresses may themselves be mapped via other page tables. When an operating system allocates memory and/or needs to map existing memory in the page tables, the operating system can manipulate the page tables that map virtual addresses of data and code as well as page tables that map virtual addresses of other page tables.

In one or more embodiments, assignment of private key IDs to hardware threads, selection of hardware thread groups, and assignment of shared key IDs to hardware thread groups may be performed by privileged software (e.g., host operating system 120, hypervisor, etc.). Before switching to a user space hardware thread, the operating system or other privileged software sets an HTKR and/or HTGR(s) in a set of HTGRs to be used by the hardware thread. The HTKR (e.g., 156A or 156B) may be set by storing a private key ID (or a pointer associated with the private key ID) to be used by the hardware thread. Alternatively, an HTGR (e.g., 158A or 158B) is set by storing a mapping of a group selector to the private key ID (or a pointer associated with the mapping) to be used by the hardware thread. In addition, one or more of the other HTGRs in the set of HTGRs may be set for shared memory by storing one or more group selectors mapped to shared key IDs for shared memory region(s) that the hardware thread is allowed to access. Additionally, embodiments herein allow for certain data structures to be used to store mappings of items or to create a mapping between items. The term ‘mapping’ as used herein, is intended to mean any link, relation, connection, or other association between items (e.g., data). Embodiments disclosed herein may use any suitable mapping, marking, or linking technique (e.g., pointers, indexes, file names, relational databases, hash table, etc.), or any other suitable technique, that creates and/or represents a link, relation, connection, or other association between the ‘mapped’ items. Examples of such data structures include, but are not necessarily limited to, the hardware thread registers (e.g., 158A, 158B) and/or the key mapping table (e.g., 162).

Although the concepts provided herein could be applied to any multithreaded process, the various isolation and thread-based encryption techniques may be particularly useful in function as a service (FaaS) and multi-tenancy applications. In an example such as functions-as-a-service (FaaS), the FaaS framework can be embodied as privileged software that stitches functions together in parallel or sequentially to create an FaaS application. The FaaS framework understands what data needs to be shared between and/or among functions and when the data needs to be shared. In at least some scenarios, information about what data, functions, and time for sharing the data can be conveyed to the privileged software from the user software itself. For example, user software can use a shared designation in an address to communicate over a socket, and the shared designation may be a trigger for the privileged software to create an appropriate group and map to the hardware mechanism for sharing data. Other triggers may include a return procedure call initiated by one software thread to another software thread, or an application programming interface (API) called by a software thread, as an indication that data is being shared between two or more threads. In yet another scenario, a region of memory could be designated for shared data. In this scenario, the privileged software may know a priori the address range of the designated region of memory to store and access shared data. It should be noted that any type of input/output (IO) direct memory access (DMA) buffers, which are known to the operating system or other privileged software, may be treated as shared memory and the hardware mechanism described herein can be implemented to form sharing groups of hardware threads for the buffers at various granularities based on the particular application.

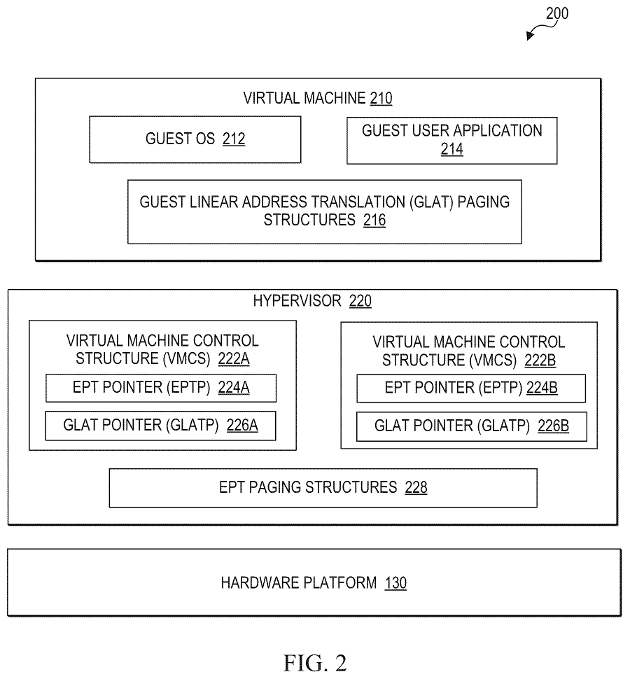

With reference to FIG. 2, an example virtualized computing system 200 including a virtual machine (VM) 210 and a hypervisor 220 implemented on the hardware platform 130 of FIG. 1 is illustrated. As previously described with reference to FIG. 1, the hardware platform 130 is configured to provide multi-key memory encryption to isolate functions of a multithreaded process per hardware thread using dedicated hardware registers provisioned for each hardware thread. FIG. 2 illustrates an example architecture for virtualizing hardware platform 130.

In some examples, applications may run in virtual machines, and the virtual machines may include respective virtualized operating systems. In virtualized computing system 200, virtual machine 210 includes a guest operating system (OS) 212, a guest user application 214, and guest linear address translation (GLAT) paging structures 216. The guest user application 214 may run multiple functions on multiple hardware threads of the same core, on hardware threads of different cores, or any suitable combination thereof.

A guest kernel of the guest operating system 212 can allocate memory for the GLAT paging structures 216. The GLAT paging structures 216 can be populated with mappings from the process address space (e.g., guest linear addresses mapped to guest physical addresses) of guest user application 214. In at least one implementation, one set of GLAT paging structures 216 may be used for guest user application 214, even if the guest user application is composed of multiple separate functions.

Generally, a hypervisor is embodied as a software program that enables creation and management of the virtual machine instances and manages the operation of a virtualized environment on top of a physical host machine. Hypervisor 220 (e.g., virtual machine monitor/manager (VMM)) runs on hardware platform 130 to manage and run the virtual machines, such as virtual machine 210. The hypervisor 220 may run directly on the host's hardware (e.g., processor 140), or may run as a software layer on the host operating system 120. The hypervisor can manage the operation of the virtual machines by allocating resources (e.g., processing cores, memory, input/output resources, registers, etc.) to the virtual machines.

The hypervisor 220 can manage linear address translation for user space memory pages. The hypervisor 220 can allocate memory for extended page table (EPT) paging structures 228 to be used in conjunction with GLAT paging structures 216 when guest user application 214 initiates a memory access request and a page walk is performed to translate a guest linear address in the memory access request to a host physical address in physical memory. In at least one implementation, a single set of EPT paging structures 228 may be maintained for a multithreaded process in a virtual machine. In other implementations, a duplicate set of EPT paging structures may be maintained for each hardware thread. The EPT paging structures 228 are populated by hypervisor 220 with mappings from the process address space (e.g., guest physical addresses to host physical addresses).

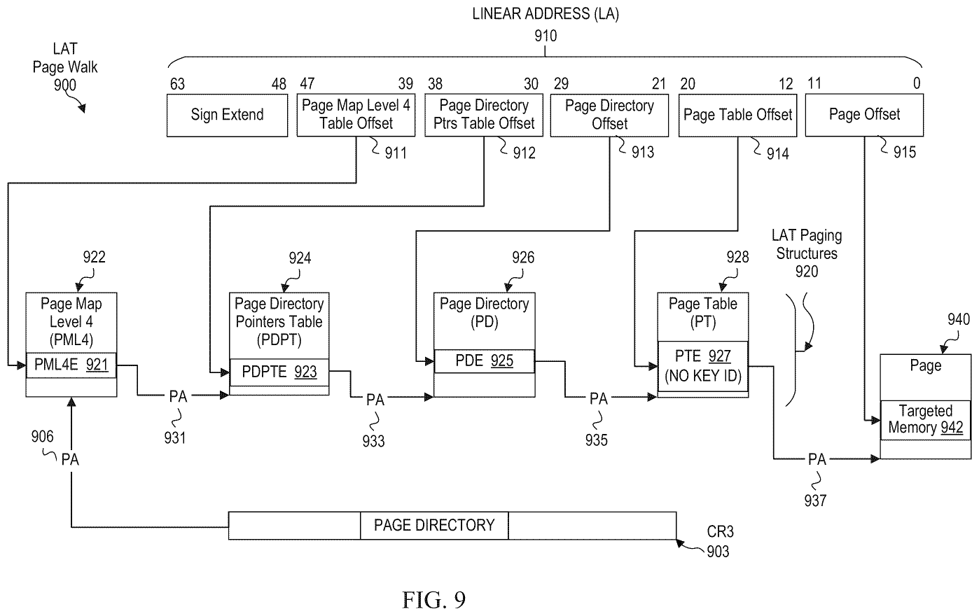

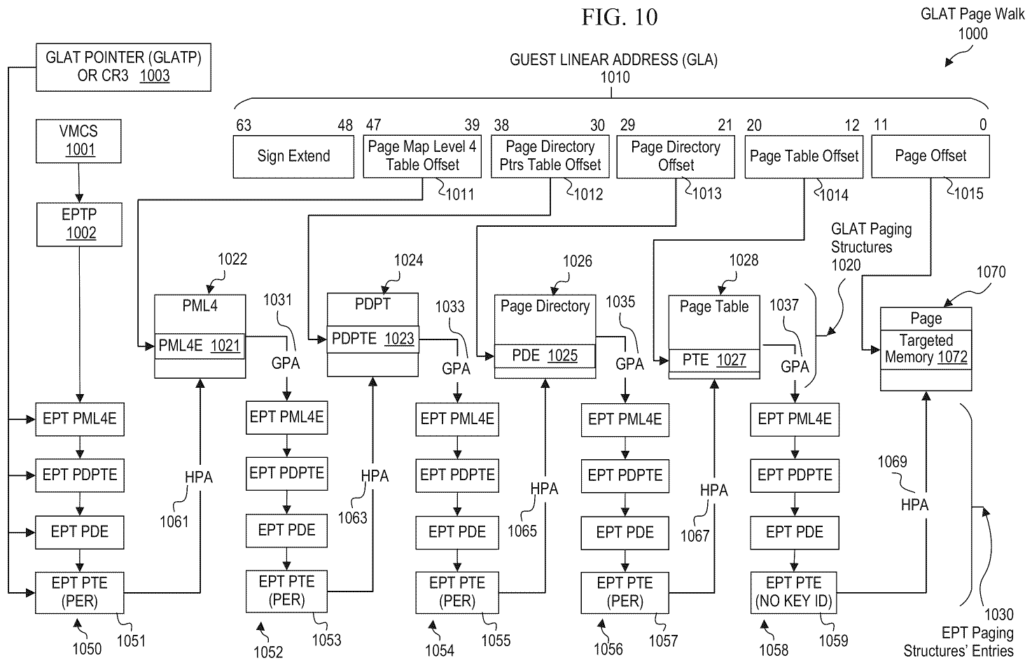

Hypervisor 220 also maintains virtual machine control structures (VMCS) 222A and 222B for each hardware thread. In the example of FIG. 2, without hyperthreading, the first VMCS 222A is utilized for the hardware thread of the first core 242A, and the second VMCS 222B is utilized for the hardware thread of second core 242B. Each VMCS specifies an extended page table pointer (EPTP) for the EPT paging structures. In addition, each VMCS specifies an GLAT pointer (GLATP) 226A and 226B to the GLAT paging structures 216 to be used with the EPT paging structures 228 during a page walk translation when a memory access request is made from one of the hardware threads. Address translation examples will be described in more detail with reference to FIGS. 9 and 10.

FIG. 3 is a block diagram illustrating an example multithreaded process 300 that could be created in a computing environment configured to isolate hardware threads of the process according to at least one embodiment. The example process 300 includes four hardware threads illustrated as hardware thread A 310, hardware thread B 320, hardware thread C 330, and hardware thread D 340. A single virtual (also known as “linear”) address space is defined for the multithreaded process 300. The hardware threads 310, 320, 330, and 340 share the virtual address space 301, which includes memory for code 302, data 304, and files 306. Stack memory allocated for each hardware thread may also be included in address space 301, but each individual stack may be accessed by the assigned hardware thread and may not be shared by the other hardware threads in the process.

Generally, a hardware thread corresponds to a physical central processing unit (CPU) or core of a processor (e.g., processor 140). A core typically supports a single hardware thread, two hardware threads, or four hardware threads. In an example of a single hardware thread per core, the four hardware threads run on separate cores. This is illustrated as a 4-core processor 350 in which hardware thread A 310, hardware thread B 320, hardware thread C 330 and hardware thread D 340 run on a core A 351A, a core B 351B, a core C 351C, and a core D 35D, respectively.

A core that supports more than one hardware thread may be referred to as ‘hardware multithreading.’ An example technology for hardware multithreading includes Intel® HyperThreading Technology. In a hardware multithreading example, two cores may support two threads each. This is illustrated as a 2-core processor 352 in which hardware threads 310 and 320 run on a core E 353A, and hardware threads 330 and 340 run on a core F 353B.

In yet another example, all four hardware threads 310, 320, 330, and 340 run on a single core G 355. This is illustrated as a 1-core processor 354. Some existing and future architectures, however, may support another number of hardware threads per core than what is illustrated in FIG. 3. Embodiments described herein are not limited to the number of hardware threads supported by the cores of a particular architecture and thus, one or more embodiments may be used with architectures supporting any number of hardware threads per core and any number of cores per processor.

Each hardware thread is provided with an execution context to maintain state required to execute the thread. The execution context can be provided in storage (e.g., registers) and a program counter (also referred to as an ‘instruction pointer register’ or ‘RIP’) in the processor. For hardware multithreading, registers provisioned for a core may be duplicated by the number of hardware threads supported by the core. For example, in one or more embodiments, a set of general and/or specific registers (e.g., 314, 324, 334, and 344) and a program counter (e.g., 316, 326, 336, and 346) for storing a next instruction to be executed may be provisioned for each hardware thread (e.g., 310, 320, 330, and 340). In one or more embodiments for isolating hardware threads, a respective set of group selector registers (HTGRs) (e.g., 312, 322, 332, and 342) may be provisioned for each hardware thread (e.g., 310, 320, 330, and 340). Depending on the embodiment, a respective key identifier register (HTKR) (e.g., 311, 321, 331, and 341) may be provisioned for each hardware thread (e.g., 310, 320, 330, and 340).

For private memories of hardware threads in the same process, unique key IDs may be assigned to the respective hardware threads by a privileged system component such as an operating system, for example. If HTKRs used, each key ID can be stored in the HTKR associated with the hardware thread to which the key ID is assigned. For example, a first key ID can be assigned to hardware thread 310 and stored in HTKR 311, a second key ID can be assigned to hardware thread 320 and stored in HTKR 321, a third key ID can be assigned to hardware thread 330 and stored in HTKR 331, and a fourth key ID can be assigned to hardware thread 340 and stored in HTKR 341.

Group selectors may be assigned to one or more hardware threads by a privileged system component such as an operating system, for example. For a given hardware thread, one or more group selectors (IDs) can be assigned to the hardware thread and stored in one of the HTGRs in the set of HTGRs associated with given hardware thread. For example, one or more group selectors can be assigned to hardware thread 310 and stored in one or more HTGRs 312, respectively. One or more group selectors can be assigned to hardware thread 320 and stored in one or more HTGRs 322, respectively. One or more group selectors can be assigned to hardware thread 330 and stored in one or more HTGRs 332, respectively. One or more group selectors can be assigned to hardware thread 340 and stored in one or more HTGRs 342, respectively. Group selectors for shared memory may be assigned to multiple hardware threads and stored in respective HTGRs of the hardware threads. If group selectors for private memory are used, then the group selectors for respective private memory regions are each assigned to a single hardware thread and stored in the appropriate HTGR associated with that hardware thread.

Generally, a software thread is the smallest executable unit of a process. One or more software threads may be scheduled (e.g., by an operating system) on each hardware thread of a process. A software thread maps to a hardware thread (e.g., on a single processor core) when executing. Multiple software threads can be multiplexed (e.g., time sliced/scheduled) on the same hardware thread and/or on a smaller number of hardware threads relative to the number of software threads. For embodiments using hardware thread registers (e.g., HTKR and/or HTGR), with each stop and start of a software thread (e.g., due to a scheduler/timer interrupt), the hardware thread HTKR and/or HTGRs will be re-populated by the kernel appropriately for the starting software thread. As shown in FIG. 3, a software thread 319 is scheduled to run on hardware thread 310, a software thread 329 is scheduled to run on hardware thread 320, a software thread 339 is scheduled to run on hardware thread 330, and a software thread 349 is scheduled to run on hardware thread 340. At least some techniques disclosed herein allow for software threads 319, 329, 339, and 349 to be isolated from each other. In addition, even within a single software thread, certain portions of code (also referred to herein as ‘compartments’) may need to be isolated from each other. For example, a single software thread may invoke multiple libraries that need to be isolated from each other.

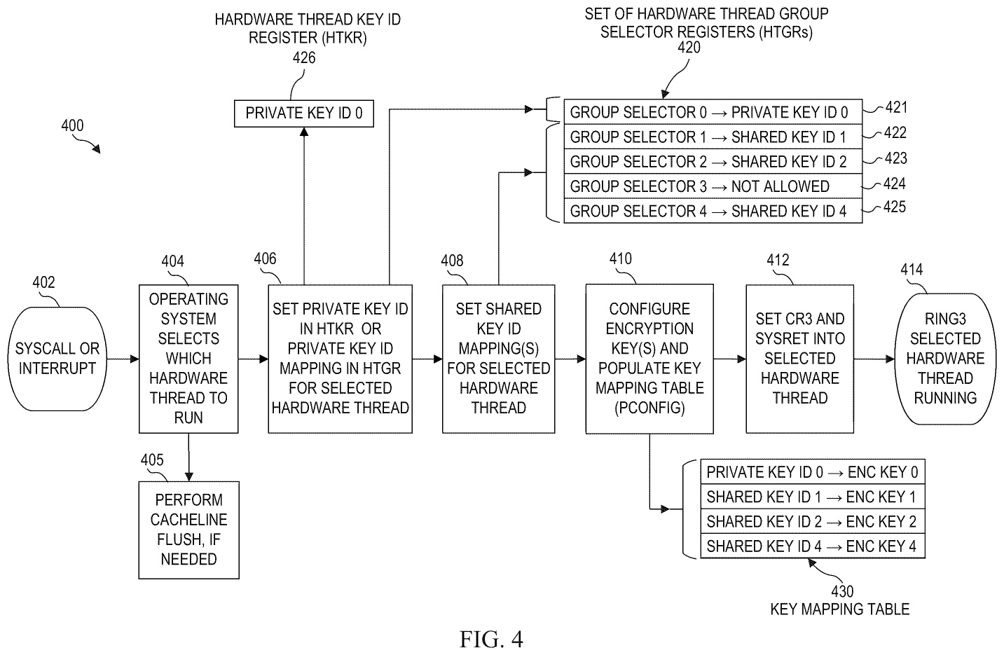

FIG. 4 illustrates a flow diagram of a process 400 to initialize registers for a hardware thread of a process according to at least one embodiment. Some processes invoke multiple functions (e.g., function as a service (FaaS) applications, multi-tenancy applications, etc.) in respective hardware threads. The hardware threads of the process may be launched at various times during the process. FIG. 4 may be associated with one or more operations to be performed in connection with launching a hardware thread of the process. The one or more operations of FIG. 4 may be performed for each hardware thread that is launched. A computing system (e.g., 100 or 200) may comprise means such as one or more processors (e.g., 140) for performing the operations. In one example, at least some operations shown in process 400 are performed by executing instructions of an operating system (e.g., 120) that initializes registers on a thread-by-thread basis for a process. Registers (e.g., 150A, 150B) may be provided for each hardware thread. Certain hardware thread-specific registers (e.g., HTKRs 156A and 156B, HTGRs 158A and 158B) of a given hardware thread can be used to assign one or more key IDs and/or group selectors to the hardware thread.

For illustrative purposes, a set of hardware thread group selector registers (HTGRs) 420 with example group selector-to-key ID mappings and a key mapping table 430 with example key ID-to-cryptographic key mappings are illustrated in FIG. 4. The set of HTGRs 420, the HTKR 426, and the key mapping table 430 illustrate examples of the sets of HTGRs 158A and 158B, the HTKRs 156A and 156B, and the key mapping table 162, respectively, of computing systems 100 and 200.

The set of HTGRs 420 may be populated by an operating system or other privileged software of a processor before switching control to the selected user space hardware thread that will use the set of HTGRs 420 in memory access operations. The key mapping table 430 in hardware (e.g., memory protection circuitry 160 and/or memory controller circuitry 148) or any other suitable storage (e.g., memory, remote storage, etc.) is populated with mappings from the private and shared key IDs assigned to the selected hardware thread to respective cryptographic keys. It should be understood, however, that the example mappings illustrated in FIG. 4 are for explanation purposes only. Greater or fewer mappings may be used for a given hardware thread based, at least in part, on a particular application being run, the number of different hardware threads used for the particular application, the number of HTGRs and/or HTKRs provisioned for hardware threads, and/or other needs and implementation factors. In one example, a functions-as-a-service process may need more hardware threads than an application that does not invoke many functions or other external modules.

At 402, a system call (SYSCALL) may be performed or an interrupt may occur to invoke the operating system or other privileged (e.g., Ring 0) software, which creates a process or a thread of a process. At 404, the operating system or other privileged software selects which hardware thread to run in the process. The hardware thread may be selected by determining which core of a multi-core processor to use. If the core implements multithreading, then a particular hardware thread (or logical processor) of the core can be selected. The operating system or other privileged software may also select which key ID(s) to assign to the selected hardware threads.

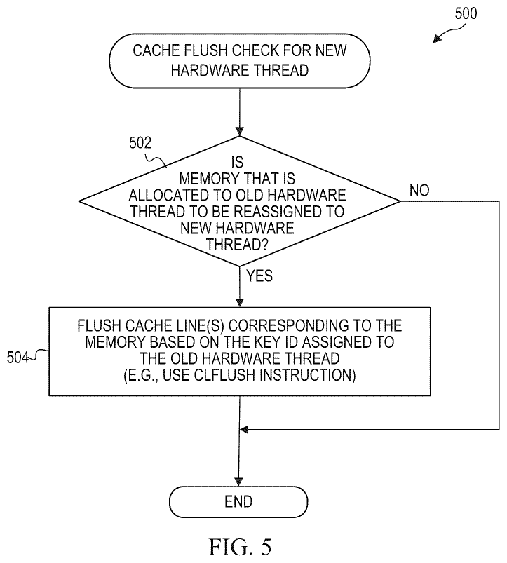

At 405, if private memory of another hardware thread, or shared memory is to be reassigned to the selected hardware thread to which a new key ID is to be assigned, a cache line flush can be performed, as will be further explained with reference to FIG. 5.

At 406, in one embodiment, the operating system or other privileged software sets a private key ID in the key ID register (HTKR) 426 for the selected hardware thread. The operating system or other privileged software can populate the HTKR 426 with the private key ID. In this scenario, a memory type (e.g., one-bit or multi-bit) may be encoded in the pointer (e.g., containing a linear address) that is used by software running on the selected hardware thread to perform memory accesses. For pointers to private memory of the hardware thread, the memory type can indicate that the memory address in the pointer is located in a private memory region of the hardware thread and that a private key ID for the private memory region is specified in the HTKR 426. The private key ID may be used to obtain a cryptographic key for encrypting or decrypting memory contents (e.g., data or code) when performing memory access operations in the private memory based on the pointer. Only the operating system or other privileged system software may be allowed to modify the HTKR 426.

In another embodiment, the separate HTKR 426 may be omitted. Instead, at 406, the operating system sets a mapping of the private key ID to a group selector in one HTGR 421 of the set of HTGRs 420 associated with the selected hardware thread. The HTGR 421 can be populated by the operating system. The group selector that is mapped to the private key ID in HTGR 421 is encoded in a pointer (e.g., linear address) used by software that is run by the selected hardware thread to access private memory associated with the selected hardware thread. Other hardware threads in the same process are not given access to the private key ID assigned to the selected hardware thread. Thus, only the hardware thread (or software threads running on the hardware thread) can use the private key ID for load and/or store operations. The private key ID may be used to obtain a cryptographic key for encrypting or decrypting memory contents (e.g., data or code) when performing memory operations in the private memory based on the pointer. In the example shown in FIG. 4, group selector 0 is mapped to private key ID 0 in HTGR 421. Only the operating system or other privileged system software may be allowed to modify the HTGR 421.

At 408, the operating system may populate the HTGR 420 with one or more group selector-to-key ID mappings for shared memory to be accessed by the selected hardware thread. In at least one embodiment, one or more group selectors can be mapped to one or more shared key IDs, respectively, that the selected hardware thread is allowed to use. The hardware thread is allowed to use the one or more shared key IDs for load and/or store operations in one or more shared memory regions, respectively. For example, a group selector mapped to a shared key ID in HTGR 420 can be encoded in a pointer (e.g., a linear address) used by software that is run by the selected hardware thread to access a particular shared memory region that the selected hardware thread is authorized to access. The software (e.g., a software thread) can use the pointer to access the shared memory region, which may be accessed by the selected hardware thread and by one or more other hardware threads of the same process. The shared key ID is assigned to the one or more other hardware threads to enable access to the same shared memory region. The shared key ID may be used to obtain a cryptographic key (if any) for encrypting or decrypting shared data during a store or load memory operation in the shared memory region by the software running on the selected hardware thread. A group selector (or multiple group selectors) may be mapped to a value indicating that no encryption is to be performed on the shared memory associated with the group selector. Thus, each hardware thread that uses a pointer encoded with that group selector would not perform encryption and decryption when accessing the shared memory region. In another implementation, a group selector (or multiple group selectors) may be mapped to a value indicating that access to memory associated with the group selector is not allowed by the hardware thread. This mapping may be useful for debugging.

HTGR 420 of FIG. 4 illustrates a populated example of group selector-to-key ID mappings in HTGRs 421, 422, 423, 424, and 425. As previously described, in some embodiments, group selector 0 is mapped to private key ID 0, which can be used only by the selected hardware thread associated with the set of HTGRs 420. In other embodiments, the private key ID may be stored in an HTKR without a group selector mapping. For shared memory regions that the selected hardware thread associated with the HTGRs 420 is allowed to access, group selector 1, group selector 2, and group selector 4 are mapped to shared key ID 1, shared key ID 2, and shared key ID 4, respectively, in mappings 422, 423, and 425. In these scenarios, the shared key IDs 1, 2, and 4 can be assigned to different areas of memory that are encrypted differently (e.g., using different cryptographic keys). The groups of hardware threads in the process that are allowed to access shared key IDs 1, 2, and 4, and therefore successfully decrypt data (or code) in the corresponding shared memory regions include at least one overlapping hardware thread and potentially more than one overlapping hardware thread.

Other mappings in HTGRs could be used to indicate memory associated with a group selector is in plaintext, or is not allowed to be accessed by the selected hardware thread. For example, mapping 424 includes group selector 3. Group selector 3 could be mapped to a value that indicates the data or code in the memory associated with group selector 3 is in plaintext, and therefore, no cryptographic key is needed. In another example where the data or code is in plaintext, the group selector 3 could be mapped to a key ID that is further mapped, in key mapping table 430, to a value that indicates no cryptographic key is available for that key ID. Thus, the memory can be accessed without needing decryption. Alternatively, group selector 3 may be mapped to a value indicating that the selected hardware thread is not allowed to access the key ID mapped to group selector 3. In this scenario, the selected hardware thread is not allowed to access the memory associated with the group selector 3, and landing on a key ID value indicating that the access is not allowed could be useful for debugging. In yet another example, group selector-to-key ID mappings may be omitted from the set of HTGRs 420 if the selected hardware thread is not allowed to access the key ID (and associated shared memory region) that is assigned to the group selector.

At 410, the hardware platform may be configured with the private and shared key IDs mapped to respective cryptographic keys. In one example, the key IDs may be assigned in key mapping table 430 in the memory controller by the BIOS or other privileged software. A privileged instruction may be used by the operating system or other privileged software to configure and map cryptographic keys to the key IDs in key mapping table 430. In some implementations, the operating system may generate or obtain cryptographic keys for each of the key IDs in HTGR 420 and/or in HTKR 426, and then provide the cryptographic keys to the memory controller via the privileged instruction. In other implementations, the memory controller circuitry may generate or obtain the cryptographic keys to be associated with the key IDs. Some nonlimiting examples of how a cryptographic key can be obtained include (but are not necessarily limited to), a cryptographic key being generated by a random or deterministic number generated, generated by using an entropy value (e.g., provided by operating system or hypervisor via a privileged instruction), obtained from processor memory (e.g., cache, etc.), obtained from protected main memory (e.g., encrypted and/or partitioned memory), obtained from remote memory (e.g., secure server or cloud storage and/or number generated), etc., or any suitable combination thereof. In one nonlimiting example, the privileged instruction to program a key ID causes the memory controller circuitry to generate or otherwise obtain a cryptographic key. One example privileged platform configuration instruction used in Intel® Total Memory Encryption Multi Key technology is ‘PCONFIG.’

The cryptographic keys may be generated based, at least in part, on the type of cryptography used to encrypt and decrypt the contents (e.g., data and/or code) in memory. In one example, Advanced Encryption Standard XEX Tweakable Block Ciphertext Stealing (AES XTS), or any other tweakable block cipher mode may be used. Generally, any suitable type of encryption may be used to encrypt and decrypt the contents of memory based on particular needs and implementations. For AES-XTS block cipher mode (and some others) memory cryptographic keys may be 128-bit, 256-bit, or more. It should be apparent that any suitable type of cryptographic key may be used based on the particular type of cryptographic algorithm used to encrypt and decrypt the contents stored in memory.

It should be noted that, in other implementations, the key mapping table 430 may be stored in memory, separate memory accessed over a public or private network, in the processor (e.g., cache, registers, supplemental processor memory, etc.), or in other circuitry. In the populated example key mapping table 430 of FIG. 4, cryptographic key 0, cryptographic key 1, cryptographic key 2, and cryptographic key 4 are mapped to private key ID 0, shared key ID 1, shared key ID 2, and shared key ID 4, respectively.

Once the key IDs are assigned to the selected hardware thread, at 412, the operating system or other privileged software may set a control register (e.g., control register 3 (CR3)) and perform a system return (SYSRET) into the selected hardware thread. Thus, the operating system or other privileged software launches the selected hardware thread.

At 414, the selected hardware thread starts running software (e.g., a software thread) in user space with ring 3 privilege, for example. In at least one embodiment, the selected hardware thread is limited to using the key IDs that are specified in the set of HTGRs 420 and/or HTKR 426 (if any). Other hardware threads can also be limited to using the key IDs that are specified in their own HTGRs and/or HTKR.

FIG. 5 illustrates a flow diagram of example operations a process 500 related to memory reassignment when using multi-key memory encryption for function isolation. One or more operations of FIG. 5 illustrate additional details of 405 of FIG. 4. The operations of FIG. 5 may be performed in connection with flushing cache when memory that is protected by an old key ID is reassigned to another hardware thread to which a new key ID is assigned. A computing system (e.g., 100) may comprise means such as one or more processors (e.g., 140) for performing the operations. In one example, at least some operations shown in process 500 are performed by executing instructions of an operating system (e.g., 120) or other privileged software. In an example scenario, process 500 may be performed during the creation of a new hardware thread, at least before the new hardware thread is launched.

At 502, a determination is made as to whether memory allocated to an old hardware thread is to be reassigned to a new hardware thread. In one example, the determination may be whether a memory range (or a portion thereof), which has been selected by the operating system or other privileged software to be allocated to a new hardware thread with a new key ID, was previously allocated for another hardware thread using an old key ID. If the memory range was previously allocated to another hardware thread, then the memory range could still be allocated to the other hardware thread. This scenario risks exposing the other hardware thread's data.

If the selected memory range (or a portion thereof) to be allocated to the new hardware thread was previously allocated for an old hardware thread using an old key ID, then at 504 a cache line flush may be performed. The cache line flush can be performed in the cache hierarchy based on the previously allocated memory addresses for the old hardware thread (e.g., virtual addresses and/or physical addresses appended with the old key ID) stored in the cache. The cache line flush can be performed before the selected memory range is reallocated to the new hardware thread with new memory addresses (e.g., virtual addresses containing a group selector mapped to a new key ID, physical addresses appended with a new private key ID). A cache line flush may include clearing one or more cache lines and/or indexes in the cache hierarchy used by the old hardware thread. Thus, when the selected memory range is accessed by the new hardware thread, old cache lines stored in cache hierarchy that correspond to the new memory addresses allocated to the new hardware thread are no longer present. In one example, a CLFLUSH instruction can be utilized to perform the required cache line flushing. Caches that can guarantee that only one dirty (modified) line may exist in the cache for any given memory location regardless of the key ID may avoid the need for flushing lines on key ID reassignments of a memory location. For example, if KeyID A was used to write to memory location 1, and then later KeyID B is used to write to the same memory location 1, KeyID A modification would first be evicted from the cache using Key A and then KeyID B (load or store) would cause the physical memory to be accessed again using Key B. At no time does the cache hold both KeyID A and KeyID B variants of the same physical memory location.

The process 500 of FIG. 5 can help avoid memory problems when using multi-key encryption to provide function isolation as disclosed herein. Cache line flushing can avoid a race condition that could otherwise potentially occur. For example, without performing cache line flushing, a stale entry in the cache could inadvertently or maliciously be written back to memory after the reassignment of the memory and overwrite new data of the new hardware thread with the stale data of the old hardware thread.

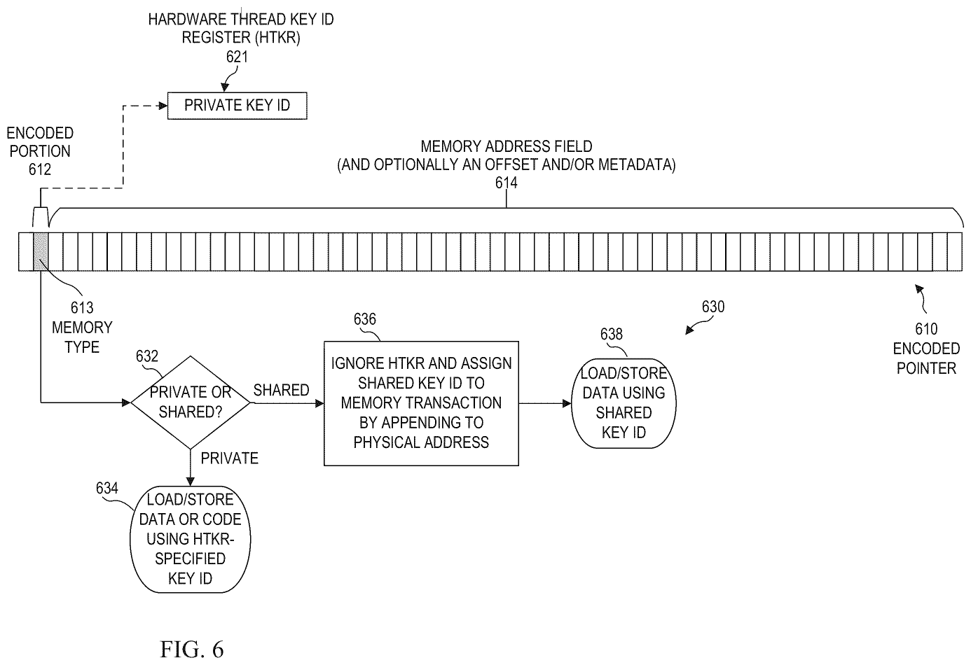

FIG. 6 is a schematic diagram of an illustrative encoded pointer 610 that may be generated for a hardware thread of a core (e.g., 142A, 142B) of a processor (e.g., 140) in a computing system (e.g., 100, 200). For example, a data pointer (e.g., 152A, 152B) can be generated by a software thread running in the hardware thread and requesting memory via appropriate instructions. The returned data pointer (e.g., 152A, 152B) may have the same or similar format as encoded pointer 610. An instruction pointer (e.g., 154A, 154B) may be generated for the processor to access code (e.g., instructions) of a software thread(s) running on the hardware thread and may have the same or similar format as encoded pointer 610.

The encoded pointer 610 includes a one-bit encoded portion 612 and a multi-bit memory address field 614. The memory address field 614 contains at least a portion of a linear address (e.g., also referred to herein as ‘virtual address’) of the memory location to be accessed. Depending on the particular implementation, other information may also be encoded in the multi-bit memory address field 614. Such information can include, for example, an offset and/or metadata (e.g., a memory tag, size, version, security metadata, etc.). Encoded pointer 610 may include any number of bits, such as, for example, 32 bits, 64 bits, 128 bits, less than 64 bits, greater than 128 bits, or any other number of bits that can be accommodated by the particular architecture. In one example, encoded pointer 610 may be configured as an Intel® x86 architecture 64-bit pointer.

In this embodiment, most thread memory accesses may be assumed to be private for the associated thread. A hardware thread key register (HTKR) 621 is provisioned in hardware for, and associated with the hardware thread. The HTKR 621 contains a private key ID that is assigned to the hardware thread and that can be used to access data and/or code that is private to the hardware thread. In at least some embodiments, a memory type 613 is specified in a pointer 610 to indicate whether data or code in the memory to be accessed is private or shared. For example, the memory type may be included in an encoded portion 612 of the pointer 610. A memory type that is included in the encoded portion 612 and indicates that shared memory is pointed to by the encoded pointer 610, allows cross thread data sharing and communication. User-space software may control setting a bit as the memory type 613 in the encoded portion 612 when memory is allocated and encoded pointer 610 is generated. For example, when the user-space software requests memory (e.g., via appropriate instructions such as malloc, calloc, etc.), the one-bit memory type 613 may be set by the user-space software to indicate whether the data written to, or read from, the linear address (from memory address field 614) is shared or private. Thus, the user-space software can control which key ID (e.g., a private key ID or a shared key ID or no key ID) is used for a particular memory allocation.

In one example, if the one-bit memory type 613 has a “1” value, then this could indicate that a private memory region of the thread is being accessed and that a private key ID specified in HTKR 621 is to be used when accessing the private memory region. The private key ID could be obtained from the HTKR 621 (e.g., similar to HTKRs 156A, 156B) associated with the hardware thread. If the one-bit memory type 613 has a “0” value, however, then this could indicate that a shared memory region is being accessed and that the shared memory region is unencrypted. Thus, no key ID is to be used in this case because the data (or code) being accessed is unencrypted. Alternatively, the “O” value could indicate that a shared memory region is being accessed and that a shared key ID is to be used to encrypt/decrypt the data or code being accessed based on the encoded pointer 610. In this embodiment, the shared key ID may be obtained via any suitable approach. For example, the key ID may be stored in (and retrieved from) memory or from another hardware thread register (e.g., hardware thread group key ID register) provisioned in hardware and associated with the hardware thread. In other implementations, the particular values indicating whether the memory being accessed is private or shared may be reversed, or additional bits (e.g., two-bit memory type, or more bits) may be used to encode the pointer with different values as the memory type. For example, a two-bit memory type could delineate between a private key ID, a shared key ID (or two different shared key IDs), and no key ID (e.g., for unencrypted memory).

FIG. 6 includes a flow diagram illustrating example logic flow 630 of possible operations in an embodiment providing cryptographic separation of hardware threads running in a shared process space. Logic flow 630 illustrates an example logic flow 630 having one or more operations that may occur in connection with a memory access request of a hardware thread in a process having multiple hardware threads. The memory access request is based on encoded pointer 610 generated for a particular memory area (e.g., private or shared memory allocation) that the hardware thread (or software thread run by the hardware thread) is allowed to access. The memory area may be a private memory allocation (e.g., containing data or code) that allocated to the hardware thread and that only the hardware thread is allowed to access. Alternatively, the memory area may be a shared memory allocation (e.g., containing data or code) that the hardware thread and one or more other hardware threads of the process are allowed to access. The memory access request may correspond to a memory access instruction to read or store data, or to a memory fetch stage for loading code (e.g., an executable instruction) to be executed by the hardware thread. A core (e.g., 142A or 142B) and/or memory controller circuitry (e.g., 148) of a processor (e.g., 140) can perform one or more operations of logic flow 630. In one example, one or more operations associated with logic flow 630 may be performed by an MMU (e.g., 145A or 145B) and/or by address decoding circuitry (e.g., 146A or 146B).

In this embodiment, a unique private key ID may be assigned to each hardware thread in the process so that contents stored in a private memory allocation of a hardware thread can only be accessed and successfully decrypted by that hardware thread. The contents (e.g., private data and/or code) that can be accessed using the private key ID may be encrypted/decrypted by the hardware thread based on a cryptographic key mapped to the private key ID (e.g., in a key mapping table or other suitable data structure). A private key ID may only be used by the particular hardware thread to which the private key ID is assigned. This embodiment allows for a private key ID assigned to a hardware thread to be stored in HTKR 621 provisioned in a processor core that supports the hardware thread.

In addition, this embodiment allows for a shared key ID (or no key ID) to be used by multiple hardware threads to access data in a shared memory region. In at least one scenario, a shared key ID may be assigned by privileged software (e.g., to multiple hardware threads) and used to allow the threads to communicate with each other or with other processes. The data in the shared memory region that can be accessed using the shared key ID may be encrypted/decrypted by the hardware threads based on a cryptographic key mapped to the shared key ID (e.g., in a key mapping table or other suitable data structure). In another scenario, the hardware threads may communicate with each other or with other processes using memory that is not encrypted (e.g., in plaintext) and therefore, a shared key ID is not needed.

With reference to logic flow 630, at 632, the core (e.g., 142A or 142B) and/or the memory controller circuitry (e.g., 148) determines a linear address based on the memory address field 614 in the pointer 610 associated with the memory access request. The core (e.g., 142A or 142B) and/or the memory controller circuitry (e.g., 148) determines whether the linear address points to private memory or to shared memory.

If the memory type 613 in pointer 610 indicates that the memory to be accessed is located in a private memory region of the hardware thread (e.g., if the one-bit memory type 613 is “1”), then at 634, the data or code pointed to by the linear address is loaded or stored (depending on the particular memory operation being performed) using HTKR 621, which specifies the private key ID for the hardware thread. The private key ID can be appended to a physical address corresponding to the linear address determined based on the memory address field 614. The data or code of the memory access request is loaded or stored (depending on the particular memory operation being performed) using the private key ID appended to the physical address. For example, the private key ID can be used to obtain a cryptographic key mapped to the private key ID. The cryptographic key can then be used to decrypt (e.g., for loading) or encrypt (e.g., for storing) the data or code that is loaded or stored at the physical address corresponding to the linear address.

If the memory type 613 in pointer 610 indicates that the memory to be accessed is shared (e.g., if the one-bit memory type 613 is “0”), then at 636, the HTKR 621 is ignored. Instead, the physical address is set to the shared key ID. In one example, the shared key ID could be retrieved from another hardware thread register designated for a shared key ID of the hardware thread. In another example, the shared key ID could be retrieved from memory. For example, the shared key ID can be appended to the physical address corresponding to the linear address 614 in the pointer 610. At 638, the data or code of the memory access request is loaded or stored (depending on the particular memory operation being performed) using the shared key ID appended to the physical address. For example, the shared key ID can be used to obtain a cryptographic key mapped to the shared key ID. The cryptographic key can then be used to encrypt (e.g., for storing) and/or decrypt (e.g., for reading) the data or code that is loaded from or stored in at the physical address corresponding to the linear address in the memory address field 614.

In another embodiment, if the data or code to be loaded from or stored in the physical address corresponding to the linear address in the memory address field 614 of pointer 610, the one-bit memory type 613 can indicate that memory pointed to by the linear address is unencrypted and therefore, no key ID is to be used. In this scenario, at 638, the plaintext data or code is loaded from or stored in (depending on the particular memory operation being performed) the physical address corresponding to the linear address in the memory address field 614 of the encoded pointer 610 without performing encryption or decryption operations.

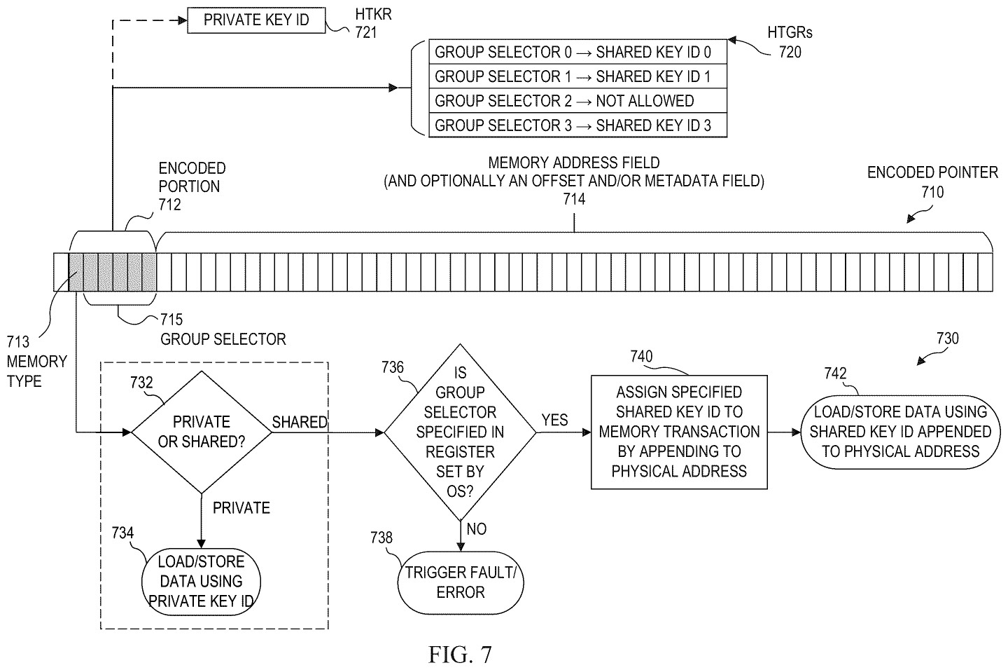

FIG. 7 is a schematic diagram of an illustrative encoded pointer architecture in which an encoded pointer 710 is generated for a hardware thread of a core (e.g., 142A, 142B) of a processor (e.g., 140). For example, a data pointer (e.g., 152A, 152B) can be generated by a software thread running in the hardware thread and may have the same format as encoded pointer 710. An instruction pointer (e.g., 154A, 154B) may be generated for the processor to access code (e.g., instructions) of a software thread(s) running on the hardware thread and may have the same format as encoded pointer 710.

The encoded pointer 710 includes a multi-bit encoded portion 712 and a multi-bit memory address field 714 containing a memory address. The memory address in the memory address field 714 contains at least a portion of a linear address of the memory location to be accessed. Depending on the particular implementation, other information may also be encoded in the pointer. Such information can include, for example, an offset and/or metadata (e.g., a memory tag, size, version, etc.). Encoded pointer 710 may include any number of bits, such as, for example, 64 bits, 128 bits, less than 64 bits, greater than 128 bits, or any other number of bits that can be accommodated by the particular architecture. In one example, encoded pointer 710 may be configured as an Intel® x86 architecture 64-bit pointer.

In this embodiment, data and/or code pointers having the format of encoded pointer 710 can be generated to enable a hardware thread to access private memory allocated to that hardware thread. An HTKR 721 is associated with the hardware thread and contains a private key ID that is assigned to the hardware thread to be used for accessing data and/or code in the private memory, as previously described herein for example, with respect to FIG. 6. In the embodiment shown in FIG. 7, however, an encoded portion 712 of the pointer 710 can include a memory type 713 and a group selector 715. The memory type 713 may be similar to the memory type 613 of FIG. 6 previously described herein. In FIG. 7, the memory type 713 can be set in a single bit in the encoded portion 712. The memory type can indicate whether the data or code pointed to by the linear address in the memory address field 714 of the encoded pointer 710 is private or shared. The memory type may be stored in a designated bit in the encoded portion 712 (shown as memory type 713 in FIG. 7), in another bit (or bits) in the pointer separate from the encoded portion 712, as a particular value of the bits (e.g., all zeros, all ones, any other recognized value) in the encoded portion 712, or in any other suitable manner or pointer encoding that may be determined based on the pointer used to access the private memory of the hardware thread.

Also in this embodiment, other data or code pointers having the format of encoded pointer 710 can be generated to enable two or more hardware threads in a process to access a shared memory region. For example, encoded pointer 710 may be generated for software running on a hardware thread of a process to access memory that can be shared by the hardware thread and one or more other hardware threads in the process. A group selector 715 may be used in the pointer for isolated sharing. Using the pointer-specified group selector 715, the hardware thread chooses from an operating system authorized set of group selectors as specified in the allowed set of group selector registers (HTGRs) 720 for the hardware thread. This determines the mapping between the pointer-specified group selector and the associated key ID. A fault can be raised if there is no allowed mapping for the hardware thread (e.g., if the pointer-specified group selector is not found in the HTGRs 720).

The encoded portion 712 may include a suitable number of bits to allow selection among a set of key IDs authorized by the operating system for the hardware thread. In at least some embodiments, the allowed set of key IDs can include both private key IDs and shared key IDs. In one example as shown, a 5-bit group selector may be included in the encoded portion 712 of pointer 710. In other scenarios, the group selector 715 may be defined as a 2-bit, 3-bit, 4-bit, 6-bit field or more. Also, as previously discussed, in some embodiments, the memory type may be implemented as part of the group selector, rather than a separate bit, and may be a predetermined group selector value (e.g., all ones or all zeros).

In embodiments associated with FIG. 7, memory accesses by a hardware thread of a multi-hardware threaded process may include accesses to one or more shared memory regions by the hardware thread and by one or more other hardware threads of the process. In one or more embodiments, a set of group selector registers (HTGRs) 720 (e.g., similar to the sets of HTGRs 158A and 158B), provisioned in a core of a processor for the hardware thread can be populated with one or more group selector-to-shared key ID mappings assigned to the hardware thread. The mappings can include group selectors mapped to respective shared key IDs that the hardware thread is authorized to use to obtain cryptographic keys. Data or code can be retrieved from (or stored in) a shared memory area based on a pointer (e.g., 710) encoded with a linear address pointing to the shared memory region. The pointer is also encoded with a particular group selector 715 that is mapped to a particular shared key ID in one of the HTGRs 720. The data or code referenced by the pointer 710 may be decrypted/encrypted with a cryptographic key mapped to the particular shared key ID in a key mapping table (e.g., similar to key mapping tables 162 and 430). In another scenario, data or code in a shared memory region may not be encrypted (e.g., plaintext) and therefore, a cryptographic key is not needed to access the plaintext shared memory area. Thus, the group selector could be mapped to a value indicating that the shared memory is in plaintext. In another implementation, the group selector could be mapped to a key ID, and in the key mapping table, the key ID could be mapped to a value indicating that the shared memory is in plaintext.

Grouped hardware threads of a process may communicate via data in the shared memory area that the grouped hardware threads are authorized to access. Embodiments described herein allow the grouped hardware threads to include all of the hardware threads of a process or a subset of the hardware threads of the process. In at least some scenarios, multiple groups having different combinations of hardware threads in a process may be formed to access respective shared memory regions. Two or more hardware threads in a process may be grouped based on a group selector that is included in an encoded portion (e.g., 712) of a pointer that includes at least a portion of a linear address to the shared memory region. Additionally, the shared memory region may be any size of allocated memory (e.g., a cache line, multiple cache lines, a page, multiple pages, etc.).

By way of illustration, a process may be created with three hardware threads A, B, and C, and pointer 710 is generated for hardware thread A (or a software thread run by hardware thread A). Four group selectors 0, 1, 2, and 3, are generated to be mapped to four key IDs 0, 1, 2, and 3 and the mappings are assigned to different groups that may be formed by two or three of the hardware threads A, B, and C. For example, shared key ID 0 could be assigned to hardware thread A and B (but not C) allowing only threads A and B to communicate via a first shared memory area. Shared key ID 1 could be assigned to hardware threads A and C (but not B) to enable only threads A and C to communicate via a second shared memory area. Shared key ID 2 could be assigned to hardware threads B and C (but not A) to enable only threads B and C to communicate via a third shared memory area. Shared key ID 3 could be assigned to hardware threads A, B and C to enable all three threads A, B, and C of the process to communicate via a fourth shared memory area.

Based on the example illustration of hardware threads A, B, and C, a set of HTGRs 720 of hardware thread A, illustrated in FIG. 1, are populated (e.g., by an operating system or other privileged software) with group selector 0, group selector 1, and group selector 3 mapped to shared key ID 0, shared key ID 1, and shared key ID 3, respectively. In this scenario, group selector 2 may not be populated in any of the HTGRs 720 because group selector 2 would be mapped to shared key ID 2, which hardware thread A is not allowed to use. Alternatively, group selector 2 may be populated in one of the HTGRs 720, but mapped to a value indicating that use of the key ID 2 mapped to group selector 2 is blocked. Thus, hardware thread A (and its corresponding software threads) would be unable to access plaintext in the third shared memory area since the HTGR containing the group selector 2 does not provide a mapping to shared key ID 2.

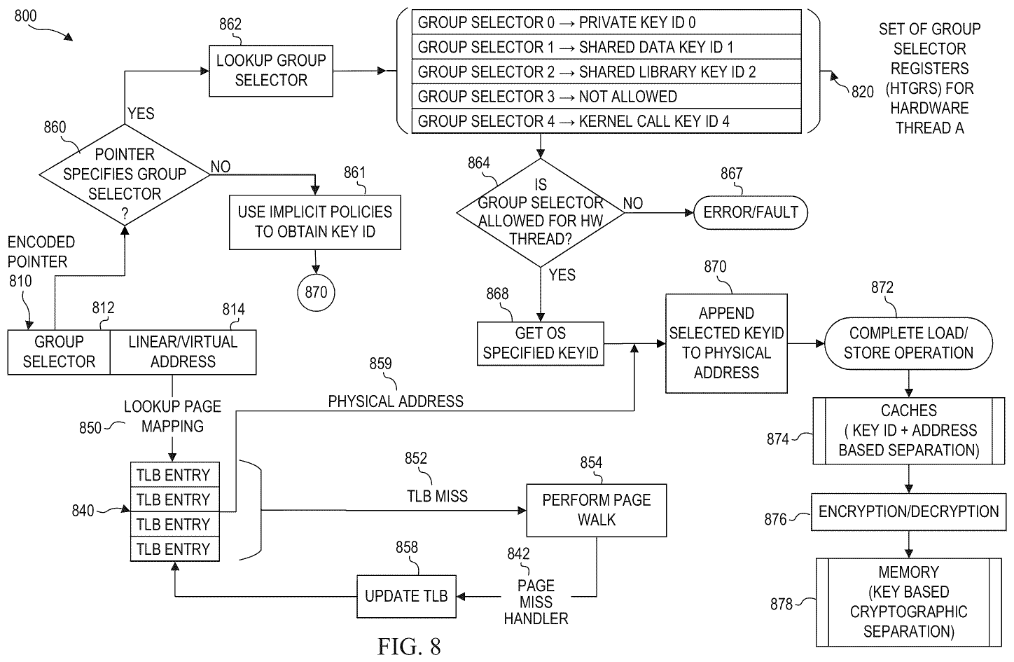

In some embodiments, a private key ID assigned to a hardware thread may also be included in an HTGR of that hardware thread. When stored in an HTGR, such as HTGR 720, a private key ID may be mapped to unique group selector that is only assigned to the hardware thread associated with that HTGR. In this embodiment, which is further shown and described with respect to FIG. 8, a separate HTKR for the hardware thread could be omitted.

FIG. 7 includes a flow diagram illustrating example logic flow 730 of possible operations in another embodiment providing sub-page cryptographic separation of hardware threads running in a shared process space. Logic flow 730 illustrates one or more operations that may occur in connection with a memory access request of a hardware thread in a process having multiple hardware threads. The memory access request is based on encoded pointer 710 generated for the hardware thread. More specifically, encoded pointer 710 may be generated for a particular memory area (e.g., private or shared memory allocation) that the hardware thread (or software thread run by the hardware thread) is allowed to access. The memory area may be a private memory allocation (e.g., containing data or code) that is allocated to the hardware thread and that only the hardware thread is allowed to access. Alternatively, the memory area may be a shared memory allocation (e.g., containing data or code) that the hardware thread and one or more other hardware threads of the process are allowed to access. The memory access request may correspond to a memory access instruction to read or store data, or to a memory fetch stage for loading code (e.g., an executable instruction) to be executed by the hardware thread. A core (e.g., 142A or 142B) and/or memory controller circuitry (e.g., 148) of a processor (e.g., 140) can perform one or more operations of logic flow 730. In one example, one or more operations associated with logic flow 730 may be performed by an MMU (e.g., 145A or 145B) and/or by address decoding circuitry (e.g., 146A or 146B).

Operations represented by 732 and 734 may be performed in embodiments that provide for a separate hardware thread key register (e.g., HTKR 721) for storing a private key ID assigned to the hardware thread. At 732, the core (e.g., 142A or 142B) and/or the memory controller circuitry (e.g., 148) determines a linear address based on the memory address field 714 in the pointer 710 associated with the memory access request. The core (e.g., 142A or 142B) and/or the memory controller circuitry (e.g., 148) determines whether the linear address points to private memory or to shared memory.

If the memory type 713 in pointer 710 indicates that the memory to be accessed is located in a private memory region of the hardware thread (e.g., if the one-bit memory type 713 is “1”), or if the predetermined value in the encoded portion 712 indicates that the memory to be accessed is located in a private memory region of the hardware thread (e.g., if the encoded portion 712 contains all ones or some other known value), then at 734, the data or code pointed to by the linear address is loaded or stored (depending on the particular memory operation being performed) using HTKR 721, which specifies the private key ID for the hardware thread. The private key ID can be appended to a physical address corresponding to the linear address determined based on the memory address field 714. The data or code of the memory access request is loaded or stored (depending on the particular memory operation being performed) using the private key ID appended to the physical address. For example, the private key ID can be used to obtain a cryptographic key mapped to the private key ID. The cryptographic key can then be used to decrypt (e.g., for loading) or encrypt (e.g., for storing) the data or code that is loaded or stored at the physical address corresponding to the linear address. It should be noted that, in another embodiment, the memory type may be implemented as predefined values in the encoded portion 712 (e.g., an all ones value indicates private memory and all zeros indicates shared memory or vice versa).

At 732, if the memory type 713 in pointer 710 indicates that the memory to be accessed is shared (e.g., if the one-bit memory type 713 is “0”), or if the predetermined value in the encoded portion 712 indicates that the memory to be accessed is shared (e.g., if the encoded portion 712 contains all zeroes), then the flow continues at 736. At 736, a determination is made as to whether the group selector 715 in the encoded portion 712 is specified in one of the HTGRS in the set of HTGR 720. If the group selector is not specified in one of the HTGRs, then a fault or error is triggered at 738 because the operating system (or other privileged software) did not assign the group selector to the hardware thread. Alternatively, the operating system (or other privileged software) may have assigned the group selector to the hardware thread, but not assigned the group selector-to-key ID mapping to the hardware thread. In this scenario, the hardware thread does not have access to the appropriate key ID associated with the memory referenced by pointer 710. Therefore, the hardware thread cannot obtain the appropriate cryptographic key needed to encrypt/decrypt the contents (e.g., data or code) at the memory address referenced by pointer 710.

If a determination is made at 736 that the group selector 715 in the encoded portion 712 is specified in one of the HTGRs 720, then at 740, core (e.g., 142A or 142B) and/or the memory controller circuitry (e.g., 148) assigns the shared key ID that is mapped to group selector in the identified HTGR to the memory transaction. In at least one embodiment, this is achieved by appending the shared key ID to the physical address corresponding to the linear address referenced in the memory address field 714 of pointer 710. In one example, translation tables may be walked using the linear address of pointer 710 to obtain the corresponding physical address.

Once the shared key ID is appended to the physical address, at 742, the memory operation (e.g., load or store) may be performed using the shared key ID appended to the physical address. The appended shared key ID can be used to search a key mapping table to find the key ID and obtain a cryptographic key that is mapped to the key ID in the table. The cryptographic key can then be used to encrypt and/or to decrypt the data or code to be read and/or stored at the physical address.

FIG. 8 is a flow diagram illustrating an example logic flow 800 of possible operations in yet another embodiment providing sub-page cryptographic separation of hardware threads running in a shared process space. Logic flow 800 illustrates one or more operations that may occur in connection with a memory access request of a hardware thread in a process having multiple hardware threads. The memory access request is based on an encoded pointer 810 generated for the hardware thread. More specifically, encoded pointer 810 may be generated for a particular memory area (e.g., private or shared memory region) that the hardware thread (or software thread run by the hardware thread) is allowed to access. The memory area may be a private memory region (e.g., containing data or code) that is allocated to the hardware thread and that only the hardware thread is allowed to access. Alternatively, the memory area may be a shared memory region (e.g., containing data or code) that is allocated for the hardware thread and one or more other hardware threads of the process to access. The memory access request may correspond to a memory access instruction to read or store data, or to a memory fetch stage for loading code (e.g., an executable instruction) to be executed by the hardware thread. A core (e.g., 142A or 142B) and/or memory controller circuitry (e.g., 148) of a processor (e.g., 140) can perform one or more operations of logic flow 800. In one example, one or more operations (e.g., 840-859 and 870-878) associated with logic flow 800 may be performed by, or in conjunction with, an MMU (e.g., 145A or 145B), a TLB (e.g., 147A or 147B), and/or by address decoding circuitry (e.g., 146A or 146B). One or more other operations (e.g., 860-868) associated with logic flow 800 may be performed by, or in conjunction with a core (e.g., 142A, 142B).

The encoded pointer 810 used in logic flow 800 may have a format similar to the pointer 710 in FIG. 7. For example, pointer 810 may include a multi-bit group selector 812 and a multi-bit linear/virtual address 814. In this embodiment, the single bit to specify memory type (e.g., 713 in encoded pointer 710) may be omitted or used as part of group selector 812. The linear address 814 indicated in encoded pointer 810 includes at least a portion of a linear address of a memory location to be accessed. Depending on the particular implementation, other information may also be encoded in the pointer. Such information can include, for example, an offset and/or metadata (e.g., a memory tag, size, version, etc.). Encoded pointer 810 may include any number of bits, such as, for example, 64 bits, 128 bits, less than 64 bits, greater than 128 bits, or any other number of bits that can be accommodated by the particular architecture. In one example, encoded pointer 710 may be configured as an Intel® x86 architecture 64-bit pointer.

The group selector 812 in pointer 810 may be used to identify a key ID in a set of hardware thread group selector registers (HTGRs) 820. The use of a group selector in logic flow 800, is similar to the use of group selector 715 in logic flow 730, which has been previously described herein. In the embodiment shown in FIG. 8, however, the set of HTGRs 720 can include a mapping of a group selector to a private key ID that is used to access private memory of the hardware thread associated with the set of HTGRs 720. The set of HTGRs 820 can also include mappings of group selectors to shared key IDs as previously described with respect to the set of HTGRs 720 in FIG. 7. Thus, group selector 812 of encoded pointer 810 may be used to identify a key ID in the set of HTGRs 820 for shared memory accesses or private memory accesses.

For illustration purposes, the hardware thread associated with the set of HTGRs 820 may be referred to herein as “hardware thread A” to distinguish hardware thread A from other hardware threads running in the same process. Hardware thread A is one of multiple hardware threads in a process. A different set of HTGRs (not shown) is provisioned for each of the multiple hardware threads in the process. An operating system or other privileged software (e.g., operating system, Ring 0 software) sets the mappings in the set of HTGRs 820 to key IDs that hardware thread A is allowed to use. Because hardware thread A is unprivileged software (e.g., Ring 3), hardware thread A can choose from the operating system (or other Ring 0 software) authorized set of group selectors as specified in the set of HTGRs 820, but cannot change the mappings in the HTGRs. In some examples, code libraries may also specify key IDs in code pointers and held in the instruction pointer register (e.g., RIP).

In the set of HTGRs 820, group selector 0 is mapped to a private key ID that can be used by hardware thread A to access private memory allocated to hardware thread A. Group selectors 1, 2, and 4 are mapped to respective shared key IDs that can be used by hardware thread A to access a shared memory allocated to hardware thread A or another hardware thread in the process. The shared key IDs can also be used by other hardware threads in the respective groups allowed to access the shared memory allocations. In this example, group selector 1 is mapped to a shared data key ID 1. Group selector 2 is mapped to a shared library key ID 2. Group selector 3 is mapped to a value indicating that hardware thread A is not allowed to use a key ID mapped to group selector 3. Group selector 4 is mapped to a kernel call key ID 4.

In some embodiments, a code pointer held in a RIP register (e.g., 154A, 154B) may be encoded with a group selector mapped to a key ID, as shown in encoded pointers 710 and 810. In other embodiments, code libraries may specify key IDs in the code pointers that are held in the RIP register. In this case, the key ID for decrypting the fetched code would be encoded directly into the code pointer instead of the group selector.

Another architectural element illustrated in FIG. 8 is a translation lookaside buffer (TLB) 840 (e.g., similar to TLB 147A or 147B of FIG. 1). TLB 840 may comprise a memory cache to store recent translations of linear memory addresses to physical memory addresses for faster retrieval by a processor. Generally, a TLB maps linear addresses (which may also be referred to as virtual addresses) to physical addresses. A TLB entry is populated after a page miss when a page is not found in main memory. In this scenario, a page walk of the paging structures determines the correct linear to physical memory mapping, and the linear to physical mapping can be cached in the TLB for fast lookup. Typically, a TLB lookup is performed by using a linear address to find a corresponding physical address to which the linear address is mapped. The TLB lookup itself may be performed for a page number. In an example having 4 Kilobyte (KB) pages, the TLB lookup may ignore the twelve least significant bits since those addresses pertain to the same 4 KB page.

The logic flow of FIG. 8 illustrates example operations associated with a memory access request based on encoded pointer 810. Initially, encoded pointer 810 is generated for a particular memory area that hardware thread A (or a software thread run by hardware thread A) is allowed to access. In this example, the memory area could be a private memory area that the key ID 0 is used to encrypt/decrypt, a shared data memory area that the shared data key ID 1 is used to encrypt/decrypt, a shared library that the shared library key ID 2 is used to encrypt, or kernel memory that the kernel call key ID 3 is used to encrypt/decrypt.

In response to a memory access request associated with hardware thread A and based on encoded pointer 810, the core (e.g., 142A or 142B) and/or memory controller circuitry (e.g., 148) of a processor (e.g., 140) can perform one or more memory operations 850-878 to complete a memory transaction (or to raise an error, if appropriate). At 850, a page lookup operation may be performed in the TLB 840. The TLB may be searched using the linear address 814 obtained (or derived) from pointer 810, while ignoring the group selector 812. In some implementations, the memory address bits in pointer 810 may include only a partial linear address, and the actual linear address may need to be derived from the encoded pointer 810. For example, some upper bits of the linear address may have been used to encode group selector 812, and the actual upper linear address bits may be inserted back into the linear address. In another scenario, a portion of the memory address bits in the encoded pointer 814 may be encrypted, and the encrypted portion is decrypted before the TLB page lookup operation 850 is performed. For simplicity, references to the linear address obtained or derived from encoded pointer 810 will be referenced herein as linear address 814.

Once the linear address 814 is determined and found in TLB 840, then a physical address to the appropriate physical page in memory can be obtained from TLB 840. If the linear address 814 is not found in TLB 840, however, then a TLB miss 852 has occurred. When a TLB miss 852 occurs, then at 854, a page walk is performed on paging structures of the process in which hardware thread A is running. Generally, the page walk involves starting with a linear address to find a memory location in paging structures created for an address space of a process, reading the contents of multiple memory locations in the paging structures, and using the contents to compute a physical address of a page frame corresponding to a page, and a physical address within the page frame. Example page walk processes are shown and described in more detail with reference to FIGS. 9 and 10.

Once the physical address is found in the paging structures during the page walk, a page miss handler 842 can update the TLB at 858 by adding a new TLB entry in the TLB 840. The new TLB entry can include a mapping of linear address 814 to a physical address obtained from the paging structures at 854 (e.g., from a page table entry leaf). In one example, in the TLB 840, the linear address 814 may be mapped to a page frame number of a page frame (or base address of the physical page) obtained from a page table entry of the paging structures. In some scenarios, a calculation may be performed on the contents of a page table entry to obtain the base address of the physical page.

Once the linear address 814 is determined from encoded pointer 810, other operations 860-868 may be performed to identify a key ID assigned to hardware thread A for a memory area accessed by pointer 810. Operations to identify a key ID may be performed before, after, or at least partially in parallel with operations to perform the TLB lookup, page walk, and/or TLB update.

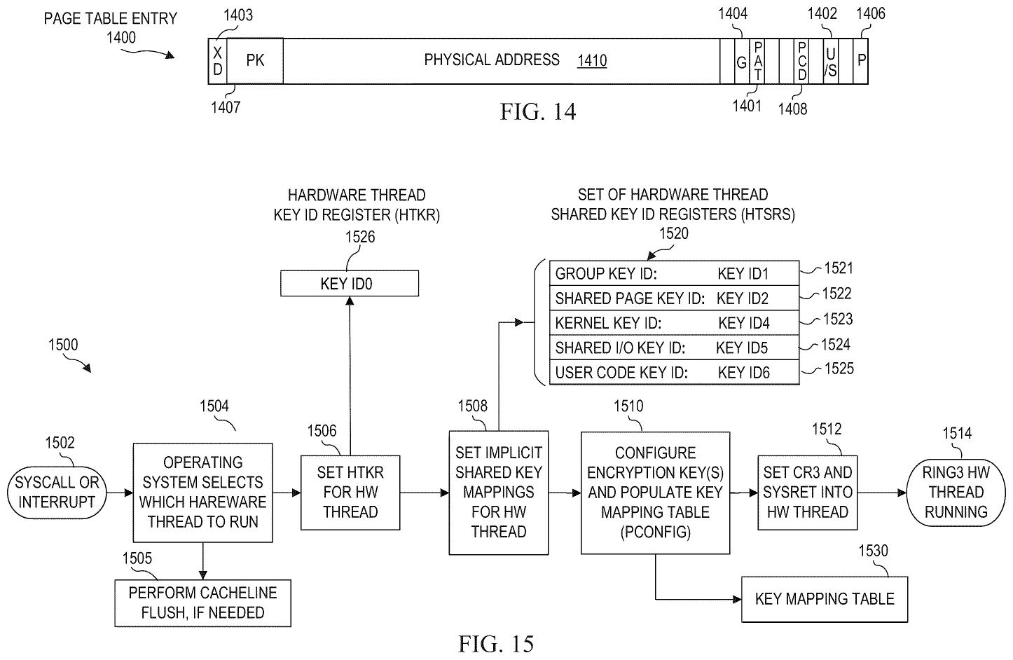

At 860, a determination may be made as to whether the pointer 810 specifies a group selector (e.g., 812). If pointer 810 does not specify a group selector, then a regular memory access (e.g., without encryption/decryption based on key IDs assigned to hardware threads) may be performed using pointer 810. Alternatively, at 861, the processor may use an implicit policy to determine which key ID should be used. Implicit policies will be further described herein with reference to FIGS. 14-16.

If pointer 810 specifies a group selector, such as group selector 812, then at 862, a key ID lookup operation is performed in the set of HTGRs 820 for hardware thread A. The HTGR 820 may be searched based on group selector 812 from encoded pointer 810.

At 864, a determination is made as to whether a group selector stored in one of the HTGRs 370 matches (or otherwise corresponds to) the group selector 812 from encoded pointer 810. If a group selector matching (or otherwise corresponding to) the group selector 812 is not found in the set of HTGRs 820, then hardware thread A is not allowed to access the memory protected by group selector 812. In this scenario, at 867, an error may be raised, a fault may be generated, or any other suitable action may be taken. In other implementations, as shown in FIG. 8, a group selector (e.g., group selector 3) of shared memory that a hardware thread is not allowed to access may be stored in an HTGR of that hardware thread. The hardware thread in this case can be mapped to a value indicating that the hardware thread is not allowed to access the memory associated with that group selector. In yet other implementations, a group selector for memory storing plaintext data that a hardware thread is allowed to access may be stored in an HTGR of that hardware thread. In this scenario, the hardware thread can be mapped to a value indicating that the hardware thread is allowed to access the shared memory, but that encryption/decryption is not to be performed.

At 864, if a group selector stored in one of the HTGRs 820 matches (or otherwise corresponds to) the group selector 812 from pointer 810, then at 868, the key ID mapped to the stored group selector is retrieved from the appropriate HTGR in the set of HTGRs 820. For example, if group selector 812 matches group selector 0 stored in the first HTGR of the set of HTGRs 720, then the private key ID 0 is retrieved from first HTGR. If group selector 812 matches group selector 1 stored in the second HTGR of the set of HTGRs 720, then shared data key ID 1 is retrieved from second HTGR. If group selector 812 matches group selector 2 stored in the third HTGR of the set of HTGRs 820, then shared library key ID 2 is retrieved from third HTGR. If group selector 812 matches group selector 4 stored in the fifth HTGR of the set of HTGRs 820, then kernel call key ID 4 is retrieved from the fifth HTGR.

At 870, the key ID retrieved from the set of HTGRs 820 (or obtained based on implicit policies at 861) is assigned to the memory transaction. The retrieved key ID can be assigned to the memory transaction by appending the retrieved key ID to the physical address 859 obtained from the TLB entry identified in response to the lookup page mapping at 850, and possibly the page walk at 854. In at least one embodiment, the retrieved key ID can be appended (e.g., concatenated) to the end of the physical address. The physical address may be a base address of a page frame (e.g., page frame number*size of page frame) combined with an offset from the linear address 814.

At 872, the memory transaction can be completed. The memory transaction can include load or store operations using the physical address with the appended key ID. For a load operation, at 872, memory controller circuitry (e.g., 148) may fetch one or more cache lines of data or code from memory (e.g., 170) based on the physical address. When the data or code is fetched from memory, the key ID appended to the physical address is ignored. If the data or code is stored in cache, however, then one or more cache lines containing the data or code can be loaded from cache at 874. In cache, the one or more cache lines containing data or code are stored per cache line based on the physical address with the appended key ID. Accordingly, cache lines are separated in the cache according to the key ID and physical address combination, and adjacent cache lines from memory that are encrypted/decrypted with the same key ID can be adjacent in the cache.

Once the data or code is fetched from memory or cache, at 876, memory protection circuitry (e.g., 160) can search a key mapping table (e.g., 162, 430) based on the key ID appended to the physical address to identify a cryptographic key that is mapped to the key ID. A cryptographic algorithm (e.g., 164) of the memory protection circuitry can be used to decrypt the one or more fetched cache lines based, at least in part, on the cryptographic key identified in the key mapping table. At 874, the decrypted cache line(s) of data or code can be moved into one or more registers to complete the load transaction.

For a store operation, one or more cache lines of data may be encrypted and then moved from one or more registers into a cache (e.g., caches 144A or 144B) and eventually into memory (e.g., 170). Initially, the key ID appended to the physical address where the data is to be stored is obtained. The memory protection circuitry (e.g., 160) can search the key mapping table (e.g., 162, 430) based on the key ID to identify a cryptographic key that is mapped to the key ID. At 876, a cryptographic algorithm (e.g., 164) of the memory protection circuitry can be used to encrypt the one or more cache lines of data based, at least in part, on the cryptographic key identified in the key mapping table. At 874, the encrypted one or more cache lines can be moved into cache. In cache, the one or more cache lines containing data are stored per cache line based on the physical address with the appended key ID, as previously described.

In at least some scenarios, at 878, the one or more stored cache lines may be moved out of cache and store in memory. Cache lines are separated in memory using key-based cryptography. Thus, adjacent cache lines accessed using the same encoded pointer (e.g., with the same group selector) may be encrypted based on the same cryptographic key. However, any other cache lines in the same process address space (e.g., within the same page of memory) that are accessed using a different encoded pointer having a different group selector, can be cryptographically separated from cache lines accessed by another encoded pointer with another group selector.

It should be noted that the logic flow 800 assumes that data and code is encrypted when stored in cache. This is one nonlimiting example implementation. In other architectures, at least some caches (e.g., L1, L2) may store the data or code in plaintext. Thus, in these architectures, one or more cache lines containing plaintext data or code are stored per cache line based on the physical address with the appended key ID. Additionally, the operations to decrypt data or code for a load operation may not be needed if the data or code is loaded from the cache. Conversely, the operations to encrypt data for a store operation may be performed when data is moved from the cache to the memory, or when the data is stored directly in memory or any other cache or storage outside the processor.

It should be noted that, in at least one embodiment, memory operations of a memory transaction may be performed in parallel, in sequence, or partially in parallel. In one example, when a memory access request is executed, operations 850-859 to obtain the physical address corresponding to the linear address 814 of the pointer 810 can be performed at least partially in parallel with operations 860-868 to identify the key ID assigned to the hardware thread for memory accessed by pointer 810.

FIG. 9 is a flow diagram of an example linear address translation (LAT) page walk 900 of example LAT paging structures 920. The LAT page walk 900 illustrates a mapping of a linear address (LA) 910 to a physical address (PA) 937 of a physical page 970. The physical page 970 includes targeted memory 942 (e.g., data or code) at a final physical address into which the LA 910 is finally translated. The final physical address may be determined by indexing the physical page. The physical page 940 can be indexed by using the physical page's PA (e.g., PA 937) determined from the LAT page walk 900 and a portion of the LA 910 as an index.

The LAT page walk 900 is performed by a processor (e.g., MMU 145A or 145B of processor 140) walking LAT paging structures 920 to translate the LA 910 to the PA 937. LAT paging structures 920 are representative of various LAT paging structures (e.g., 172, 854) referenced herein. Generally, LAT page walk 900 is an example page walk that may occur in any of the embodiments herein that are implemented without extended page tables and in which a memory access request (e.g., read, load, store, write, move, copy, etc.) is invoked based on a linear address in a process address space of a multithreaded process.

The LAT paging structures 920 can include a page map level 4 table (PML4) 922, a page directory pointer table (PDPT) 924, a page directory (PD) 926, and a page table (PT) 928. Each of the LAT paging structures 920 may include entries that are addressed using a base and an index. Entries of the LAT paging structures 920 that are located during LAT page walk 900 for LA 910 include PML4E 921, PDPTE 923, PDE 925, and PTE 927.

During the walk through the LAT paging structures 920, the index into each LA paging structure can be provided by a unique portion of the GLA 1010. The entries in the LA paging structures that are accessed during the LAT page walk, prior to the last level PT 928, each contain a physical address (e.g., 931, 933, 935), which may be in the form of a pointer, to the next LA paging structure in the paging hierarchy. The base for the first table (the root) in the paging hierarchy of the LAT paging structures, which is PML4 922, may be provided by a register, such as CR3 903, which contains PA 906. PA 906 represents the base address for the first LAT paging structure, PML4 922, which is indexed by a unique portion of LA 910 (e.g., bits 47:39 of LA), indicated as a page map level 4 table offset 911. The identified entry, PML4E 921, contains PA 931.

PA 931 is the base address for the next LAT paging structure in the LAT paging hierarchy, PDPT 924. PDPT 924 is indexed by a unique portion of LA 910 (e.g., bits 30:38 of LA), indicated as a page directory pointers table offset 912. The identified entry, PDPTE 923, contains PA 933.

PA 933 is the base address for the next LAT paging structure in the LAT paging hierarchy, PD 926. PD 926 is indexed by a unique portion of LA 910 (e.g., bits 21:29 of LA), indicated as a page directory offset 913. The identified entry, PDE 925 contains PA 935.

PA 935 is the base address for the next LAT paging structure in the LAT paging hierarchy, PT 928. PT 928 is indexed by a unique portion of LA 910 (e.g., bits 12:20 of LA), indicated as a page table offset 914. The identified entry, PTE 927, contains the PA 937.

PA 937 is the base address for the physical page 940 (or page frame) that includes a final physical address to which the LA 910 is finally translated. The physical page 970 is indexed by a unique portion of LA 910 (e.g., bits 0:11 of LA), indicated as a page offset 915. Thus, the LA 910 is effectively translated to a final physical address in the physical page 940. Targeted memory 942 (e.g., data or code) is contained in the physical page 940 at the final physical address into which the LA 910 is translated.

FIG. 10 is a flow diagram of an example guest linear address translation (GLAT) page walk 1000 of example GLAT paging structures 1020 with example extended page table (EPT) paging structures. The GLAT page walk 1000 illustrates a mapping of a guest linear address (GLA) 1010 to a host physical address (HPA) 1069 of a physical page 1070. The physical page 1070 includes targeted memory 1072 (e.g., data or code) at a final physical address into which the GLA 1010 is finally translated. The final physical address may be determined by indexing the physical page. The physical page 1070 can be indexed by using the physical page's HPA (e.g., HPA 1069) determined from the GLAT page walk 1000 and a portion of the GLA 1010 as the index.

In virtualized environments, GLAT paging structures 1020 are used to translate GLAS in a process address space to guest physical addresses (GPAs). An additional level of address translation, e.g., EPT paging structures, is used to convert the GPAs located in the GLAT paging structures 1020 to HPAs. Each GPA identified in the GLAT paging structures 1020 is used to walk the EPT paging structures to obtain an HPA of the next paging structure in the GLAT paging structures 1020. One example of EPT paging structures includes Intel® Architecture 32 bit (IA32) page tables with entries that hold HPAs, although other types of paging structures may be used instead.

The GLAT page walk 1000 is performed by a processor (e.g., MMU 145A or 145B of processor 140) walking GLAT paging structures 1020 and EPT paging structures to translate the GLA 1010 to the HPA 1069. EPT paging structures are not illustrated for simplicity, however, EPT paging structures' entries 1030 that are located during the page walk are shown. GLAT paging structures 1020 are representative of various GLAT paging structures (e.g., 216, 854) referenced herein, and EPT paging structures' entries 1030 are representative of entries obtained from EPT paging structures (e.g., 228) referenced herein. Generally, GLAT page walk 1000 is an example page walk that may occur in any of the embodiments disclosed herein implemented in a virtual environment and in which a memory access request (e.g., read, load, store, write, move, copy, etc.) is invoked based on a guest linear address in a process address space of a multithreaded process.

The GLAT paging structures 1020 can include a page map level 4 table (PML4) 1022, a page directory pointer table (PDPT) 1024, a page directory (PD) 1026, and a page table (PT) 1028. EPT paging structures also include four levels of paging structures. For example, EPT paging structures can include an EPT PML4, an EPT PDPT, an EPT PD, and an EPT PT. Each of the GLAT paging structures 1020 and each of the EPT paging structures may include entries that are addressed using a base and an index. Entries of the GLAT paging structures 1020 that are located during GLAT page walk 1000 for GLA 1010 include PML4E 1021, PDPTE 1023, PDE 1025, and PTE 1027. Entries of the EPT paging structures that are located during GLAT page walk 1000 are shown in groups of entries 1050, 1052, 1054, 1056, and 1058.

During a GLAT page walk, EPT paging structures translate a GLAT pointer (GLATP) to an HPA 1061 and also translate GPAs identified in the GLAT paging structures to HPAs. GLAT paging structures map the HPAs identified in the EPT paging structures to the GPAs that are translated by the EPT paging structures to other HPAs. The base address for the first table (the root) in the paging hierarchy of the EPT paging structures (e.g., EPT PML4), may be provided by an extended page table pointer (EPTP) 1002, which may be in a register in a virtual machine control structure (VCMS) 1001 configured by a hypervisor per hardware thread. Thus, when a core supports only one hardware thread, the hypervisor maintains one VMCS. If the core supports multiple hardware threads, then the hypervisor maintains multiple VMCS's. In some examples (e.g., such computing system 200 having specialized registers such as HTKR and/or HTGRs), a guest user application that executes multiple functions running on multiple hardware threads sharing the same process address space, then one set of EPT paging structures may be used by all of the functions across the multiple hardware threads. Other examples, as will be further described herein, involve the use of multiple EPT paging structures for a multithreaded process.

During the first walk through the EPT paging structures, the base for the first table (the root) in the EPT paging hierarchy (e.g., EPT PML4) is provided by the EPTP 1002, and the index into each of the EPT paging structures can be provided by a unique portion of the GLATP 1005. The entries of the EPT paging structures that are accessed in the EPT paging hierarchy, prior to the last level EPT PT, each contain a physical address, which may be in the form of a pointer, to the next EPT paging structure in the paging hierarchy. The entry that is accessed in the last level of the EPT paging hierarchy is EPT PTE 1051 and contains an HPA 1061. HPA 1061 is the base address for the first GLAT paging structure, PML4 1022. PML4 1022 is indexed by a unique portion of GLA 1010 (e.g., bits 47:39 of GLA), indicated as a page map level 4 table offset 1011. The identified entry, PML4E 1021, contains the next GPA 1031 to be translated by the EPT paging structures.

In the next walk through the EPT paging structures, the base for the first table (the root) in the EPT paging hierarchy (e.g., EPT PML4) is provided by the EPTP 1002, and the indexes into the respective EPT paging structures can be provided by unique portions of the GPA 1031. The entry that is accessed in the last level of the EPT paging hierarchy is EPT PTE 1053 and contains an HPA 1063. HPA 1063 is the base address for the next GLAT paging structure, PDPT 1024. PDPT 1024 is indexed by a unique portion of GLA 1010 (e.g., bits 30:38 of GLA), indicated as a page directory pointers table offset 1012. The identified entry, PDPTE 1023 contains the next GPA 1033 to be translated by the EPT paging structures.

In the next walk through the EPT paging structures, the base for the first table (the root) in the EPT paging hierarchy (e.g., EPT PML4) is provided by the EPTP 1002, and the indexes into the respective EPT paging structures can be provided by unique portions of the GPA 1033. The entry that is accessed in the last level of the EPT paging hierarchy is EPT PTE 1055 and contains an HPA 1065. HPA 1065 is the base for the next GLAT paging structure, PD 1026. PD 1026 is indexed by a unique portion of GLA 1010 (e.g., bits 21:29 of GLA), indicated as a page directory offset 1013. The identified entry, PDE 1025 contains the next GPA 1035 to be translated by the EPT paging structures.

In the next walk through the EPT paging structures, the base for the first table (the root) in the EPT paging hierarchy (e.g., EPT PML4) is provided by the EPTP 1002, and the indexes into the respective EPT paging structures can be provided by unique portions of the GPA 1035. The entry that is accessed in the last level of the EPT paging hierarchy is EPT PTE 1057 and contains an HPA 1067. HPA 1067 is the base for the next GLAT paging structure, PT 1028. PT 1028 is indexed by a unique portion of GLA 1010 (e.g., bits 12:20 of GLA), indicated as a page table offset 1014. The identified entry, PTE 1027 contains the next GPA 1037 to be translated by the EPT paging structures.

In the last walk through the EPT paging structures, the base for the first table (the root) in the EPT paging hierarchy (e.g., EPT PML4) is provided by the EPTP 1002, and the indexes into the respective EPT paging structures can be provided by unique portions of the GPA 1037. The entry that is accessed in the last level of the EPT paging hierarchy is EPT PTE 1059. EPT PTE 1059 is the EPT leaf and contains an HPA 1069. HPA 1069 is the base address for the physical page 1070 (or page frame) that includes a physical address to which the GLA 1010 is finally translated. The physical page 1070 is indexed by a unique portion of GLA 1010 (e.g., bits 0:11 of GLA), indicated as a page offset 1015. Thus, the GLA 1010 is effectively translated to a final physical address in the physical page 1070. Targeted memory 1072 (e.g., data or code) is contained in the physical page 1070 at the final physical address into which the GLA 1010 is translated.

In one or more embodiments in which specialized hardware registers are provided for each hardware thread (e.g., HTKR, HTGR), an EPT PTE leaf (e.g., 1059) resulting from a page walk does not contain a key ID encoded in bits of the HPA (e.g., 1069) of the physical page (e.g., 1070). Similarly, in implementations using LAT paging structures, a PTE leaf (e.g., 927) resulting from a page walk does not contain a key ID encoded in bits of the PA (e.g., 939) of the physical page (e.g., 940). In other embodiments that will be further described herein, key IDs may be encoded in HPAs stored in EPT PTE leaves located during GLAT page walks, or in PAs stored in PTE leaves located during LAT page walks.

The embodiments described herein that allow the key ID to be omitted from the PTE leaves or EPT leaves offer several benefits. The key ID obtained from a hardware thread group selector register (e.g., HTGR 420, 720, 820), or from a hardware thread key register (e.g., HTKR 426, 621, 721), is appended directly to a physical address selected by a TLB (e.g., 840) for previously translated LAs/GLAs or determined by an LAT/GLAT page walk. Because key IDs are appended to physical addresses without storing every key ID (which may include multiple key IDs per page) in the physical addresses stored in the paging structures (e.g., EPT paging structures), adding a TLB entry to the TLB for every sub-page key ID in a page can be avoided. Thus, TLB pressure can be minimized and sharing memory can be maximized, since embodiments do not require any additional caching in the TLB. Otherwise, additional TLB caching could potentially include multiple TLB entries in which different key IDs are appended to the same physical address corresponding to the same physical memory location (e.g., the same base address of a page). Instead, no overhead is incurred in embodiments using a hardware thread register (e.g., HTGRs 420, 720, 820 and/or HTKR 426, 621, 721) for key ID assignments to private and/or shared memory allocated in an address space of a single process having one or more hardware threads.

The embodiments enable the same TLB entry in a TLB (e.g., 840) to be reused for multiple key ID mappings on the same page. This allows different cache lines on the same page to be cryptographically isolated to different hardware threads depending on the key ID that is used for each cache line. Thus, different hardware threads can share the same physical memory page but use different keys to access their thread private data at a sub-page (e.g., per data object) granularity, as illustrated in FIG. 10. In contrast, processes and virtual machines cannot isolate data at a sub-page granularity.

One or more embodiments can realize increased efficiency and other advantages. Since the key ID is appended after translating the linear address through the TLB or a page walk if a TLB miss occurs, the TLB pressure is decreased as there is only one page mapping for multiple key IDs for multiple hardware threads. Consequently, the processor caching resources can be used more efficiently. Additionally, context switching can be very efficient. Hardware thread context switching only requires changing the key ID register. This is more efficient than process context switching in which the paging hierarchy is changed and the TLBs are flushed. Moreover, no additional page table structures are needed for embodiments implementing hardware thread isolation using dedicated hardware thread registers for key IDs. Thus, the memory overhead can be reduced.

When jumping between code segments, an address of a function can be accessed using a group selector in a code pointer to decrypt and allow execution of shared code libraries. Stacks may be accessed as hardware thread private data by using a group selector mapped to a hardware thread private key ID specified in an HTGR (e.g., 420, 820, 720), or by using a private key ID specified in an HTKR (e.g., 426, 621, 721). Accordingly, a hardware thread program call stack may be isolated from other hardware threads. Groups of hardware threads running simultaneously may share the same key ID (e.g., in an HTGR or an HTKR, depending on the implementation) if they belong to the same domain allowing direct sharing of thread private data between simultaneously executing hardware threads.

Embodiments enable several approaches for sharing data between hardware threads of a process. Group selectors in pointers allow hardware threads to selectively share data with other hardware threads that can access the same group selectors. Access to the shared memory by other hardware threads in the process can be prevented if an operating system (or other privileged software) did not specify the mapping between the group selector the key ID in the HTGR of the other hardware threads.

In one approach for sharing data, data may be accessed using a hardware thread's private key ID (obtained from HTGR or HTKR depending on the embodiment) and written back to shared memory using a key ID mapped to a group selector specified in the HTGRs of other hardware threads to allow data sharing by the other hardware threads. Thus, data sharing can be done within allowed groups of hardware threads. This can be accomplished via a data copy, which involves an inline re-encryption read from the old (private) key ID and written using the new (shared) key ID.

In another approach for sharing data, memory can be allocated for group sharing at memory allocation time. For example, the heap memory manger may return a pointer with an address to a hardware thread for a memory allocation that is to be shared. The hardware thread may then set the group selector in the pointer and then write to the allocation. Thus, the hardware thread can write to the memory allocation using a key ID mapped to the group selector in an HTGR of the hardware thread. The hardware thread can read from the memory allocation by using the same key ID mapped to the group selector in the HTGR. When key IDs are changed for a memory location (e.g., when memory is freed from the heap), the old key ID may need to be flushed from cache so the cache does not contain two key ID mappings to the same physical memory location. In some cases, flushing may be avoided for caches that allow only one copy of a memory location (regardless of the key ID) to be stored in the cache at a time.

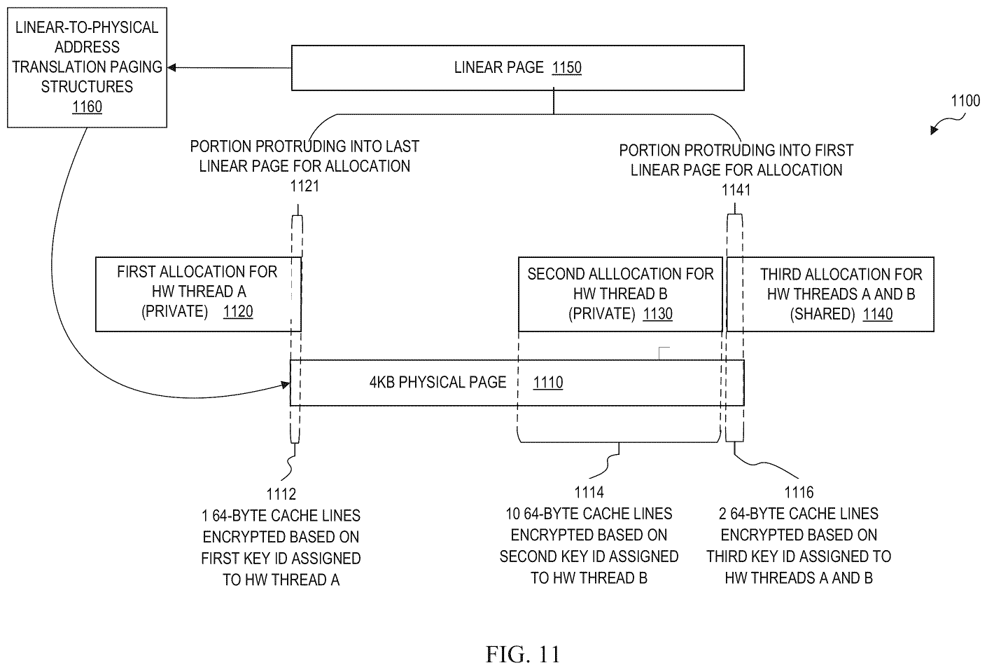

FIG. 11 is a block diagram illustrating an example linear page mapped to a multi-allocation physical page in an example process having multiple hardware threads. In FIG. 11, memory 1100 contains a linear page 1150, which is part of a linear address space of a process. The linear page 1150 is mapped to a physical data page 1110, and three memory allocations have different intersection relationships to the linear page 1150 and to the physical data page 1110. The three allocations include a first memory allocation 1120, a second memory allocation 1130, and a third memory allocation 1140.

Linear addresses can be translated to physical addresses via one or more linear-to-physical translation paging structures 1160. Paging structures 1160 store the mapping between linear addresses and physical addresses (e.g., LAT paging structures 920, EPT paging structures 930). When a process is created, the process is given a linear address space that appears to be a contiguous section of memory. Although the linear address space appears to be contiguous to the process, the memory may actually be dispersed across different areas of physical memory. As illustrated in FIG. 11, for every page of linear memory (e.g., 1150), there is a page of underlying contiguous physical memory (e.g., 1110). Each adjacent pair of linear pages, however, may or may not be mapped to an adjacent pair of physical pages.

The example scenario shown in FIG. 11, the linear page 1150 is a portion of linear address space (or ‘process space’) of a process. The process includes three hardware threads A, B, and C. The three hardware threads A, B, and C may each run on a different core of a processor, on the same core of a processor, or split across two cores of a processor. The first allocation 1120 is a first private linear address range in the process space. The first private linear address range is allocated for hardware thread A (or software running on hardware thread A). The second allocation 1130 is a second private linear address range in the process space. The second private linear address range is allocated for hardware thread B (or software running on hardware thread B). The third allocation 1140 is a shared linear address range in the process space. The shared linear address range may be allocated for one of the hardware threads, but all three hardware threads A, B, and C are given authorization to access the shared linear address range.

By way of example, physical page 1110 is 4 KB and can hold a total of 64 64-byte cache lines. In this scenario, physical page 1110 cache lines are reserved for a portion 1121 of the first allocation 1120, the entirety of the second allocation 1130, and a portion 1141 of the third allocation 1140. Based on the example sizes (e.g., 4-KB physical page, 64-byte cache lines), the portion 1112 of the first allocation reserved in the physical page 1110 includes 1 64-byte cache line. The entirety of the second allocation reserved in the physical page 1110 includes 10 64-byte cache lines. The portion 1116 of the third allocation reserved in the physical page 1110 includes 2 64-byte cache lines.

In one or more embodiments described herein that provide for multi-key encryption to isolate hardware threads of a process, key IDs are assigned to hardware threads via hardware thread-specific registers (e.g., HTKR, HTGR). Storing the key IDs in hardware-specific registers enables adjacent cache lines belonging to different hardware threads and/or to a hardware thread group in a contiguous part of physical memory, such as physical page 1110, to be encrypted differently. For example, the portion 1121 of the first allocation 1120 of hardware thread A (e.g., 1 64-byte cache lines) can be encrypted based on a first key ID assigned to hardware thread A. In this scenario, the first key ID may be stored in a hardware thread register provisioned on the core of hardware thread A. The second allocation 1130 of hardware thread B (e.g., 10 64-byte cache lines) can be encrypted based on a second key ID assigned to hardware thread B. In this scenario, the second key ID may be stored in a hardware thread register provisioned on the core of hardware thread B. The portion 1141 of the third allocation 1140 of hardware thread C (e.g., 2 64-byte cache lines) can be encrypted based on a third key ID assigned to hardware thread C and assigned to one or more other hardware threads (e.g., hardware thread A and/or B). In this scenario, the third key ID may be stored in a hardware thread register provisioned on the core of hardware thread C and in one or more other hardware registers provisioned on the cores of the one or more other hardware thread registers.

It should be apparent that the hardware thread registers could be configured using any of the embodiments disclosed herein (e.g., HTGR, HTKR, etc.), and that the key ID may be mapped to a group selector in the hardware thread register, depending on the embodiment.

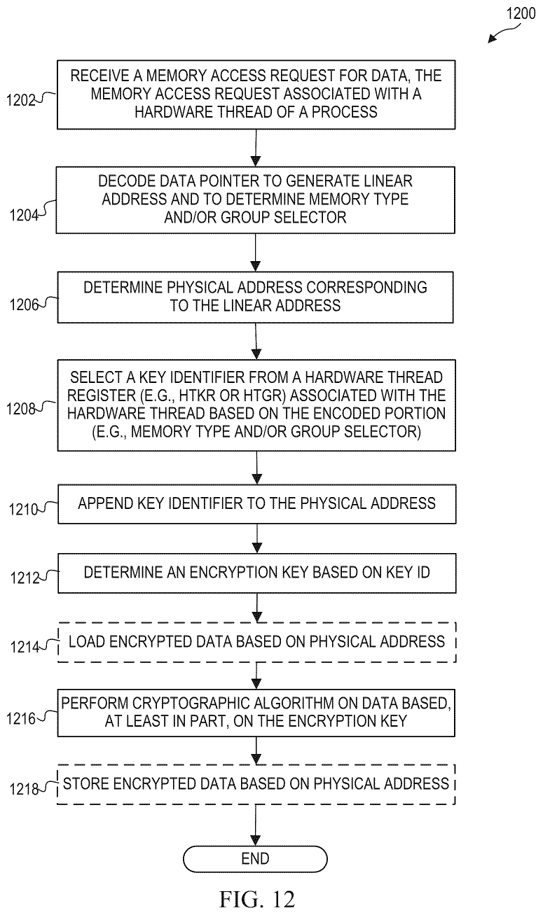

FIG. 12 is a simplified flow diagram 1200 illustrating example operations associated with a memory access request according to at least one embodiment. The memory access request may correspond to a memory access instruction to load or store data using an encoded pointer with an encoded portion that is similar to one of the encoded portions (e.g., 612, 712, 812) of encoded pointers 610, 710, and 810. A computing system (e.g., computing system 100) may comprise means such as one or more processors (e.g., 140) and memory (e.g., 170), for performing the operations. In one example, at least some operations shown in flow diagram 1200 may be performed by a core (e.g., 142A or 142B) and/or memory controller circuitry (e.g., 148) of a processor (e.g., 140). In more particular examples, one or more operations of flow diagram 1200 may be performed by an MMU (e.g., 145A or 145B), address decoding circuitry (e.g., 146A or 146B), and/or memory protection circuitry 160.

At 1202, a core of a processor may receive a memory access request associated with a hardware thread of a process running multiple hardware threads on one or more cores. The memory access request may correspond to a memory access instruction to load or store data. For example, software running on the hardware thread may invoke a memory access instruction to load or store data. The core may cause the memory controller circuitry to fetch the memory access instruction into an instruction pointer register of the core.

At 1204, a data pointer of the memory access request indicating an address to load or store data is decoded by the core to generate a linear address of the targeted memory location and to determine the memory type and/or the group selector encoded in the data pointer. The data pointer may point to any type of memory containing data such as the heap, stack, or data segment of the process address space, for example.

At 1206, a physical address corresponding to the generated linear address is determined. For example, memory controller circuitry can perform a TLB lookup as previously described herein (e.g., 850 in FIG. 8). If a TLB miss occurs, then a linear-to-physical address translation may be performed in a page walk as previously described herein (e.g., 854 in FIG. 8, 900 in FIG. 9).

At 1208, the core selects a key identifier in the appropriate hardware thread register associated with the hardware thread. For example, if the data pointer used in the memory access request includes an encoded portion containing only memory type (e.g., encoded pointer 610), then if the memory type indicates that the memory to be accessed is private, the private key ID contained in the HTKR associated with the hardware thread is selected (e.g., obtained from the HTKR). If the memory type indicates that the memory to be accessed is shared, then a shared key ID is selected using any suitable mechanism (e.g., obtained from another hardware thread register holding a shared key ID, obtained from memory storing a shared key ID, etc.). In another example, if the data pointer used in the memory access request includes an encoded portion containing only a group selector (e.g., encoded pointer 810), then the group selector encoded in the pointer can be used to find an HTGR in a set of HTGRs associated with the hardware thread that contains a corresponding group selector. The key ID mapped to the corresponding group selector in the HTGR is selected (e.g., obtained from the identified HTGR). In yet another example, if the data pointer used in the memory access request includes an encoded portion containing a memory type and a group selector (e.g., encoded pointer 710), then if the memory type indicates that the memory to be accessed is private, a private key ID contained in the HTKR associated with the hardware thread is selected. If the memory type indicates that the memory to be accessed is shared, then the group selector encoded in the pointer can be used to find an HTGR in a set of HTGRs associated with the hardware thread that contains a corresponding group selector. The key ID mapped to the corresponding group selector in the HTGR is selected.

At 1210, the memory controller circuitry appends the key identifier to the physical address determined at 1206. The memory controller circuitry may complete the memory transaction. At 1212, a cryptographic key is determined based on the identified key ID. In at least one embodiment, the cryptographic key may be determined from a key mapping table in which the cryptographic key is associated with the key ID.

If the memory access request corresponds to a memory access instruction for loading data, then at 1214, the targeted data stored in memory at the physical address, or stored in cache and indexed by the key ID and at least a portion of the physical address, is loaded. If a lookup is performed in memory, then the key ID appended to the physical address may be removed or ignored. Typically, the targeted data in memory is loaded by cache lines. Thus, one or more cache lines containing the targeted data may be loaded at 1214.

At 1216, if the data has been loaded as the result of a memory access instruction to load the data, then the cryptographic algorithm decrypts the data (e.g., or the cache line containing the data) using the cryptographic key. Alternatively, if the memory access request corresponds to a memory access instruction to store data, then the data to be stored is in an unencrypted form and the cryptographic algorithm encrypts the data using the cryptographic key. It should be noted that, if data is stored in cache in the processor (e.g., L1, L2), the data may be in an unencrypted form. In this case, data loaded from the cache may not need to be decrypted.

At 1218, if the memory access request corresponds to a memory access instruction to store data, then the encrypted data is stored based on the physical address (e.g., obtained at 1206). The encrypted data may be stored in cache and indexed by the key ID and at least a portion of the physical address.

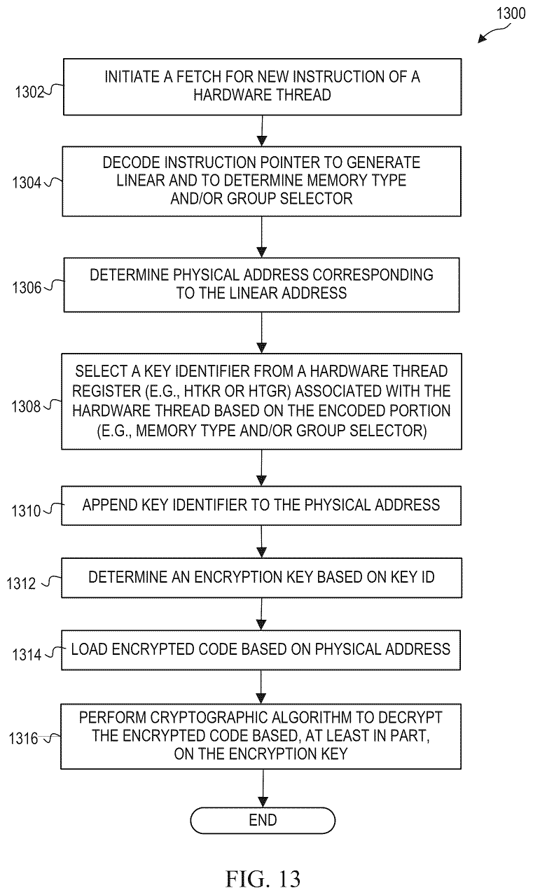

FIG. 13 is a simplified flow diagram 1300 illustrating example operations associated with initiating a fetch operation for code according to at least one embodiment. The fetch operation for code uses an encoded pointer with an encoded portion that is similar to one of the encoded portions (e.g., 612, 712, 812) of encoded pointers 610, 710, and 810. A computing system (e.g., computing system 100) may comprise means such as one or more processors (e.g., 140) and memory (e.g., 170), for performing the operations. In one example, at least some operations shown in flow diagram 1300 may be performed by a core (e.g., 142A or 142B) and/or memory controller circuitry (e.g., 148) of a processor (e.g., 140). In more particular examples, one or more operations of flow diagram 1300 may be performed by an MMU (e.g., 145A or 145B), address decoding circuitry (e.g., 146A or 146B), and/or memory protection circuitry 160.

At 1302, a core of a processor may initiate a fetch for a next instruction of code to be executed for a hardware thread of a process running multiple hardware threads on one or more cores.

At 1304, an instruction pointer (e.g., in an instruction pointer register (RIP)) is decoded to generate a linear address of the targeted memory location containing the next instruction to be fetched and to determine the memory type and/or the group selector encoded in the instruction pointer. The instruction pointer may point to any type of memory containing code such as a code segment of the process address space, for example.

At 1306, a physical address corresponding to the generated linear address is determined. For example, a TLB lookup can be performed as previously described herein (e.g., 850 in FIG. 8). If a TLB miss occurs, then a linear-to-physical address translation may be performed in a page walk as previously described herein (e.g., 854 in FIG. 8, 900 in FIG. 9).

At 1308, the core selects a key identifier in the appropriate hardware thread register associated with the hardware thread. For example, if the instruction pointer used in the fetch operation includes an encoded portion containing only memory type (e.g., encoded pointer 610), then if the memory type indicates that the memory to be accessed is private, the private key ID contained in the HTKR associated with the hardware thread is selected (e.g., obtained from the HTKR). If the memory type indicates that the memory to be accessed is shared, then a shared key ID is selected using any suitable mechanism (e.g., obtained from another hardware thread register holding a shared key ID, obtained from memory storing a shared key ID, etc.). In another example, if the data pointer used in the memory access request includes an encoded portion containing only a group selector (e.g., encoded pointer 810), then the group selector encoded in the pointer can be used to find an HTGR in a set of HTGRs associated with the hardware thread that contains a corresponding group selector. The key ID mapped to the corresponding group selector in the HTGR is selected (e.g., obtained from the identified HTGR). In yet another example, if the data pointer used in the memory access request includes an encoded portion containing a memory type and a group selector (e.g., encoded pointer 710), then if the memory type indicates that the memory to be accessed is private, the key ID contained in the HTKR associated with the hardware thread is obtained. If the memory type indicates that the memory to be accessed is shared, then the group selector encoded in the pointer can be used to find an HTGR in a set of HTGRs associated with the hardware thread that contains a corresponding group selector. The key ID mapped to the corresponding group selector in the HTGR is selected.

At 1310, the memory controller circuitry appends the key identifier is appended to the physical address determined at 1306. The memory controller circuitry may complete the memory transaction. At 1312, a cryptographic key is determined based on the identified key ID. In at least one embodiment, the cryptographic key may be determined from a key mapping table in which the cryptographic key is associated with the key ID.

At 1314, the targeted instruction stored at the physical address, or stored in cache and indexed by the key ID and at least a portion of the physical address, is loaded. Typically, a targeted instruction in memory is loaded in a cache line. Thus, one or more cache lines containing the targeted instruction may be loaded at 1314.

At 1316, a cryptographic algorithm decrypts the instruction (e.g., or the cache line containing the instruction) using the cryptographic key. It should be noted that, if data is stored in cache in the processor (e.g., L1, L2), the data may be in an unencrypted form. In this case, data loaded from the cache may not need to be decrypted.

Hardware Thread Isolation Using Implicit Policies with Thread-Specific Registers

Another approach to achieving hardware thread isolation by key ID switching using thread-specific registers can include the use of implicit policies. Implicit policies can be based on different types of memory being accessed from a hardware thread. Rather than embedding group selectors in pointers, memory indicators may be used to implement the implicit policies to infer what type of shared memory is being accessed and to cause a memory access operation to use a designated hardware thread register based on the type of shared memory being accessed. For certain types of shared memory, implicit policies can be used to infer which type of memory is being accessed in a memory access operation associated with a hardware thread. The inference can be based on one or more memory indicators that provide information about a particular physical area of memory (e.g., a physical page) to be accessed. The designated hardware thread register holds the correct key ID to be used for the memory access operation associated with the hardware thread.

Hardware thread registers can be provisioned per hardware thread and have different designations for different types of shared memory. At least some memory indicators can be embodied in bits of address translation paging structures that are set with a first value (e.g., ‘0’ or ‘1’) to indicate a first type of shared memory, and set with a second value (e.g., ‘1’ or ‘0’) to indicate a different type of shared memory. The different type of shared memory may be inferred based on one or more other memory indicators. In one example, for a process address space used by a hardware thread, one or more memory indicators can be provided in a page table entry of linear address translation (LAT) paging structures or of an extended page table (EPT) paging structures.

In at least some embodiments, memory indicators for implicit policies may be used in combination with an encoded portion (e.g., memory type) in pointers to heap and stack memory of a process address space. An encoded portion in pointers for heap and stack memory may include a memory type to indicate whether the memory being accessed is located in a shared data region that two or more hardware threads in a process are allowed to access. A memory type bit may be used to encode a pointer to specify a memory type as previously described herein with reference to FIG. 6, for example.

FIG. 14 is a schematic diagram of an example page table entry architecture illustrating possible memory indicators that may be used to implement implicit policies if the processor determines that no group selector is present in an encoded pointer (e.g., at 860-861 in FIG. 8). In this example, the PTE architecture may include a 32-bit (4-byte) page table entry (PTE) 1400. One or more PTEs 1400 may be included in a page table of LAT paging structures, EPT paging structures, or any other type of paging structures used to map a physical address in memory to a linear address (which may or may not be a guest linear address) of a process address space. It should be noted however, that any other suitable number of bits (e.g., greater than or less than 32 bits) may be used in address translation paging structures' entries, and specifically, for page table entries in page tables of address translation paging structures. The 32-bit PTE 1400 illustrated in FIG. 14 is intended to be a non-limiting example of one possible implementation and it should be noted that any suitable size (e.g., less than 32 bits, greater than 32 bits) may be used to implement page table entries.

PTE 1400 includes bits for a physical address 1410 (e.g., frame number or other suitable addressing mechanism) and additional bits controlling access protection, caching, and other features of the physical page that corresponds to the physical address 1410. The additional bits can be used individually and/or in various combinations as memory indicators for implicit policies. In at least one embodiment, one or more of the following additional bits may be used as memory indicators: a first bit 1401 (e.g., page attribute table (PAT)) to indicate caching policy, a second bit 1402 (e.g., user/supervisor (U/S) bit), a third bit 1403 (e.g., execute disable (XD) bit), and a fourth bit 1404 (e.g., global (G) bit or a new shared-indicator bit).

A first implicit policy may be implemented for pages being used for input/output (e.g., direct memory access devices). Such pages are typically marked as non-cacheable or write-through, which are memory types in a page attributable table. The PAT bit 1401 can be set to a particular value (e.g., ‘1’ or ‘0’) to indicate that PAT is supported. A memory caching type can be indicated by other memory indicator bits, such as the cache disable bit 1408 (e.g., PCD). If the PAT bit 1401 is set to indicate that PAT is supported, and the PCD bit 1408 is set to indicate that the page pointed to by physical address 1410 will not be cached, then the data can either remain unencrypted or may be encrypted using a shared IO key ID. The first implicit policy can cause the processor to select the shared IO key ID when a memory access targets a non-cached memory page. In addition, other registers (e.g., memory type range registers (MTRR)) also identify memory types for ranges of memory and can also (or alternatively) be used for the indicating that the memory location being accessed is not cached and, therefore, a shared IO key ID is to be used.

A second implicit policy may be implemented for supervisor pages that are indicated by the U/S bit 1402 in PTE 1400. The U/S bit 1402 can control access to the physical page based on privilege level. In one example, when the U/S bit is set to a first value, then the page may be accessed by code having any privilege level. Conversely, when the U/S bit is set to a second value, then only code having supervisor privileges (e.g., kernel privilege, Ring 0) may access the page. Accordingly, in one or more embodiments, the implicit policy can cause the processor to use a shared kernel key ID when the U/S bit is set to the second value. Alternatively, any linear mappings in the kernel half of the memory range can be assumed to be supervisor pages and a kernel key ID can be used. An S-bit (e.g., 63^{rd} bit in 64-bit linear address) in a linear address may indicate whether the address is located in the top half or bottom half of memory. One of the halves of memory represents the supervisor space and the other half of memory represents the user space. In this scenario, the implicit policy causes the processor to automatically switch to the kernel key ID when accessing supervisor pages as indicated by the S-bit being set (or not set depending on the configuration).

A third implicit policy may be implemented for executable pages in user space. In this example, a combination of memory indicators may be used to implement the third implicit policy. User space may be indicated by the U/S bit 1402 in PTE*1400 being set to a first value (e.g., ‘1’ or ‘0). Executable pages may be indicated by the XD bit 1403 in PTE 1400 being set to a second value (e.g., ‘0’ or ‘1’). Accordingly, when the XD bit 1403 is set to the value indicating executable pages and the U/S bit 1402 is set to the value indicating user space pages, then a shared user code key ID may be used. In this scenario, the implicit policy causes the processor to switch to the shared code key ID when encountering user space executable pages. It should be noted that the first value of the U/S bit 1402 and the second value of the XD bit 1403 may be the same or different values.

A fourth implicit policy may be implemented for explicitly shared pages such as named pipes. A named pipe is a one-way or duplex pipe for communication between a pipe server and one or more pipe clients. Named pipes may be used for interprocess communication. Similarly, physical pages that are shared across processes (e.g. per-process page tables map to the same shared physical page) can be used for interprocess communication. In this example, a combination of memory indicators may be used to implement the fourth implicit policy. When the global bit 1404 is set to a first value (e.g., ‘1’ or ‘0’), the global bit indicates that the page has a global mapping, which means that the page exists in all address spaces. Accordingly, when the global bit 1404 is set to the first value and the U/S bit 1402 is set to indicate user space, this combination indicates shared pages where a per-process shared page key ID can be used by the processor when accessing such a physical page. Other embodiments may define a new page table bit to indicate the page is shared and should use the shared page keyID. In this way, pages that were shared across processes may share data using the shared page keyID when consolidated into the same process.

It should be noted that an architecture can determine which values are set in the memory indicators to indicate which information about a physical page. For example, one architecture may set a U/S bit to ‘1’ to indicate that a page is a supervisor page, while another architecture may use a U/S bit to ‘O’ to indicate that a page is a supervisor page. Moreover, one or more memory indicators could also be embodied in multiple bits. Multi-bit memory indicators may be set to any suitable values based on the particular architecture and/or implementation.

At least some, but not necessarily all, PTE architectures can include a multi-bit protection key 1407 (e.g., 4-bit PK) and/or a present bit 1406 (e.g., P bit). The protection key 1407 may be used to enable/disable access rights for multiple physical pages across different address spaces. The present bit 1406 may indicate whether the page pointed to by physical address 1410 is loaded in physical memory at the time of a memory access request for that page. If memory access is attempted to a physical page that is not present in memory, then a page fault occurs and the operating system (or hypervisor) can cause the page to be loaded into memory. The protection key 1407 and present bit 1406 may be used in other embodiments described herein to achieve hardware and/or software thread isolation of multithreaded processes sharing the same process address space.

FIG. 15 illustrates a flow diagram of example operations of a process 1500 related to initializing registers of a hardware thread of a process that are selected during memory access operations based on implicit policies or explicit pointer encodings according to at least one embodiment. The process is configured to invoke multiple functions (e.g., function as a service (FaaS) applications, multi-tenancy applications, etc.) in respective hardware threads. The hardware threads may be launched at various times during the process. FIG. 15 illustrates one or more operations that may be performed in connection with launching a hardware thread of the process. The one or more operations of process 1500 of FIG. 15 may be performed for each hardware thread that is launched.

A computing system, such as computing system 100 or 200, may comprise means such as one or more processors (e.g., 140) for performing the operations of process 1500. In one example, at least some operations shown in process 1500 are performed by executing instructions of an operating system (e.g., 120) or a hypervisor (e.g., 220) that initializes registers on a thread-by-thread basis for a process. Registers may be associated with each hardware thread of the process. Each set of registers associated with a hardware thread may include a data pointer (e.g., 152A or 152B) and an instruction pointer (e.g., 154A or 154B). As shown in FIG. 15, certain hardware thread-specific registers including an HTKR 1526 (e.g., similar to HTKRs 156A, 156B, 426, 621, 721) and a set of hardware thread shared key ID registers (HTSRs) 1520 can be provisioned for each hardware thread to assign one or more key IDs to the hardware thread.

In at least one embodiment, for computing systems 100 and 200 to be configured to achieve hardware thread isolation by using implicit policies to cause key ID switching, respective sets of HTSRs 1520 may be provisioned for each hardware thread instead of HTGRs 158A and 158B. A set of HTSRs provisioned for a hardware thread can include registers designated for holding shared key IDs. At least some of the shared key IDs may be selected during memory access operations based on implicit policies (e.g., memory indicators in PTEs). Optionally, at least one of the shared key IDs may be selected during memory access operations based on an explicit encoding in a pointer used for the memory access operations.

The set of HTSRs 1520 represents one possible set of HTSRs that may be implemented for each hardware thread in computing systems 100 and 200. In this example, the set of HTSRs 1520 includes a group key ID register 1521 (e.g., ‘hwThreadSharedKeyID’ register), a shared page key ID register 1522 (e.g., ‘SharedPagesKeyID’ register), a kernel key ID register 1523 (e.g., ‘KernelKeyID’ register), an I/O key ID register 1524 (e.g., ‘SharedIOKeyID’ register), and a user code key ID register 1525 (e.g., ‘UserCodeKeyID’ register). The shared page key ID register 1522 can be used for named pipes so that a per process key ID can be used by the processor for such pages. A kernel key ID register 1523 can be used when a page being accessed is a supervisor page. A shared I/O key ID register 1524 can be used for pages that are non-cacheable or write-through (e.g., DMA accesses). A user code key ID register 1525 can be used when accessing user space executable code. A different key ID can be stored in each HTSR of the set of HTSRs 1520.

In one or more embodiments, the set of HTSRs 1520 may also include a register (or more than one register) designated for holding a group key ID assigned to the hardware thread for a certain type of shared memory, such as a shared heap region in the process address space, or any other memory that is shared by a group of hardware threads in the process. In the set of HTSRs 1520, the group key ID register 1521 may be used to hold a group key ID assigned to the hardware thread and that may be used for encrypting/decrypting a shared memory region in the process address space that the hardware thread is allowed to access, along with one or more other hardware threads in the process. In one or more embodiments, the group key ID in the group key ID register 1521 may be selected during a memory access operation based on an explicit encoding in the pointer used in the memory access operation.

Explicit pointer encodings may be implemented, for example, as a memory type encoding. In this example, memory type encodings may be similar, but not identical to memory type encodings of FIGS. 6 and 7. For example, pointers to the process address space in which the hardware thread runs, can include a one-bit encoded portion or a multi-bit encoded portion. A particular value of an encoded portion (e.g., ‘1’ or ‘0’) of a pointer can indicate that the memory address is located in a shared memory region and that a shared key ID in the group key ID register 1521 is to be used for encrypting and decrypting data pointed to by the pointer. Otherwise, if the encoded portion contains a different value (e.g., ‘0’ or ‘1’), then this can indicate that the implicit policies should be evaluated to determine whether another HTSR holds a shared key ID that should be used for encrypting and decrypting data or code pointed to by the pointer. If none of the implicit policies are triggered, then this indicates that the data or code pointed to by the pointer is located in a private memory region of the hardware thread, such as heap or stack memory. Accordingly, a private key ID can be obtained from the HTKR 1526 and used for encrypting and decrypting data or code located at the memory address in the pointer.

Alternative embodiments of the encoded portions of a pointer are also possible. For example, in some embodiments, the encoded portion may include more than one bit. For these embodiments, additional HTSRs may be provisioned for each hardware thread so that multiple shared key IDs can potentially be assigned to a hardware thread to enable the hardware thread to access multiple encrypted shared memory regions in the process address space that are not triggered by implicit policies. In another embodiment, the encoded portion in the pointers used in memory accesses may be configured in the same or similar manner as previously described herein with reference to FIG. 7 or 8. For example, the encoded portion of a pointer may include multiple bits to store a group selector and a single bit to store a value that indicates a memory type (e.g., similar to encoded portion 712 of pointer 710 of FIG. 7). The group selector obtained from the encoded pointer can be used to identify a shared key ID for a shared memory region that is not triggered by implicit policies. The single bit can be used to identify a private key ID in the HTKR to be used for a private memory region. In yet another example, the encoded portion of a pointer (e.g., similar to encoded portion 812 of encoded pointer 810 of FIG. 8) may include multiple bits to hold a group selector that can be used to map the shared key IDs that are not triggered by implicit policies, and to map a private key ID for a private memory region of the hardware thread.

For illustrative purposes, the set HTSRs 1520 in FIG. 15 are populated with example key IDs (e.g., KEY ID 1, KEY ID 2, KEY ID 4, KEY ID 5, and KEY ID 6) for various shared memory regions in a process address space. The HTKR 1526 is populated with an example key ID (e.g., KEY ID 0) for a private memory region of the process address space. A key mapping table 1530 illustrates an example of a key mapping table (e.g., 162) of computing systems 100 and 200. The key mapping table 1530 may be similar to key mapping table 430 of FIG. 4, and may be configured, generated, and/or populated as previously shown and described herein with respect to key mapping tables 162 and 430.

The set of HTSRs 1520 and HTKR 1526 may be populated by an operating system or other privileged software of a processor before switching control to the selected user space hardware thread that will use the set of HTSRs 1520 in memory access operations. The key mapping table 1530 in hardware (e.g., memory protection circuitry 160 and/or memory controller circuitry 148) may be populated with mappings from the private key ID (e.g., from HTKR 1526) and the shared key IDs (e.g., from HTSRs 1521-1525), assigned to the selected hardware thread, to respective cryptographic keys. It should be understood, however, that the example key IDs illustrated in FIG. 15 are for explanation purposes only. Greater or fewer key IDs may be used for a given hardware thread. In addition, the number of mappings in the key mapping table 1530 from key IDs to cryptographic keys is based, at least in part, on a particular application being run, the number of different hardware threads used for the particular application, the number of HTSRs and/or HTKRs provisioned for hardware threads, and/or other needs and implementation factors.

At 1502, a system call (SYSCALL) may be performed or an interrupt may occur to invoke the operating system or other privileged (e.g., Ring 0) software, which creates a process or a thread of a process. At 1504, the operating system or other privileged software selects which hardware thread to run in the process. The hardware thread may be selected by determining which core of a multi-core processor to use. If the core implements multithreading, then a particular hardware thread (or logical processor) of the core can be selected. The operating system or other privileged software may also select which key ID(s) to assign to the selected hardware threads.

At 1505, if private memory of another hardware thread, or shared memory is to be reassigned to the selected hardware thread to which a new key ID is to be assigned, a cache line flush can be performed, as previously explained herein reference to FIG. 5.

At 1506, the operating system or other privileged software sets a private key ID in the key ID register (HTKR) 1526 for the selected hardware thread. The operating system or other privileged software can populate the HTKR 1526 with the private key ID. In this example, HTKR 1526 is populated with KEY ID0.

At 1508, the operating system may populate the set of HTSRs 1520 with one or more shared key IDs for the various types of shared memory to be accessed by the selected hardware thread. The registers in the set of HTSRs 1520 are designated for the different types of shared memory that may be accessed by the selected hardware thread. Some types of shared memory accessed by a hardware thread may be identified based on implicit policies. These different types of shared memory may include, but are not necessarily limited to, explicitly shared pages such as named pipes, supervisory pages, shared I/O page (e.g., DMA), and executable pages in user space. In this example, the shared page key ID register 1522 for explicitly shared pages is populated with KEY ID2, the kernel key ID register 1523 for supervisory pages is populated with KEY ID4, the shared I/O key ID register 1524 for shared I/O pages is populated with KEY ID5, and the user code key ID register 1525 for executable pages in user space is populated with KEY ID6.

Some other types of shared memory accessed by a hardware thread may not be identified by implicit policies. Accordingly, in addition to registers designated for shared memory that can be identified based on implicit policies, the set of HTSRs 1520 can also include a one or more registers designated for shared memory that is not identified by implicit policies. For example, shared heap memory of a process address space may not be identified by implicit policies. Accordingly, the set of HTSRs 1520 can include a group key ID register 1521 for shared memory in heap. In this example, the group key ID register 1521 is populated with KEY ID 1.

For shared memory that is not identified based on implicit policies, a memory type (e.g., one-bit or multi-bit) may be used to encode the pointer (e.g., containing a linear address) that is used by software running on the selected hardware thread to perform memory accesses. The memory type can indicate that the memory address in the pointer is located in a shared memory region and that a shared key ID is specified in the HTSR register (e.g., 1521) designated for shared memory. The shared key ID (e.g., KEY ID1) may be used to obtain a cryptographic key for encrypting or decrypting memory contents (e.g., data or code) when performing memory access operations in the shared memory region based on the pointer. Only the operating system or other privileged system software may be allowed to modify the HTKR 1526.

If the memory type in a pointer does not indicate that the memory address in the pointer is located in the type of shared memory region that is not identifiable by implicit policies, then implicit policies can be evaluated to determine whether the memory address is located in another type of shared memory. If no implicit policies are triggered, then the memory address can be assumed to be located in a private memory region of the hardware thread.

It should be noted that the number of registers in the set of HTSRs 1520 that are used by a hardware thread depends on the particular software running on the hardware thread. For example, some software may not access any shared heap memory regions or shared I/O memory. In this scenario, the group key ID register 1521 and the shared I/O key ID 1524 may not be set with a key ID. In addition, only the operating system or other privileged system software may be allowed to modify the registers in the set of HTSRs 1520.

In another embodiment, group selectors and group selector mappings may be used for the HTKR 1526 and the group key ID register 1521. In this scenario, the operating system or other privileged software sets the private key ID to group selector mapping in a group selector register associated with the selected hardware thread. The operating system or other privileged software can also set a shared key ID to group selector mapping in one or more other registers for one or more other shared memory regions that the selected hardware thread is allowed to access and that are not identifiable based on implicit policies. The group selectors in the group selector register for private memory can be encoded in a pointer to the private memory region of the hardware thread. The group selectors in the group selector registers for shared memory regions can be encoded in respective pointers to the respective shared memory region(s) that the hardware thread is allowed to access. Pointers to other shared memory may be encoded with a default value indicating that the pointer contains a memory address located in a type of shared memory that can be identified based on implicit policies. Only the operating system or other privileged system software may be allowed to modify the group selector registers.

At 1510, the hardware platform may be configured with the private and shared key IDs mapped to respective cryptographic keys. In one example, the key IDs may be assigned in key mapping table 1530 in the memory controller by the BIOS or other privileged software. A privileged instruction may be used by the operating system or other privileged software to configure and map cryptographic keys to the key IDs in key mapping table 1530. In some implementations, the operating system may generate or otherwise obtain cryptographic keys for each of the key IDs in the set of HTSRs 1520 and/or in HTKR 1526, and then provide the cryptographic keys to the memory controller via the privileged instruction. Cryptographic keys can be generated and/or obtained using any suitable technique(s), at least some of which have been previously described herein with reference to key mapping table 430 of FIG. 4. In one nonlimiting example, the privileged instruction to program a key ID and cause the memory controller circuitry to generate or otherwise obtain a cryptographic key, may be a privileged instruction. One example privileged platform configuration instruction used in Intel® Total Memory Encryption Multi Key technology is ‘PCONFIG.’

Once the key IDs are assigned to the selected hardware thread, at 1512, the operating system or other privileged software may set a control register (e.g., control register 3 (CR3)) and perform a system return (SYSRET) into the selected hardware thread. Thus, the operating system or other privileged software launches the selected hardware thread.

At 1514, the selected hardware thread starts running software (e.g., a software thread) in user space with ring 3 privilege, for example. The selected hardware thread is limited to using the key IDs that are specified in the set of HTSRs 1520 and/or HTKR 1526. Other hardware threads can also be limited to using the key IDs that are specified in their own sets of HTSRs and/or HTKR.

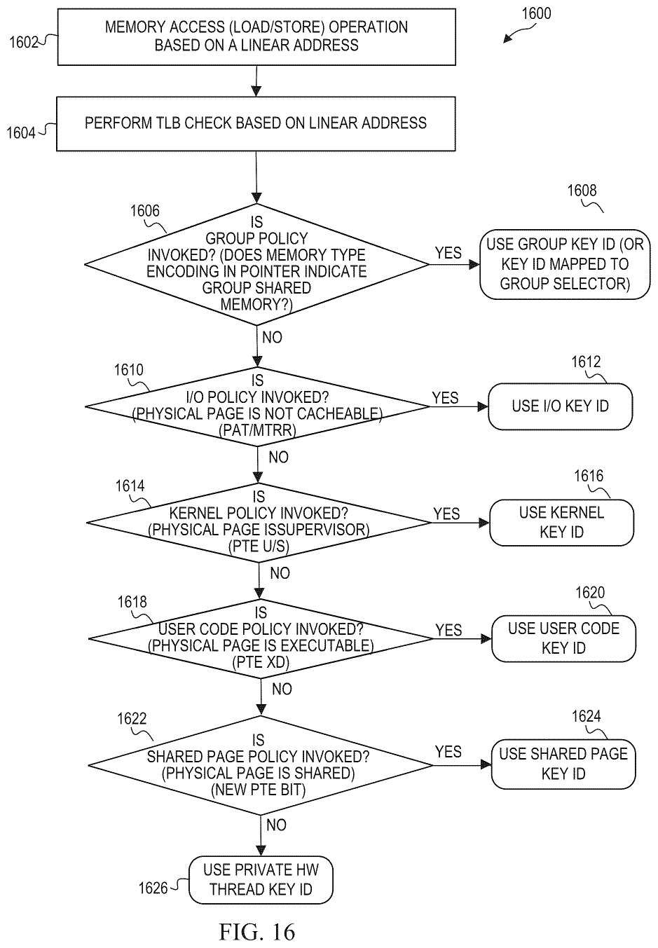

FIG. 16 is a flow diagram illustrating a logic flow 1600 of possible operations that may be related to using implicit policies with multi-key memory encryption to provide function isolation according to at least one embodiment. The logic flow 1600 illustrates one or more operations that may occur in connection with a memory access request of a hardware thread in a process having multiple hardware threads. The memory access request is based on a linear address (e.g., encoded pointer 610, 710, 810, etc., or a pointer without encoding) generated for software running on the hardware thread. More specifically, the linear address may be generated for a particular memory area (e.g., private or shared memory regions) that the hardware thread (or software thread run by the hardware thread) is allowed to access. The memory area may be a private memory region (e.g., containing data or code) that is allocated to the hardware thread and that only the hardware thread is allowed to access. Alternatively, the memory area may be a shared memory region (e.g., containing data or code) that is allocated for the hardware thread and one or more other hardware threads of the process to access. The memory access request may correspond to a memory access instruction to read or store data, or to a memory fetch stage for loading code (e.g., an executable instruction) to be executed by the hardware thread. A core (e.g., 142A or 142B) and/or memory controller circuitry (e.g., 148) of a processor (e.g., 140) can perform one or more operations of logic flow 1600. In one example, one or more operations associated with logic flow 1600 may be performed by, or in conjunction with, memory controller circuitry (e.g., 148), an MMU (e.g., 145A or 145B), a TLB (e.g., 147A or 147B), and/or by address decoding circuitry (e.g., 146A or 146B).

The logic flow 1600 illustrates example operations associated with a memory access request based on a linear address. Although the linear address could be provided in a pointer (or any other suitable representation of a linear address) or encoded pointer depending on the particular embodiment, the description of logic flow 1600 assumes a pointer (e.g., 610, 710, 810, etc.) containing at least a portion of a linear address and encoded with a memory type. For illustration purposes, the description of logic flow 1600 assumes a memory access request originates from software running on a hardware thread associated with the populated set of HTSRs 1520 and the populated HTKR 1526.

At 1602, a memory access (e.g., load/store) operation is initiated. In this example, the memory access operation could be based on a linear address to a private memory region that the key ID 0 is used to encrypt/decrypt, a shared data memory region (e.g., in heap) that the shared data KEY ID1 is used to encrypt/decrypt, an explicitly shared page library that KEY ID2 is used to encrypt, a supervisory page in kernel memory that KEY ID4 is used to encrypt/decrypt, a shared I/O page that KEY ID5 is used to encrypt/decrypt, or an executable page in user space that KEY ID6 is used to encrypt/decrypt.

At 1604, a translation lookaside buffer (TLB) check may be performed based on the linear address associated with the memory access operation. A page lookup operation may be performed in the TLB. A TLB search may be similar to the TLB lookup 850 of FIG. 8. The TLB may be searched using the linear address obtained (or derived) from the encoded pointer. In some implementations, the memory address bits in the encoded pointer may include only a partial linear address, and the actual linear address may need to be derived from the encoded pointer as previously described herein (e.g., 810 of FIG. 8).

Once the linear address is determined and found in the TLB, then a physical address to the appropriate physical page in memory can be obtained from the TLB. If the linear address is not found in the TLB, however, then a TLB miss has occurs. When a TLB miss occurs, a page walk can be performed using appropriate address translation paging structures (e.g., LAT paging structures, GLAT paging structures, EPT paging structures) of the process address space in which the hardware thread is running. Example page walk processes are shown and described in more detail with reference to FIGS. 8, 9, and 10. Once the physical address is found in the address translation paging structures during the page walk, the TLB can be updated by adding a new TLB entry in the TLB.

The existing TLB entry found in the TLB check, or the newly updated TLB entry added as a result of a page walk, can include a mapping of the linear address derived from the pointer of the memory access operation to a physical address obtained from the address translation paging structures. In one example, in the TLB, the physical address that is mapped to the linear address corresponds to the contents of the page table entry for the physical page being accessed. Thus, the physical address can contain various memory indicator bits shown and described with reference to PTE 1400 of FIG. 14.

At 1606, initially, a determination can be made as to whether a group policy is invoked. A group policy may be invoked if a memory type specified in the encoded pointer indicates that the memory address in the encoded pointer is located in a shared memory region (e.g., heap) that a group of hardware threads in the process is allowed to access. In one example, this may be indicated if the encoded portion of the pointer includes a memory type bit that is set to a certain value (e.g., ‘1’ or ‘0’). If the memory type indicates that the memory address in the encoded pointer is located in a shared memory region that a group of hardware threads is allowed to access, then the group policy is invoked and at 1608, a group key ID stored in the designated HTSR for shared group memory is obtained. For example, KEY ID1 may be obtained from group key ID register 1521. The group key ID, KEY ID1, can then be used for encryption/decryption of data or code associated with the memory access operation.

If the memory type specified in the encoded pointer does not indicate that the memory address in the encoded pointer is located in a memory region that is shared by a group of hardware threads in the process, then the memory address in the encoded pointer may be located in either a private memory region of the hardware thread or in a type of shared memory that can be identified by memory indicators. In this scenario, the memory indicators may be evaluated first. If none of the memory indicators trigger the implicit policies, then the memory address to be accessed can be assumed to be located in a private memory region.

In another embodiment, group selectors may be used, as previously described herein (e.g., FIGS. 7, 8). In this embodiment, at 1606, a determination is made as to whether a group selector is specified (e.g., stored, encoded, included) in the pointer of the memory access request (e.g., similar to the determination at 860). If a determination is made that the pointer specifies a group selector, then at 1608, a key ID mapped to the group selector in a hardware thread group selector register (HTGR) is obtained (e.g., as previously described with respect to 862-868 of FIG. 8). In this scenario, a private key ID may also be mapped to a group selector and obtained from an HTGR. If a determination is made at 1606 that a group selector is not specified in the pointer of the memory access request (e.g., similar to the determination at 860 of FIG. 8), then implicit policies are evaluated at 1610-1624. The evaluation of implicit policies at 1610-1624 offers example details of possible implicit policy evaluations that could be performed at 861 in FIG. 8.

If a determination is made at 1606 that the memory type specified in the encoded pointer does not indicate that the targeted memory region is shared by a group of hardware threads in the process, or that a group selector is not specified in the pointer then, at 1610, a determination may be made as to whether an I/O policy is to be invoked. An I/O policy may be invoked if the physical page to be accessed is noncacheable. A page attribute table (PAT) bit (e.g., 1401) in a page table entry of the physical page to which the linear address in the pointer is mapped may be set to a particular value (e.g., ‘1’ or ‘0) to indicate that the page is not cacheable. If the page to be accessed is determined to be not cacheable based on a memory indicator (e.g., PAT bit), then the I/O policy is invoked and at 1612, a shared I/O key ID stored in the designated HTSR for non-cacheable memory is obtained. For example, KEY ID5 may be obtained from shared I/O key ID register 1524. The shared I/O key ID, KEY ID5, can then be used for encryption/decryption of data associated with the memory access operation.

If the physical page to be accessed is determined to be cacheable (e.g., based on the PAT bit), then then at 1614, a determination may be made as to whether a kernel policy is to be invoked. A kernel policy may be invoked if the page to be accessed is a supervisor page (e.g., kernel memory). A user/supervisor (U/S) bit (e.g., 1402) in a page table entry of the physical page to which the linear address in the pointer is mapped may be set to a particular value (e.g., ‘1’ or ‘0) to indicate that the page to be accessed is a user page (e.g., any access level). The U/S bit may be set to the opposite value (e.g., ‘0’ or ‘1’) to indicate that the page to be accessed is a supervisor page. If the page to be accessed is determined to be a supervisor page based on a memory indicator (e.g., PTE U/S bit), then the kernel policy is invoked and at 1616, a kernel key ID stored in the designated HTSR for kernel pages is obtained. For example, KEY ID4 may be obtained from kernel key ID register 1523. The kernel key ID, KEY ID4, can be used for encryption/decryption of data or code associated with the memory access operation.

If the physical page to be accessed is determined to be a user page based on the memory indicator (e.g., PTE U/S bit), then at 1618, a determination may be made as to whether a user code policy is to be invoked. A user code policy may be invoked if the page to be accessed is executable (e.g., user code). When an execute disable (XD) bit (e.g., 1403) in a page table entry of the physical page to which the linear address in the pointer is mapped is set to a particular value (e.g., ‘0’ or ‘1) to indicate the page contains executable code, and the PTE U/S bit in the page table entry is set to a particular value that indicates the page is a user page (e.g., any access level), this can indicate that the page to be accessed is executable user code. The XD bit may be set to the opposite value (e.g., ‘1’ or ‘0’) to indicate that the page to be accessed does not contain executable code. If the page to be accessed is determined to contain executable user code based on two memory indicators (e.g., PTE U/S bit and XD bit), then the user code policy is invoked and at 1620, a user code key ID stored in the designated HTSR for user code pages is obtained. For example, KEY ID6 may be obtained from kernel key ID register 1523. The user code key ID, KEY ID6, can be used for encryption/decryption of data or code associated with the memory access operation.

If the physical page to be accessed is determined to not contain executable user code based on the two memory indicators (e.g., PTE U/S bit and XD bit), then at 1622, a determination may be made as to whether a shared page policy is to be invoked. A shared page policy may be invoked if the page to be accessed is explicitly shared (e.g., named pipes). When the PTE U/S bit in the page table entry is set to a particular value that indicates the page is a user page (e.g., any access level), and a global bit (e.g., 1404) in a page table entry of the physical page is set to a particular value (e.g., ‘1’ or ‘0), this can indicate that the page to be accessed is a an explicitly shared page. The global bit may be set to the opposite value (e.g., ‘0’ or ‘1’) to indicate that the page to be accessed is not explicitly shared. If the page to be accessed is determined to explicitly shared based on two memory indicators (e.g., G bit and PTE U/S bit), then the shared page policy is invoked and at 1624, a shared page key ID stored in the designated HTSR for explicitly shared pages is obtained. For example, KEY ID2 may be obtained from kernel key ID register 1523. The shared page key ID, KEY ID2, can be used for encryption/decryption of data or code associated with the memory access operation.

If the physical page to be accessed is determined to not be an explicitly shared page based on the memory indicators (e.g., PTE U/S bit and G bit), then a private memory policy is to be invoked. A private memory policy may be invoked at 1626, if none of the implicit policies or the explicit group policy are invoked for the physical page. Thus, the processor can infer that the memory address to be accessed is located in a private memory region of the hardware thread. Accordingly, a private key ID stored in the HTKR for a private memory region is obtained. For example, KEY ID0 may be obtained from the HTKR 1526. The private key ID, KEY ID0, can be used for encryption/decryption of data or code associated with the memory access operation. The data or code may be in a private memory region that is smaller than the physical page, bigger than the physical page, or exactly the size of the physical page. In some implementations (e.g., multi-bit memory type encoding) a particular value stored in a particular bit or bits in the encoded pointer may indicate that the memory address to be accessed is located in a private memory region. In this scenario, if the physical page of a memory access request does not cause the implicit policies, the explicit group policy, or the explicit private memory policy to be invoked, then an error can be raised. It should be noted that, if group selectors are used, it is possible to map a private key ID to a group selector and therefore, a private key ID can be identified and obtained (e.g., at 1606-1608) without determining whether to invoke implicit policies.

### Fine-Grained Isolation for Multithreaded Processes Using Privileged Software

Multithreaded applications like web servers, browsers, etc. use third party libraries, modules, and plug-ins. Additionally, such multithreaded applications often run mutually distrustful contexts within a process. For example, high performance event driven server frameworks that form the backbone of networked web services can multiplex many mutually distrustful contexts within a single worker process.

In a multithreaded application, the address space is shared among all the threads. As previously described herein, with reference to FIG. 3 for example, a process may include one or more hardware threads and each hardware thread can run a single software thread. In many architectures, multiple software threads can run on a single hardware thread and a scheduler can manage the scheduling of the software threads (or portions thereof) on the hardware thread's CPU. In many modern applications (e.g., FaaS, multi-tenancy, web servers, browsers, etc.) software threads in a process need security isolation due to memory safety attacks and concurrency vulnerabilities.

A multithreaded application in which the address space is shared among the software threads is vulnerable to attacks. A compromised software thread can access data owned by other software threads and be exploited to gain privilege and/or control of another software thread, inject arbitrary code into another software thread, bypass security of another software thread, etc. Even an attacker that is an unprivileged user without root permissions may be capable of controlling a software thread in a vulnerable multithreaded program, allocating memory, and forking more software threads up to resource limits on a trusted operating system. The adversary could try to escalate privileges through the attacker-controlled software threads or to gain control of another software thread (e.g., by reading or writing data of another module or executing code of another module). The adversary could attempt to bypass protection domains by exploiting race conditions between threads or by leveraging confused deputy attacks (e.g., through the API exported by other threads). Additionally, an untrusted thread (e.g., a compromised worker thread) may access arbitrary software objects (e.g., a private key used for encryption/decryption) within the process (e.g., a web server) of the thread.

Some platforms execute software threads of an application as separate processes to provide process-based isolation. While this may effectively isolate the threads, context switching and software thread interaction can negatively impact efficiency and performance. Some multi-tenant and serverless platforms (e.g., micorservices, FaaS, etc.) attempt to minimize interaction latency by executing functions of an application as separate threads within a single container. The data and code in such implementations, however, may be vulnerable. Some multi-tenant and serverlass platforms rely on software-based isolation, such as WebAssembly and V8 Javascript engine Isolates for data and code security. Such software-based isolation, may be susceptible to typical JavaScript and WebAssembly attacks. Moreover, language-level isolation generally, is weaker than container-based isolation and may incur high overhead by adding programming and/or state management complexity. Thus, there is a need to efficiently protect memory references of software threads sharing the same address space to prevent unintentional or malicious accesses to privileged memory areas, and to shared memory areas that are not shared by all threads in an application, during the lifetime of each software thread in a process.

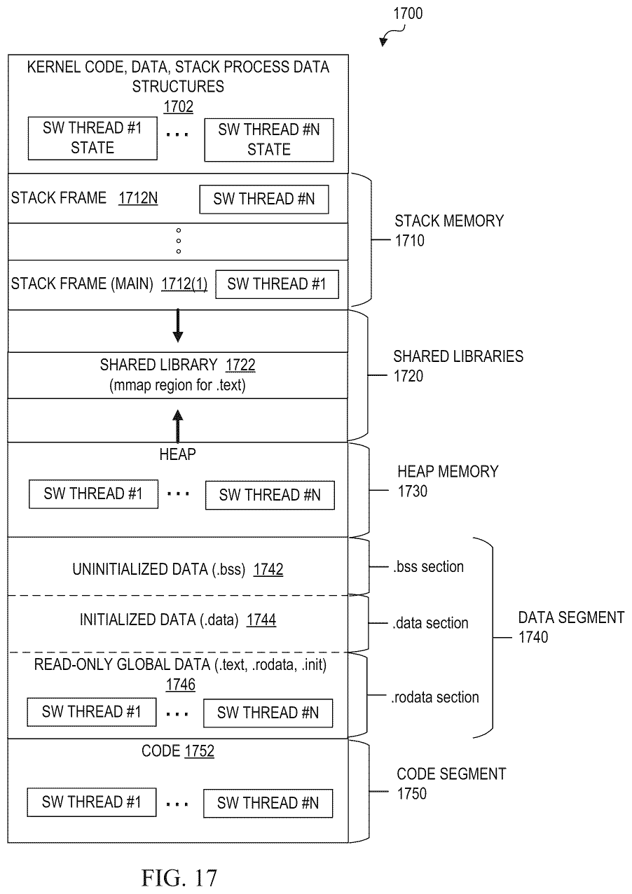

In FIGS. 17-21, a first embodiment is illustrated of system using privileged software with a multi-key memory encryption scheme to provide fine-grained isolation for multithreaded processes, and can resolve many of the aforementioned issues (and more). One or more embodiments, use privileged software (e.g., operating system, hypervisor, etc.) in conjunction with a multi-key memory encryption scheme (e.g., Intel® MKTME, etc.) to manage fine-grained cryptographic isolation, among mutually untrusted domains running on different software threads in a multithreaded application (e.g., microservices/FaaS runtimes, browsers, multi-tenants, etc.) that share the same address space. Each software thread is considered a domain and uses multi-key memory encryption to cryptographically isolate in-memory code and data within, and across, domains. The code and data of each software thread may be encrypted uniquely within the multithreaded process, using unique cryptographic keys. As the execution transitions between domains, appropriate cryptographic keys are used to correctly encrypt and decrypt data and code. Shared cryptographic keys may also be used by a group of two or more software threads in the multithreaded process to access shared memory. Thus, software threads may communicate with each other through mutually shared memory, but the memory boundaries and private memory access are restricted for each thread.

FIG. 17 is a block diagram illustrating an example process memory layout with cryptographic memory isolation for software threads (e.g., Thread #1 through Thread #N), according to at least one embodiment. By way of example, and not of limitation, Linux implements software threads that share an address space as standard processes. Each software thread has a software thread control block (e.g., task_struct) and appears to the operating system kernel as a process sharing address space with others. A single-threaded process has one process control block while a multithreaded process has one thread control block for each software thread. A thread control block may the same or similar to a process control block used for a process. A thread control block can contain information needed by the kernel to run the software thread and to enable thread switching within the process. The thread control block for a software thread can include thread-specific information. Thread switching within a multithreaded process is similar to process switching, except that the address space stays the same. In Linux multithreaded applications, however, no hardware enforced isolation is present among threads. Software threads share heap but have separate stacks and thread-local-storage in stack. A software thread, however, can read, write, or even wipe out another software thread's stack, given a pointer to the stack memory.

As shown in the example process memory of FIG. 17, the process address space includes kernel code, data, and stack process data structures 1702. The process data structures can include a thread control block (e.g., task_struct) for each software thread (e.g., SW Thread #1 through SW Thread #N) for storing software thread state (e.g., SW thread state #1 through SW thread state #N) of each software thread.

The process address space 1700 also includes stack memory 1710, shared libraries 1720, heap memory 1730, a data segment 1740, and a code (or text) segment 1750. Stack memory 1710 can include multiple stack frames 1712(1) through 1712(N) that include local variables and function parameters, for example. Function parameters and a return address may be stored each time a new software thread is initiated (e.g., when a function or other software component is called). Each stack frame 1712(1) through 1712(N) may be allocated to a different software thread (e.g., SW thread #1 through SW thread #N) in the multithreaded process.

The process address space 1700 can also include shared libraries 1720. One or more shared libraries, such as shared library 1722 may be shared by multiple software threads in the process, which can be all, or less than all, of the software threads.

Heap memory 1730 is an area of the process address space 1700 that is allotted to the application and may be used by all of the software threads (e.g., SW thread #1 through SW thread #N) in the process to store and load data. Each software thread may be allotted a private memory region in heap memory 1730, different portions of which can be dynamically allocated to the software thread as needed when that software thread is running. Heap memory 1730 can also include shared memory region(s) to be shared by a group of two or more software threads (e.g., SW thread #1 through SW thread #N) in the process. Different shared memory regions may be shared by the same or different groups of two or more software threads.

Data segment 1740 includes a first section (e.g., bss section) for storing uninitialized data 1742. Uninitialized data 1742 can include read-write global data that is initialized to zero or that is not explicitly initialized in the program code. Data segment 1740 may also include a second section (e.g., data section) for storing initialized data 1744. Initialized data 1744 can include read-write global data that is initialized with something other than zeroes (e.g., characters string, static integers, global integers). The data segment 1740 may further include a third section (e.g., rodata section) for storing read-only global data 1746. Read-only global data 1746 may include global data that can be read, but not written. Such data may include constants and strings, for example. The data segment 1740 may be shared among the software threads (e.g., SW thread #1 through SW thread #N).

The code segment 1750 (also referred to as ‘text segment’) of the virtual/linear address space 1700 further includes code 1752, which is composed of executable instructions. In some examples, code 1752 may include code instructions of a single software thread that is running. In a multithreaded application, code 1752 may include code instructions of multiple software threads (e.g., SW thread #1 through SW thread #N) in the same process that are running.

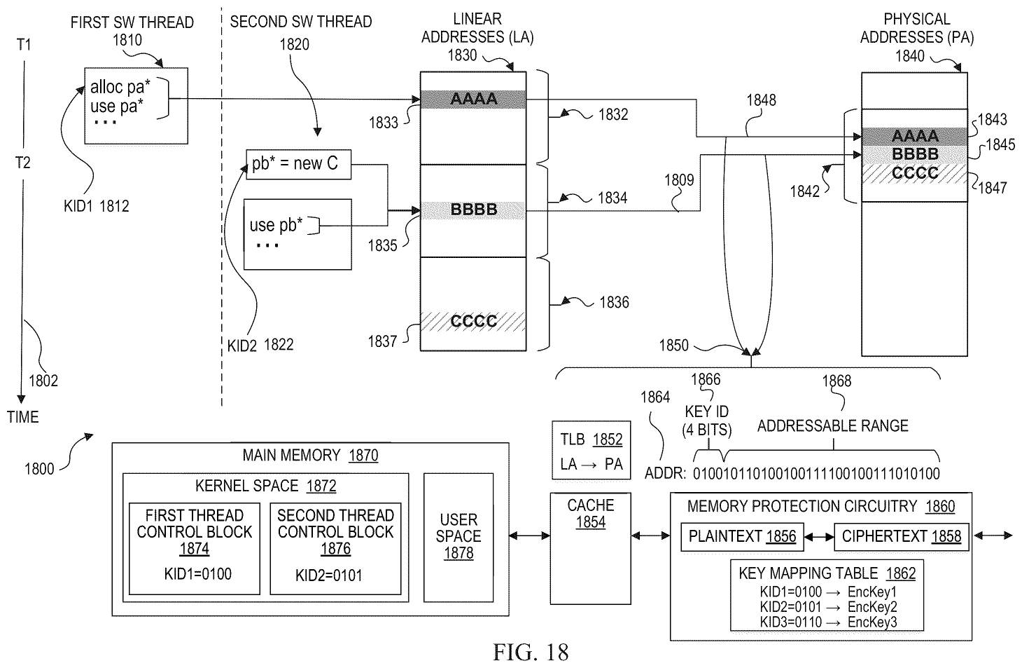

FIG. 18 is a block diagram illustrating an example execution flow 1800 of two software threads 1810 and 1820 in a multithreaded process over a given period 1802 using privileged software with a multi-key memory encryption mechanism to enforce fine-grained cryptographic isolation. FIG. 18 illustrates how multi-key memory encryption hardware, as disclosed herein, can be utilized in commodity platforms for implementing thread isolation without any major hardware changes. FIG. 18 will be described with reference to per-thread heap memory isolation. It should be appreciated, however, that the concepts and techniques described with respect to heap memory (e.g., 1730) can be extended to code memory (e.g., 1750), stack memory (e.g., 1710), and a data segment (e.g., 1740) of a process address space.

FIG. 18 illustrates an example scenario of a first software thread 1810 and second software thread 1820 running in period 1802 at times T1 and T2 and sharing the same process address space. In at least some architectures (e.g., Linux), the first and second software threads may have respective thread control blocks (e.g., task_struct data structures) even while sharing the same process address space. The process address space corresponds to a linear address space with linear addresses 1830 that map to physical addresses 1840 in memory. In this example, the linear addresses 1830 are allotted to heap memory in the process, which includes a first linear page 1832 including a first allocation 1833 of the first software thread 1810, a second linear page 1834 including a second allocation 1835 of the second software thread 1820, and a third linear page 1837 including a shared memory region 1837 that the first and second software threads are allowed to access. The first allocation 1833 of the first linear page 1832 and a second allocation 1835 of the second linear page 1834 map to physical addresses in the same physical page 1842. The first allocation 1833 may compose at least a portion of a first private memory region of the first software thread 1820. The second allocation 1835 may compose at least a portion of a second private memory region of the second software thread 1830. Although the private and shared memory of the process reside in the same physical page 1842 of the physical address space, in the linear address space, the first allocation 1833, the second allocation 1835, and the shared memory region 1837 reside in three different linear pages. It should also be noted that the first allocation 1833, the second allocation 1835, and the shared memory region 1837 maintain the same offset in the physical page 1842 as in their respective linear pages 1832, 1834, and 1836.

FIG. 18 also illustrates hardware components 1850 that enable data encryption and decryption for the multithreaded process, and also code decryption when fetching instructions for execution. The hardware components 1850 include a translation lookaside buffer 1852 (e.g., similar to TLB 147A, 147B, 840), a cache 1854 (e.g., similar to cache 144A, 144B), and memory protection circuitry 1860 (e.g., similar to 160). The TLB 1852 stores linear address (LA) to physical address (PA) translations that have been performed in response to recent memory access requests. In at least some scenarios, the software threads 1810 and 1820 may run in different hardware threads, and a TLB and at least some caches are provisioned for each hardware thread.

In some example systems that are not virtualized, linear address translation (LAT) paging structures (e.g., 920) may be used to perform page walks to translate linear addresses to physical addresses for memory accesses to linear addresses that do not have corresponding translations stored in the TLB 1852. In other example systems, guest linear address translation (GLAT) paging structures (e.g., 172, 1020) and EPT paging structures (e.g., 228) may be used to perform page walks to translate guest linear addresses (GLA) to host physical addresses (HPAs) for memory accesses to GLAs that do not have corresponding translations stored in the TLB 1852.

The memory protection circuitry 1860 includes a key mapping table 1862 (e.g., similar to key mapping tables 162, 430, and/or 1530). The key mapping table 1862 can include associations (e.g., mappings, relations, connections, links, etc.) of key IDs to cryptographic keys. The key IDs are assigned to particular software threads and/or particular memory regions of the software threads (e.g., private memory region of the first software thread, private memory region of the second software thread, shared memory region accessed by the first and second software threads). A key ID may be stored in certain bits of a physical memory address in a page table entry (PTE) (e.g., 927) of a page table (e.g., 928) in LAT paging structures (e.g., 920, 172), or in an extended page table (EPT) PTE (e.g., 1059) of an EPT in EPT paging structures (e.g., 228). Thus, in the embodiments described with respect to FIG. 18, the leaf PTEs and/or leaf EPT PTEs may each include a key ID embedded in the physical address stored in that leaf of the particular paging structures. During a memory access by one of the software threads, a key ID embedded in a physical address stored in a PTE 927 or in an EPT PTE 1059 (depending on the system) is found during a page walk and can be used by memory protection circuitry 1860 to determine the appropriate cryptographic key (e.g., a cryptographic key that is associated with the key ID in the key mapping table 1862).

FIG. 18 illustrates a possible flow of data through the memory protection circuitry 1860 during a memory access. In one example, after a page walk occurs for a linear address (or guest linear address) of a memory access request associated with one of the software threads 1810 or 1820, a physical address 1864 that is determined based on the page walk may be used to access the memory. The physical address 1864 obtained from a PTE or EPT PTE in the translation paging structures can include an addressable range 1868 (e.g., physical page) and a key ID 1866 that is embedded in upper address bits of the physical address 1864. The linear address (or guest linear address) that is translated to obtain the physical address 1864 includes lower address bits that serve as an index into the physical page (e.g., an offset to addressable range 1868).

If data is being read from memory, the physical address 1864 (indexed by lower bits of the linear address or guest linear address being translated) may be used to retrieve the data. In at least one embodiment, the key ID 1866 is ignored by the memory controller circuitry. The data being accessed may be in the form of ciphertext 1858 in the memory location referenced by the indexed physical address 1864. The key ID 1866 can be used to identify an associated cryptographic key (e.g., EncKey1) to decrypt the data. Memory protection circuitry 1860 can decrypt the ciphertext 1858 using the identified cryptographic key (e.g., EncKey1), to generate plaintext 1856. The plaintext 1856 can be stored in cache 1854, and the translation of the linear address (or guest linear address) that was translated to physical address 1864 can be stored in the TLB 1852. If data is being stored to memory, then plaintext 1856 can be retrieved from cache 1854. The plaintext 1856 can be encrypted using the identified cryptographic key, to generate ciphertext 1858. The ciphertext 1858 can be stored in physical memory.

A description of the creation of software threads in a multithreaded process will now be provided. During the creation of a software thread, such as first software thread 1810 at time T1, privileged software assigns a first data key ID 1812 (e.g., KID1=0100) to the first software thread 1810 for encrypting/decrypting data in a first private (linear) memory region (including the first allocation 1832) allotted for the first software thread. The privileged software may be, for example, an operating system (e.g., kernel) or hypervisor. The memory protection circuitry 1860 can be programmed with the first data key ID (e.g., 0100). If the first private memory region (including the first allocation 1832) is to be encrypted, then the programming includes generating or otherwise obtaining (e.g., as previously described herein, for example with reference to key mapping tables 162, 430, 1530) a first cryptographic key (e.g., EncKey1) and associating the first data key ID to the first cryptographic key (e.g., 0100→EncKey1). While the first software thread's heap memory allocations may potentially belong to different physical pages, all of the first software thread's heap memory allocations are encrypted and decrypted using the same cryptographic key (e.g., EncKey1).

During the creation of second software thread 1820 at time T2, the privileged software may assign a second data key ID 1822 (e.g., KID2=0101) to the second software thread 1820 for encrypting/decrypting data in a second private (linear) memory region (including the second allocation 1834). The memory protection circuitry 1860 can be programmed with the second data key ID. If the second private memory region (including the second allocation 1834) is to be encrypted, then the programming includes generating or otherwise obtaining (e.g., as previously described herein, for example with reference to key mapping tables 162, 430, 1530) a second cryptographic key (e.g., EncKey2) and associating the second data key ID to the second cryptographic key (e.g., 0101→EncKcy2). All of the second software thread's heap memory allocations are encrypted and decrypted using the same cryptographic key (e.g., EncKey2) even if the second software thread's heap memory allocations belong to different physical pages.

The key IDs may also be stored in thread control blocks for each software thread. For example, the first key ID (e.g., 0100) can be stored in a first thread control block 1874 in kernel space 1872 of main memory 1870. The second key ID (e.g., 0101) can be stored in a second thread control block 1876 in kernel space 1872 of main memory 1870. The thread control blocks can be configured in any suitable manner including, but not limited to, a task_struct data structure of a Linux architecture. The thread control blocks can store additional information needed by the kernel to run each software thread and to enable thread switching within the process. The first thread control block 1874 stores information specific to the first software thread 1810, and the second thread control block 1876 stores information specific to the second software thread 1820.

During runtime, the first software thread 1810 may allocate a first cache line (e.g., first allocation 1833) of the first private memory region in the first linear page 1832, and the second software thread 1820 may allocate a second cache line (e.g., second allocation 1835) of the second private memory region in the second linear page 1834. It should be noted that the first cache line 1833 and the second cache line 1835 reside in different linear pages, which are mapped to respective cache lines in the same or different physical pages. In this example, the first cache line 1833, which is in first linear page 1832, is mapped to a first cache line 1843 in a first physical page 1842 of physical memory, and the second cache line 1835, which is in second linear page 1834, is mapped to a second cache line 1845 in the same first physical page 1842. Thus, the linear addresses of the first and second cache lines 1833 and 1835 reside in different linear memory pages but the same physical page. In addition, the shared memory region 1837, which can be accessed by both the first and second software threads 1810 and 1820, is located in the third linear page 1836 and is mapped to a third cache line 1847 in the same first physical page 1842.

In a typical implementation without software thread isolation, a single mapping in address translation paging structures may be used to access both the first cache line 1833 and the second cache line 1835 when the cache lines are located in the same physical page. In this scenario, the same key ID is used to encrypt all the data in the physical page. In some scenarios, however, multiple software threads with allocations in the same physical page may need the data in those allocations to be encrypted with different keys.

To resolve this issue and enable sub-page isolation using multi-key memory encryption provided by memory protection circuitry 1860, one or more embodiments herein use software-based page table aliasing. As previously described herein (e.g., FIGS. 9 and 10), address translation paging structures can include linear-to-physical address (LA-to-PA) mappings that can translate linear addresses referencing locations in respective linear pages of a process address space to respective physical addresses referencing respective physical pages of the process address space. Page table aliasing involves creating additional mappings in the address translation paging structures for a particular physical page. The additional mappings can be created for allocations that are located at least partially within the same physical page and that belong to different software threads of the same process. When different allocations are located in the same physical page, the allocations may each have a cache line granularity, smaller than a cache line granularity, larger than a cache line granularity (but not spanning the entire physical page), and/or any suitable combination thereof. It should apparent that, if an allocation crosses a physical page boundary, then other mappings may be generated to correctly map other portions of the allocation in the other physical page(s).

For a single physical page containing allocations belonging to different software threads, multiple page table entries (e.g., 927 or 1059) in the address translation paging structures may be created. Each page table entry for the same physical page corresponds to a respective software thread, and the respective software thread's key ID is embedded in the physical address stored in that PTE. In a virtual environment, guest linear address to host physical address (GLA-to-HPA) mappings and associated alias mappings may be used. For simplicity, the subsequent description references LA-to-PA address mappings as an example.

To perform page aliasing in the example scenario shown in FIG. 18, the operating system can generate two different mappings. A first mapping can translate linear address(es) in the first allocation 1833 to the physical address of physical page 1842. A second mapping can translate linear address(es) in the second allocation 1835 to the same physical address of physical page 1842. Two page table entries (PTEs) are created in the two mappings, respectively, and hold the same physical address of the physical page 1842. Two different key IDs are embedded in the upper address bits of the two same physical addresses stored in the two PTEs, respectively.

In the example of FIG. 18 more specifically, a first mapping for the physical page 1842 maps a linear address of the first cache line 1833 to a physical address of physical page 1842 in which the physical cache line 1843 is located. The first key ID of the first software thread 1810 is stored in upper bits of the physical page's physical address, which is stored in a page table entry (e.g., 927 or 1059) of the first mapping. By way of example, if the linear address of the first cache line 1833 is represented by linear address 910 of FIG. 9, for example, then the first key ID could be stored in PTE 927. If the linear address of the first cache line 1833 is represented by guest linear address 1010 of FIG. 10, for example, then the first key ID could be stored in EPT PTE 1059.

A second (alias) mapping for the physical page 1842 maps a linear address of the second cache line 1835 to the same physical address of the same physical page 1842 in which the physical cache line 1845 is also located. The second key ID of the second software thread 1820 is stored in upper bits of the physical page's physical address, which is stored in a page table entry (e.g., 927 or 1059) of the second mapping. If the linear address of the second cache line is represented by linear address 910 of FIG. 9, for example, then the second key ID could be stored in PTE 927. If the linear address of the second cache line is represented by guest linear address 1010 of FIG. 10, for example, then the second key ID could be stored in EPT PTE 1059. It should be noted that an allocation may be smaller or bigger than a single cache line.

The first access to a physical page containing a memory allocation of the first software thread 1810 results in a page fault if the page is not found in main memory. On a page fault, a physical page containing an address mapped to the linear address being accessed, is loaded to the process address space (e.g., in main memory). Also, a page table entry (PTE) mapping of a linear address to a physical address (LA→PA) is created. In other systems, an EPT PTE mapping of a guest linear address to a host physical address (GLA→HPA) is created. The key ID (e.g., 0100) assigned to the first software thread for the first software thread's private data region is embedded in the physical address stored in the PTE or EPT PTE.

Key IDs and the associated cryptographic keys that are installed in the memory protection circuitry 1860 may continue to be active even if the execution switches from one software thread to another. Hence, on switching from the first software thread 1810 to the second software thread 1820, the second software thread's key ID (e.g., KID2=0101) needs to be active while other key IDs need to be deactivated. In one example, a platform configuration instruction (e.g., PCONFIG) may be used by the privileged software to deactivate all of the key IDs assigned to other software threads that are not the currently executing software thread.

One or more memory regions may be shared by a group of two or more software threads in a process. For example, a third memory region 1836 to be shared by the first and second software threads 1810 and 1820 is allotted in the heap memory. The privileged software may assign a third data key ID (e.g., KID3=0110) to the third memory region. The third data key ID (e.g., KID3=0110) can be programmed in the memory protection circuitry 1860. If the shared memory region is to be encrypted, then the programming includes generating (or otherwise obtaining) a third cryptographic key and creating an association from the third key ID to the third cryptographic key (e.g., KID3→EncKey3). The first and second software threads 1810 and 1820 are allowed to share the third key ID and will be able to access any shared data allocated in the shared third memory region.

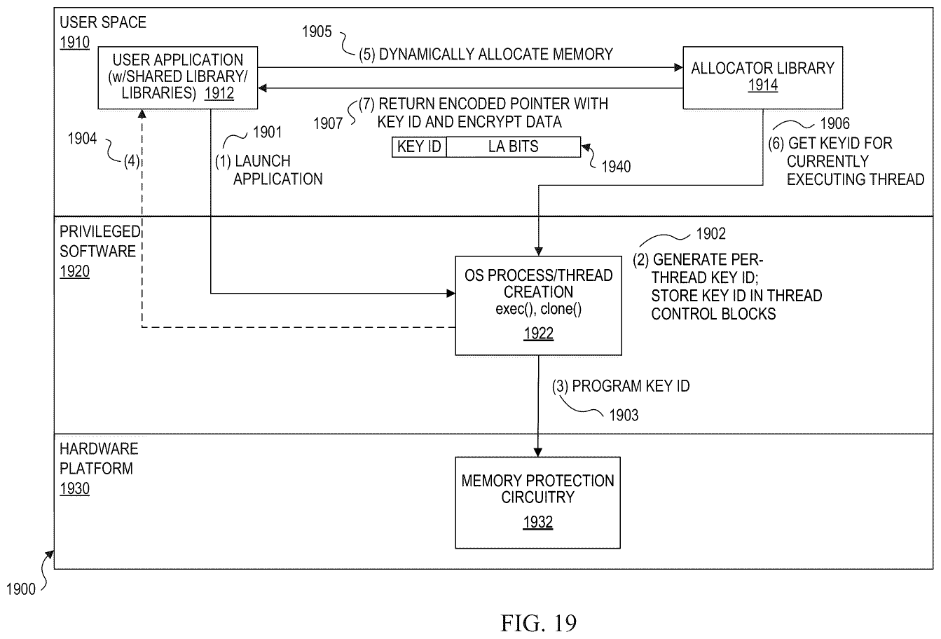

FIG. 19 illustrates an example system architecture 1900 using privileged software with a multi-key memory encryption scheme to achieve fine-grained cryptographic software thread isolation, according to at least one embodiment. The system architecture 1900 illustrates portions of a computing system in which a process creation flow occurs, including a user space 1910, privileged software 1920, and a hardware platform 1930. The system architecture 1900 may be similar to computing systems 100 or 200 (without the specialized hardware registers HTKRs 156 and HTGRs 158). In particular examples, the user space 1910 may be similar to user space 110 or virtual machine 210. The privileged software 1920 may be similar to operating system 120, guest operating system 212, and/or hypervisor 220. Hardware platform 1930 may be similar to hardware platform 130.

The hardware platform 1930 includes memory protection circuitry 1932, which may be similar to memory protection circuitry 160 or 1860, among others, as previously described herein. Memory protection circuitry 1932 can include a key mapping table in which associations of key IDs to cryptographic keys are stored. Memory protection circuitry 1932 can also include a cryptographic algorithm to perform cryptographic operations to encrypt data or code during memory store operations, and to decrypt data or code during memory load operations.

Privileged software 1920 may be embodied as an operating system or a hypervisor (e.g., virtual machine monitor (VMM)), for example. In at least one implementation, the privileged software 1920 corresponds to a kernel of an operating system that can run with the highest privilege available in the system, such as a ring 0 protection ring, for example. In the example system architecture 1900, privileged software 1920 may be an open source UNIX-like operating system using a variant of the Linux kernel. It should be appreciated, however, that any other operating system or hypervisor may be used in other implementations including, but not necessarily limited to, a proprietary operating system such as Microsoft® Windows® operating system from Microsoft Corporation or a proprietary UNIX-like operating system.

User space 1930 includes a user application 1912 and an allocator library 1914. The user application 1912 may include one or more shared libraries. The user application may be instantiated as a process with two or more software threads. In some scenarios, the software threads may be untrusted by each other. All of the software threads, however, share the same process address space. Different key IDs and associated cryptographic keys may be generated (or otherwise obtained) for each software thread's private memory region (e.g., heap memory 1730, stack memory 1710) during the instantiation of the user application 1912, as shown in FIG. 19.

As illustrated in the process creation flow of FIG. 19, at 1901, the user application 1912 is launched to create a multithreaded process. At 1922, the operating system creates the multithreaded process and the software threads of the process. For example, exec( ) and clone( ) system calls in the operating system may be instrumented to perform at least some of the tasks. At 1902, during the process and software thread creation, per-software thread key IDs (e.g., a fixed number of key IDs) can be created and stored in appropriate thread control blocks (e.g., task_struct in Linux) of the respective software threads. In some implementations, programming the key IDs can be initiated by the operating system, and in other implementations, programming the key IDs can be initiated by the allocator library 1914. Alternatively, key IDs can be programmed on-demand. For example, one key ID can be programmed for the main thread during the process and main software thread creation, and other key IDs can be programmed on-demand as new threads are created.

At 1903, the privileged software 1920 can program key IDs in memory protection circuitry 1932 for software threads of the process. In one example, the privileged software 1920 can generate a first key ID for a private memory region of a first software thread and execute an instruction (e.g., PCONFIG or other similar instruction) to cause the memory protection circuitry 1932 to generate (or otherwise obtain) a cryptographic key and to associate the cryptographic key to the first key ID. The cryptographic key may be mapped to the key ID in a key mapping table, for example. The privileged software 1920 can program other key IDs in the memory protection circuitry 1932 for other software threads of the process and/or for shared memory used by multiple software threads of the process, in the same manner.

After the process has been created and the process address space has been reserved, the privileged software can create address translation paging structures for the process address space. At 1904, the first software thread of the user application can begin executing.

At 1905, as the first software thread of the user application executes, memory may be dynamically allocated by allocator library 1914. In one or more embodiments, a new system call may be implemented for use by the allocator library 1914 to obtain a key ID of the currently executing thread at runtime. The allocator library 1914 can instrument allocation routines to obtain the key ID from privileged software 1920. The privileged software 1920 may retrieve the appropriate key ID from the thread control block of the currently executing software thread.

At 1906, the instrumented allocation routines can receive the key ID from privileged software 1920. In one possible implementation, the key Id can be embedded in a linear memory address for the dynamically allocated memory, as shown by encoded pointer 1940. Encoded pointer 1940 includes at least a portion of the linear address (LA bits) with the key ID embedded in the upper address bits of the linear address. Embedding a key ID in a linear address is one possible technique to systematically generate different linear addresses for different threads to be mapped to the same physical address. This could happen, for example, if allocations for different software threads using different key IDs and cryptographic keys are stored in the same linear page and mapped to the same physical page. In this scenario, the linear page addresses in an encoded pointer are different for each allocation based on the different key IDs embedded in the encoded pointers. It should be appreciated that any other suitable technique to implement heap mapping from different linear addresses to the same physical address stored in different leaf PTEs may be used in alternative implementations. At 1907, the encoded pointer 1940 can be returned to the executing software thread. The encoded pointer can be used by the software thread to perform memory accesses to the memory allocation. Data can be encrypted during store/write memory accesses of the allocation and decrypted during read/load memory accesses of the allocation.

In one or more embodiments, page table aliasing can be implemented via the privileged software 1920. On a page fault, when a physical page of a software thread is first accessed, the physical page can be loaded into the process address space in main memory. In this scenario, privileged software 1920 can create a page table entry mapping of a linear address to a physical address of the physical page in the address translation paging structures. The PTE (or EPT PTE) in the mapping can contain the physical address of the page. The key ID assigned to the currently executing software thread can be embedded in the upper bits of the physical address in the PTE. Other PTE mappings of linear addresses to the same physical address of the same physical page may be created in the address translation paging structures for memory allocations of other software threads that are located at least partially within that same physical page. In one example, for an allocation of a second software thread that has a second linear address mapped to the same physical page, the operating system can create a second PTE mapping of the second linear address to the physical address of the physical page. The PTE in the second PTE mapping can contain the same physical address of the physical page. However, a different key ID assigned to the second software thread is stored in the upper bits of the physical address stored in the PTE of the second PTE mapping.

It should be understood that the linear-to-physical address mappings may be created in linear address paging structures and/or in extended page table paging structures if the system architecture is virtualized, for example. Thus, references to ‘page table entry’ and ‘PTE’ are intended to include a page table entry in a page table of linear address paging structures, or an EPT page table entry in an extended page table of EPT paging structures.

In an alternative embodiment, the allocator library 1914 can be configured to perform thread management and may generate key IDs and store the per-thread key IDs during the process and software thread creation. The allocator library 1914 can manage and use the per-software thread key IDs for runtime memory allocations and accesses. At runtime, the allocator library 1914 instruments allocation routines to get the appropriate key ID for the software thread currently executing and encode the pointer 1940 to the memory that has been dynamically allocated for the currently executing software thread. The pointer 1940 can be encoded by embedding the retrieved key ID in particular bits of the pointer 1940.

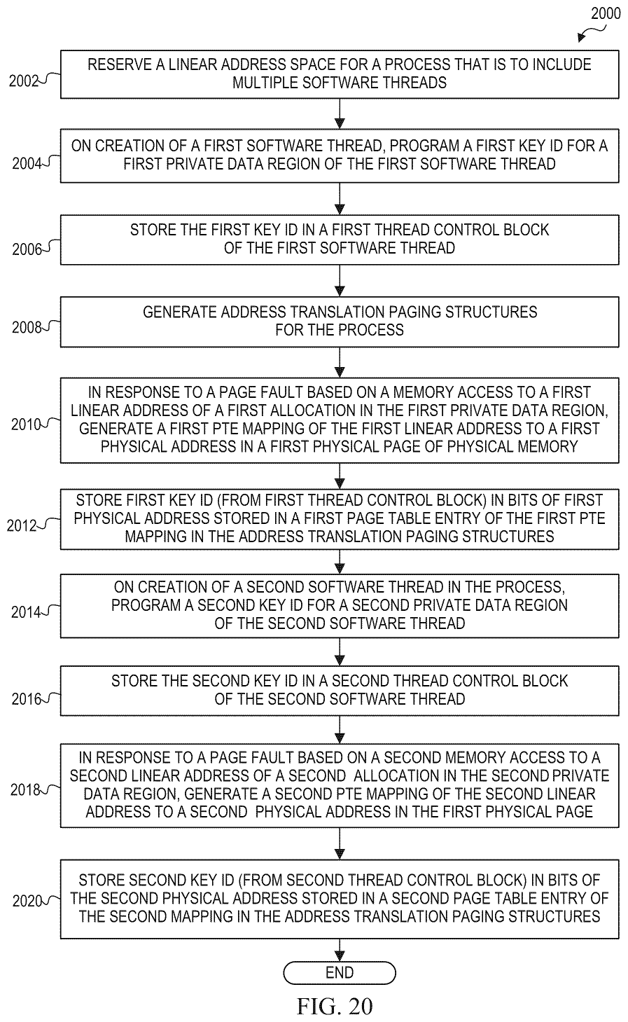

FIG. 20 is a simplified flow diagram 2000 illustrating example operations associated with privileged software using a multi-key memory encryption scheme to provide fine-grained cryptographic isolation in a multithreaded process according to at least one embodiment. A computing system (e.g., computing system 100, 200, 1900) may comprise means such as one or more processors (e.g., similar to processor 140 but without hardware thread registers 156 and 158) and memory (e.g., 170, 1700, 1870) for performing the operations. In one example, at least some operations shown in flow diagram 2000 may be performed by privileged software, such as an operating system or a hypervisor, running on a core of the processor of the computing system to set up address translation paging structures (e.g., 172, 216 and 228, 920, 1020 and 1030) for first and second software threads 1810 and 1820. Although flow diagram 2000 is described with reference to PTEs, PTE mappings, and physical addresses, it should be appreciated that the operations described with reference to flow diagram 2000 are also applicable to virtualized systems that use EPT PTEs, EPT PTE mappings, and host physical addresses. In at least some scenarios, a kernel of the operating system performs one or more of the operations in flow diagram 2000. Although flow diagram 2000 references only two software threads of a user application, it should be appreciated that flow diagram 2000 is applicable to any number of software threads that are created for a user application. Furthermore, the two (or more) software threads may be separate functions (e.g., functions as a service (FaaS), tenants, etc.) that share a single process address space.

At 2002, privileged software (e.g., operating system, hypervisor, etc.) reserves a linear address space for a process that is to include multiple software threads.

At 2004, on creation of a first software thread, a first key ID is programmed for a first private data region of the first software thread. The first key ID may be programmed by being provided to memory protection circuitry via a privileged instruction executed by privileged software (e.g., PCONFIG or other suitable instruction). Programming the first key ID can include generating or otherwise obtaining a first cryptographic key and associating the first cryptographic key to the first key ID in any suitable manner (e.g., mapping in a key mapping table).

At 2006, the first key ID may be stored in a first thread control block associated with the first software thread. The thread control block may be similar to a process control block (e.g., task_struct data structure in Linux) and may contain thread-specific information about the first software thread needed by the operating system to run the thread and to perform context switching when execution of the first software thread switches from executing to idle, from idle to executing, from executing to finished, or any other context change.

At 2008, the privileged software generates address translation paging structures for the process address space of the process. The address translation paging structures may be any suitable form of mappings from linear addresses of the process address space to physical addresses (e.g., 172, 920), or from guest linear addresses of the process address space to host physical addresses (e.g., 216 and 228, 1020 and 1030).

Once a software thread running in a process address space begins executing, a page fault occurs when a memory access is attempted to a linear address corresponding to a physical address that has not yet been loaded to the process address space in memory. In response to a page fault based on a memory access using a first linear address in a first allocation in the first private data region of the first software thread, at 2010, a first page table entry mapping is generated for the address translation paging structures. The first PTE mapping can translate the first linear address to a first physical address stored in a PTE of the first PTE mapping. The PTE contains a first physical address of a first physical page of the physical memory.

At 2012, the first key ID is obtained from the first thread control block associated with the first software thread. The first key ID is stored in bits (e.g., upper bits) of the first physical address stored in the PTE of the first PTE mapping in the address translation paging structures.

At 2014, on creation of a second software thread, a second key ID is programmed for a second private data region of the second software thread. The second key ID may be programmed by being provided to memory protection circuitry via a privileged instruction executed by privileged software (e.g., PCONFIG or other suitable instruction). Programming the second key ID can include generating or otherwise obtaining a second cryptographic key and associating the second cryptographic key to the second key ID in any suitable manner (e.g., mapping in a key mapping table).

At 2016, the second key ID may be stored in a second thread control block associated with the second software thread.

In response to a page fault based on a memory access using a second linear address in a second allocation in the second private data region of the second software thread, at 2018, a second page table entry mapping is generated for the address translation paging structures. The second PTE mapping can translate the second linear address to a second physical address stored in a PTE of the second PTE mapping. The PTE contains a second physical address of a second physical page of the physical memory.

At 2020, the second key ID is obtained from the second thread control block associated with the second software thread. The second key ID is stored in bits (e.g., upper bits) of the second physical address stored in the PTE of the second PTE mapping in the address translation paging structures.

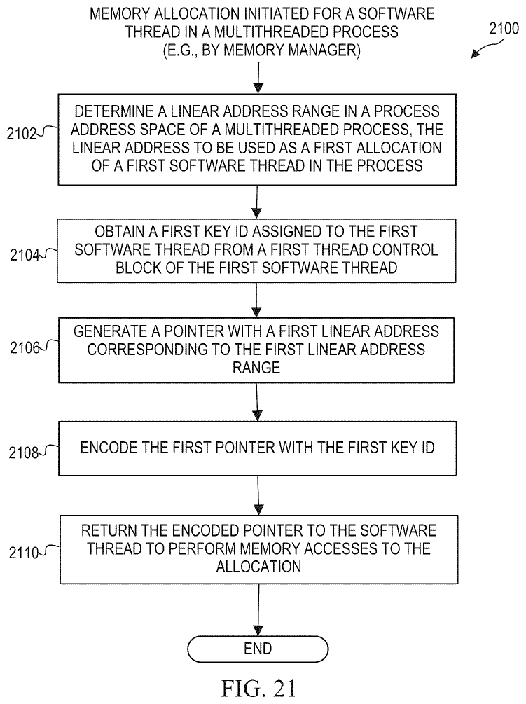

FIG. 21 is a simplified flow diagram 2100 illustrating example operations associated with securing an encoded pointer to a memory region dynamically allocated during the execution of a software thread in a multithreaded process. One or more operations in the flow diagram 2100 may be executed by hardware, firmware, and/or software of a computing device (e.g., computing system 100, 200, 1900). In one example, an allocator library (e.g., 1914) may perform one or more of the operations. The one or more operations can begin in response to a memory allocation initiated by privileged software such as a memory manager module of an operating system (e.g., 120) or hypervisor (e.g., 220). The memory manager module may be embodied as, for example, a loader, a memory manager service, or a heap management service. Initially, the memory manager module may initiate a memory allocation operation for a software thread in a multithreaded process.

At 2102, the allocator library may determine a linear address and an address range in a process address space (e.g., heap memory 1730, stack memory 1710, etc.) to be allocated for a first software thread in a multithreaded process. Other inputs may also be obtained, if needed, to encode the linear address of the allocation.

At 2104, the allocator library obtains a first key ID assigned to the first software thread. The first key ID may be obtained from a thread control block of the first software thread.

At 2106, a pointer may be generated with the linear address of the linear address range for the allocation.

At 2108, the first pointer is encoded with the first key ID. The first key ID may be stored in some bits (e.g., upper bits or any other predetermined linear address bits) of the pointer.

At 2110, the encoded pointer may be returned to the software thread to perform memory accesses to the memory allocation.

### Using Privileged Software and EPTs for Software Thread Isolation

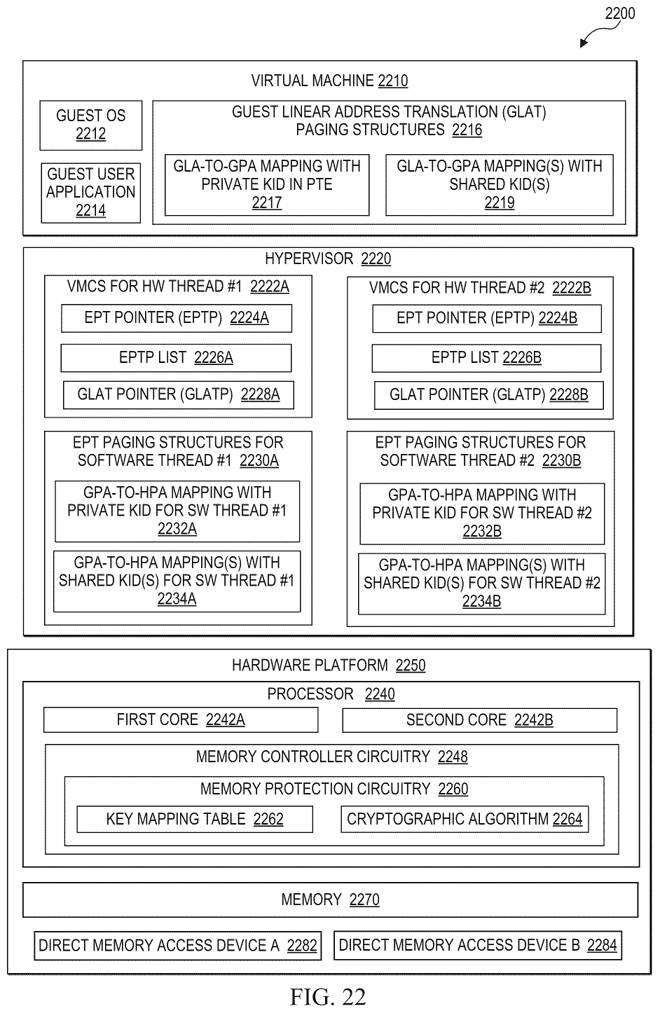

Turning to FIGS. 22-24, another embodiment provides for using privileged software with a multi-key memory encryption scheme (e.g., Intel® MKTME) to enable software thread isolation for software threads running on one or more hardware threads. In this embodiment, privileged software, such as a hypervisor or virtual machine manager (VMM), controls which key IDs a hardware thread of a process is allowed to switch between. Key IDs that are provided through EPT page table mappings are made accessible exclusively to the hardware threads to which the key IDs have been assigned via the privileged software. For a multithreaded process associated with a guest user application in a virtual machine, the GLAT paging structures (e.g., GLA-to-GPA mappings) can be static for all of the hardware threads in the process. The hypervisor, however, can create EPT paging structures for each software thread. The EPT paging structures for a particular software thread are provisioned with a key ID assigned to the hardware thread for private memory accesses. In any given software thread's EPT paging structures, the GPAs that map to private memory regions allocated to other software threads using the same process address space are not mapped to those other private memory regions in the given software thread's EPT paging structures. A virtual machine control structure (VMCS) can be set up per hardware thread by the hypervisor. However, an instruction can be executed by a user application (e.g., tenant) to select which EPT paging structures a hardware thread uses. This selection may be performed by an appropriate instruction such as, for example, the VM function 0 (VMFUNC0) instruction. In one embodiment, the VMFUNC instruction can be executed each time a software thread (e.g., tenant) is switched. In this embodiment, the EPT paging structures can map the entire tenant could access both Thus, isolating the software threads and hardware threads can be achieved without hardware changes in this embodiment.

FIG. 22 illustrates an example virtualized computing system 2200 configured to control software thread isolation with privileged software when using a multi-key memory encryption scheme, such as Intel® MKTME, according to at least one embodiment. In this example computing system 2200 includes a virtual machine (VM) 2210 and a hypervisor 2220 implemented on a hardware platform 2250. Hardware platform 2250 may be similar to hardware platform 130 of FIG. 1. For example, hardware platform 2250 includes a processor 2240 with two (or more) cores 2242A and 2242B and memory controller circuitry 2248, memory 2270, and direct memory access (DMA) devices 2282 and 2284. Processor 2240 may be similar to processor 140. Cores 2242A and 2242B may be similar to cores 142A and 142B, but may not include specialized hardware registers HTKRs 156 and HTGRs 158. Memory controller circuitry 2248 may be similar to memory controller circuitry 148. Memory protection circuitry 2260 may be similar to memory protection circuitry 160 and may implement a multi-key memory encryption scheme such as Intel® MKTME, for example. Additionally, memory 2270 may be similar to memory 170, and hardware platform may include one or more DMA devices 2282 and 2284 similar to the DMA devices 182 and 184.

The cores 2242A and 2242B may be single threaded or, if hyperthreading is implemented, the cores may be multithreaded. For example purposes, the process of guest user application 2214 is assumed to run on two hardware threads, with first core 2242A supporting hardware thread #1 and second core 2242B supporting hardware thread #2. Separate software threads may be run on separate hardware threads, or multiplexed on a smaller number of available hardware threads than software threads via time slicing. In this example, software thread #1 (e.g., a first tenant) is running on hardware thread #1 of the first core 2242A, and a software thread #2 (e.g., a second tenant) is running on hardware thread #2 of the second core 2242B. In one example, the software threads are tenants. It should be noted, however, that the concepts described herein for using privileged software to enforce software thread and hardware thread isolation are also applicable to other types of software such as compartments and functions, which could also be treated as isolated tenants.

In virtualized computing system 2200, virtual machine 2210 includes a guest operating system (OS) 2212, a guest user application 2214, and guest linear address translation (GLAT) paging structures 2216. Although only a single virtual machine 2210 is illustrated in computing system 2200, it should be appreciated that any number of virtual machines may be instantiated on hardware platform 2250. Furthermore, each virtual machine may run a separate virtualized operating system. The guest user application 2214 may include multiple tenants that run on multiple hardware threads of the same core in hardware platform 2250, on hardware threads of different cores in hardware platform 2250, or any suitable combination thereof.

A guest kernel of the guest operating system 2212 can allocate memory for the GLAT paging structures 2216. The GLAT paging structures 2216 can be populated with mappings (e.g., guest linear addresses (GLAs) mapped to guest physical addresses (GPAs)) from the process address space of guest user application 2214. One set of GLAT paging structures 2216 may be used for guest user application 2214, even if the guest user application includes multiple separate tenants (e.g., or compartments, functions, etc.) running on different hardware threads. The GLAT paging structures 2216 can be populated with one GLA-to-GPA mapping 2217 with a private key ID in a page table entry. All software threads in the process that access their own private memory region can be mapped through the same GLA-to-GPA mapping 2217 with the private key ID. The GLAT paging structures 2216 can also be populated with one or more GLA-to-GPA mappings 2219 with respective shared key IDs in respective page table entries. Shared memory regions of the process are mapped through GLA-to-GPA mappings 2219 and are accessible by each software thread that is authorized to access the shared memory regions. Even software threads that are not part of an authorized group for a particular shared memory region can access the GLA-to-GPA mapping for that shared memory region. The hardware thread-specific EPT paging structures ultimately prevents access to the shared memory region.

Hypervisor 2220 (e.g., virtual machine manager/monitor (VMM)) can be embodied as a software program that runs on hardware platform 2250 and enables the creation and management of virtual machines, such as virtual machine 2210. The hypervisor 2220 may run directly on the host's hardware (e.g., processor 2240), or may run as a software layer on a host operating system. It should be noted that virtual machine 2210 provides one possible implementation for the concepts provided herein, but such concepts may be applied in numerous types of virtualized systems (e.g., containers, FaaS, multi-tenants, etc.).

The hypervisor 2220 can create, populate, and maintain a set of extended page table (EPT) paging structures for each software thread of the guest user application process. EPT paging structures can be created to provide an identity mapping from GPA to HPA, except that a separate copy of the EPT paging structures is created for each key ID to be used for private data of a tenant. Each set of EPT paging structures would map the entire physical address range with a GPA key ID to a private HPA key ID for the corresponding tenant. No other tenant would be able to access memory with that same private HPA key ID. In addition, each set of EPT paging structures could map a set of shared GPA key IDs to the shared HPA key IDs for the shared regions that the associated tenant is authorized to access. Optionally, the leaf EPT PTEs for the shared ranges could be shared between all sets of EPT paging structures to promote efficiency. In this example, the hypervisor 2220 can allocate memory for EPT paging structures 2230A for software thread #1 on hardware thread #1 of first core 2242A. The hypervisor 2220 can also allocate memory for EPT paging structures 2230B for software thread #2 on hardware thread #2 of second core 2242B. Separate sets of EPT paging structures would also be created if software threads #1 and #2 run on the same hardware thread. The EPT paging structures 2230A and 2230B are populated by hypervisor 2220 with mappings (e.g., guest physical addresses (GPAs) to host physical addresses (HPAs)) from the process address space that are specific to their respective software threads.

In the example of FIG. 22, the first set of EPT paging structures 2230A can be populated with a GPA-to-HPA mapping 2232A for the private memory region allocated to software thread #1. The page table entry with the HPA for the private memory region of software thread #1 contains a private key ID (e.g., KID0) assigned to the private memory region of software thread #1. The EPT paging structures 2230A can also be populated with one or more GPA-to-HPA mappings 2234A for respective shared memory regions that software thread #1 is allowed to access. Each page table entry with an HPA for a shared memory region that the software thread #1 is allowed to access contains a respective shared key ID. Similarly, the second set of EPT paging structures 2230B can be populated with a GPA-to-HPA mapping 2232B for the private memory region allocated to software thread #2. The page table entry with the HPA for the private memory region of software thread #2 contains a private key ID (e.g., KID1) assigned to the private memory region of software thread #2. The EPT paging structures 2230B can also be populated with one or more GPA-to-HPA mappings 2234B for respective shared memory regions that software thread #2 is allowed to access. Each page table entry with an HPA for a shared memory region that the software thread #2 is allowed to access contains a respective shared key ID.

The hypervisor 2220 can also maintain virtual machine control structures (VMCS) for each hardware thread of the guest user application process. In the example of FIG. 22, a first VMCS 2222A is utilized for hardware thread #1 of the first core 2242A, and a second VMCS 2222B is utilized for hardware thread #2 of the second core 2242B. Each VMCS specifies an extended page table pointer (EPTP) for the EPT paging structures currently being used by the associated hardware thread. For example, VMCS 2222A includes an EPTP 2224A that points to the root of EPT paging structures 2230A for software thread #1 on hardware thread #1. VMCS 2222B includes an EPTP 2224B that points to the root of EPT paging structures 2230B for software thread #2 on hardware thread #2. Each VMCS may also specify an GLAT pointer (GLATP) 2228A and 2228B that points to the GLAT paging structures 2216. In this embodiment, GLATPs 2228A and 2228B point to the same set of GLAT paging structures 2216.

In at least one embodiment, an instruction that is accessible from a user space application, such as guest user application 2214, can be used to switch the set of EPT paging structures (e.g., 2230A or 2230B) that is currently being used in the system. The same guest page tables (e.g., GLAT paging structures 2216) stay in use for all software threads of the process. The EPT paging structures, however, are switched whenever a currently active software thread ends and another software thread of the process is entered. In one example, a VMFUNC instruction (or any other suitable switching instruction) can be used to achieve the switching. When the VMFUNC instruction is used to switch EPT paging structures, the instruction can be executed in user mode and can be used to activate the appropriate EPT paging structures for the software thread being entered. Specifically, the VMFUNC0 instruction allows software in a VMX non-root operation to load a new value for the EPTP to establish a different set of EPT paging structures to be used. The desired EPTP is selected from an entry in an EPTP list of valid EPTPs that can be used by the hardware thread on which the software thread is running.

The EPT paging structures 2230A or 2230B can be used in conjunction with GLAT paging structures 2216 when software thread #lor software thread #2, respectively, initiates a memory access request and a page walk is performed to translate a guest linear address in the memory access request to a host physical address in physical memory. The GLAT paging structures 2216 translate the GLA of the memory access request to a GPA. Depending on which hardware thread is has been entered, the EPT paging structures (e.g., 2230A or 2230B) translates the GPA to an HPA of a physical memory page where the data is stored.

EPT paging structures (e.g., 2230A and 2230B, 228) can have page entries that are larger than a default size (e.g., typically 4 KB). For example, “HugePages” is a feature integrated into the Linux kernel 2.6 that allows a system to support memory pages greater than the default size. System performance can be improved using large page sizes by reducing the amount of system resources needed to access the page table entries. With large page entries, each entire key ID space can be mapped using just a few large page entries in the EPT paging structures. For example, if all kernel pages are mapped in the same guest physical address range, a single large (or huge) EPT page may assign a kernel key ID to the lot. This can save a significant amount of memory as the EPT paging structures are much smaller and quicker to create.

While the above approach described with respect to FIG. 22 enables the efficient switching of key IDs (e.g., using VMFUNC instruction) when switching between software threads (e.g., tenants), another approach involves using an instruction to switch EPT paging structures (e.g., VMFUNC) while a single tenant is active. In this other approach, an instruction executed in user mode (e.g., VMFUNC) can be used to switch EPT paging structures within a single tenant running on a hardware thread. The EPT paging structures can be switched during the execution of the software thread (e.g., tenant). For a tenant's memory access that targets a different memory region than a memory region mapped by currently active EPT paging structures, a user mode instruction can be executed to switch the currently active EPT paging structures to different EPT paging structures. The different EPT paging structures map the targeted memory region (GPA-to-HPA) and the leaf EPT PTEs include the key ID used to encrypt/decrypt that targeted memory region. This approach involving switching EPT paging structures (e.g., using VMFUNC) within a single tenant include reduced guest page table sizes and changes due to avoiding the need for mapping different GPA “key ID regions” in a guest page table. Thus, linear address bits are not consumed for key IDs.

Additional details for this embodiment will now be described. As previously noted, a VMCS (e.g., 2222A and 2222B) can be configured per core per hardware thread. Because the VMCS specifies the extended page table pointer (EPTP), each hardware thread can have its own EPT paging structures with its own key ID mapping, even if each hardware thread is running in the same process using the same CR3-specified operating system page table (PTE) mapping.

The difference between the entries of each hardware thread's EPT paging structures is the key ID. Otherwise, the guest to physical memory mappings may be identical copies. Thus, every hardware thread in the same process has access to the same memory as every other thread. Because the key IDs are different, however, the memory is encrypted using different cryptographic keys, depending on which hardware thread is accessing the memory. Thus, key ID aliasing can be done by the per hardware thread EPT paging structures, which can be significantly smaller tables given the large page mappings.

Since the VMCS is controlled by the hypervisor (or virtual machine manager (VMM)), a hardware thread cannot change the EPT key ID mappings received from the hypervisor. This prevents one hardware thread from accessing another hardware thread's private key IDs.

Multiple guest physical address ranges can be mapped into each EPT space. For example, one mapping of a first guest physical address range to a first hardware thread's private key ID range, and another mapping of a second guest physical address range to a shared key ID range, can be mapped into each EPT space. Thus, a hardware thread can use a guest linear address to guest physical address mapping to select between the hardware thread's private and shared key ID. For the hardware thread software, this results in using one linear address range for the physical shared key ID mapping and a different linear address range for the physical private key ID mapping.

Since all the memory is shared between threads, individual cache lines within a page can be encrypted using different key IDs, as specified by each hardware thread's unique EPT paging structures. Thus, embodiments disclosed herein also provide cache line granular access to memory.

When freeing an allocation for a hardware thread, the allocation should be flushed to memory (e.g., CLFLUSH/CLFLUSHOPT instructions) before reassigning the heap allocation to a different hardware thread or shared key ID, as illustrated and described herein with respect to FIG. 4.

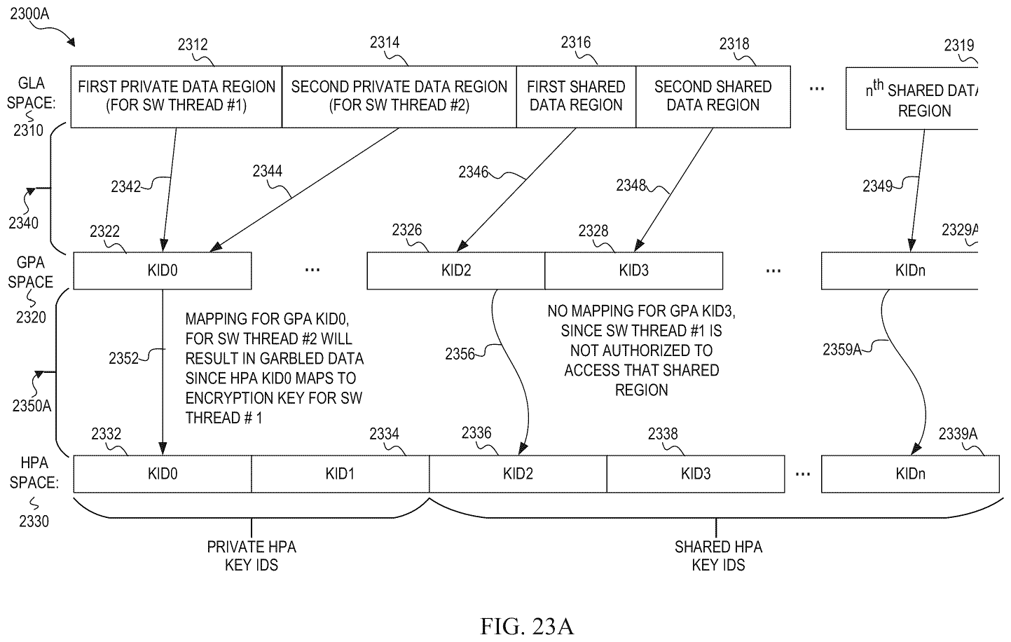

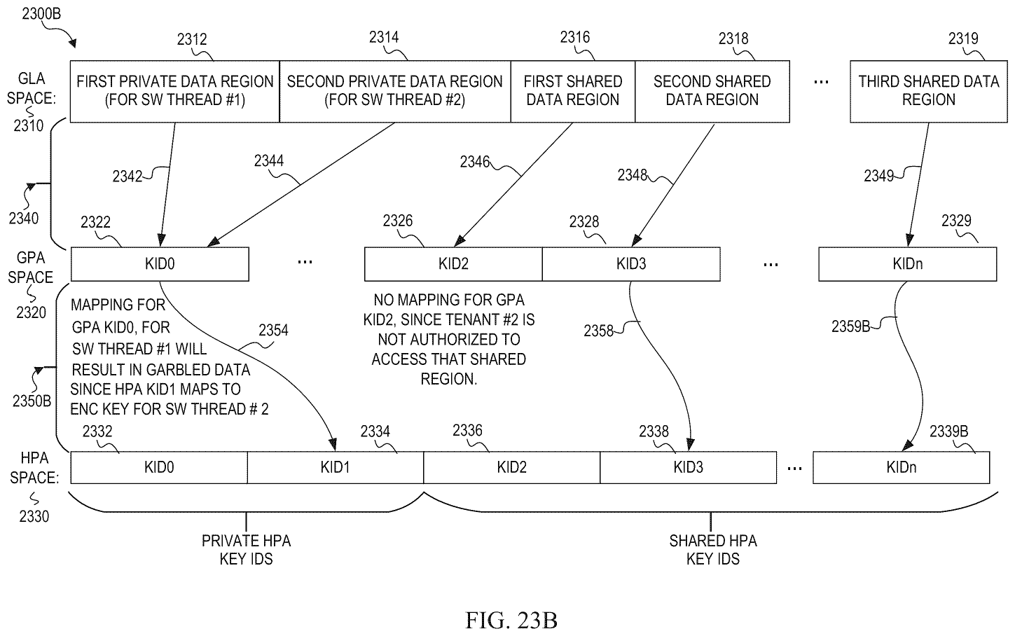

FIGS. 23A and 23B are block diagrams illustrating an example scenario of page table mappings in computing system 2200 of FIG. 22. Page table mappings 2300A are generated to provide one set of GLAT paging structures and respective EPT paging structures to be switched from user mode when switching between tenants (or potentially other software components such as compartments or functions) in a process. FIG. 23A illustrates page table mappings 2300A for a software thread #1 running in a hardware thread #1. FIG. 23B illustrates page table mappings 2300B after switching from software thread #1 to a software thread #2 running in hardware thread #1 or a hardware thread #2. Software threads #1 and #2 run in the same guest linear address (GLA) space 2310 of the same process. The GLA space 2310 maps to a guest physical address (GPA) space 2320, and the GPA space 2320 maps to a host physical address (HPA) space 2330. The same GLAT paging structures (e.g., 2216) map GLAs to GPAs. For mapping GPAs to HPAs, however, the software threads #1 and #2 use different EPT paging structures (e.g., 2230A and 2230B). EPT paging structures that provide an identity mapping from GPAs to HPAs can be created. A separate copy of the EPT paging structures for each private key ID (KID #) to be used for private data in a software thread can be available for use. A user mode instruction (e.g., VMFUNC 0) can be used to activate the appropriate EPT paging structures of the software thread that is being entered.

The GLA space 2310 of the process includes a first private data region 2312 for software thread #1 of the process, a second private data region 2314 for software thread #2 of the process, and one or more shared data regions. As shown in FIG. 23A, any number of shared data regions (e.g., 0, 1, 2, 3, or more) may be allocated in GLA space 2310. For case of description, however, in the following description it is assumed that only a first shared data region 2316, a second shared data region 2318, and an nt shared data region 2319 are allocated in the GLA space 2310.

A set of GLAT paging structures (e.g., 2216) is generated for the process and used in memory access operations of both software thread #1 and software thread #2. The set of GLAT paging structures includes a set of page table entry (PTE) mappings 2340 from GLAs in the GLA space 2310 to PTEs containing GPAs in the GPA space 2320. The PTE mappings 2340 in the GLAT paging structures (e.g., 2216) include a first PTE mapping 2342, a second PTE mapping 2346, and a third PTE mapping 2349. The PTE mappings 2342, 2346, and 2349 each map GLAs that software thread #1 is allowed to access. The GLAT paging structures also include a fourth PTE mapping 2344 and a fifth PTE mapping 2348. Software thread #1 is not allowed to access memory pointed to by the GLAs mapped in the PTE mappings 2344 and 2348. As will be illustrated in FIG. 23B, the PTE mappings 2344, 2348, and 2349 each map GLAs that software thread #2 is allowed to access.

It should be noted that each PTE mapping shown in FIG. 23A may represent one or more GLA-to-GPA mappings depending on the size of the particular allocation. For example, if the first private data region 2312 spans two linear pages, then the first PTE mapping 2342 may represent two PTE mappings from two guest linear pages in GLA space 2310 to two GPAs stored in two PTEs, respectively. The two GPAs can be mapped in the EPT translation layer to two different HPAs that reference two different physical pages in physical memory.

The GPAs in GPA space 2320 can be encoded with software-specified key IDs. For example, the first private data region is using software-specified KID0 2322 in the GPA space 2320. That is, KID0 may be carried in the one or more page table entries (PTEs) of the page table in the GLAT paging structures containing the GPAs. Accordingly, in the first PTE mapping 2342, the GLAs in the first private data region 2312 are mapped to one or more PTEs containing one or more GPAs, respectively, encoded with KID0 2322. In the fourth PTE mapping 2344, the GLAs in the second private data region 2314 are mapped to the one or more PTEs containing one or more GPAs, respectively, which are also encoded with KID0 2322. In some scenarios, at least some of the GLAs of the first private data region 2312 and at least some GLAs of the second private data region 2314 may be mapped to a single GPA (e.g., when private data of software thread #1 and private data of software thread #2 are stored in the same physical page).

For shared data regions in the GLA space 2310, each region can use a respective software-specified key ID in the GPA space 2320. For example, in the second PTE mapping 2346, the GLAs in the first shared data region 2316 are mapped to one or more PTEs containing one or more GPAs, respectively, encoded with KID2 2326. In the third PTE mapping 2349, the GLAs in the n^{th} shared data region 2319 are mapped to one or more PTEs containing one or more GPAs, respectively, encoded with KIDn 2329. In the fifth PTE mapping 2348, the GLAs in the second shared data region 2318 are mapped to one or more PTEs containing one or more GPAs, respectively, encoded with KID3 2328.

The EPT translation layer from GPA space 2320 to HPA space 2330, shown in FIG. 23A, represents the first set of EPT PTE mappings 2350A in a first set of EPT paging structures (e.g., 2230A) that is used by software thread #1 for memory accesses. Similarly, the EPT translation layer from GPA space 2320 to HPA space 2330, shown in FIG. 23B, represents the second set of EPT PTE mappings 2350B in a second set of EPT paging structures (e.g., 2230B) that is used by software thread #2 for memory accesses. Each set of EPT paging structures created for the process could map the entire physical address range with GPA KID0 to the private HPA key ID for the corresponding software thread. No other software thread would be able to access memory with that same private HPA key ID.

The EPT translation layer can provide translations from GPAs in the GPA space 2320 to HPAs in the HPA space 2330, and can change the software-specified key ID to any hardware-visible key ID in the HPA space 2330. In the example shown in FIG. 23A, the first private data region 2312 of software thread #1 and the second private data region 2314 of software thread #2 each map into the same KID0 2322 in GPA space 2320. However, in the first set of EPT paging structures (e.g., 2230A) that is activated for software thread #1, a first EPT PTE mapping 2354 maps the GPA(s) encoded with KID0 2322 to HPA(s) encoded with KID0 2332. That is, the page table entries in the first set of EPT paging structures for software thread #1 carry KID0, for both the first private data region 2312 and the second private data region 2314. The KID0 2332 (encoded in one or more HPAs stored in one or more EPT PTEs) is hardware-visible and maps to a cryptographic key (e.g., in key mapping table 2262) for software thread #1's private data region 2312. In the first set of EPT paging structures, the mapping for the GPA(s) encoded with KID0 for software thread #2's private data region 2314 maps to the same cryptographic key that is used for encryption/decryption of data accessed by software thread #1. Thus, if software thread #1 accesses the second private data region 2314 (e.g., stored in the same physical page as the first private data region or in other physical pages), then the cryptographic key mapped to KID0 2332 would be used to decrypt the data in the second private data region 2314 and would render invalid results (e.g., garbled data).

Additionally, a set of shared HPA key IDs could be defined, and each set of EPT paging structures could map the set of shared GPA key IDs to shared HPA key IDs for the shared memory regions that the associated software thread is authorized to access. The leaf EPTs (e.g., EPT page table entries) for the shared regions could be shared among all of the EPT paging structures used in the process. More specifically, the top-level EPT paging structures would be distinct for each software thread, but the lower-level EPT paging structures, especially the leaf EPTs, could be shared between the software threads. The separate upper EPT paging structures for the separate software threads could all reference the same lower EPT paging structures for the shared data regions. That reduces the memory needed for storing the total EPT paging structures. This would increase ordinary data cache hit rates and specialized EPXE cache hit rates during page walks. Furthermore, EPT paging structures could use 1G huge page mappings to minimize overheads from the second level of address translation.

In this example, in the HPA space 2330, the shared HPA key IDs include KID2 2336, KID3 2338, and KIDn 2339A. Software thread #1 is allowed to access the first shared data region 2316 and the third shared data region 2318, but is not allowed to access the second shared data region 2318. Accordingly, the first set of EPT paging structures includes a second EPT PTE mapping 2356 from the GPA(s) encoded with KID2 2326 to HPA(s) encoded with KID2 2336 and stored in EPT PTE(s) of the EPT page table of the first set of EPT paging structures. The first set of EPT paging structures also includes a third EPT PTE mapping 2359A from the GPA(s) encoded with KIDn 2329 to HPA(s) encoded with KIDn 2339A and stored in EPT PTE(s) of the EPT page table of the first set of EPT paging structures.

If a software thread is not authorized to access a particular shared data region, then the EPT paging structures for that unauthorized software thread omits a mapping for the GPA key ID to the HPA key ID. For example, because software thread #1 is not allowed to access the second shared data region 2318, an EPT PTE mapping for the second shared data region 2318 is omitted from the EPT PTE mappings 2350A of the first set of EPT paging structures. Thus, there is no mapping for page table entries carrying GPA KID3 2328 to page table entries carrying HPA KID3 2338. Consequently, if software thread #1 tries to access the second shared data region 2318, the page walk can end with a page fault or other another suitable error can occur. Additionally, the page table entries with the HPA shared key IDs (e.g., KID2, KID3, through KIDn) of the EPT paging structures could be shared between all sets of EPT paging structures.

FIG. 23B illustrates page table mappings 2300B after switching from software thread #1 and entering software thread #2. The same guest paging structures (e.g. GLAT paging structures 2216) with the same PTE mappings 2340 can be used during page walks to translate a guest linear address. However, the first set of EPT paging structures (e.g., 730A) that includes EPT PTE mappings 2340 used for software thread #1 is switched to the second set of EPT paging structures (e.g., 730B) that includes a different set of EPT PTE mappings 2350B for software thread #2. The second set of EPT paging structures for software thread #2 can be activated by a VMFUNC instruction and the appropriate EPTP is selected from the EPTP list for software thread #2.

As shown in FIG. 23B, the second private data region 2314 of software thread #2 is in the same GLA space 2310 as the first private data region 2312 of software thread #1, and maps into the same KID0 2322 in the GPA space 2320. However, the second set of EPT paging structures (e.g., 2230B) that is activated for software thread #2, includes an EPT PTE mapping 2354 that maps the GPA(s) encoded with KID0 2322 to HPA(s) encoded with KID1 2334. That is, the page table entries in the second set of EPT paging structures for software thread #2 carry KID1, for both the second private data region 2314 and the first private data region 2312. The KID1 2334 (encoded in one or more HPAs stored in one or more EPT PTEs) is hardware-visible and maps to a cryptographic kcy (e.g., in key mapping table 2262) for software thread #2's private data region 2314. Thus, in the second set of EPT paging structures, the GPA(s) encoded with KID0 for software thread #1's private data region 2312 map to the same cryptographic key that is used for encryption/decryption of data accessed by software thread #2. Thus, if software thread #2 accesses the first private data region 2312 (e.g., stored in the same physical page as the second private data region or in other physical pages), the cryptographic key mapped to KID1 2334 would be used to decrypt the data and would render invalid results (e.g., garbled data).

In this example, software thread #2 is authorized to access the second shared data region 2318 and the n′ shared data region 2319, but not the first shared data region 2316. Thus, as shown in FIG. 23B, the second set of EPT paging structures includes a second EPT PTE mapping 2358 from the GPA(s) encoded with KID3 2328 to HPA(s) encoded with KID3 2338. The second set of EPT paging structures also includes a third EPT PTE mapping 2359B from GPA(s) encoded with KIDn 2329 to HPA(s) encoded with KIDn 2339B and stored in EPT PTE(s) of the EPT page table of the second set of EPT paging structures. Because software thread #2 is not allowed to access the first shared data region 2316, an EPT PTE mapping for the first shared data region 2316 is omitted from the EPT PTE mappings 2350B of the second set of EPT paging structures. Thus, there is no mapping for page table entries carrying GPA KID2 2326 to page table entries carrying HPA KID2 2336. Consequently, if software thread #2 tries to access the first shared data region 2316, the page walk can end with a page fault or other another suitable error can occur.

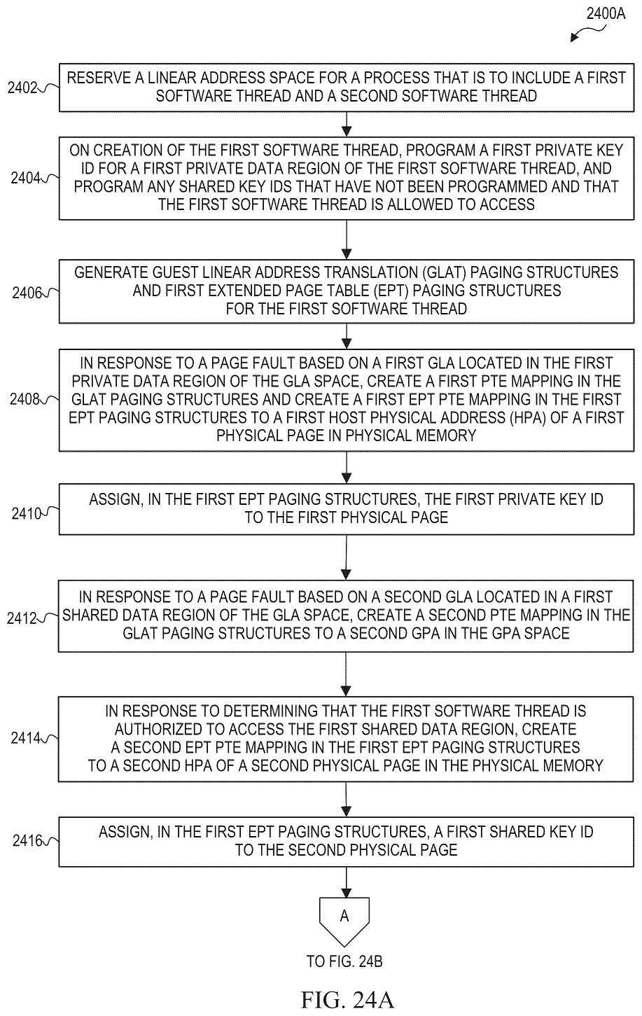

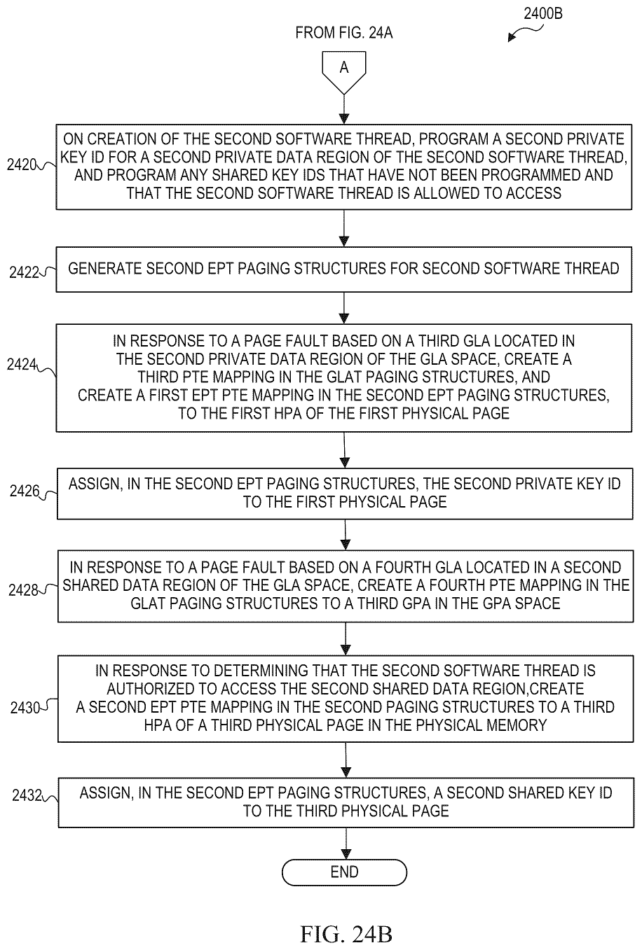

FIGS. 24A and 24B are a simplified flow diagrams 2400A and 2400B illustrating example operations associated with using privileged software to control software thread isolation when using a multi-key memory encryption scheme according to at least one embodiment. A computing system (e.g., computing system 100, 200, 2200) may comprise means such as one or more processors (e.g., 2240, 140) and memory (e.g., 170, 2270) for performing the operations. In one example, at least some operations shown in flow diagrams 2400A and 2400B may be performed by a hypervisor (e.g., 2220) running on a core of the processor of the computing system to set up page tables (e.g., 2230A, 2230B) for first and second software threads of a guest user application (e.g., 2214) in a virtual machine (e.g., 2210). Although flow diagrams 2400A and 2400B reference only two software threads of the guest user application, it should be appreciated that more than two software threads may be used. Furthermore, it should be noted that a virtual machine provides one possible implementation for the concepts provided herein, but such concepts, including flow diagrams 2400A and 2400B, are also applicable to other suitable implementations (e.g., containers, FaaS, multi-tenants, etc.). Generally, the two software threads may be embodied as separate functions (e.g., functions as a service (FaaS), tenants, containers, etc.) that share a single process address space.

At 2402, a hypervisor running on a processor, or a guest operating system (e.g., 2212), reserves a linear address space for a process that is to include multiple software threads. The reserved linear address space is a guest linear address (GLA) space (or range of GLA addresses) of memory that is to be mapped to a guest physical address (GPA) space (or range of GPA addresses).

At 2404, on creation of a first software thread, a first private key ID (e.g., KID0) is programmed for a first private data region (e.g., 2312) of the first software thread. The first private key ID may be programmed by being provided to memory protection circuitry via a privileged instruction (e.g., PCONFIG) executed by privileged software. Programming the first private key ID can include generating or otherwise obtaining a first cryptographic key and associating the first cryptographic key to the first private key ID in any suitable manner (e.g., mapping in a key mapping table).

Also at 2404, any shared key IDs for shared data regions that the first software thread is allowed to access may be programmed. In this example, a first shared key ID (e.g., KID2) may be programmed via a privileged instruction (e.g., PCONFIG) executed by privileged software. Each shared key ID may be associated with a respective cryptographic key (e.g., mapping in a key mapping table).

At 2406, the privileged software generates address translation paging structures for the process address space of the process. The address translation paging structures may be any suitable form of mappings from guest linear addresses of the process address space to host physical addresses (also referred to herein as ‘physical address’). For example, guest linear address translation (GLAT) paging structures (e.g., 216, 1020, 2216) and extended page table (EPT) paging structures (e.g., 228, 1030, 2230A) may be generated. In some, but not necessarily all, examples, the other EPT paging structures for other hardware threads (e.g., 2230B) may also be generated.

Once a software thread running in a process address space begins executing, a page fault occurs when a memory access is attempted to a guest linear address corresponding to a host physical address that has not yet been loaded to the process address space. In response to a page fault based on a memory access by the first software thread using a first GLA located in the first private data region (e.g., 2312) of the GLA space (e.g., 2310), at 2408, a first page table entry (PTE) mapping (e.g., 2342) is created in the GLAT paging structures. In the first PTE mapping, the first GLA can be mapped to a first GPA in the GPA space (e.g., 2320). The first PTE mapping enables the translation of the first GLA to the first GPA, which is stored in a first PTE of a PTE page table of the GLAT paging structures. In at least some scenarios, the first private key ID (e.g., KID0 2322) may be stored in bits (e.g., upper bits) of the first GPA. However, a different key ID or no key ID may be stored in the bits of the first GPA in other scenarios.

In addition, a first EPT PTE mapping (e.g., 2352) is created in the first EPT paging structures of the first software thread. In the first EPT PTE mapping of the first EPT paging structures, the first GPA is mapped to a first host physical address (HPA) in the HPA space (e.g., 2330). The first EPT PTE mapping of the first EPT paging structures enables the translation of the first GPA to the first HPA, which is stored in a first EPT PTE in an EPT page table (EPTPT) of the first EPT paging structures. The first HPA stored in the first EPT PTE in the EPT page table of the first EPT paging structures is a reference to a first physical page of the physical memory.

At 2410, in the first EPT paging structures, the first private key ID (e.g., KID0 2332) is assigned to the first physical page. To assign the first private key ID to the first physical page, the first private key ID can be stored in bits (e.g., upper bits) of the first HPA stored in the first EPT PTE in the EPT page table of the first EPT paging structures.

At 2412, in response to a page fault based on a memory access by the first software thread using a second GLA located in a first shared data region (e.g., 2316) of the GLA space, a second PTE mapping (e.g., 2346) is created in the GLAT paging structures. In the second PTE mapping, the second GLA is mapped to a second GPA in the GPA space. The second PTE mapping enables the translation of the second GLA to the second GPA, which is stored in a second PTE in the PTE page table of the GLAT paging structures. In at least some scenarios, a first shared key ID (e.g., KID2 2326) may be stored in bits (e.g., upper bits) of the second GPA. In different scenarios, however, a different key ID or no key ID may be stored in the bits of the second GPA.

At 2414, a determination may be made as to whether the first software thread is authorized to access the first shared data region. In response to determining that the first software thread is authorized to access the first shared data region, a second EPT PTE mapping (e.g., 2356) is created in the first EPT paging structures. In the second EPT PTE mapping of the first EPT paging structures, the second GPA is mapped to a second HPA in the HPA space. The second EPT PTE mapping enables the translation of the second GPA to the second HPA, which is stored in a second EPT PTE in the EPT page table of the first EPT paging structures. The second HPA stored in the second EPT PTE in the EPT page table of the first EPT paging structures is a reference to a second (shared) physical page in the physical memory. In this example (and as illustrated in FIGS. 23A-23B), a different physical page is used for each shared key ID. In other examples, however, the same underlying shared physical memory may be mapped using multiple shared key IDs.

Alternatively, if a determination is made that the first software thread is not allowed to access the first shared data region, then the second EPT PTE mapping in the first EPT paging structures is not created. Without the second EPT PTE mapping in the first EPT paging structures of the first software thread, the first software thread would be unable to access the first shared data region.

At 2416, in the first EPT paging structures, the first shared key ID (e.g., KID2 2336) is assigned to the second physical page. To assign the first shared key ID to the second physical page, the first shared key ID can be stored in bits (e.g., upper bits) of the second HPA stored in the second EPT PTE in the EPT page table in the first EPT paging structures.

It should be noted that the first EPT page table may not be exclusive to the first EPT paging structures. Each set of EPT paging structures is configured to map the set of shared GPA key IDs to the shared HPA key IDs for the shared data regions that the associated software thread is authorized to access. However, the leaf EPTs (e.g., the EPT page tables) could be shared between all of the EPT paging structures, which could increase data cache hit rates and EPXE cache hit rates during page walks.

At 2420 in FIG. 24B, on creation of a second software thread, a second private key ID (e.g., KID1) is programmed for a second private data region (e.g., 2314) of the second software thread. The second private key ID may be programmed by being provided to memory protection circuitry via a privileged instruction (e.g., PCONFIG) executed by privileged software. Programming the second private key ID can include generating or otherwise obtaining a second cryptographic key and associating the second cryptographic key to the second private key ID in any suitable manner (e.g., mapping in a key mapping table).

Also at 2420, any shared key IDs for shared data regions that the second software thread is allowed to access may be programmed. In this example, a second shared key ID (e.g., KID3) may be programmed via a privileged instruction (e.g., PCONFIG) executed by privileged software. Each shared key ID may be associated with a respective cryptographic key (e.g., mapping in a key mapping table).

At 2422, the privileged software generates second EPT paging structures (e.g., 2230B) for the second software thread.

At 2424, in response to a page fault based on a memory access by the second software thread using a third GLA located in the second private data region (e.g., 2314) of the GLA space (e.g., 2310), a third PTE mapping (e.g., 2344) is created in the GLAT paging structures. In the third PTE mapping, the third GLA can be mapped to the first GPA in the GPA space (e.g., 2320). The third PTE mapping enables the translation of the third GLA to the first GPA, which is stored in the first PTE of the PTE page table of the GLAT paging structures. As previously described, the first private key ID (e.g., KID0 2322) may be stored in bits (e.g., upper bits) of the first GPA. However, a different key ID or no key ID may be stored in the bits of the first GPA in other scenarios.

In addition, a first EPT PTE mapping (e.g., 2354) is created in the second EPT paging structures of the second software thread. In the first EPT PTE mapping of the second EPT paging structures, the first GPA is mapped to the first HPA in the HPA space (e.g., 2330). The first EPT PTE mapping of the second EPT paging structures enables the translation of the first GPA to the first HPA, which is stored in a first EPT PTE in the EPT page table of the second EPT paging structures. The first HPA stored in the first EPT PTE in the EPT page table of the second EPT paging structures is a reference to the first physical page of the physical memory.

At 2426, in the second EPT paging structures, the second private key ID (e.g., KID1 2334) is assigned to the first physical page. To assign the second private key ID to the first physical page, the second private key ID can be stored in bits (e.g., upper bits) of the first HPA stored in the first EPT PTE in the EPT page table of the second EPT paging structures.

At 2428, in response to a page fault based on a memory access by the second software thread using a fourth GLA located in a second shared data region (e.g., 2318) of the GLA space, a fourth PTE mapping (e.g., 2348) is created in the GLAT paging structures. In the fourth PTE mapping, the fourth GLA is mapped to a third GPA in the GPA space. The fourth PTE mapping enables the translation of the fourth GLA to the third GPA, which is stored in a third PTE in the PTE page table in the GLAT paging structures. In at least some scenarios, a second shared key ID (e.g., KID3 2328) may be stored in bits (e.g., upper bits) of the third GPA. In different scenarios, however, a different key ID or no key ID may be stored in the bits of the third GPA.

At 2430, a determination may be made as to whether the second software thread is authorized to access the second shared data region. In response to determining that the second software thread is authorized to access the second shared data region, a second EPT PTE mapping (e.g., 2358) is created in the second EPT paging structures. In the second EPT PTE mapping in the second EPT paging structures, the third GPA is mapped to a third HPA in the HPA space. The second EPT PTE mapping enables translation of the third GPA to the third HPA, which is stored in the second EPT PTE of the EPT page table in the second EPT paging structures. The third HPA stored in the second EPT PTE in the EPT page table of the second EPT paging structures is a reference to a third physical page in the physical memory.

Alternatively, if a determination is made that the second software thread is not allowed to access the second shared data region, then the second EPT PTE mapping in the second EPT paging structures is not created. Without the second EPT PTE mapping in the second EPT paging structures of the second software thread, the second software thread would be unable to access the second shared data region.

At 2432, in the second EPT paging structures, a second shared key ID (e.g., KID3 2338) is assigned to the third physical page. To assign the second shared key ID to the third physical page, the second shared key ID can be stored in bits (e.g., upper bits) of the third HPA stored in the second EPT PTE in the EPT page table of the second EPT paging structures.

Several advantages are realized in the various embodiments described herein using privileged software and a multi-key memory encryption scheme, without significant hardware changes, to provide fine-grained cryptographic isolation of software threads in a multithreaded process preserves performance and latency. The privileged software can repurpose an existing multi-key memory encryption scheme, such as Intel® MKTME for example, to provide sub-page isolation. Thus, fine-grained cryptographic isolation may be achieved without significant hardware changes. Sub-page isolation can be used to provide low-overhead domain isolation for multi-tenancy use cases including, but not limited to, FaaS, microservices, web servers, browsers, etc. Using shared memory and a shared cryptographic key, embodiments also enable zero-copy memory sharing between software threads. For example, communication between software threads can be effected by using shared memory and a shared key ID. Thus, a first software thread does not have perform a memory copy to communicate data to a second software thread, as would be needed if the software threads were running in separate processes. Instead, embodiments described herein enable the software threads to communicate data by accessing the same shared memory. Additionally, one or more embodiments can achieve a legacy compatible solution with existing hardware that inherently provides code and data separation among mutually untrusted domains while offering performance and latency benefits.

### Extending Multi-Key Memory Encryption for Fine-Grained Function Isolation

Several extensions involving multi-key memory encryption, such as Intel® MKTME, are disclosed. Several examples provided herein of multi-key memory encryption enable selection of a different key for each cache line. Thread workloads ca cryptographically separate objects, even if sub-page, allowing multiple threads with different key IDs to share the same heap memory from the same pages while maintaining isolation. Accordingly, one hardware thread cannot access another hardware thread's data/objects even if the hardware threads are sharing the same memory page. Additional features described herein help improve the performance and security of hardware thread isolation.

Several embodiments for achieving function isolation with multi-key memory encryption may use additional features and/or existing features to achieve low-latency, which improves performance, and fine-grained isolation of functions, which improves security. The examples described herein to further enhance performance and security include defining hardware thread-local key ID namespaces, restricting key ID accessibility within cores without needing to update uncore state, mapping from page table entry (PTE) protection key (PKEY) to keys, and incorporating capability-based compartment state to improve memory isolation.

### Using Combination Identifiers for Cryptographic Isolation.

A first embodiment to enhance performance and security of multi-key memory encryption, such as MKTME, involves the creation and use of a combination identifier (ID) mapped to cryptographic keys. This approach addresses the challenge of differentiating memory accesses of software threads from the same address space that may be running concurrently on different hardware threads. To achieve isolation, each software thread should be granted access to only a respective authorized cryptographic key. In some multi-key encryption schemes (e.g., Intel MKTME), however, cryptographic keys are managed at the memory controller, and translation page tables are relied upon to control access to particular key IDs that are mapped to the cryptographic keys in the memory controller. Thus, all of the cryptographic keys for the concurrently running software threads may be installed in the memory controller for the entire time that those software threads are running. Since those software threads run in the same address space, i.e., with the same page tables, the concurrently running software threads in a process can potentially access the cryptographic keys belonging to each other.

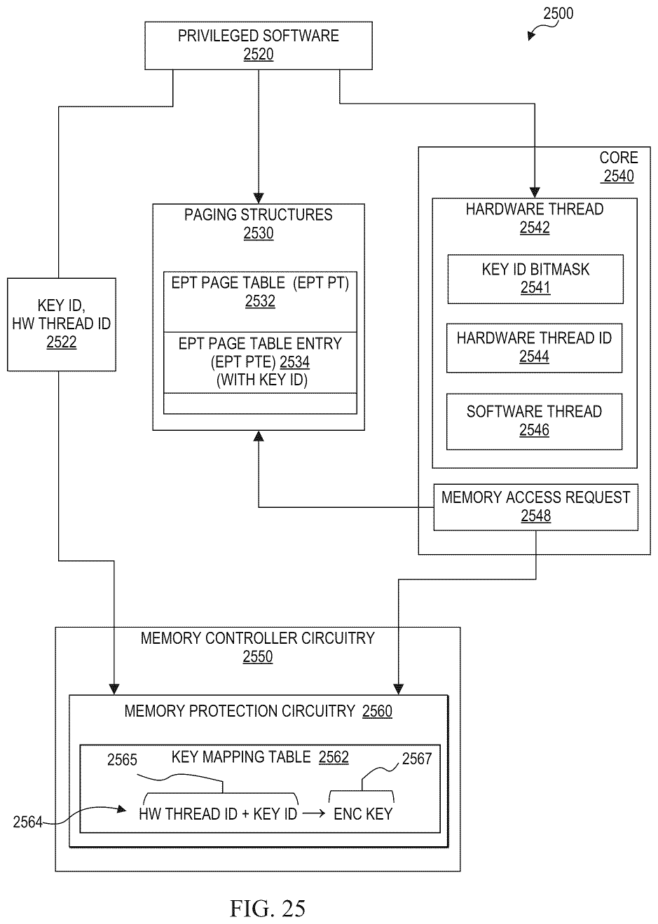

In FIG. 25, a computing system 2500 is illustrated with selected possible components to enable a first approach using multi-key memory encryption, such as MKTME, with a combination key identifier, including a hardware thread ID and a key ID, to provide isolation for software threads in a process according to at least one embodiment. In this embodiment, a hardware thread identifier (ID) on which a software thread is scheduled, is combined (e.g., concatenated) with a key ID obtained from page table paging structures to generate a combination ID and to avoid needing to update uncore state whenever switching hardware threads. The memory controller can maintain a mapping from this combination ID to underlying cryptographic key values. The mapping can be updated when scheduling software threads on hardware threads. For each hardware thread, only keys that should currently be accessible from that hardware thread are covered by a combination ID mapping for that hardware thread to the underlying key.

This embodiment may be configured in computing system 2500, which includes a core 2540, privileged software 2520, paging structures 2530, and memory controller circuitry 2550 that includes memory protection circuitry 160. Computing system 2500 may be similar to computing systems 100 or 200, but may not include specialized hardware registers such as HTKR 156 and HTGRs 158. For example, core 2540 may be similar to core 142A or 142B and may be provisioned in a processor with one or more other cores. Privileged software 2520 may be similar to operating system 120 or hypervisor 220. Paging structures 2530 may be similar to LAT paging structures 172 or to GLAT paging structures 216 and EPT paging structures 228.

Memory controller circuitry 2550 may be similar to memory controller circuitry 148. By way of example, memory controller circuitry 2550 may be part of additional circuitry and logic of a processor in which core 2540 is provisioned. Memory controller circuitry 2550 may include one or more of an integrated memory controller (IMC), a memory management unit (MMU), an address generation unit (AGU), address decoding circuitry, cache(s), load buffer(s), store buffer(s), etc. In some hardware configurations, one or more components of memory controller circuitry 2550 may be provided in core 2540 (and/or other cores in the processor). In some hardware configurations, one or more components of memory controller circuitry 2550 could be communicatively coupled with, but separate from, core 2540 (and/or other cores in the processor). For example, all or part of the memory controller circuitry may be provisioned in an uncore of the processor and closely connected to core 2540 (and other cores in the processor). In some hardware configurations, one or more components of memory controller circuitry 2550 could be communicatively coupled with, but separate from, the processor in which the core 2540 is provisioned. In addition, memory controller circuitry 2550 may also include memory protection circuitry 2560, which may be similar to memory protection circuitry 160, but modified to implement combination IDs and appropriate mappings of combination IDs to cryptographic keys in a key mapping table 2562.

Core 2540 includes a hardware thread 2542 with a unique hardware thread ID 2544. A software thread 2546 is scheduled to run on hardware thread 2542. In some embodiments, hardware thread 2542 also includes a key ID bitmask 2541. The key ID bitmask can be used to keep track of which key IDs are active for the hardware thread at a given time.

Paging structures 2530 include an EPT page table 2532 (for implementations with extended page tables) with multiple page table entries. The paging structures 2530 are used to map linear addresses (or guest linear addresses) of memory access requests associated with the software thread 2546, or associated with other software threads in the same process, to host physical addresses. In FIG. 25, an example EPT PTE 2534 is illustrated, which is the result of a page walk for memory access request 2548. One of the key IDs is stored in available bits of the EPT page table entry 2534. The key ID stored in EPT PTE 2534 is assigned to a particular memory region targeted by memory access request 2548 of the software thread 2546. Memory protection circuitry 2560 includes a key mapping table 2562, which includes a mapping 2564 of a combination ID 2565 to a cryptographic key 2567. It should be understood that some systems may not use extended page tables and that the paging structures 2530 in those scenarios may be similar to LAT paging structures 920 of FIG. 9. In such an implementation, the page table entries can contain host physical addresses rather than guest physical addresses.

In computing system 2500, a combination identifier (ID) may be configured to differentiate memory accesses by software threads that are using the same address space but are running on different hardware threads. Because each hardware thread can only run one software thread at a time, a respective hardware thread identifier (ID) can be generated or determined for each hardware thread on which a software thread is running. In one possible implementation, the hardware thread IDs for the hardware threads of a process can compose a static set of unique identifiers. On a quad core system with each core having two hyperthreads, for example, the set of unique identifiers can include eight hardware IDs. The hardware IDs may remain the same at least for the entire process, regardless of how many different software threads are scheduled to run on each hardware thread during the process.

The hardware IDs may be statically assigned to each hardware thread in the system using any suitable random or deterministic scheme in which each hardware thread on the system has a unique identifier relative to the other hardware thread identifiers of the other hardware threads on the computing system or processor. In other scenarios, the hardware thread IDs may be dynamically assigned in any suitable manner that ensures that at least the hardware threads used in the same process are unique relative to each other. One or more implementations may also require the hardware thread IDs to be unique relative to all other hardware threads on the processor or on the computing system (for multi-processor computing systems). In the scenario illustrated in FIG. 25, hardware thread ID 2544 is assigned to hardware thread 2542.

Privileged software 2520 (e.g., an operating system, a hypervisor) generates or otherwise determine the hardware thread IDs and assign the hardware thread IDs to each hardware thread in a process. For example, the privileged software 2520 generates software thread identifiers for software threads to run on hardware threads. The privileged software 2520 then schedules the software threads on the hardware threads, which can include creating the necessary hardware thread IDs. The privileged software can send a request to configure the key mapping table 2562 with one or more combination IDs that are each generated based on a combination of a key ID and associated hardware thread ID 2544 for a memory region to be accessed by software thread 2546. In one example, the privileged software 2520 can invoke a platform configuration instruction (e.g., PCONFIG) to program a combination ID mapping 2564 for software thread 2546, which is scheduled to run on hardware thread 2542. The privileged software 2520 can assign a key ID to any memory region (e.g., private memory, shared memory, etc. in any type of memory such as heap, stack, global, data segment, code segment, etc.) that is allocated to the software thread 2546. The key ID can be assigned to the memory via paging structures 2530 and storing the key ID in some bits of host physical addresses stored in one or more EPT PTE leaves such as EPT PTE 2534, or in PTE leaves of paging structures without an EPT level. The privileged software 2520 can pass parameters 2522 to the memory protection circuitry 2560 to generate the mapping 2564. The parameters may include a key ID and the hardware thread ID 2544 to be used by the memory protection circuitry to generate the combination ID. Alternatively, the privileged software can generate the combination ID, which can be passed as parameter 2522 to the memory protection circuitry. If the memory region needs to be encrypted, then the privileged software can request the memory circuitry to generate or determine a cryptographic key 2567 to be associated with the combination ID in a mapping in the key mapping table 2562.

Memory protection circuitry 2560 receives the instruction with parameters 2522 and generates combination ID 2565, if needed. Combination ID 2565 includes the hardware thread ID 2544 and the key ID provided by the privileged software 2520. The hardware thread ID 2544 and the key ID can be combined in any suitable manner (e.g., concatenation, logical operation, etc.). If encryption is requested, the memory protection circuitry 2560 can generate or otherwise determine cryptographic key 2567. The key mapping table 2562 can be updated with mapping 2564 of combination identifier (ID) 2565, which includes hardware thread ID 2544 and the key ID, being mapped to (or otherwise associated with) cryptographic key 2567. Additional mappings for software thread 2546 may be requested.

Once the key mapping table 2562 is configured with requested mappings, execution of a software thread 2546 may be initiated. Memory access request 2548 can be associated with software thread 2546 running on the hardware thread 2542 of a process that includes multiple software threads running on different hardware threads of one or more cores of a processor. In some examples, two or more software threads may be multiplexed to run on the same hardware thread. Memory access request 2548 can be associated with accessing code or data. In one scenario, a memory access request corresponds to initiating a fetch stage to retrieve the next instruction in code to be executed from memory, based on an instruction pointer in an instruction pointer register (RIP). The instruction pointer can include a linear address indicating a targeted memory location in an address space of the process from which the code is to be fetched. In another scenario, a memory access request corresponds to invoking a memory access instruction to load (e.g., read, fetch, move, copy, etc.) or store (e.g., write, move, copy) data. The memory access instruction can include a data pointer (e.g., including a linear address) indicating a targeted memory location in the address space of the process for the load or store operation.

The memory access request 2548 may cause a page walk to be performed on paging structures 2530, if the targeted memory is not cached, for example. In this example, a page walk can land on EPT PTE 2534, which contains a host physical address of the targeted physical page. A key ID may be obtained from some bits of the host physical address in the EPT PTE 2534. The core 2540 can determine the hardware thread ID 2544. For example, some cache hierarchy implementations may propagate the hardware thread ID alongside requests for cache lines so that the responses to those requests can be routed to the appropriate hardware thread. Otherwise, the cache hierarchy could be extended to propagate that information deep enough into the cache hierarchy to be used to select a key ID. The needed depth would correspond to the depth of the encryption engine in the cache hierarchy. Yet another embodiment would be to concatenate the hardware thread ID with the HPA as it emerges from the hardware thread itself. For example, this may be advantageous if available EPTE/PTE bits are tightly constrained, but more HPA bits are available in the cache hierarchy.

The hardware thread ID and the key ID obtained from the physical address can be combined to form a combination ID. The memory protection circuitry 2560 can use the combination ID to search the key mapping table 2562 for a match. A cryptographic key (e.g., 2567) associated with an identified match (e.g., 2565) can be used to encrypt/decrypt data or code associated with the memory access request 2548.

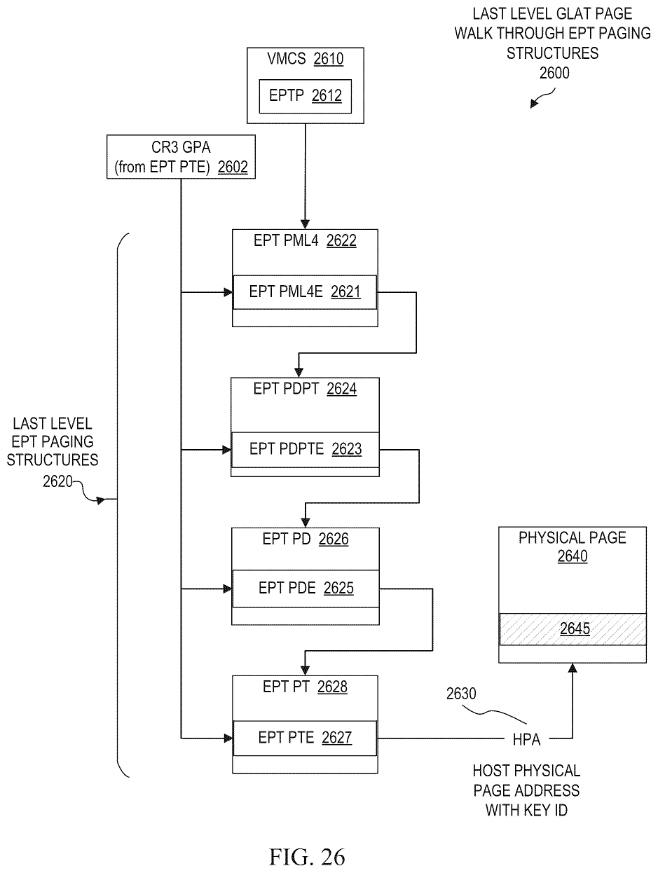

FIG. 26 is a block diagram illustrating an example last level page walk 2600 through extended page table (EPT) paging structures 2620 according to at least one embodiment to find an EPT PTE leaf containing a host physical address of a physical page table to be accessed. EPT paging structures 2620 represent an example of at least some of the EPT paging structures 930 used in the GLAT page walk 1000 illustrated in FIG. 10. Specifically, the last level page walk 2600 of FIG. 26 represents the EPT paging structures that are walked after the PTE 1027 of page table 1028 has been found. The EPT paging structures 2620 can include an EPT page map level 4 table (EPT PML4) 2622, an EPT page directory pointer table (EPT PDPT) 2624, an EPT page directory (EPT PD) 2626, and an EPT page table (EPT PT) 2628.

During an GLAT page walk (e.g., 1000), GLAT paging structures map host physical addresses (HPAs) provided by the EPT paging structures to guest physical addresses (GPAs) that are translated by the EPT paging structures to the HPAs. When a GPA is produced by one of the GLAT paging structures and needs to be translated, the base for the first table (the root) of the EPT paging structures 2620, which is EPT PML4 2622, may be provided by an extended page table pointer (EPTP) 2612. EPTP 2612 may be maintained in a virtual machine control structure (VMCS) 2610. The GPA 2602 to be translated in the last level page walk 2600 is obtained from a page table entry (e.g., 1027) of a page table (e.g., 1028) of the GLAT paging structures (e.g., 1020).

The index into the EPT PML4 2622 is provided by a portion of GPA 2602 to be translated. The EPT PML4 entry 2621 provides a pointer to EPT PDPT 2624, which is indexed by a second portion of GPA 2602. The EPT PDPT entry 2623 provides a pointer to EPT PD 2626, which is indexed by a third portion of GPA 2602. The EPT PD entry 2625 provides a pointer to the last level of the EPT paging hierarchy, EPT PT 2628, which is indexed by a fourth portion of GPA 2602. The entry that is accessed in the last level of the EPT paging hierarchy, EPT PT entry 2627, is the leaf and provides HPA 2630, which is the base for a final physical page 2640 of the GLAT page walk. A unique portion of the GLA being translated (e.g., 1010) is used with HPA 2630 to index the final physical page 2640 to locate the targeted physical memory 2645 from which data or code is to be loaded, or to which data is to be stored.

Prior to the GLAT page walk that includes the last level page walk 2600, during GLAT page mapping operations by the hypervisor (e.g., 220) and guest operating system (e.g., 212), a combination ID is associated with the virtual machine (e.g., 210) is assigned to the final memory page 2640. The HIKID may be assigned to the final physical memory page 2640 by the hypervisor (e.g., 130) storing the HIKID in designated bits of EPT PTE leaf 2627 when the hypervisor maps the physical page in the EPT paging structures after the physical page has been allocated by the guest kernel. The HIKID can indicate that the contents (e.g., data and/or code) of physical page 2640 are to be protected using encryption and integrity validation.

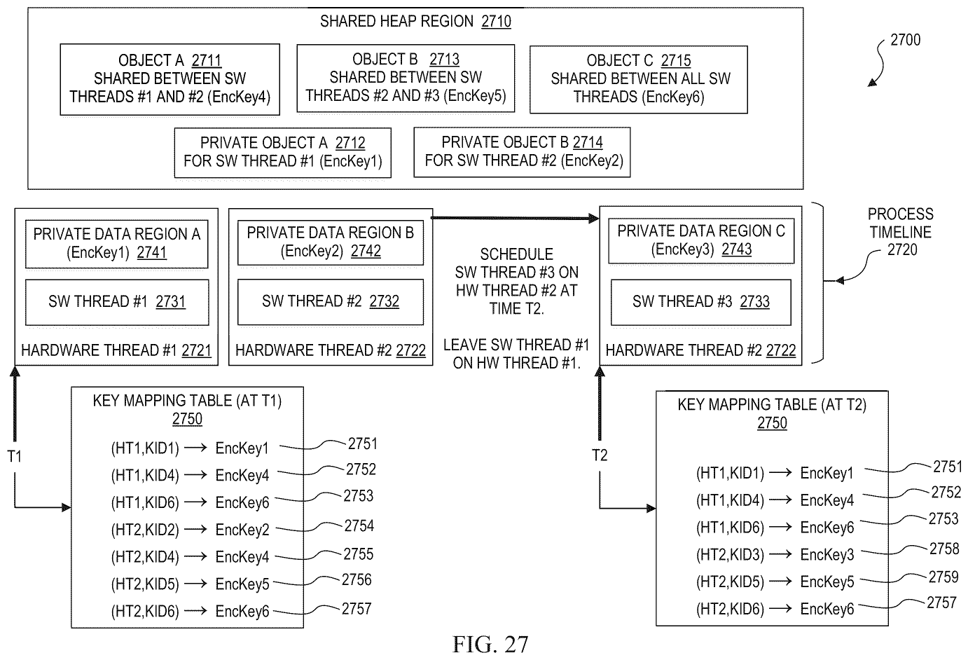

FIG. 27 is a block diagram illustrating an example scenario of a process 2700 running on a computing system with multi-key memory encryption providing differentiation of memory accesses via a combination ID according to at least one embodiment. Process 2700 illustrates a timeline 2720 of three software threads running on two different hardware threads 2721 and 2722, and the state of a key mapping table at different periods in the timeline 2720.

At time T1, a software thread #1 2731 is scheduled on hardware thread #1 2721, and a software thread #2 2732 is scheduled on a hardware thread #2 2722. At a subsequent time T2, a software thread #3 2733 is scheduled on hardware thread #2 2722. Also at time T2, software thread #1 2731 remains scheduled on hardware thread #1 2721, and software thread #2 2732 is no longer scheduled to run on any hardware thread.

An address space of the process 2700 includes a shared heap region 2710, which is used by all software threads in the process. In this example shared heap region 2710, object A 2711 is shared between software threads #1 and #2, and is encrypted/decrypted by a cryptographic key designated as EncKe28. In shared heap region 2710, object B 2713 is shared between software threads #2 and #3 and is encrypted/decrypted by a cryptographic key designated as EncKe29. In shared heap region 2710, object C 2715 is shared among all software threads, and is encrypted/decrypted by a cryptographic key designated as EncKe30. In this example, private objects area also allocated for two software threads #1 and #2. Private object A 2712 is allocated to software thread #1 2731 and is encrypted/decrypted by a cryptographic key designated as EncKey1. Private object B 2714 is allocated to software thread #2 2632 and is encrypted/decrypted by a cryptographic key designated as EncKe26.

In addition, each of the software threads #1, #2, and #3 may also access private data that is not in shared heap region 2710. For example, the software threads may access global data that is associated, respectively, with the executable images for each of the software threads. In this scenario, private data region A 2741 belongs to software thread #1 2731 on hardware thread #1 2721 and is encrypted/decrypted by EncKey1. Private data region B 2742 belongs to software thread #2 2732 on hardware thread #2 2722 and is encrypted/decrypted by EncKe26. At time T2, private data region C 2743 belongs to software thread #3 2733 on hardware thread #2 2722 and is encrypted/decrypted by EncKe27.

Each of the cryptographic keys are mapped to combination key IDs in a key mapping table 2750 in memory controller circuitry 2550 (or other suitable storage), which can be used to identify and retrieve the cryptographic key for cryptographic operations. Key mapping table 2750 contains combination IDs mapped to cryptographic keys. In this example, the combination IDs include a hardware thread ID concatenated with a key ID.

At time T1, key mapping table 2750 includes three software thread #1 mappings 2751, 2752, and 2753 with three respective combination IDs for hardware thread #1. At time T1, key mapping table 2750 also includes four software thread #2 mappings 2754, 2755, 2756, and 347 with four respective combination IDs for hardware thread #2. For reference, ‘HT #’ refers to a hardware thread identifier, ‘KID #’ refers to a key ID, and ‘EncKey #’ refers to a cryptographic key. For example, first software #1 mapping 2751 includes a combination ID (HT1 concatenated with KID1) mapped to EncKey1, a second software #1 mapping 2752 includes a combination ID (HT1 concatenated with KID4) mapped to EncKe28, and so on.

At time T2, when the software thread #3 2733 is scheduled on hardware thread #2, and replaces software thread #2 2732, new mapping entries for software thread #3 are added to key mapping table 2750, old mapping entries for software thread #2 2732 are removed from key mapping table 2750, and old entries for software thread #1 2731 remain. For example, mappings 2751, 2752, and 2753 for software thread #1 2731 remain in the key mapping table at time T2. Mapping 2756 for object C 2715, which is shared by all of the software threads, also remains in the key mapping table at time T2. Other software thread #2 mappings 2754, 2755, and 2757 are removed from the key mapping table 2750 at time T2. Finally, new software thread #3 mappings 2758 and 2759 are added to the key mapping table at time T2 to allow software thread #3 2733 to access shared object B 2713, shared object C 2715, and private data region C 2743.

Key mapping table 2750 includes three combination IDs for hardware thread #1, and four combination IDs for hardware thread #2. For reference, ‘HT #’ refers to a hardware thread identifier, ‘KID #’ refers to a key ID, and ‘EncKey #’ refers to a cryptographic key. At time T1, the combination IDs for hardware thread #1 2721 include HT1 concatenated with KID1, HT1 concatenated with KID4, and HT1 concatenated with KID6. Also at time T1, the combination IDs for hardware thread #2 2722 include HT2 concatenated with KID2, HT2 concatenated with KID4, HT2 concatenated with KID5, and HT1 concatenated with KID6. Each of the combination IDs are mapped to a unique cryptographic key (EncKey #) as shown in key mapping table 2750 at time T1.

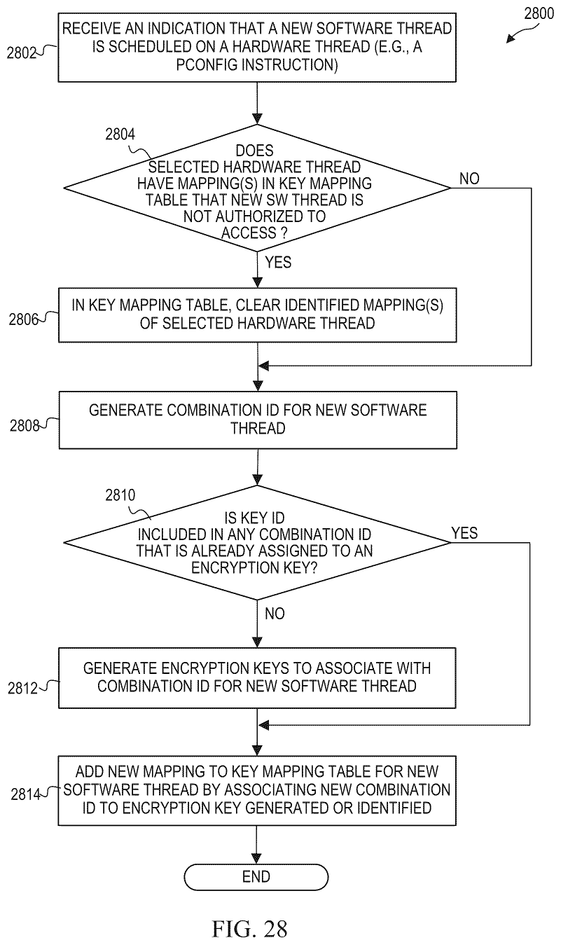

FIG. 28 is a simplified flow diagram 2800 illustrating example operations associated with using a combination identifier in a multi-key memory encryption scheme according to at least one embodiment. Flow diagram 2800 may be associated with one or more sets of operations. A computing system (e.g., computing system 2500, 100, 200) may comprise means such as one or more processors (e.g., 140) and memory (e.g., 170), for performing the operations. In one example, at least some operations shown in flow diagram 2800 may be performed memory protection circuitry (e.g., 2560) and/or memory controller circuitry (e.g., 2550). Operations in flow diagram 2800 may begin when privileged software (e.g., 2520) invokes an instruction to configure the platform with appropriate mappings to cryptographic keys for memory to be used by a new software thread (e.g., 2546) of a process that is scheduled to run on a selected hardware thread (e.g., 2542).

At 2802, memory controller circuitry and/or memory protection circuitry receive an indication that a new software thread is scheduled on the selected hardware thread. For example, a platform configuration instruction (e.g., PCONFIG) may be invoked by privileged software (e.g., 2520) to configure a new mapping of a key ID to be assigned to the new software thread and used to access a particular memory region allocated to or shared by the new software thread.

At 2804, a determination is made as to whether any existing combination ID-to-cryptographic key mappings in the key mapping table are assigned to the selected hardware thread. The combination IDs in the mappings can be evaluated to determine whether any include the hardware thread ID (e.g., 2544) of the selected hardware thread. If any of the combination IDs are identified in the mappings as including the hardware thread ID of the selected hardware thread ID, then at 2806, the entries in the key mapping table that contain the identified mappings can be cleared (or overwritten).

Once the old mappings are cleared, or if no mappings are identified as containing the hardware thread ID of the selected hardware thread, then at 2808, the memory controller circuitry and/or memory protection circuitry can generate a combination ID for the new software thread. The combination ID can be generated, for example, by combining parameters (e.g., key ID and hardware thread ID) provided in the platform configuration instruction invoked by the privileged software. In another example, the combination ID can be generated by combining the key ID and hardware thread ID before invoking the platform configuration instruction, and the combination ID can be provided as a parameter in the platform configuration instruction. In one implementation, the key ID and hardware thread ID may be concatenated to generate the combination ID. In other implementations, any other suitable approach (e.g., logical operation, etc.) for combining the key ID and hardware thread ID can be used.

At 410, a determination is made as to whether the key ID provided as a parameter in the instruction is included in any mapping. If a mapping is identified, this indicates that the memory associated with the key ID is shared and therefore, instead of generating a new cryptographic key, the cryptographic key in the identified mapping is to be used to generate another mapping for the new software thread on the selected hardware thread.

If an existing mapping that has the key ID as part of the combination ID is not found, then at 412, a cryptographic key is generated or otherwise determined. For example, the cryptographic key could be a randomly generated string of bits, a deterministically generated string of bits, or a string of bits that are derived based on an entropy value, for example.

At 2814, a new mapping entry is added to the key mapping table. The new mapping entry can include an association between the combination ID generated for the new software thread at 2808, and the cryptographic key that is either generated at 2812 or identified in an existing mapping at 2810. The new mapping can be used by the new software thread to access memory to which the key ID is assigned in the page table paging structures.

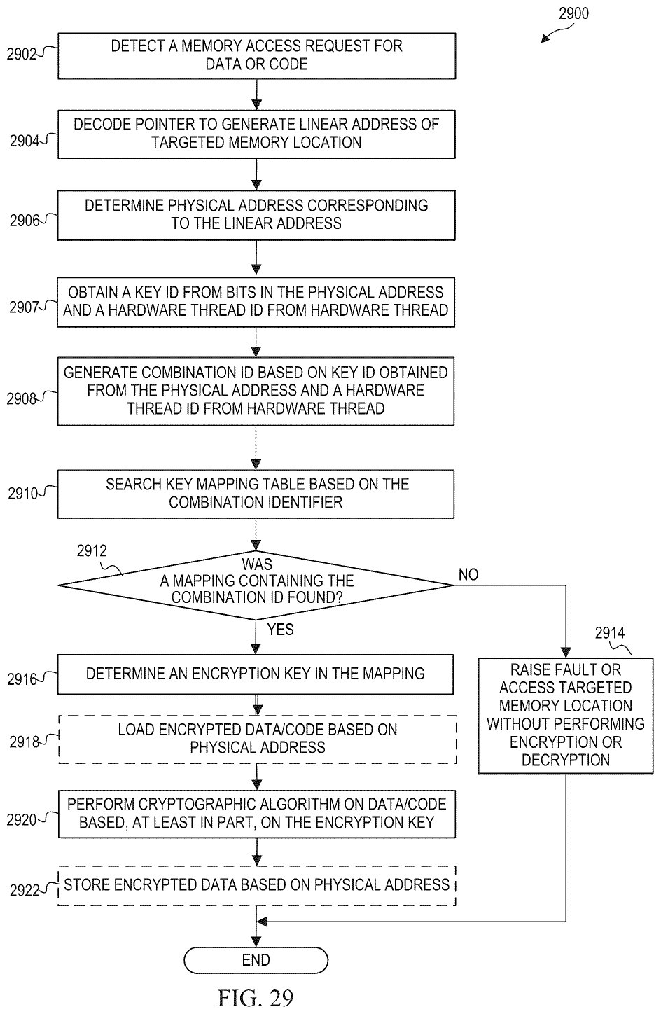

FIG. 29 is a simplified flow diagram illustrating further example operations associated with a memory access request when using a combination identifier in a multi-key memory encryption scheme according to at least one embodiment. The memory access request may correspond to a memory access instruction to load or store data. In other scenarios, the memory access request may correspond to a fetch stage of a core to load the next instruction of code to be executed. A computing system (e.g., computing system 2500, 100, 200) may comprise means such as one or more processors (e.g., 140) and memory (e.g., 170), for performing the operations. In one example, at least some operations shown in flow diagram 2900 may be performed by a core (e.g., hardware thread 2542) of a processor and/or memory controller circuitry (e.g., 2550) of the processor. In more particular examples, one or more operations of flow diagram 2900 may be performed by an MMU (e.g., 145A or 145B), address decoding circuitry (e.g., 146A or 146B), and/or memory protection circuitry 2560.

At 2902, a memory access request for data or code is detected. For example, detecting a memory access request can include fetching, decoding, and/or beginning execution of a memory access instruction with a data pointer. Alternatively, a memory access request can include entering a fetch stage for the next instruction in code referenced by an instruction pointer. The memory access request is associated with a software thread running on a hardware thread of a multithreaded process.

At 2904, the core and/or memory controller circuitry 2550 can decode a pointer (e.g., data pointer or instruction pointer) associated with the memory access request to generate a linear address of the targeted memory location. The data pointer may point to any type of memory containing data such as the heap, stack, data segment, or code segment of the process address space, for example.

At 2906, the core and/or memory controller circuitry 2550 determines a physical address corresponding to the generated linear address is determined. For example, a TLB lookup can be performed as previously described herein (e.g., 850 in FIG. 8). If a TLB miss occurs, then a linear-to-physical address translation may be performed in a page walk of paging structures as previously described herein (e.g., 854 in FIG. 8, 900 in FIG. 9, 1000 in FIG. 10, 2600 in FIG. 26). The page walk identifies a page table entry (e.g., PTE or EPT PTE) that contains the physical address of a physical page targeted by the memory access request.

At 2907, the core 2542 and/or memory controller circuitry 2550 can obtain a key ID from some bits (e.g., upper bits) of the host physical address stored in the identified page table entry of the paging structures. In addition, a hardware thread ID of the hardware thread can also be obtained.

At 2908, the core 2542 and/or memory controller circuitry 2550 can generate a combination identifier based on the key ID obtained from bits in the host physical address and the hardware thread ID obtained from the hardware thread associated with the memory access request.

At 2910, the hardware thread can issue the memory access request with the combination ID to the memory controller circuitry 2550. The memory controller and/or memory protection circuitry can search the key mapping table based on the combination ID. The combination ID is used to find a key mapping that includes the combination ID mapped to a cryptographic key.

At 2912, the core 2542 and/or memory controller circuitry 2550 can determine whether a key mapping was found in the key mapping table that contains the combination ID. If no key mapping is found, then at 2914, a fault can be raised or any other suitable actions based on an abnormal event. In another implementation, if no key mapping is found, then this can indicate that the targeted memory is not encrypted and the targeted memory can then be accessed without performing encryption or decryption.

If a key mapping with the combination ID is found at 2912, then at 2916, a cryptographic key associated with the combination ID in the key mapping is determined.

If the memory access request corresponds to a memory access instruction for loading data, then at 2918, the core 2542 and/or memory controller circuitry 2550 loads the data stored at the targeted physical address, or stored in cache and indexed by the key ID and at least a portion of the physical address. Typically, the targeted data in memory is loaded by cache lines. Thus, one or more cache lines containing the targeted data may be loaded at 2918.

At 2920, if the data has been loaded as the result of a memory access instruction to load the data or as part of a memory access instruction to store the data, then the cryptographic algorithm decrypts the data (e.g., or the cache line containing the data) using the cryptographic key. Alternatively, if the memory access request corresponds to a memory access instruction to store data, then the data to be stored is in an unencrypted form and the cryptographic algorithm encrypts the data using the cryptographic key. It should be noted that, if data is stored in cache in the processor (e.g., L1, L2), the data may be in an unencrypted form. In this case, data loaded from the cache may not need to be decrypted.

If the memory access request corresponds to a memory access instruction to store data, then at 2922, the core 2542 and/or memory controller circuitry 2550 stores the encrypted data is based on the physical address (e.g., obtained at 2906), and the flow can end.

A second embodiment to enhance performance and security of multi-key memory encryption, such as MKTME, includes locally restricting hardware threads as to which key IDs can be specified. This may be advantageous because updating accessible key IDs at the memory controller level involves communicating out to the memory controller from a core, which can be time-consuming. One possible solution is to use a mask of key IDs, such as key ID bitmask 2541. The mask of key IDs can be maintained within each hardware thread to block other key IDs from being issued at the time that the mask is active. As a memory request is being submitted to the translation lookaside buffer (e.g., 840), a page fault can be generated if the specified key ID is not within the active mask. An equivalent check can be performed on the results of page walks as well. Alternatively, as a memory request is being issued from the hardware thread to the cache, the memory request can be blocked if the specified key ID is not within the active mask.

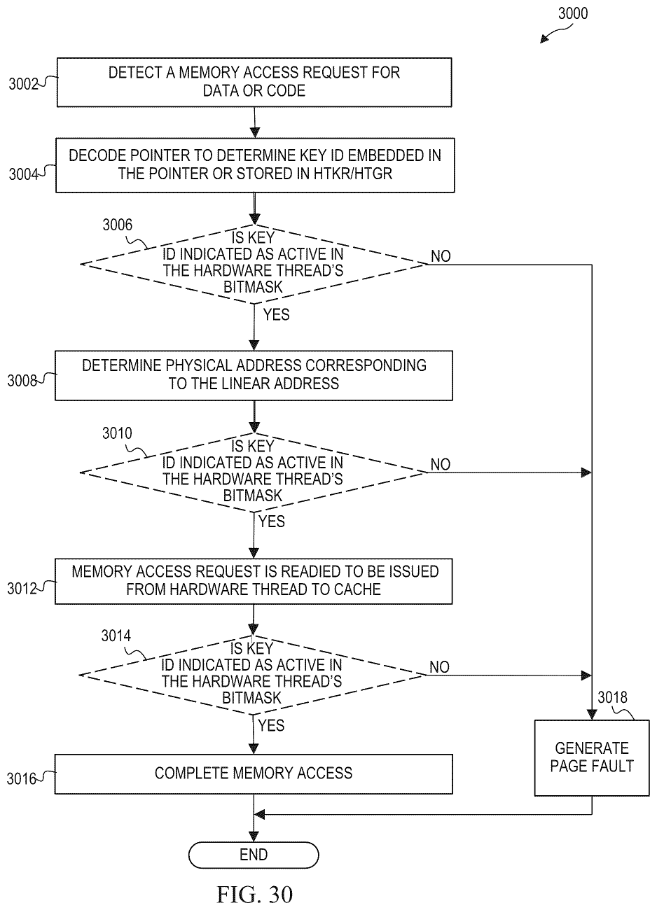

FIG. 30 a simplified is a flow diagram illustrating further example operations associated with a memory access request when using a combination identifier and a key ID bitmask in a multi-key memory encryption scheme according to at least one embodiment. FIG. 30 illustrates an alternative flow associated with a memory access request from a hardware thread, as shown in FIG. 29. FIG. 30 uses dashed-line decision boxes to indicate various options in the flow for performing a bitmask check to determine whether a key ID associated with the memory access request is allowed to be issued from that hardware thread.

At 3002, a memory access request for data or code is detected. For example, detecting a memory access request can include fetching, decoding, and/or beginning execution of a memory access instruction with a data pointer. Alternatively, a memory access request can include entering a fetch stage for the next instruction in code referenced by an instruction pointer. The memory access request is associated with a software thread running on a hardware thread of a multithreaded process.

At 3004, a pointer (e.g., data pointer or code pointer) of the memory access instruction indicating an address to load or store data is decoded to generate a linear address of the targeted memory location. The data pointer may point to any type of memory containing data such as the heap, stack, or data segment of the process address space, for example.

In some embodiments described herein, the key ID for the memory access may be embedded in the data pointer. In this embodiment, a key ID bitmask check can be performed at 3006, as the linear address is being sent to the TLB to be translated. The key ID bitmask (e.g., 2541) can be checked to determine whether a bit that represents the key ID specified in the data pointer for the memory access instruction indicates that the key ID is active for the hardware thread. For example the bit may be set to “1” to indicate the key ID is active for the hardware thread and to “0” to indicate the key ID is not allowed for the hardware thread. In other examples, the values may be reversed. If the key ID is determined to not be allowed (e.g., if the bit is not set), then at 3018, a page fault is generated. If the key ID is determined to be active, however, then the memory access request flow can continue at 3008.

At 3008, a physical address corresponding to the generated linear address is determined. For example, a TLB lookup can be performed as previously described herein (e.g., 850 in FIG. 8). If a TLB miss occurs, then a linear-to-physical address translation may be performed in a page walk as previously described herein (e.g., 854 in FIG. 8, 900 in FIG. 9, 1000 in FIG. 10, 2600 in FIG. 26).

In some embodiments, the key ID for the memory access may be included in the PTE leaf of a page walk (e.g., in the host physical address of the physical page to be accessed). In this embodiment, an alternative approach for the key ID bitmask check is to be performed at 3010 (instead of at 3006), after the page walk has been performed or the address has been obtained from the TLB. The key ID bitmask check may be the same as the key ID bitmask check described with reference to 3006. If the key ID is determined to not be allowed (e.g., if the bit is not set), then at 3018, a page fault is generated. If the key ID is determined to be active, however, then the memory access request flow can continue at 3012.

At 3012, the memory access request is readied to be issued from the hardware thread to cache.

An alternative approach for the key ID bitmask check is to be performed at 3014 (instead of at 3006 or 3010), once the memory access request is ready to be issued from the hardware thread to cache. The key ID bitmask check may be the same as the key ID bitmask check described with reference to 3006. If the key ID is determined to not be allowed (e.g., if the bit is not set), then at 3018, a page fault is generated. If the key ID is determined to be active, however, then the memory access request flow can continue to completion at 3012.

The mask of key IDs can be efficiently updated if the mask is maintained in the hardware thread of the core. The mask can be updated when software threads are being rescheduled on the hardware threads. In one example, a new instruction can be used to perform the update. One example new instruction could be “Update_KeyID_Mask.” The instruction can include an operand that includes a new value for the key ID mask. For example, one bit within the mask may represent each possible key ID that could be specified. The new value for the mask can be supplied as the operand to the instruction. The instruction would then update a register within the within the hardware thread with the new mask value supplied by the operand.

### Using Protection Keys to Specify Cryptographic Isolation

A third embodiment to enhance performance and security of a multi-key memory encryption scheme, such as Intel® MKTME, includes repurposing existing page table entry bits (e.g., 4-bit protection key (PKEY) of Intel® Memory Protection Keys (MPK)) to specify the multi-key memory encryption enforced isolation without absorbing physical address bits and with flexible sharing. MPK is a user space hardware mechanism to control page table permissions. Protection keys (or PKEYs) are stored in 4 unused bits in each page table entry (e.g., PTE, EPT PTE). In this example using 4 dedicated bits to store protection keys, up to 16 different protection keys are possible. Thus, a memory page referenced by a page table entry can be marked with one out of 16 possible protection keys. Permissions for each protection key are defined in a Protection Key Rights for User Pages (PKRU) register. The PKRU register may be updated from user space using specific read and write instructions. In one example, the PKRU allows 2 bits for each protection key to define permissions associated with the protection keys. The permissions associated with a given protection key are applied to the memory page marked by that protection key.

Due to limitations in available PTE bits and register sizes, the number of PKEYs that can be supported is limited (e.g., up to sixteen values). The limited number of protection keys that can be supported prevents scalability for processes running multiple software threads with many different memory regions needing different protections. For example, if a process is running 12 software threads with 12 private memory regions, respectively, then 12 protection keys, then for any given running software thread, only one of the 12 protection keys would be marked in the software thread's PKRU with permissions (e.g., read or read/write) for the associated private memory region. This would leave only 4 remaining protection keys to be used for shared memory regions among the 12 software threads. Thus, as the number of private memory regions used in a process increases, the number of available protection keys for shared memory regions decreases.

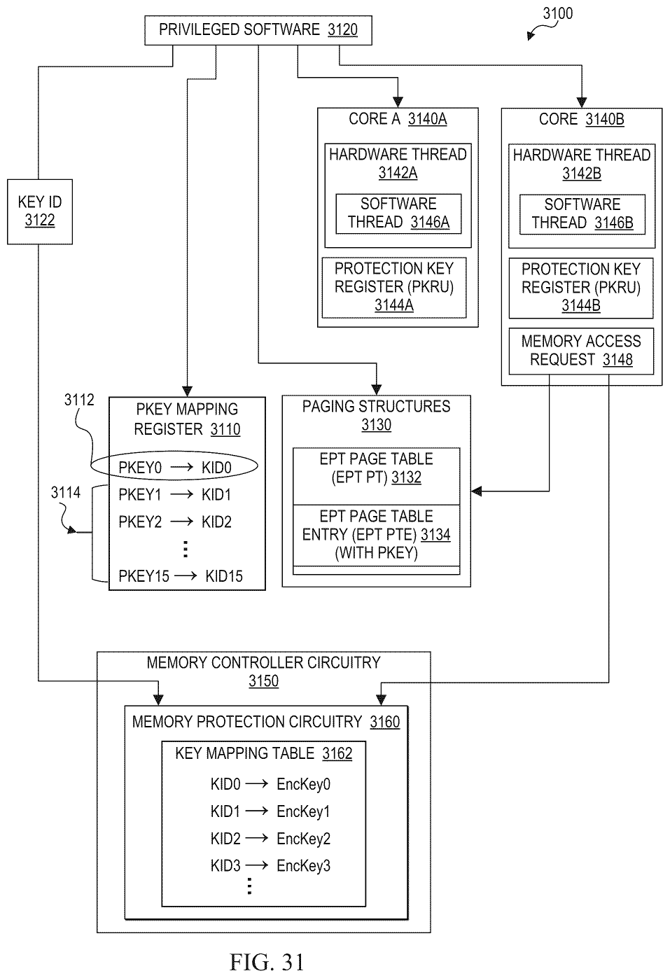

In FIG. 31, a computing system 3100 illustrated with selected possible components to repurpose existing page table entry bits to specify multi-key memory encryption enforced isolation, can resolve the constraints of MPK and enhance security and performance of MKTME. Defining an additional register 3110 that maps PKEY values (e.g., the 4-bit protection key identifiers stored in the PTEs) to MKTME key IDs, allows scaling up the number of PKEYs while still supporting shared regions between software threads. For example, 15 of the 16 available protection keys may be used for memory regions that are shared amongst various software threads, and the remaining one of the protection keys may be used for per-thread private data regions. When a switch is made between different software threads, the mapping from that one private PKEY value to its associated MKTME key ID can be updated to correspond to the key ID for the software thread being entered. If a software thread in the process accesses private memory belonging to a different software thread in the process, MPK does not block the access because the PKRU register will allow access to that PKEY value. In that scenario, however, the wrong key ID will be identified, and therefore, the wrong cryptographic key will be used to encrypt or decrypt data. This can result in an integrity violation if integrity checks are enabled, or at least garbled data otherwise. This also avoids eating into physical address bits for specifying key IDs.

Computing system 3100 includes a core A 3140A, a core B 3140B, a protection key (PKEY) mapping register 3110, privileged software 3120, paging structures 3130, and memory controller circuitry 3150 that includes memory protection circuitry 160. Computing system 3100 may be similar to computing systems 100 or 200, but may not include specialized hardware registers such as HTKR 156 and HTGRs 158. For example, cores 3140A and 3140B may be similar to cores 142A and 142B and may be provisioned in a processor, potentially with one or more other cores. Privileged software 3120 may be similar to operating system 120 or hypervisor 220. Paging structures 3130 may be similar to LAT paging structures 172, 920 or to GLAT paging structures 216, 1020 and EPT paging structures 228, 1030. Memory controller circuitry 3150 may be similar to memory controller circuitry 148. Memory protection circuitry 3160 may be similar to memory protection circuitry 160. Computing system 3100, however, includes PKEY mapping register 3110 to repurposing existing page table entry bits used for protection keys to specify the multi-key memory encryption enforced isolation via the PKEY mapping register 3110.

In FIG. 31, computing system 3100 shows an example process having two hardware threads 3142A and 3142B on cores 3140A and 3140B, respectively. In this example, software thread 3146B is currently running on hardware thread 3142B of core B 3140B, but software thread 3146A is not yet scheduled to run on hardware thread 3142A of core A 3140A. Core A 3140A includes a PKRU register for defining permissions to be applied to the protection keys (e.g., PKEY0-PKEY15) when software thread 3146A is initiated and begins accessing memory. Core B 3140B also includes a PKRU register for defining permissions to be applied to the protection keys (e.g., PKEY0-PKEY15) when software thread 3146A accesses memory, such as in memory access request 3148.

Paging structures 3130 include an EPT page table 3132 (for implementations with extended page tables) with multiple page table entries. In one or more embodiments, each EPT PTE of paging structures 3130 can include a host physical address of a physical page in the address space of the process. A protection key (e.g., PKEY0-PKEY15) may be stored in some bits (e.g., 4 bits or some other suitable number of bits) of the host physical address stored in the EPT PTE to mark the memory region (e.g., physical page) that is referenced by the host physical address stored in that EPT PTE. In addition, the key ID used for encryption/decryption associated with the memory region may be omitted from the page table entry since the protection key is mapped to the key ID in the PKEY mapping register 3110. In the example of FIG. 31, the paging structures 3130 are used to map linear addresses (or guest linear addresses) of memory access requests associated with software threads 3146A and 3146B.

An example EPT PTE 3134 is found as the result of a page walk for memory access request 3148. The EPT PTE 3134 includes a protection key stored in the bits of a host physical address for the physical page referenced by the host physical address. The protection key permissions applied to the physical page accessed by the memory access request 3148 are defined by certain bits (e.g., 2 bits of 32 bits) in the PKRU register 3144B in core B 3140 that correspond to the protection key stored in the PTE 3134. It should be understood that some systems may not use extended page tables and that the paging structures 3130 in those scenarios may be similar to LAT paging structures 920. In such an implementation, the page table entries can contain host physical addresses rather than guest physical addresses.

Memory protection circuitry 3160 includes a key mapping table 3162, which includes mappings of key IDs to cryptographic keys. The key IDs are assigned to software threads (or corresponding hardware threads) for accessing memory regions that the software thread is authorized to access.

The PKEY mapping register 3110 provides a mapping between protection keys and key IDs used by a process. For a 4-bit protection key, up to 16 different protection keys, PKEY0-PKEY1 are possible. One protection key (e.g., PKEY0) can be used in a mapping 3112 to a key ID (e.g., KID0) that is assigned for a private memory region of a software thread. For example, PKEY0 may be mapped to KID0, which is assigned to software thread 3146B for accessing a private memory region allocated to software thread 3146B. The remaining protection keys PKEY1-PKEY15 may be used in mappings 3114 to various key IDs assigned to various groups of software threads authorized to access one or more shared memory regions. When a new software thread is scheduled (e.g., software thread 3146A), the protection key PKEY0 used for the private memory regions can be remapped to a key ID that is assigned to the new software thread and used for encrypting/decrypting the new software thread's private memory region. Thus, the remaining 15 protection keys PKEY1-PKEY15 can be used by various groups of the software threads to access various shared memory regions. In addition, PKRU registers 2546A and 2546B of the respective hardware threads 2540A and 2540B, can continue to be used during execution to control which shared regions are accessible for each of the software threads that get scheduled.

Privileged software 3120 (e.g., an operating system, a hypervisor) can remap the PKEY mapping register 3110, when software threads are scheduled. In some scenarios, only a single mapping used for private memory regions may be updated with a newly scheduled software thread's assigned key ID for private memory. For each software thread in a process, the privileged software 3120 can invoke a platform configuration instruction (e.g., PCONFIG) to send one or more requests to configure the key mapping table 3162 with one or more key IDs for the memory regions that a software thread is authorized to access. For example, if software thread 3146A is being scheduled on hardware thread 3142A of core A 740A, then a key ID such as KID18, which is not currently mapped to a PKEY in PKEY mapping register 3110, may be provided as a parameter key ID 3122 in a platform configuration instruction. The memory protection circuitry 3160 can create, in key mapping table 3162, a mapping from KID18 to a cryptographic key that is to be used for encrypting/decrypting a private memory region of software thread 3146A. The privileged software 2520 may also remap PKEY0 to KID18 in PKEY mapping register 3110. Thus, PKEY0 can be stored in the EPT page table entries containing host physical addresses to the private memory region allocated to software thread 3146A. The permissions of PKEY0 can be controlled in the PKRU 3144A of core A 3140A.

From time to time, a scheduled software thread may invoke and execute memory access requests, such as memory access request 3148. Memory access request 3148 may include a pointer to a linear address (or guest linear address) of the targeted memory in the process address space. The memory access request 3148 may cause a page walk to be performed on paging structures 3130, if the targeted memory is not cached, for example.

In this example, a page walk can land on EPT PTE 3134, which contains a host physical address of the targeted physical page. A protection key may be stored in some bits of the host physical address. Bits in the PKRU 31446 that correspond to the protection key can be checked to determine if the software thread has permission to perform the particular memory access request 3148 on the targeted memory. If the software thread does not have permission, then the access may be blocked and a page fault may be generated. If the software thread does have permission to access the targeted memory, then the protection key can be used to search the PKEY mapping register 3110 to find a matching protection key mapped to a key ID. The memory controller circuitry 3150 and/or memory protection circuitry 3160 can use the key ID identified in the PKEY mapping register to search the key mapping table 3162 for a matching key ID. The cryptographic key 2567 associated with the identified matching key can be used to encrypt/decrypt data associated with the memory access request 3148.

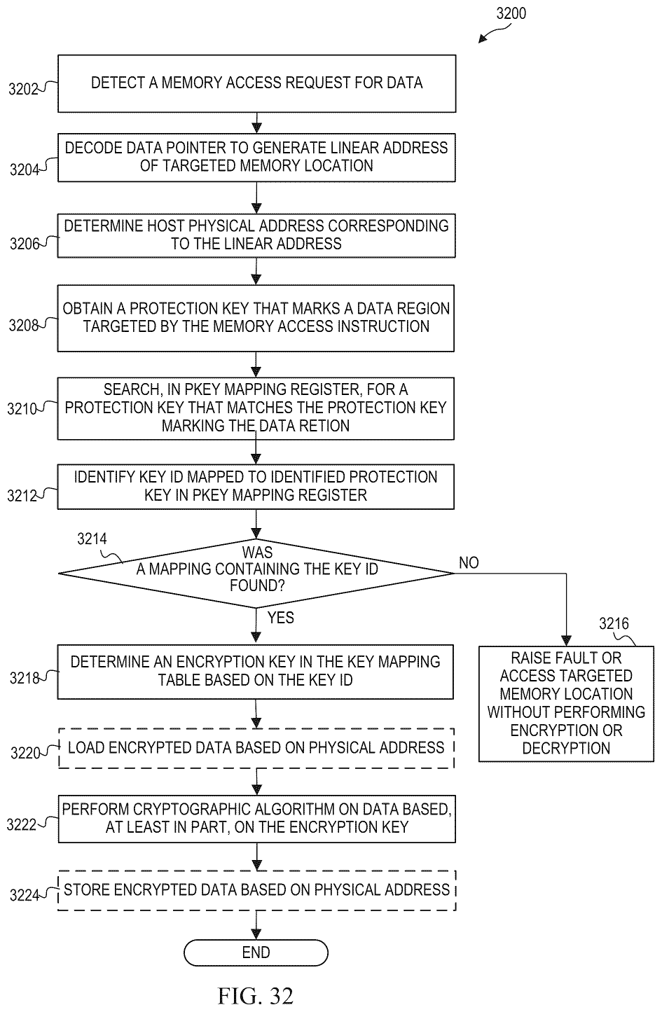

FIG. 32 is a simplified flow diagram 3200 illustrating further example operations associated with a memory access request of a software thread running in a process on a computing system configured with a feature to repurpose existing page table entry bits to specify multi-key memory encryption enforced isolation, according to at least one embodiment. The memory access request (e.g., 3148) may correspond to a memory access instruction to load or store data. A computing system (e.g., computing system 3100, 100, 200) may comprise means such as one or more processors (e.g., 140) and memory (e.g., 170), for performing the operations. In one example, at least some operations shown in flow diagram 3200 may be performed by a core 3140B (e.g., hardware thread 3142B) of a processor and/or memory controller circuitry (e.g., 3150). In more particular examples, one or more operations of flow diagram 3200 may be performed by an MMU (e.g., 145A or 145B), address decoding circuitry (e.g., 146A or 146B), and/or memory protection circuitry 3160.

At 3202, a memory access request for data is detected. For example, detecting a memory access request can include fetching, decoding, and/or beginning execution of a memory access instruction with a data pointer. The memory access request is associated with a software thread running on a hardware thread of a multithreaded process.

At 3204, the core 3140A or 3140B and/or memory controller circuitry 3150 can decode a data pointer of the memory access instruction to generate a linear address of the targeted memory location. The data pointer may point to any type of memory containing data such as the heap, stack, or data segment of the process address space, for example.

At 3206, the core 3140A or 3140B and/or memory controller circuitry 3150 determines a host physical address corresponding to the generated linear address. For example, a TLB lookup can be performed as previously described herein (e.g., 850 in FIG. 8). If a TLB miss occurs, then a linear-to-physical address translation may be performed in a page walk as previously described herein (e.g., 854 in FIG. 8, 900 in FIG. 9, 1000 in FIG. 10, 2600 in FIG. 26). The page walk identifies a page table entry (e.g., PTE or EPT PTE) that contains the host physical address of the physical page targeted by the memory access request.

At 3208, the core 3140A or 3140B and/or memory controller circuitry 3150 determines that a data region targeted by the memory access request (e.g., data region pointed to by the physical address) is marked by a protection key embedded in the host physical address in the page table entry. For example, a 4-bit protection key may be stored in 4 upper bits of the host physical address contained in the EPT PTE (e.g., 3134) of the EPT PT (e.g., 3132) of the paging structures (e.g., 3130) that were created for the address space of the process. The protection key can be obtained from the relevant bits of the host physical address. At 3210, the PKEY mapping register is searched for a protection key in the register that matches the protection key obtained from the host physical address.

At 3212, the core 3140A or 3140B and/or memory controller circuitry 3150 determines a key ID mapped to the protection key identified in the PKEY mapping register. The key ID and the physical address can be provided to the memory controller circuitry 2550 and/or memory protection circuitry 3152.

At 3214, the key mapping table is searched for a mapping containing the key ID determined from the PKEY mapping register. A determination is made as to whether a key ID-to-cryptographic key mapping was found in the key mapping table. If a mapping is not found, then at 3216, a fault can be raised or any other suitable actions based on an abnormal event. In another implementation, if no mapping is found, then this can indicate that the targeted memory is not encrypted and the targeted memory can then be accessed without performing encryption or decryption.

If a mapping with the key ID is found at 3214, then at 3218, a cryptographic key associated with the key ID in the mapping is determined.

If the memory access request corresponds to a memory access instruction for loading data, then at 3220, the core 3140A or 3140B and/or memory controller circuitry 3150 loads the data stored at the targeted physical address, or stored in cache and indexed by the key ID and at least a portion of the physical address. Typically, the targeted data in memory is loaded by cache lines. Thus, one or more cache lines containing the targeted data may be loaded at 3220.

At 3222, if the data has been loaded as the result of a memory access instruction to load the data or as part of a memory access instruction to store the data, then the cryptographic algorithm decrypts the data (e.g., or the cache line containing the data) using the cryptographic key. Alternatively, if the memory access request corresponds to a memory access instruction to store data, then the data to be stored is in an unencrypted form and the cryptographic algorithm encrypts the data using the cryptographic key. It should be noted that, if data is stored in cache in the processor (e.g., L1, L2), the data may be in an unencrypted form. In this case, data loaded from the cache may not need to be decrypted.

If the memory access request corresponds to a memory access instruction to store data, then at 3224, the core 3140A or 3140B and/or memory controller circuitry 3150 stores the encrypted data based on the physical address (e.g., obtained at 3206), and the flow can end.

### Multi-Key Memory Encryption in a Capability-Based Addressing System.

Embodiments are provided herein to improve the security of a capability-based addressing system by leveraging a multi-key memory encryption scheme, such as Intel® MKTME for example. In some examples, memory accesses are performed via a capability, e.g., instead of a pointer. Capabilities are protected objects that can be held in registers or memory. In at least some scenarios, memory that holds capabilities is integrity-protected. In some examples, a capability is a value that references an object along with an associated set of access rights. Capabilities can be created through privileged instructions that may be executed by privileged software (e.g., operating system, hypervisor, etc.). Privileged software can limit memory access by application code to particular portions of memory without separating address spaces. Thus, by using capabilities, address spaces can be protected without requiring a context switch when a memory access occurs.

Capability-based addressing schemes comprise compartments and software threads that invoke compartments, which can be used in multithreaded applications such as FaaS applications, multi-tenant applications, web servers, browsers, etc. A compartment is composed of code and data. The data may expose functions as entry points. A software thread can include code of a compartment, can be scheduled for execution, and can own a stack. At any given time, a single software thread can run in one compartment. A compartment may include multiple items of information (e.g., state elements). Each item of information within a single compartment can include a respective capability (e.g., a memory address and security metadata) to that stored item. In at least some examples, each compartment includes a compartment identifier (CID) programmed in a register. As used herein, the term ‘state elements’ is intended to include data, code (e.g., instructions), and state information (e.g., control information).

At least some capability mechanisms support switching compartments within a single address space based on linear/virtual address ranges with associated permissions and other attributes. For example, previous versions of Capability Hardware Enhanced RISC Instructions (CHERI) accomplish this using CCall/CReturn instructions. More recent versions of CHERI can perform compartment switching using a CInovke instruction. CHERI is a hybrid capability architecture that combines capabilities with conventional MMU-based architectures and with conventional software stacks based on linear (virtual) memory and programming languages C and C++.

One feature of capability mechanisms includes a 128-bit (or larger) capability size, rather than a smaller size (e.g., 64-bit, 32-bit) that is common for pointers in some architectures. Having an increased size, such as 128 bits or larger, enables bounds and other security context to be incorporated into the capabilities/pointers. Combining a capability mechanism (e.g., CHERI or others that allow switching compartments) and a cryptographic mechanism can be advantageous for supporting legacy software that cannot be recompiled to use 128-bit capabilities for individual pointers. The capability mechanism could architecturally enforce coarse-grained boundaries and cryptography could provide object-granular access control within those coarse-grained boundaries.

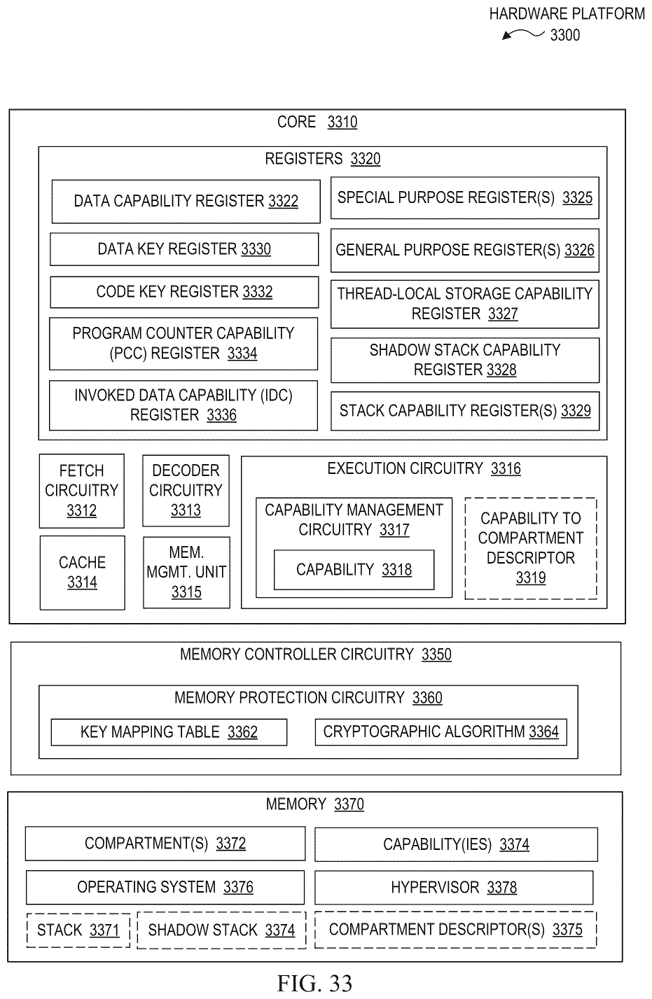

Turning to FIG. 33, FIG. 33 is a block diagram illustrating a hardware platform 3300 of a capability-based addressing system configured with multi-key memory encryption. The hardware platform 3300 includes a core 3310, memory controller circuitry 3350, and memory 3370. The core 3310 includes capability management circuitry 3317 and is coupled to the memory 3370, which via the memory controller circuitry 3350. Although memory controller circuitry 3350 is depicted outside the core 3310, it should be appreciated that some or all of the memory controller circuitry 3350 may be included within the core 3310 (and/or within other cores if the hardware platform includes a multi-core processor), as previously described herein at least with respect to memory controller circuitry 148 of FIG. 1.

Memory 3370 can include any form of volatile or non-volatile memory as previously described with respect to memory 170 of FIG. 1. Generally, memory 3370 may be similar to memory 170 of FIG. 1 and may have one or more of the characteristics described with respect to memory 170 of FIG. 1. Memory 3370 stores an operating system 3376 and, for a virtualized system, memory 3370 stores a hypervisor 3378. Hypervisor 3378 may be embodied as a software program that enables creation and management of virtual machines. In some examples, hypervisor 3378 can be similar to other hypervisors previously described herein (e.g., 220). Hypervisor 3378 (e.g., virtual machine manager/monitor (VMM)) runs on a processor (or core) to manage and run the virtual machines. Hypervisor 3378 may run directly on the host's hardware (e.g., core 3310), or may run as a software layer on the host operating system 3376.

Memory 3370 may store data and code used by core 3310 and other cores (if any) in the processor. The data and code for a particular software component (e.g., FaaS, tenant, plug-in, web server, browser, etc.) may be included in a single compartment. Accordingly, memory 3370 can include a plurality of compartments 3372, each of which contains a respective software component's data and code (e.g., instructions). Two or more of the plurality of compartments can be invoked in the same process and can run in the same address space. Thus, for first and second compartments running in the same process, the data and code of the first compartment and the data and code of the second compartment can be co-located in the same process address space.

Memory 3370 may also store linear address paging structures (not shown) to enable the translation of linear addresses (or guest linear addresses and guest physical addresses) for memory access requests associated with compartments 3372 to physical addresses (or host physical addresses) in memory.

Core 3310 in hardware platform 3300 may be part of a single-core or multi-core processor of hardware platform 3300. Core 3310 represents a distinct processing unit and may, in some examples, be similar to cores 142A and 142B of FIG. 1. A software thread of a compartment can run on core 3310 at a given time. If core 3310 implements symmetric multithreading, one or more software threads of respective compartments in a process could be running (or could be idle) on core 3310 at any given time. Core 3310 includes fetch circuitry 3312 to fetch an instruction (e.g., from memory 3370). Core 3310 also includes decoder circuitry 3313 to decode an instruction and generate a decoded instruction. An example instruction to be fetched and decoded may be an instruction to request access to a block (or blocks) of memory 3370 storing a capability (e.g., a pointer) and/or an instruction to request access to a block (or blocks) of memory 3370 based on capability 3318 that indicates the storage location of the block (or blocks) of memory 3370. Execution circuitry 3316 can execute the decoded instruction.

In some capability-based addressing systems, an instruction utilizes a compartment descriptor 3375. A compartment descriptor for a compartment stores one or more capabilities and/or pointers associated with that compartment. Examples of items of information that the one or more capabilities and/or pointers for the compartment can identify include, but are not necessarily limited to, state information, data, and code corresponding to the compartment. In one or more examples, a compartment descriptor is identified by its own capability (e.g., 3319). Thus, the compartment descriptor can be protected by its own capability separate from the one or more capabilities stored in the compartment descriptor.

In some capability-based addressing systems, an instruction utilizes a capability 3319 including a memory address (or a portion thereof) and security metadata. In at least some examples, a capability may be a pointer with a memory address. In one or more examples, the memory address in the capability (or the pointer) may be a linear address (or guest linear address) to a memory location where a particular compartment descriptor 3375 is stored. In some examples, security metadata may be included in the capability. In other capability-based addressing systems that do not utilize compartment descriptors, the memory address in the capability may be a linear address (or guest linear address) to a particular capability register or to memory storing the capability.

The security metadata in a capability as will be further illustrated in FIG. 250B, can include, for example, one or more of permissions data, object type, or bound(s). In some embodiments of a capability-based addressing system configured with a multi-key memory encryption scheme, the security metadata stored in a capability may include a key identifier, group selector, or cryptographic key assigned to the compartment for the particular memory referenced by the capability.

In some examples, in response to receiving an instruction that is requested for fetch, decode, and/or execution, capability management circuitry 3317 checks whether the instruction is a capability-aware instruction (also referred to herein as a ‘capability instruction) or a capability-unaware instruction (also referred to herein as a ‘non-capability instruction’). If the instruction is a capability-aware instruction, then access is allowed to memory 3370 storing a capability 3374 (e.g., a capability in a global variable referencing a heap object). If the instruction is a capability-unaware instruction then access to memory 3370 is not allowed, where the memory is storing (i) a capability (e.g., in a compartment descriptor 3375) and/or (ii) state, data, and/or instructions (e.g., in a compartment 3372) protected by a capability.

The execution circuitry 3316 can determine whether an instruction is a capability instruction or a non-capability instruction based on (i) a field (e.g., an opcode or bit(s) of an opcode) of the instruction and/or (ii) the type of register (e.g., a whether the register is a capability register or another type of register that is not used to store capabilities).

In certain examples, capability management circuitry 3317 manages the capabilities, including setting and/or clearing validity tags of capabilities in memory and/or in register(s). A validity tag in a capability in a register can be cleared in response to the register being written by a non-capability instruction. In a capability-based addressing system that utilizes compartment descriptors, in at least some examples, the capability management circuitry 3317 does not permit access by capability instructions to individual capabilities within a compartment descriptor (except load and store instructions for loading and storing the capabilities themselves). A compartment descriptor 3375 may have a predetermined format with particular locations for capabilities. Thus, explicit validity tag bits may be unnecessary for capabilities in a compartment descriptor.

A capability 3318 can be loaded from memory 3370, or from a compartment descriptor 3375 in memory 3370, into a register of registers 3320. An instruction (e.g., microcode or micro-instruction) to load a capability may include an opcode (e.g., having a mnemonic of LoadCap) with a source operand indicating the address of the capability in memory or in the compartment descriptor in memory. A capability 3318 can also be stored from a register of registers 3320 into memory 3370, or into a compartment descriptor 3375 in memory 3370. An instruction (e.g., microcode or micro-instruction) to store a capability may include an opcode (e.g., having a mnemonic of LoadCap) with a destination operand indicating the address of the capability in memory, or in the compartment descriptor in memory.

In some examples, a capability with bounds may indicate a storage location for state, data, and/or code of a compartment. In some other examples, a capability with metadata and/or bounds can indicate a storage location for state, data, and/or code of a compartment.

In some examples, state, data, and/or code that are protected by a capability with bounds can be loaded from a compartment 3372 in memory 3370 into an appropriate register of registers 3320. An instruction (e.g., microcode or micro-instruction) to load state, data, and/or code that are protected by a capability with bounds may include an opcode (e.g., having a mnemonic of LoadData) with a source operand indicating the capability (e.g., in a register or in memory) with bounds for the state, data, and/or code to be loaded. In other examples, the state, data, and/or code to be loaded may be protected by a capability with metadata and/or bounds.

In some examples, state, data, and/or code that are protected by a capability with bounds can be stored from an appropriate register of registers 3320 into a compartment 3372 in memory 3370. An instruction (e.g., microcode or micro-instruction) to store state, data, and/or code that are protected by a capability with bounds may include an opcode (e.g., having a mnemonic of StoreData) with a destination operand indicating the capability (e.g., in a register or in memory) with bounds for the state, data, and/or code to be stored. In other examples, the state, data, and/or code to be stored may be protected by a capability with metadata and/or bounds.

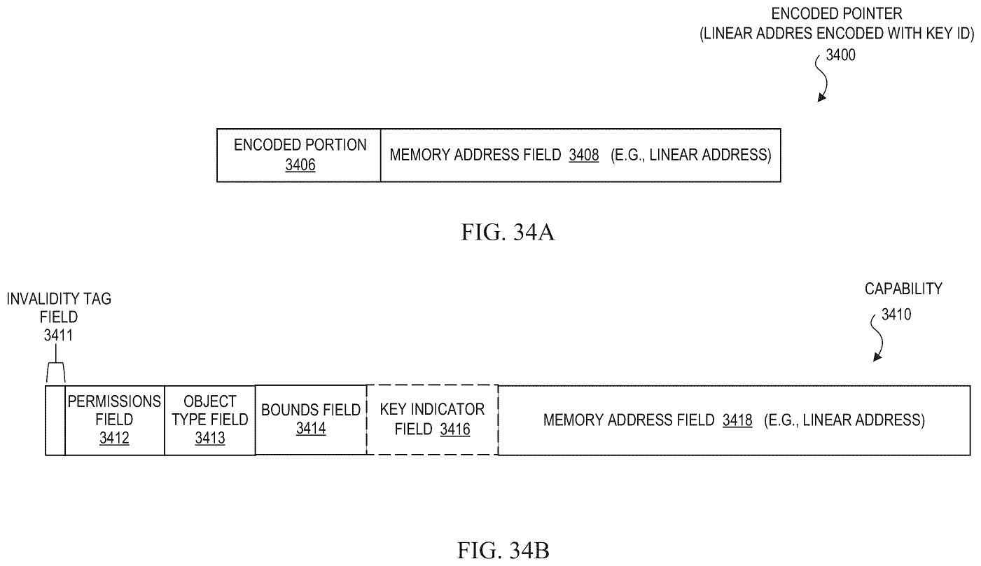

A capability instruction can be requested for execution during the execution of user code and/or privileged software (e.g., operating system or other privileged software). In certain examples, an instruction set architecture (ISA) includes one or more instructions for manipulating the capability field(s). Manipulating the capability fields of a capability can include, for example, setting the metadata and/or bound(s) of an object in memory in fields of a capability (e.g., further shown in FIG. 34B).

Capability management circuitry 3317 provides initial capabilities for of an application (e.g., user code) to be executed to the firmware, allowing data accesses and instruction fetches across the full address space. This may occur at boot time. Tags may also be cleared in memory. Further capabilities can then be derived (e.g., in accordance with a monotonicity property) as the capabilities are passed from firmware to boot loader, from boot loader to hypervisor, from hypervisor to the OS, and from the OS to the application. At each stage in the derivation chain, bounds and permissions may be restricted to further limit access. For example, the OS may assign capabilities for only a limited portion of the address space to the user code, preventing use of other portions of the address space. Capability management circuitry 3317 is configured to enable a capability-based OS, compiler, and runtime to implement memory safety and compartmentalization with a programming language, such as C and/or C++, for example.

One or more capabilities 3374 may be stored in memory 3370. In some examples, a capability may be stored in one or more cache lines in addressable memory, where the size of a cache line (e.g., 32 bytes, 64 bytes, etc.) depends on the particular architecture. Other data, such as compartments 3372, compartment descriptors 3375, etc., may be stored in other addressable memory regions. In some examples, tags (e.g., validity tags) may be stored in a data structure (not shown) in memory 3370 for capabilities 3374 stored in memory 3370. In other examples, the capabilities may be stored in the data structure with their corresponding tags. In further examples, capabilities may be stored in compartment descriptors 3375. For a given compartment, a capability (or pointer) may indicate (e.g., point to) a compartment descriptor containing other capabilities associated with the compartment.

In some examples, memory 3370 stores a stack 3371 and possibly a shadow stack 3373. A stack may be used to push (e.g., load) data onto the stack and/or to pop data (e.g., remove). Examples of a stack include, but are not necessarily limited to, a call stack, a data stack, or a call and data stack. In some examples, memory 3370 stores a shadow stack 3373, which may be separate from stack 3371. A shadow stack may store control information associated with an executing software component (e.g., a software thread).

Core 3310 includes one or more registers 3320. Registers 3320 may include a data capability register 3322, special purpose register(s) 3325, general purpose register(s) 3326, a thread-local storage capability register 3327, a shadow stack capability register 3328, a program counter capability (PCC) register 3334, an invoked data capability (IDC) register 3336, any single one of the aforementioned registers, any other suitable register(s) (e.g., HTKR and/or HTGR) or any suitable combination thereof. In addition, a data key register 3330 and code key register may also be provisioned to enable multi-key memory encryption in one or more embodiments.

The data capability register 3322 stores a capability (or pointer) that indicates corresponding data in memory 3370. The data can be protected by the data capability. The data capability may include security metadata and at least a portion of a memory address (e.g., linear address) of the data in memory 3370. In some scenarios, the data capability register 3322 may be used to store an encoded pointer for legacy software instructions that use pointers having a native width that is smaller than the width of the capabilities.

Special purpose register(s) 3325 can store values (e.g., data). In some examples, the special purpose register(s) 3325 are not protected by a capability, but may in some scenarios be used to store a capability. In some examples, special purpose register(s) 3325 include one or any combination of floating-point data registers, vector registers, two-dimensional matrix registers, etc.

General purpose register(s) 3326 can store values (e.g., data). In some examples, the general purpose register(s) 3326 are not protected by a capability, but may in some scenarios be used to store a capability. Nonlimiting examples of general purpose register(s) 3326 include registers RAX, RBX, RCX, RDX, RBP, RSI, RDI, RSP, and R8 through R15.

The thread-local storage capability register 3327 stores a capability that indicates thread-local storage in memory 3370. Thread-local storage (TLS) is a mechanism by which variables are allocated such that there is one instance of the variable per extant thread, e.g., using static or global memory local to a thread. The thread-local storage can be protected by the thread-local storage capability. The thread-local storage capability may include security metadata and at least a portion of a memory address (e.g., linear address) of the thread-local storage in memory 3370.

The shadow stack capability register 3328 stores a capability that indicates an element in the shadow stack 3373 in memory 3370. The shadow stack capability may include security metadata and at least a portion of a memory address (e.g., linear address) of the element in the shadow stack. The stack register capability register 3329 stores a capability that indicates an element in the stack 3371 in memory 3370. The stack capability may include security metadata and at least a portion of a memory address (e.g., linear address) of the element in the stack. The shadow stack element can be protected by the shadow stack capability, and the stack element can be protected by the stack capability.

The data key register 3330 can be used in one or more embodiments to enable multi-key memory encryption of data of a compartment by using hardware-thread specific register(s) in a capability-based addressing system. The data key register 3330 can store a key identifier, a cryptographic key, or mappings that includes a key ID, a group selector, and/or a cryptographic key, as will be further described herein (e.g., with reference to FIG. 34B). In some examples, the data key register 3330 may be general purpose register(s) 3326, a special purpose register(s) 3325, or one or more dedicated registers provisioned on the core (e.g., HTKR 156 or HTGR 158 of FIG. 1, etc.). In other embodiments, the data key register 3330 can store a capability (or pointers) to a key ID, cryptographic key, or mapping, which may be stored in memory 3370.

The code key register 3332 can be used in one or more embodiments to enable multi-key memory encryption of code of a compartment by using hardware-thread specific registers in a capability-based addressing system. The code key register 3332 can store a key identifier, a cryptographic key, or mappings that includes a key ID, a group selector, and/or a cryptographic key, as will be further described herein (e.g., with reference to FIG. 34B). In some examples, the code key register 3332 may be general purpose register(s) 3326, a special purpose register(s) 3325, or one or more dedicated registers provisioned on the core (e.g., HTKR 156 or HTGR 158 of FIG. 1, etc.). In other embodiments, the code key register 3332 can store a capability (or pointers) to a key ID, cryptographic key, or mapping, which may be stored in memory 3370.

The program counter capability (PCC) register 3334 stores a code capability that is manipulated to indicate the next instruction to be executed. Generally, a code capability indicates a block of code (e.g., block of instructions) of a compartment via a memory address (e.g., a linear address) of the code in memory. The code capability also includes security metadata that can be used to protect the code. The security metadata can include bounds for the code region, and potentially other metadata including, but necessarily limited to, a validity tag and permissions data. A code capability can be stored as a program counter capability in a program counter capability register 3334 and manipulated to point to each instruction in the block of code as the instructions are executed. The PCC is also referred to as the ‘program counter’ or ‘instruction pointer.’

The invoked data capability (IDC) register 3336 stores an unsealed data capability for the invoked (e.g., called) compartment. In at least some embodiments, a trusted stack may be used to maintain at least the caller compartment's program counter capability and invoked data capability.

In some examples, register(s) 3320 include register(s) dedicated only for capabilities (e.g., registers CAX, CBX, CCX, CDX, etc.). In some examples, register(s) 3320 include other register(s) to store non-capability pointers used by legacy software. Some legacy software may be programmed to use a particular bit size (e.g., 32 bits, 64 bits, etc.). In some examples, capability-based addressing systems are designed to use larger capabilities (e.g., 128 bits, or potentially more). If legacy software is to run on a capability-based addressing system using larger capabilities than the pointers in the legacy software, then other registers may be included in registers 3320 to avoid having to reprogram and recompile the legacy software. Thus, the legacy software can continue to use 64-bit pointers (or any other size pointers used by that legacy software). Capabilities associated with the legacy software, however, may be used to enforce coarse grain boundaries between different compartments, which may include one or more legacy software applications.

Memory controller circuitry 3350 may be similar to memory controller circuitry 148 of computing system 100 in FIG. 1 and/or to any variations or alternatives as described with reference to memory controller circuitry 148. In some examples, memory controller circuitry 3350 includes memory protection circuitry 3360 (e.g., similar to memory protection circuitry 160 of FIG. 1). The memory protection circuitry 3360 can include a key mapping table 3362 and a cryptographic algorithm 3364. The memory protection circuitry 3360 may be configured to provide multi-key memory encryption for data and/or code in memory. The memory protection circuitry 3360 can include a key mapping table (e.g., similar to key mapping table 162 of FIG. 1) and a cryptographic algorithm (e.g., similar to cryptographic algorithm 164 of FIG. 1).

As illustrated in FIG. 33, in at least some examples, a memory management unit (MMU) 3315 (e.g., similar to MMU 145A or 145B) is included in core 3310. In other examples, the MMU 3315 may be separate from the core and located, for example, in memory controller circuitry 3350. In other examples, all or a portion of memory controller circuitry 3350 may be incorporated into core 3310 (and in other cores in a multi-core processor).

Core 3310 is communicatively coupled to memory 3370 via memory controller circuitry 3350. Memory 3370 may be similar to memory 170 of computing system 100 in FIG. 1 and/or to any variations or alternatives as described with reference to memory 170. Memory 3370 may include hypervisor 3378 (e.g., similar to hypervisor 220 of FIG. 2) and an operating system (OS) 3376 (e.g., similar to operating system 120 of FIG. 1 and FIG. 2). In an implementation that is virtualized, the hypervisor 3378 may be omitted.

Optionally, compartment descriptors 3375 may be utilized in a capability-based addressing system, such as a computing system with hardware platform 3300. In some examples, compartment descriptors 3375 are stored in memory 3370. A compartment descriptor contains capabilities (e.g., security metadata and memory address) that point to one or more state elements (e.g., data, code, state information) stored in a corresponding compartment 3372. In some examples, core 3310 uses a compartmentalization architecture in which a compartment identifier (CID) is assigned to each compartment 3372. The CID value may be programmed into a specified register of a core, such as a control register. A CID may be embodied as a 16-bit identifier, although any number of bits may be used (e.g., 8 bits, 32 bits, 64 bits, etc.). In certain examples, the CID uniquely identifies a compartment 3372 per process. This allows compartments 3372 to be allocated in a single process address space of addressable memory 3370. In other examples, the CID uniquely identifies a compartment 3372 per core or per processor in a multi-core processor. In some examples, all accesses are tagged if compartmentalization is enabled and the tag for an access must match the current (e.g., active) compartment identifier programmed in the specified register in the core. For example, at least a portion of the tag must correspond to the CID value.

One or more compartments 3372 may be stored in memory 3370. Each compartment 3372 can include multiple items of information (e.g., state elements). State elements can include data, code (e.g., instructions), and state information. In some examples, each item of information (or state element) within a single compartment 3372, includes a respective capability (e.g., address and security metadata) to that stored information.

In capability-based addressing systems that utilize compartment descriptors, each compartment 3372 has a respective compartment descriptor 3375. A compartment descriptor 3375 for a single compartment stores one or more capabilities for a corresponding one or more items of information stored within that single compartment 3372. In some examples, each compartment descriptor 3375 is stored in memory and includes a capability 3374 (or pointer) to that compartment descriptor 3375.

During a process that includes multiple compartments, from time to time, execution of code in a first (e.g., active) compartment of the process may be switched to execution of code in a second compartment. Prior to switching, while the first compartment is active, registers 3320 in core 3310 may contain either state elements of the first compartment, or capabilities indicating the state elements of the first compartment. In addition, prior to switching, the state elements of the second compartment are stored in memory 3370, and capabilities that indicate any of those state elements are also stored in memory 3370. For capability-based addressing systems that utilize compartment descriptors, the capabilities indicating the state elements of the second compartment are stored in a compartment descriptor associated with the second compartment. If the first compartment represents legacy software, some registers 3320 may contain legacy pointers (e.g., smaller pointers than the capability-based addressing system) for accessing state elements of the legacy software.

In a capability-based addressing system, certain instructions load a capability, store a capability, and/or switch between capabilities (e.g., switch an active first capability to being inactive and switch an inactive second capability to being active) in the core 3310. In some examples, this may be performed via capability management circuitry 3317 using capability-based access control for enforcing memory safety. For example, core 3310 (e.g., fetch circuitry 3312, decoder circuitry 3313 and/or execution circuitry 3316) fetches, decodes, and executes a single instruction to (i) save capabilities that indicate various elements (e.g., including state elements) from registers 3320 (e.g., the content of any one or combination of registers 3320) into memory 3370 or into a compartment descriptor 3375 for a compartment 3372 and/or (ii) load capabilities that indicate various elements (e.g., including state elements) from memory or from a compartment descriptor 3375 associated with a compartment 3372 into registers 3320 (e.g., any one or combination of registers 3320).

In some examples, to switch from a currently active first compartment to a currently inactive second compartment, an instruction can be executed to invoke (e.g., activate) the second compartment. The instruction, when executed, loads the data capability for the data of the second compartment from a first register holding the data capability into an appropriate second register (e.g., invoked data capability (IDC) register 3336), and further loads the code capability for the code of the second compartment from a third register holding the code capability into an appropriate fourth register (e.g., program counter capability (PCC) register 3334). An instruction (e.g., microcode or micro-instruction) to load the data and code capabilities of the inactive second compartment to cause the second compartment to be activated may include an opcode (e.g., having a mnemonic of CInvoke) with a sealed data capability-register operand and a sealed code capability-register operand. The invoke compartment instruction can enter userspace domain-transition code indicated by the code capability, and can unscal the data capability. The instruction has jump-like semantics and performs a jump-like operation, which does not affect the stack. The instruction can be used again to exit the second compartment to go back to the first compartment or to switch to (e.g., invoke) a third compartment.

It should be noted that, as described above, if the operands of the invoke compartment instruction (e.g., CInvoke) are registers, then prior to executing the invoke compartment instruction, a load instruction (e.g., LoadCap) may be executed to load the data capability of the second compartment (e.g., for a private memory region of the second compartment) from memory 3370 into the first register to hold the data capability. Additionally, the load instruction (e.g., LoadCap) to load a code capability of the second compartment from memory 3370 into the third register to hold the code capability is also executed. In other implementations, the operands of the invoke compartment instruction may include memory addresses (e.g., pointers or capabilities) of the data and code capabilities in memory, to enable the data and code capabilities to be loaded from memory into the appropriate respective registers (e.g., IDC and PCC).

Alternative embodiments to effect a switch from a first compartment to a second compartment may use paired instructions that invoke an exception handler in the operating system. The exception handler may implement jump-like or call/return-like semantics. In one example, the exception handler depends on a selector value (e.g., a value that selects between call vs. jump semantics) passed as an instruction operand. A first instruction (e.g., microcode or micro-instruction) of a pair of instructions to switch to (e.g., call) a second compartment from a first compartment includes an opcode (e.g., having a mnemonic of CCall) with operands for a sealed data capability and a sealed code capability for the second compartment, which is being activated/called. A second instruction (e.g., microcode or micro-instruction) of the pair of instructions to switch back (e.g., return) from the second compartment to the first compartment may include an opcode (e.g., having a mnemonic of CReturn). When the CCall/CReturn exception handler implements call/return-like semantics, it may maintain a stack of code and data capability values that are pushed for each call (e.g., CCall) and popped and restored for each return (e.g., CReturn).

In capability-based addressing systems that use compartment descriptors, multiple capabilities for data and code of a compartment are collected into a single compartment descriptor, as previously described herein. In this example, the compartment switching instructions (e.g., CInvoke, CCall) may accept as an operand, a capability (or pointer) to a compartment descriptor. The compartment switching instructions may then retrieve the data and code capabilities from within the compartment descriptor indicated by the operand. For example, the invoke compartment instruction (e.g., CInvoke) and the call compartment instruction (e.g., CCall) may each accept a compartment descriptor as an operand, and the data and code capabilities of the compartment associated with the compartment descriptor can be retrieved from the compartment descriptor to perform the compartment switching operations. If a switching compartment instruction (e.g., CInvoke or CCall) uses register operands, then prior to the switching compartment instruction being executed, a load instruction (e.g., LoadCap) may be executed to load the compartment descriptor capability (or pointer) from memory into an appropriate register that can be used for the operand in the switching compartment instruction.

FIG. 34A illustrates an example format of an encoded pointer 3400 including an encoded portion 3406 and a memory address field 3408 according to at least one embodiment. In some examples, the encoded portion 3406 may include a key identifier (ID) or a group selector. The encoded pointer 3400A may be generated for data or code of a compartment running on a core (e.g., 3310) of a computing system. For example, capability 3400 may be generated to reference a compartment's data (including state information) or code.

In one or more embodiments, encoded pointer 3400 may be generated for legacy software written for a native architecture having native pointers that are smaller than capabilities used on that platform. For example, the encoded pointer 3400 generated for legacy software that was programmed for a 64-bit platform may be 64 bits wide, while 128-bit capabilities may be used on the same platform. It should be noted, however, that the concepts disclosed herein are applicable to any other bit sizes of capabilities and legacy pointers (e.g., 3400), but that the concepts are particularly advantageous when a width discrepancy exists such that encoded pointers of legacy software are smaller than capabilities that are generated on the same platform. In such scenarios, one or more embodiments herein protect the memory (e.g., using fine-grained multi-key encryption) in capability-based systems without requiring legacy software to be reprogrammed and recompiled for a new architecture size.

In the encoded pointer 3400, the encoded portion 3406 may include a multi-bit key ID, a single or multi-bit memory type, or a group selector. In at least one example, a key ID may be embedded in upper bits of the memory address (e.g., similar to key ID embedded in encoded pointer 1940 of FIG. 3). The key ID in the encoded portion 3406 may be assigned to a compartment for particular data or code to be encrypted and/or decrypted. The key ID in the encoded portion 3406 may be mapped to a cryptographic key (e.g., in a key mapping table 3342 as previously described for example with reference to key mapping tables 162 of FIG. 1 or 430 of FIG. 4, or to memory, or to other storage). A cryptographic algorithm may be used to encrypt/decrypt the data or code indicated by the linear address in the memory address field 3408. In some examples, the memory address field 3408 contains at least a portion of a linear address of the memory location of the data or code.

In another embodiment, the encoded portion 3406 includes a single or multi-bit memory type as previously described with reference to memory types 613 in FIG. 6 or 713 in FIG. 7. The memory type may indicate whether the contents of the memory referenced by the memory address private or shared. Based on the value, an appropriate hardware register may be selected to obtain a cryptographic key or to obtain a key ID to be used to obtain the cryptographic key (e.g., in a key mapping table 3342 in the core, or in memory, or in other storage).

In yet another embodiment, the encoded portion 3406 can include a group selector. Group selectors can enhance scalability and provide memory protection by limiting which key ID can be selected for the pointer and may be similar to other group selectors previously described herein (e.g., group selectors 715 in FIG. 7, or 812 in FIG. 8). In this embodiment, key IDs are selected by privileged software (e.g., operating system, hypervisor, etc.) and assigned to compartments and/or to the memory region to be accessed by the compartment (and other compartments if the memory region to be accessed is shared). During a compartment's memory access based on a pointer encoded with a group selector, the group selector can be translated to the appropriate key ID assigned, by the privileged software, to the compartment and/or to the memory region to be accessed.

As illustrated and described previously herein, the translation of group selectors to key IDs may be implemented in dedicated hardware registers (e.g., 158A, 158B, 312, 322, 332, 342, 420, 720, 820, 1520) or in other types of memory. Examples of other types of memory that may be used to store mappings of group selectors to key IDs includes, but are not limited to main memory, encrypted main memory, memory in a trusted execution environment, content-addressable memory of the processor, or remote storage. In one or more embodiments, the data key register(s) 3330 and code key register 3332, may be used as the dedicated hardware registers for storing mappings.

In further embodiments, implicit policies may be used to determine which key ID is to be selected from one or more key IDs that have been assigned to a compartment by privileged software. Examples of implicit policies have been previously described herein at least with reference to FIGS. 15-16. Furthermore, a combination of implicit policies and group selectors may be used as previously described herein.

FIG. 34B illustrates an example format of a capability 3410 for a computing system having a capability-based addressing system, such as hardware platform 3300. A capability may have different formats and/or fields depending on the particular architecture and implementation. In some examples, a capability is twice the width (or greater than twice the width) of a native (e.g., integer) pointer type of the baseline architecture, for example, 128-bit or 129-bit capabilities on 64-bit platforms, and 64-bit or 65-bit capabilities on 32-bit platforms. It should be appreciated that capability 3410 may be any size to accommodate the fields in capability 3410. In some examples, each capability includes an (e.g., integer) address of the natural size for the architecture (e.g., 32 or 64 bit) and additional metadata in the remaining (e.g., 32 or 64) bits of the capability. In some examples, the additional metadata may be compressed in order to fit in the remaining bits and/or, a certain number of (e.g., unused) upper bits of the address may be used for some of the metadata.

Accordingly, in some examples, capability 3410 may be twice the width (or some other multiple greater than 1.0) of the baseline architecture. For example, capability 3410 may be 128 bits on a 64-bit architecture. The example format of capability 3410 in FIG. 34B includes a validity tag field 3411, a permissions field 3412, an object type field 3413, a bounds field 3414, a key indicator field 3416, and a memory address field 3418 according to at least one embodiment. Other formats of a capability may include any one or more of the metadata fields shown in capability 3410 and/or other metadata not illustrated. In some examples, each item of metadata in the capability 3410 contributes to the protection model and is enforced by hardware (e.g., capability management circuitry 3317).

Capability 3410 may be generated for data or code of a compartment running on a core (e.g., 3310) of a computing system. For example, capability 3410 may be generated to reference a compartment's code or data (e.g., including state information). In some examples, the memory address field 3418 in capability 3410 includes a linear address or a portion of the linear address of the memory location of the capability-protected data or code.

A validity tag may be associated with each capability and stored in validity tag field 3411 in capability 3410 to allow the validity of the capability to be tracked. For example, if the invalidity tag indicates that the tag capability is invalid, then the capability cannot be used for memory access operations (e.g., load, store, instruction fetch, etc.). The validity tag can be used to provide integrity protection of the capability 3410. In some examples, capability-aware instructions can maintain the invalidity tag in the capability.

In at least some examples, an object type can be stored in the object type field 3413 in capability 3410 to ensure that corresponding data and code capabilities for the object are used together correctly. For example, a data region may be given a ‘type’ such that the data region can only be accessed by code having the same type. An object type may be specified in the object type field 3413 as a numeric identifier (ID). The numeric ID may identify an object type defined in a high-level programming language (e.g., C++, Python, etc.). Instructions for switching compartments compare the object types specified in code and data capabilities to check that code is operating on the correct type of data. The object type may further be used to ‘seal’ the capability based on the value of the object type. If the object type is determined to not be equal to a certain value (e.g., −1, or potentially another designated value), then the capability is sealed with the object type and therefore, cannot be modified or dereferenced. However, if the object type is determined to equal the certain value (e.g., −1 or potentially another designated value), then the capability is not sealed with an object type. In this scenario, the data that is referenced by the capability can be used by any code that possesses the capability, rather than being restricted to code capabilities that are sealed with a matching object type.

Permissions information in the permissions field 3412 in capability 3410 can control memory accesses using the capability (or using an encoded pointer 3400 of legacy software to the same memory address) by limiting load and/or store operations of data or by limiting instruction fetch operations of code. Permissions can include, but are not necessarily limited to, permitting execution of fetch instructions, loading data, storing data, loading capabilities, storing capabilities, and/or accessing exception registers.

Bounds information may be stored in the bounds field 3414 to identify a lower bound and/or an upper bound of the portion of the address space to which the capability authorizes memory access by the capability (or by an encoded pointer 3400 of legacy software to the same memory address). The bounds information can limit access to the particular address range within the bounds specified in the bounds field 3414.

When legacy software is executed in a capability-based system and uses encoded pointers having a native width that is smaller (e.g., 64-bit or smaller) than the width of capabilities generated by the system, the capabilities can have features that provide memory safety benefits to the legacy software. For example, a larger capability (e.g., 64-bit, 128-bit or larger) may be used to specify the code and data regions to set overall coarse-grained bounds and permissions for the accesses with the smaller (e.g., 64-bit) encoded pointers. In addition, in some examples, the encoded portion (e.g., 3406) of a legacy software pointer (e.g., 3400) may include a group selector mapped to a key ID in the appropriate register (e.g., data key register 3330 and/or code key register 3332), or a memory type (e.g., memory type 613 of FIG. 6, 713 of FIG. 7) indicating which register should be accessed based on whether the memory to be accessed holds data or code for the compartment. In another embodiment, implicit policies as previously described herein (e.g., FIGS. 14-16) may be used to determine which register contains the correct key ID or cryptographic key for a particular memory access.

In some examples, when capabilities are generated for legacy software that uses pointers having a smaller native width than the width of the capabilities, a key indicator field 3416 in a capability 3410 may be used to populate appropriate registers (e.g., data key register 3330 and/or code key register 3332) used during the execution of the legacy software. The registers to be populated can be accessed during the legacy software memory accesses to enable cryptographic operations on data or code. The registers may be similar to specialized hardware thread registers previously described herein (e.g., HTKRs 156, HTGRs 158). It should be noted that populating selected registers based on a key field in a capability may be performed if the legacy software pointers are encoded with group selectors (e.g., group selectors 715 in FIG. 7, 812 in FIG. 8) or memory type (e.g., memory type 613 of FIG. 6, 713 of FIG. 7). If legacy software pointers are encoded with a key ID, however, the registers may not be used for storing key IDs, group selector mappings, or cryptographic keys. This is because during a memory access operation, the key ID can be obtained from the encoded pointer used in the memory access request. The key ID obtained from the encoded pointer can be used to search a key mapping table (or memory or other storage) to identify a cryptographic key to be used in cryptographic operations performed on the data or code associated with the memory access operation.

In embodiments where pointers of legacy software are to be encoded with a group selector or memory type rather than a key ID, the use of a key indicator field 3416 of a capability 3410 for data or code of the legacy software compartment can be configured in several possible ways. In one embodiment, a key ID may be stored in a key indicator field 3416 of a capability 3410 for data or code of the legacy software compartment. The key ID can be obtained from the key indicator field 3416 of the capability 3410 and used to populate the appropriate register (e.g., data key register 3330 or code key register 3332) depending on the type of memory indicated (pointed to) by the capability 3410.

In another embodiment, an indication (e.g., indirect reference such as an address or pointer) to a key ID may be stored in a key indicator field 3416 of a capability 3410 for data or code of a legacy software compartment. The key ID can be retrieved from memory referenced by the pointer or capability in the key indicator field 3416. The retrieved key ID can be used to populate the appropriate register (e.g., data key register 3330 or code key register 3332) depending on the type of memory indicated (pointed to) by the capability 3410.

In another embodiment, a cryptographic key may be stored in a key indicator field 3416 of a capability 3410 for data or code of the legacy software compartment. The cryptographic key can be obtained from the key indicator field 3416 of the capability 3410 and used to populate the appropriate register (e.g., data key register 3330 or code key register 3332) depending on the type of memory indicated (pointed to) by the capability 3410.

In another embodiment, an indication (e.g., indirect reference such as an address or pointer) to a cryptographic key may be stored in a key indicator field 3416 of a capability 3410 for data or code of a legacy software compartment. The cryptographic key can be retrieved from memory referenced by the pointer or capability in the key indicator field 3416. The retrieved cryptographic key can be used to populate the appropriate register (e.g., data key register 3330 or code key register 3332) depending on the type of memory indicated (pointed to) by the capability 3410.

When key IDs or cryptographic keys are stored in registers for a legacy software compartment, then during memory accesses, the registers may be accessed based on the particular encoding in the legacy software pointer used in the memory access. For example, a respective group selector may be mapped to a key ID or cryptographic key in one or more registers. In addition, one group selector for the code of the legacy software compartment may be embedded in a legacy software pointer for the code, and a different group selector for the data of the legacy software compartment may be embedded in a legacy software pointer for the data. Similar to other group selectors previously described herein (e.g., group selectors 715 in FIG. 7, 812 in FIG. 8), the group selectors embedded in the legacy software pointers can be used to identify the correct key ID or cryptographic key stored in a register that is to be used for a given memory access by the legacy software. In addition, other registers may contain group selectors mapped to shared key IDs (or shared cryptographic keys) for shared memory regions, or any other memory region (e.g., kernel memory, I/O memory, etc.) that is encrypted using a different cryptographic key, or using a different cryptographic key and key ID if key IDs are used.

In another example, the legacy software pointer may be encoded with a memory type to indicate which register is to be used during a memory access to obtain a key ID or cryptographic key. For example, the memory type (e.g., single bit) may indicate whether the memory is data or code. In this scenario, the data could be encrypted using one cryptographic key and the code could be encrypted using a different cryptographic key. Other variations may be possible including two or more bits to indicate different registers for other key IDs or cryptographic keys to be used for different types of memory (e.g., shared memory, I/O memory, etc.), as previously described herein (e.g., memory type 613 of FIG. 6, 713 of FIG. 7).

In other embodiments, key IDs or indications of key IDs may not necessarily be embedded in capabilities. For example, in some embodiments, key IDs may be embedded directly in the smaller (e.g., 64-bit) pointers (e.g., 3400A) of legacy software that are used to access data and code, as illustrated by encoded pointer 3400 of FIG. 34A. In this scenario, registers are not used to hold key IDs or group selector-to-key ID mappings since the key IDs are embedded in the encoded pointers. Thus, the key indicator field (e.g., 3416) may be omitted from the capabilities such that neither key IDs nor indications to key IDs are stored in the capabilities.

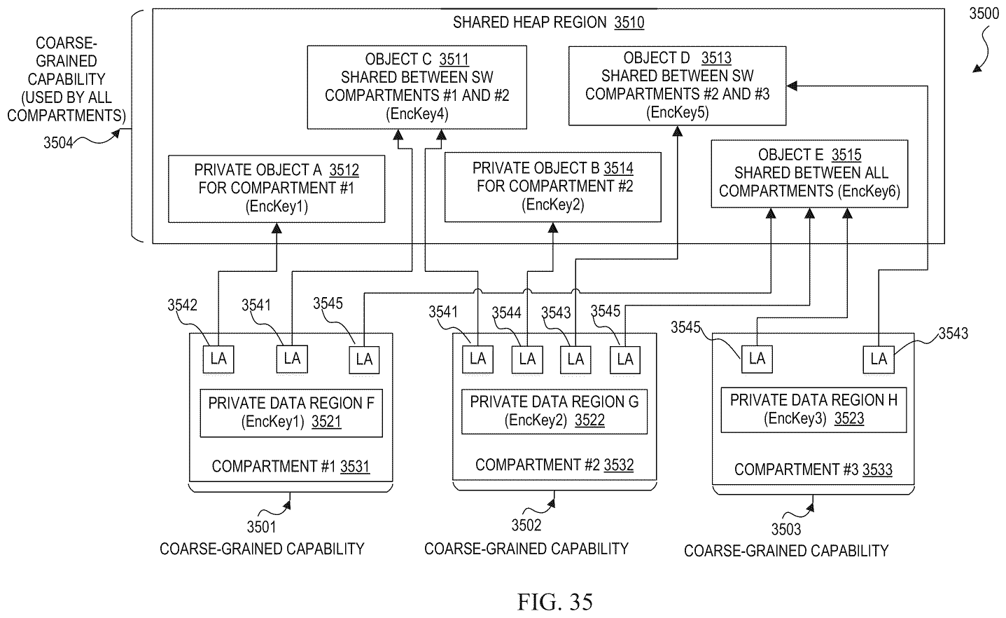

FIG. 35 is a block diagram illustrating an address space 3500 in memory of an example process instantiated from legacy software and running on a computing system with a capability mechanism and a multi-key memory encryption scheme according to at least one embodiment. In the process, compartment #1 3531, compartment #2 3532, and compartment #3 3533 compose a single process and use the same process address space. The compartments may be scheduled to run on different hardware threads. The hardware threads may be supported on one, two, or three cores.

The address space of the example process includes a shared heap region 3510, which is used by all compartments in the process. A coarse-grained capability 3504 for the shared heap region 3510 may be used by all compartments of the process to define the overall bounds for the shared heap region 3510 and permissions for accessing the shared heap region 3510. In addition, per-thread coarse-grained capabilities may be generated for each compartment. For example, a coarse-grained capability 3501 may be generated for compartment #1 3531, a coarse-grained capability 3502 may be generated for compartment #2 3532, and a coarse-grained capability 3503 may be generated for compartment #3 3533.

In the example shared heap region 3510, object C 3511 is shared between compartment #1 and #2, and is encrypted/decrypted by a cryptographic key designated as EncKe28. In shared heap region 3510, object D 3513 is shared between compartments #2 and #3 and is encrypted/decrypted by a cryptographic key designated as EncKe29. In shared heap region 3510, object E 3515 is shared among all compartments and is encrypted/decrypted by a cryptographic key designated as EncKe30. In this example, private objects are also allocated for compartments #1 and #2. Private object A 3512 is allocated to compartment #1 and is encrypted/decrypted by a cryptographic key designated as EncKey1. Private object B 3514 is allocated to compartment #2 and is encrypted/decrypted by a cryptographic key designated as EncKe26.

In addition, each of the compartments #1, #2, and #3 may also access private data that is not in shared heap region 3510. For example, the compartments may access global data that is associated, respectively, with the executable images for each of the compartments. In this scenario, a private data region F 3521 belongs to compartment #1 3531 and is encrypted/decrypted by EncKey1. Private data region G 3522 belongs to compartment #2 3532 and is encrypted/decrypted by EncKey2. Private data region H 3523 belongs to compartment #3 3533 and is encrypted/decrypted by EncKey3.

Each of the cryptographic keys may be mapped to a key ID (e.g., in a key mapping table 3342 in memory controller circuitry 3350 or other suitable storage), which can be used to identify and retrieve the cryptographic key for cryptographic operations.

The coarse-grained capability 3504 can be used to enforce coarse-grained boundaries between the process address space (e.g., 3510) of the process including compartments #1, #2, and #3 and other process address spaces that include other processes. Capabilities 3501, 3502, and 3503 can be used to enforce coarse-grained boundaries between compartments #1. #2, and #3. Within each compartment, cryptography using cryptographic keys can be used to enforce object granular access control to enhance memory safety. For example, controlling which objects can be shared across which compartments can be achieved. In addition, buffer overflows and use after free memory safety issues can be mitigated.

In this example, private linear address 3542 is generated for compartment #1 to access private object A 3512, and private linear address 3544 is generated for compartment #2 to access private object B 3514. Other LAs are generated for shared objects and may be used by compartments authorized to access those shared objects. Shared linear address 3541 is generated for compartments #1 and #2 to access shared object C 3511. Shared linear address 3543 is generated for compartments #2 and #3 to access shared object D 3513. Shared linear address 3545 is generated for all compartments #1. #2 and #3 to access shared object E 3515. In one or more embodiments, the LAs 3541-3545 may be configured as encoded pointers (e.g., linear addresses encoded with a key ID or a group selector) as shown and described with reference to FIG. 250A. It should be appreciated, however, that numerous variations of an encoded pointer may be suitable to implement the broad concepts of this disclosure. For example, additional metadata may be embedded in the pointer and/or one or more portions of the pointer may be encrypted. Additionally, for processes instantiated based software that uses the same pointer width as the baseline architecture, the LAs 3541-3545 may be configured as capabilities shown and described with reference to FIG. 34B.

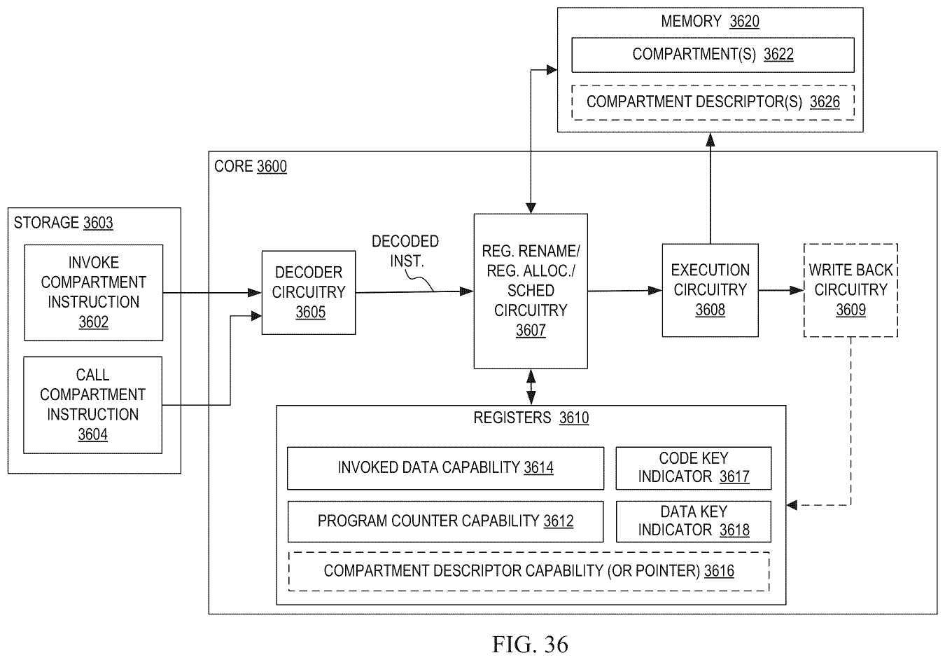

FIG. 36 illustrates an example of computing hardware to process an invoke compartment instruction or a call compartment instruction 3604 supporting multi-key memory encryption according to at least one embodiment. FIG. 36 illustrates an example core 3600 of a processor configured to process one or more invoke compartment instructions or one or more call compartment instructions 3604. As illustrated, storage 3603 can store an invoke compartment instruction 3602 and/or a call compartment instruction 3604. Storage 3603 represents any possible storage location from which a CPU can fetch instructions such as main memory, cache, etc.

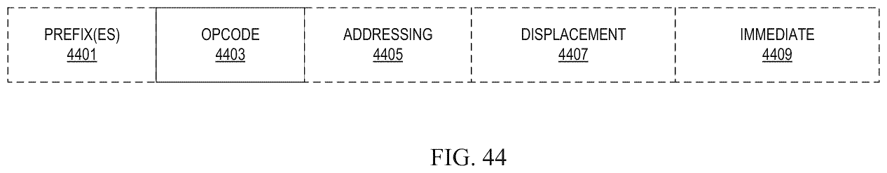

With reference to the invoke compartment instruction 3602 (e.g., CInvoke mnemonic), the instruction 3602 is received by decoder circuitry 3605. For example, the decoder circuitry 3605 receives this instruction from fetch circuitry (not shown). The invoke compartment instruction 3602 may be in any suitable format, such as that described with reference to FIG. 44 below. In an example, the instruction includes fields for an opcode, a first operand identifying a code capability and a second operand identifying a data capability. In some examples, the first and second operands are registers containing the capabilities. In other examples, the first and second operands are one or more memory locations of the capabilities. In some examples, one or more of the operands may be an immediate operand with the capabilities. In some examples, the opcode details the invocation of (e.g., switch to, jump to, or calling of) a target compartment to be performed. The invocation of a target compartment (e.g., compartment to be switched to, jumped to, or called) includes switching from a current active compartment to the target compartment.

More detailed examples of at least one instruction format for the instruction are further detailed herein. The decoder circuitry 3605 decodes the instruction 3602 into one or more operations. In some examples, this decoding includes generating a plurality of micro-operations to be performed by execution circuitry (such as execution circuitry 3608). The decoder circuitry 3605 also decodes instruction prefixes, if any.

In some examples, register renaming, register allocation, and/or scheduling circuitry 3607 provides functionality for one or more of: 1) renaming logical operand values to physical operand values (e.g., a register alias table in some examples), 2) allocating status bits and flags to the decoded instruction, and 3) scheduling the decoded instruction for execution by execution circuitry 3608 out of an instruction pool (e.g., using a reservation station in some examples).

Registers (register file) 3610 and/or memory 3620 store data as operands of the instruction to be executed by execution circuitry 3608. Memory 3620 stores compartments 3622, which include the target compartment (e.g., data, code, and state information of the target compartment) and the currently active compartment (e.g., data, code, and state information of the currently active or compartment) associated with the invoke compartment instruction 3602. The currently active compartment is the compartment that is invoking (e.g., switching to, jumping to, calling) the target compartment.

Registers 3610 store a variety of capabilities (or pointers) or data to be used with the invoke compartment instruction 3602. Example register types include packed data registers, general purpose registers (GPRs), floating-point registers, special purpose registers, capability registers (e.g., data capability registers, code capability registers, thread local storage capability registers, shadow stack capability registers, stack capability registers, descriptor capability registers).

For example, registers 3610 can store an invoked data capability 3614, a program counter capability 3612, code key information 3617, and data key information 3618. The invoked data capability 3614 represents a capability for data of the target compartment. The program counter capability 3612 represents the next instruction to be executed in the code of the target compartment. The code key information 3617 and data key information 3618 can vary depending on the particular embodiment. Examples of possible code and data key information includes (but are not necessarily limited to) key identifiers, cryptographic keys, or mappings that include a key ID, a group selector, and/or a cryptographic key.

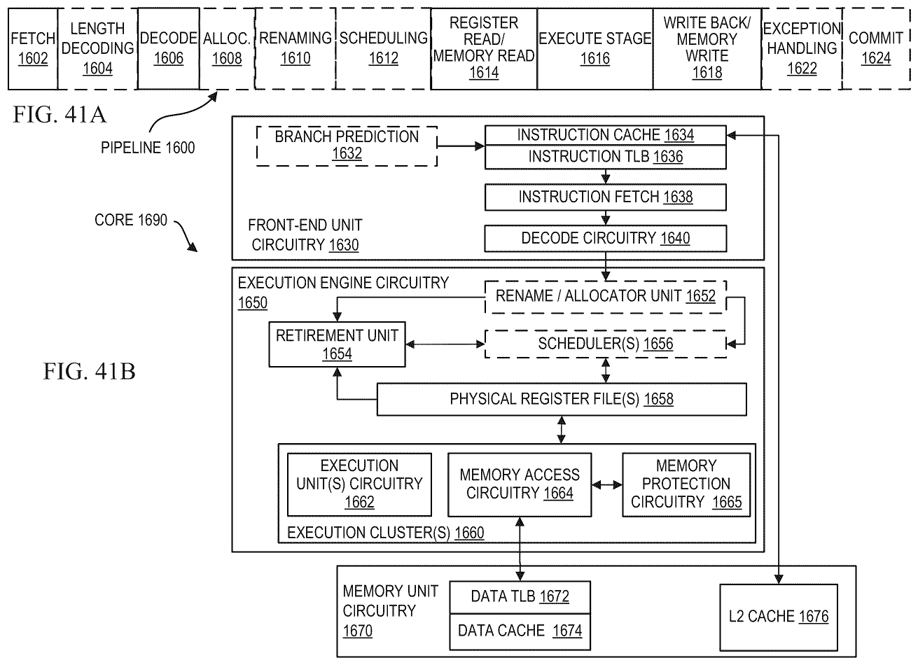

Execution circuitry 3608 executes the decoded instruction. Example detailed execution circuitry includes execution circuitry 3316 shown in FIG. 33, and execution cluster(s) 4160 shown in FIG. 41B, etc. The execution of the decoded instruction causes the execution circuitry to invoke (or switch/jump to) a target compartment.

In some examples, retirement/write back circuitry 3609 architecturally commits the registers (e.g., containing the capabilities or pointers to data and code in the target compartment) into the registers 3610 and/or memory 3620 and retires the instruction.

An example of a format for an invoke compartment instruction is:
CInvoke cs, cb

In some examples, CInvoke is the opcode mnemonic of the instruction. CInvoke is used to jump between compartments using sealed code and sealed data capabilities of a target compartment. In some examples, CInvoke indicates that the execution circuitry is to check to determine whether the specified data and code capabilities are accessible, valid, and sealed, and whether the specified capabilities have matching types and suitable permissions and bounds. CInvoke indicates that the execution circuitry is to unseal the specified data and code capabilities, initialize an invoked data capability register with the unsealed data capability, update a data key register with data key information (e.g., key ID or cryptographic key) embedded in the specified data capability or referenced indirectly by the specified data capability, initialize a program counter capability register with the unscaled code capability, and update a code key register with code key information indicator (e.g., key ID or cryptographic key, etc.) embedded in the specified code capability or referenced indirectly by the specified code capability. In certain examples, one or both of the cs and cb operands are capability registers of registers 3610.

The cs is a field for a first (e.g., code) source operand, such as an operand that identifies code in the target compartment, e.g., where cs is (i) a memory address storing a code pointer or code capability to a code block in the target compartment, (ii) a register storing a code pointer or code capability to a code block in the target compartment, or (iii) a memory address of a code block in the target compartment. The code pointer or code capability may reference the first instruction in the code block that is to be executed.

The cb is a field for a second (e.g., data) source operand, such as an operand that identifies the data in the target compartment, e.g., where cb is (i) a memory address storing a data pointer or data capability to a memory region of data within the target compartment, (ii) a register storing a data pointer or data capability to the memory region of data within the target compartment, or (iii) a memory address of a memory region of data within the target compartment.

With reference to the call compartment instruction 3604 (e.g., CCall mnemonic), the instruction 3604 is received by decoder circuitry 3605. For example, the decoder circuitry 3605 receives this instruction from fetch circuitry (not shown). The call compartment instruction 3604 may be in any suitable format, such as that described with reference to FIG. 44 below. In an example, the instruction includes fields for an opcode, a first (e.g., code) source operand identifying a code capability and a second (e.g., data) source operand identifying a data capability. In some examples, the first and second source operands are registers containing the capabilities. In other examples, the first and second source operands are one or more memory locations of the capabilities. In some examples, one or more of the source operands may be an immediate operand with the capabilities. In some examples, the opcode details the call to (or switch to) a target compartment to be performed. The call to a target compartment includes saving state of the current active compartment (to enable a return instruction) and switching from the current active compartment to the target compartment.

More detailed examples of at least one instruction format for the instruction are further detailed herein. The decoder circuitry 3605 decodes the instruction 3604 into one or more operations. In some examples, this decoding includes generating a plurality of micro-operations to be performed by execution circuitry (such as execution circuitry 3608). The decoder circuitry 3605 also decodes instruction prefixes, if any.

In some examples, register renaming, register allocation, and/or scheduling circuitry 3607 provides functionality for one or more of: 1) renaming logical operand values to physical operand values (e.g., a register alias table in some examples), 2) allocating status bits and flags to the decoded instruction, and 3) scheduling the decoded instruction for execution by execution circuitry 3608 out of an instruction pool (e.g., using a reservation station in some examples).

Registers (register file) 3610 and/or memory 3620 store data as operands of the instruction to be executed by execution circuitry 3608. Memory 3620 stores compartments 3622, which include the target compartment (e.g., data, code, and state information of the target compartment) and the source compartment (e.g., data, code, and state information of the source compartment) associated with the call compartment instruction 3604.

Registers 3610 store a variety of capabilities (or pointers) or data to be used with the call compartment instruction 3604. Example register types include packed data registers, general purpose registers (GPRs), floating-point registers, special purpose registers, capability registers (e.g., data capability registers, code capability registers, thread local storage capability registers, shadow stack capability registers, stack capability registers, descriptor capability registers).

For example, registers 3610 can store an invoked data capability 3614, a program counter capability 3612, code key information 3617, and data key information 3618. The invoked data capability 3614 represents a capability for data of the target compartment. The program counter capability 3612 represents the next instruction to be executed in the code of the target compartment. The code key information 3617 and data key information 3618 can vary depending on the particular embodiment. Examples of possible code and data key information includes (but are not necessarily limited to) key identifiers, cryptographic keys, or mappings that include a key ID, a group selector, and/or a cryptographic key.

Execution circuitry 3608 executes the decoded instruction. Example detailed execution circuitry includes execution circuitry 3316 shown in FIG. 33, and execution cluster(s) 4160 shown in FIG. 41B, etc. The execution of the decoded instruction causes the execution circuitry to invoke (or switch/jump to) a target compartment.

In some examples, retirement/write back circuitry 3609 architecturally commits the registers (e.g., containing the capabilities or pointers to data and code in the target compartment) into the registers 3610 and/or memory 3608 and retires the instruction.

An example of a format for an invoke compartment instruction is:
CCall cs, cb

In some examples, CCall is the opcode mnemonic of the instruction. CCall is used to switch between compartments using sealed code and sealed data capabilities of a target compartment. In some examples, CCall indicates that the execution circuitry is to check to determine whether the specified data and code capabilities are accessible, valid, and sealed, and whether the specified capabilities have matching types and suitable permissions and bounds. CCall indicates that the execution circuitry is to save current register values (e.g., PCC and IDC) in a trusted stack, unseal the specified code capability and store in the program counter capability register, unseal the specified data capability and store in the invoked data capability, update a data key register with data key information (e.g., key ID or cryptographic key) embedded in the specified data capability or referenced indirectly by the specified data capability, and update a code key register with code key information indicator (e.g., key ID or cryptographic key, etc.) embedded in the specified code capability or referenced indirectly by the specified code capability. In certain examples, one or both of the cs and cb operands are capability registers of registers 3610.

In one example, CCall causes a software trap (e.g., exception), and the exception handler can implement jump-like or call/return-like semantics, possibly depending on a selector value passed as an instruction operand in addition to cs and cb. When the CCall (and corresponding CReturn) exception handler implements call/ret-like semantics, the exception handler may maintain the trusted stack of code and data capability values that are pushed for each CCall and popped and restored for each CReturn.

The cs is a field for a first (e.g., code) source operand, such as an operand that identifies code in the target compartment, e.g., where es is (i) a memory address storing a code pointer or code capability to a code block in the target compartment, (ii) a register storing a code pointer or code capability to a code block in the target compartment, or (iii) a memory address of a code block in the target compartment. The code pointer or code capability may reference the first instruction in the code block that is to be executed.

The cb is a field for a second (e.g., data) source operand, such as an operand that identifies the data in the target compartment, e.g., where cb is (i) a memory address storing a data pointer or data capability to a memory region of data within the target compartment, (ii) a register storing a data pointer or data capability to the memory region of data within the target compartment, or (iii) a memory address of a memory region of data within the target compartment.

In embodiments that utilize compartment descriptors, memory 3620 stores compartment descriptors 3626, and registers 3610 hold compartment descriptor capabilities 3616 to the compartment descriptors 3626. In addition, the invoke compartment instruction 3602 and/or the call compartment instruction 3604 may be modified to accept a compartment descriptor as a source operand (e.g., src). The source operand that identifies a compartment descriptor can be (i) a memory address storing a pointer or capability to a target compartment descriptor, (ii) a register storing a pointer or capability to the target compartment descriptor, or (iii) a memory address of the target (e.g., called/switched to/jumped to) compartment. The instructions 3602 and 3604 can retrieve the capabilities for data and code from within the descriptor. The data and code capabilities can be used to update the appropriate registers (e.g., IDC register 3336 and PCC register 3334) with an invoked data capability 3614 and program counter capability 3612, respectively. In some scenarios, a bitmap may be embedded in each descriptor to indicate which registers are to be loaded.

In some examples that utilize compartment descriptors, the call compartment instruction 3604 can accept another compartment descriptor as a destination operand (e.g., dest). The destination operand identifies the compartment descriptor of the currently active compartment (e.g., where dest is (i) a memory address storing a pointer or capability to the compartment descriptor of the currently active compartment, (ii) a register storing a pointer or capability to the compartment descriptor of the currently active compartment, or (iii) a memory address of the compartment descriptor of the currently active compartment). The mnemonic for the call compartment instruction that utilizes compartment descriptors (e.g., SwitchCompartment) indicates the execution circuitry is to cause a save of the current register values into the compartment descriptor referenced by the destination operand, clear (e.g., zero out) the saved registers to avoid disclosing their contents to the target compartment, and load new register values from the compartment descriptor referenced by the source operand (e.g., and check a bitmap embedded within that descriptor to determine which registers from the target compartment to load). In certain examples, one or both of the sre or dest operands are capability registers. In certain examples, either the src or dest operand may be specified as a null value, e.g., 0, which will cause instruction to skip accesses to the missing compartment descriptor.

As previously described herein with reference to compartment descriptors (e.g., 3375), the descriptor may include at least a code capability that indicates (e.g., points to) code stored in the compartment and a data capability that indicates (e.g., points to) a data region that the compartment is allowed to access. In one example the data region indicated by the data capability in the descriptor may be a private or shared data region that the compartment is allowed to access. In another example, multiple additional capabilities are included in the compartment descriptor for different types of data in other data regions that the compartment is allowed to access. For example, a compartment descriptor can include any one or a combination of a private data region capability, one or more shared data region capabilities, one or more shared libraries capabilities, one or more shared pages capabilities, one or more kernel memory capabilities, one or more shared I/O capabilities, a shadow stack capability, a stack capability, a thread-local storage capability.

In certain examples of an invoke compartment instruction and a call compartment instruction, a current active compartment is a first function (e.g., as a service in a cloud) and the target compartment is a second function (e.g., as a service in the cloud), e.g., where both compartments are part of the same process and use the same process address space.

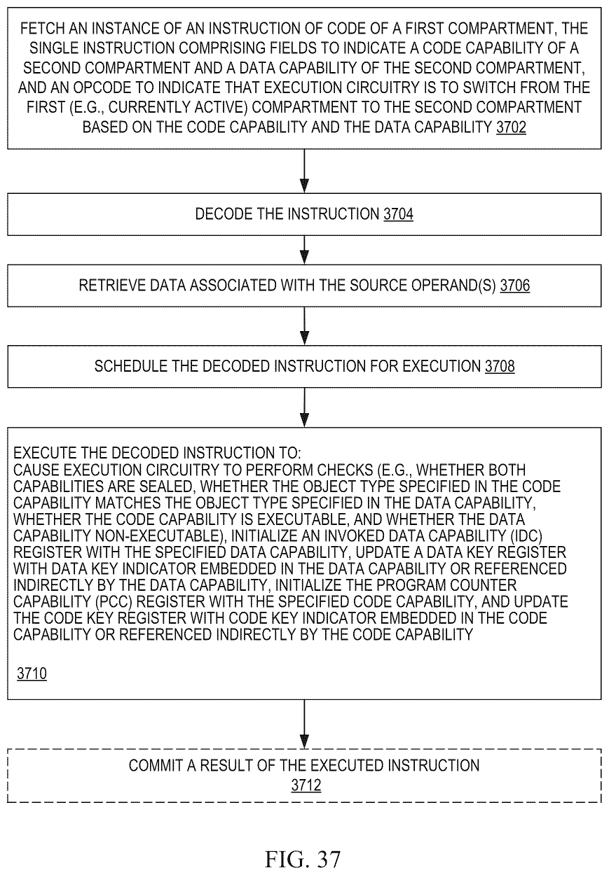

FIG. 37 illustrates operations of a method of processing an invoke compartment instruction according to at least one embodiment. For example, a processor core (e.g., as shown in FIGS. 33, 36, and/or 41B), a pipeline as detailed below, etc., performs this method.

At 3702, an instance of single instruction is fetched. For example, an invoke compartment instruction is fetched. The instruction includes fields for an opcode (e.g., mnemonic CInvoke), a first source operand (e.g., cs) identifying a code capability, and a second source operand (e.g., cb) identifying a data capability. In some examples, the instruction further includes a field for a writemask. In some examples, the instruction is fetched from an instruction cache. The opcode indicates that the execution circuitry is to perform a switch from a first (currently active) compartment to a second compartment based on the code and data capabilities identified by the first and second source operands, respectively.

The fetched instruction is decoded at 3704. For example, the fetched CInvoke instruction is decoded by decoder circuitry such as decode circuitry 4140 detailed herein.

Data values associated with the source operands of the decoded instruction are retrieved at 3706. In at least some scenarios, the data values are retrieved when the decoded instruction is scheduled at 3708. For example, when one or more of the source operands are memory operands, the data from the indicated memory location is retrieved.

At 3710, the decoded instruction is executed by execution circuitry (hardware) such as execution circuitry 3316 shown in FIG. 33, execution circuitry 3608 shown in FIG. 36, or execution cluster(s) 4160 shown in FIG. 41B. For the CInvoke instruction, the execution is to cause execution circuitry to perform the operations described in connection with FIGS. 33 and 36. In various examples, execution of the CInvoke instruction is to include performing checks on the instruction, initializing an invoked data capability (IDC) register with the specified data capability in the second operand, updating a data key register with a data key indicator embedded in the data capability or referenced indirectly by the data capability, initializing a program counter capability (PCC) register with the specified code capability, and updating the code key register with a code key indicator embedded in the code capability or referenced indirectly by the code capability.

The method of processing an invoke compartment instruction in FIG. 37 may be modified in a system that utilizes compartment descriptors. First, the invoke compartment instruction (e.g., CInvoke) may be modified to accept a compartment descriptor as a source operand (e.g., dest). Second, at 3706, the invoke compartment instruction can retrieve the capabilities for data and code from within the descriptor. In at least some examples, a bitmap within the second compartment can indicate which capabilities are to be retrieved from the descriptor. The data and code capabilities retrieved from the compartment descriptor can be used to perform the operations described above with respect to 3710.

The method of processing an invoke compartment instruction in FIG. 37 may be modified for a call compartment instruction (e.g., CCall). The same operands may be used for a call compartment instruction as for an invoke compartment instruction. For a call compartment instruction, however, additional operations may be performed at 3710 to save the state of the software thread corresponding to the currently active first compartment. For example, the call compartment instruction causes the execution circuitry to invoke a software trap (e.g., exception), and an exception handler can implement jump-like or call/return-like semantics, possibly depending on a selector value passed as an instruction operand in addition to the first and second operands. The exception handler can push the data and code capabilities in the IDC and PCC registers, respectively, for the currently executing first compartment to a trusted stack. This occurs prior to initializing the IDC and PCC registers with the data and code capabilities of the second compartment. When a CReturn is executed, the data and code capabilities may be popped from the trusted stack and used to initialize the IDC and PCC registers, respectively.

The method of processing a call compartment instruction with reference to 37 may be modified in a system that utilizes compartment descriptors. In a system that utilizes compartment descriptors, a call compartment instruction (e.g., CCall) may be modified to accept a first compartment descriptor as a destination operand (e.g., dest) and a second compartment descriptor as a source operand (e.g., src). At 3706, the capabilities for data and code from within the second compartment descriptor (e.g., source) can be retrieved. In at least some examples, a bitmap within the second compartment can indicate which capabilities are to be retrieved from the second compartment descriptor. At 3710, the execution circuitry may first invoke an execution handler to save the state of the software thread corresponding to the first (calling) compartment. The particular execution handler to invoke may be determined based on a selector value passed as a third operand. The exception handler can push the data and code capabilities of the first compartment in the IDC and PCC registers, respectively, into appropriate locations within the a trusted stack in the first compartment. This occurs prior to the other operations described with reference to 3710 to initialize the IDC and PCC registers with the data and code capabilities of the second compartment. When a CReturn is executed, the data and code capabilities may be popped from the trusted stack in the first compartment and used to initialize the IDC and PCC registers, respectively.

It should be noted that the invoke compartment instruction or call compartment instruction may alternatively processed using emulation or binary translation. In this scenario, a pipeline and/or emulation/translation layer performs certain aspects of the process. For example, a fetched single instruction of a first instruction set architecture is translated into one or more instructions of a second instruction set architecture. This translation is performed by a translation and/or emulation layer of software in some examples. In some examples, this translation is performed by an instruction converter. In some examples, the translation is performed by hardware translation circuitry. The translated instructions may be decoded, data values associated with source operand(s) may be retrieved, and the decoded instructions may be executed as described above with reference to FIG. 37 and any of the various alternatives.

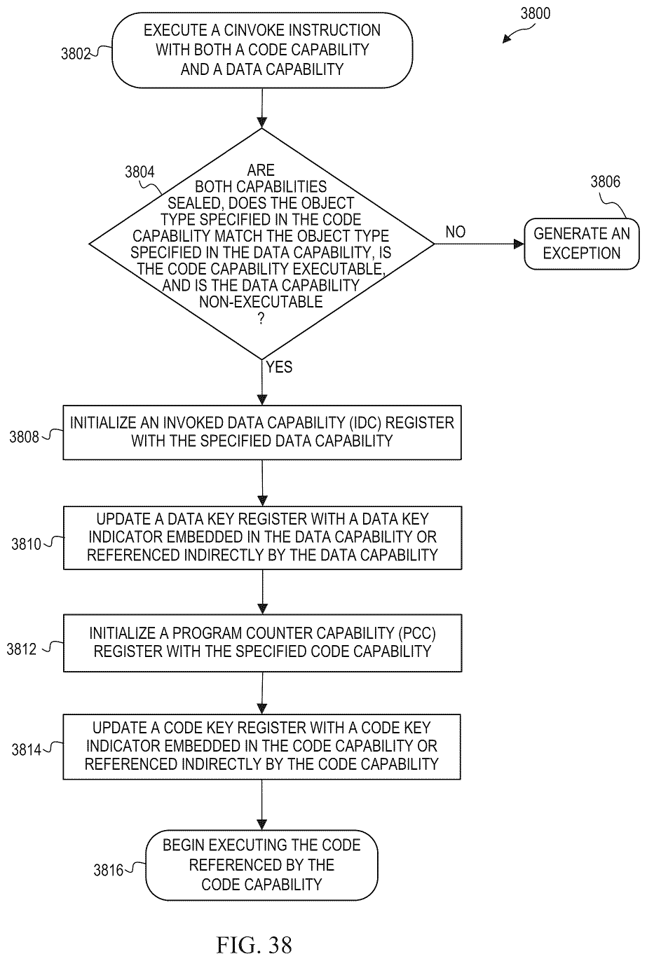

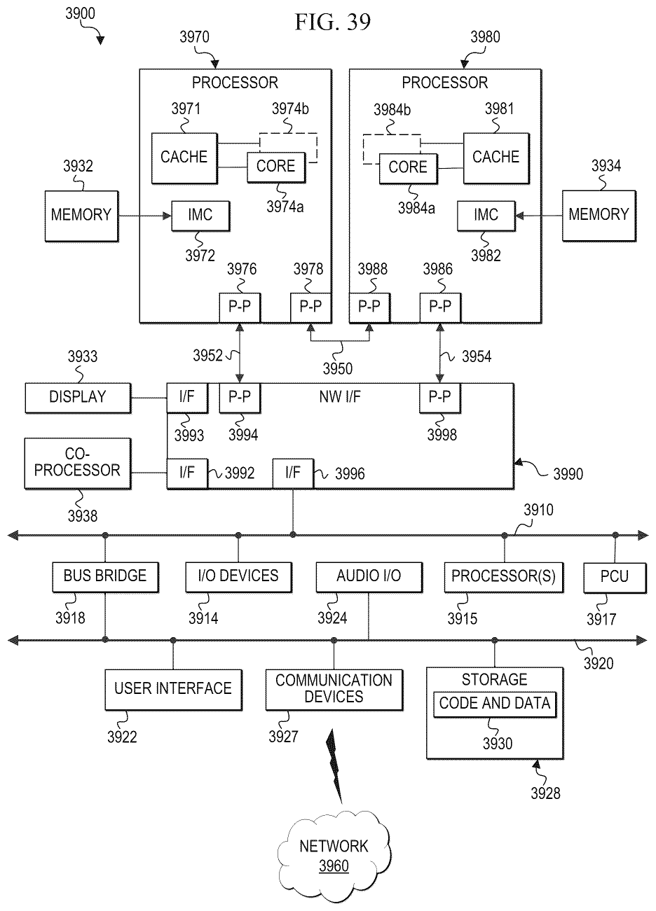

FIG. 38 illustrates operations of a method of processing an invoke compartment (e.g., CInvoke) instruction utilizing multi-key memory encryption techniques according to at least one embodiment. At 3802, the CInvoke instruction is to accept both a code capability and a data capability as operands.

At 3804, checks are performed to determine whether the instruction can be executed or an exception should be generated. The checks can include whether both capabilities are sealed, whether an object type specified in the code capability matches the object type specified in the data capability, whether the code capability points to executable memory contents, and whether the data capability points to non-executable memory contents. If (i) either of the capabilities are unsealed, (ii) the object type specified in the code capability does not match the object type specified in the data capability, (iii) the code capability does not point to executable memory contents, or (iv) the data capability does not point to non-executable memory contents, then at 3806, an exception can be generated. Otherwise, the CInvoke instruction can be executed at 3808-3814.

At 3808, an invoked data capability (IDC) register can be initialized with the specified data capability. At 3810, a data key register can be updated with a data key indicator (e.g., key ID or cryptographic key) embedded in the data capability or referenced indirectly by the data capability.

At 3812, a program counter capability (PCC) register can be initialized with the specified code capability. At 3810, a code key register can be updated with a code key indicator (e.g., key ID or cryptographic key) embedded in the code capability or referenced indirectly by the code capability.

At 3816, the code referenced by the specified code capability in the PCC register can begin executing.

### Example Computer Architectures

Detailed below are descriptions of example computer architectures that may be used to implement one or more embodiments of associated with multi-key memory encryption described above. System designs and configurations are known in the art for laptops, desktops, handheld personal computers (PCs), personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, and are also suitable. In general, a variety of systems or electronic devices capable of incorporating a processor and/or other execution logic as disclosed herein are generally suitable. Generally, suitable computer architectures for embodiments disclosed herein (e.g., computing systems 100, 200, 1900, 2200, 2500, 3100, 3300, etc.) can include, but are not limited to, configurations illustrated in the below FIGS. 39-18.

FIG. 39 illustrates an example computing system. Multiprocessor system 3900 is an interfaced system and includes a plurality of processors or cores including a first processor 3970 and a second processor 3980 coupled via an interface 3950 such as a point-to-point (P-P) interconnect, a fabric, and/or bus. In some examples, the first processor 3970 and the second processor 3980 are homogeneous. In some examples, first processor 3970 and the second processor 3980 are heterogenous. Though the example system 3900 is shown to have two processors, the system may have three or more processors, or may be a single processor system. In some examples, the computing system is a system on a chip (SoC). Generally, one or more of the computing systems or computing devices described herein (e.g., computing systems 100, 200, 1900, 2200, 2500, 3100, 3300, etc.) may be configured in the same or similar manner as computing system 3900 with appropriate hardware, firmware, and/or software to implement the various possible embodiments related to multi-key memory encryption, as disclosed herein.

Processors 3970 and 3980 may be implemented as single core processors 3974a and 3984a or multi-core processors 3974a-3974b and 3984a-3984b. Processors 3970 and 3980 may each include a cache 3971 and 3981 used by their respective core or cores. A shared cache (not shown) may be included in either processor or outside of both processors, yet connected with the processors via P-P interconnect, such that either or both processors' local cache information may be stored in the shared cache if a processor is placed into a low power mode.

Processors 3970 and 3980 are shown including integrated memory controller (IMC) circuitry 3972 and 3982, respectively. Processor 3970 also includes interface circuits 3976 and 3978; similarly, second processor 3980 includes interface circuits 3986 and 3988. Processors 3970, 3980 may exchange information via the interface 3950 using interface circuits 3978, 3988. IMCs 3972 and 3982 couple the processors 3970, 3980 to respective memories, namely a memory 3932 and a memory 3934, which may be portions of main memory locally attached to the respective processors.

Processors 3970, 3980 may each exchange information with a network interface (NW I/F) 3990 via individual interfaces 3952, 3954 using interface circuits 3976, 3994, 3986, 3998. The network interface 3990 (e.g., one or more of an interconnect, bus, and/or fabric, and in some examples is a chipset) may optionally exchange information with a coprocessor 3938 via an interface circuit 3992. In some examples, the coprocessor 3938 is a special-purpose processor, such as, for example, a high-throughput processor, a network or communication processor, compression engine, graphics processor, general purpose graphics processing unit (GPGPU), neural-network processing unit (NPU), embedded processor, or the like. Network interface 3990 may also provide information to a display 3933 using an interface circuitry 3993, for display to a human user.

Network interface 3990 may be coupled to a first interface 3910 via interface circuit 3996. In some examples, first interface 3910 may be an interface such as a Peripheral Component Interconnect (PCI) interconnect, a PCI Express interconnect or another I/O interconnect. In some examples, first interface 3910 is coupled to a power control unit (PCU) 3917, which may include circuitry, software, and/or firmware to perform power management operations with regard to the processors 3970, 3980 and/or coprocessor 3938. PCU 3917 provides control information to a voltage regulator (not shown) to cause the voltage regulator to generate the appropriate regulated voltage. PCU 3917 also provides control information to control the operating voltage generated. In various examples, PCU 3917 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 3917 is illustrated as being present as logic separate from the processor 3970 and/or processor 3980. In other cases, PCU 3917 may execute on a given one or more of cores (not shown) of processor 3970 or 3980. In some cases, PCU 3917 may be implemented as a microcontroller (dedicated or general-purpose) or other control logic configured to execute its own dedicated power management code, sometimes referred to as P-code. In yet other examples, power management operations to be performed by PCU 3917 may be implemented externally to a processor, such as by way of a separate power management integrated circuit (PMIC) or another component external to the processor. In yet other examples, power management operations to be performed by PCU 3917 may be implemented within BIOS or other system software.

Various I/O devices 3914 may be coupled to first interface 3916, along with a bus bridge 3918 which couples first interface 3916 to a second interface 3920. In some examples, one or more additional processor(s) 3915, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 3916. In some examples, second interface 3920 may be a low pin count (LPC) interface. Various devices may be coupled to second interface 3920 including, for example, a user interface 3922 (such as a keyboard, mouse, touchscreen, or other input devices), communication devices 3927 (such as modems, network interface devices, or other types of communication devices that may communicate through a computer network 3960), and storage circuitry 3928. Storage circuitry 3928 may be one or more non-transitory machine-readable storage media as described below, such as a disk drive or other mass storage device which may include instructions/code and data 3930 and may implement the storage 3603 in some examples. Further, an audio I/O 3924 may be coupled to second interface 3920. Note that other architectures than the point-to-point architecture described above are possible. For example, instead of the point-to-point architecture, a system such as multiprocessor system 3900 may implement a multi-drop interface or other such architecture.

Program code, such as code 3930, may be applied to input instructions to perform the functions described herein and generate output information. The output information may be applied to one or more output devices, in known fashion. For purposes of this application, a processing system may be part of computing system 3900 and includes any system that has a processor, such as, for example; a digital signal processor (DSP), a microcontroller, an application specific integrated circuit (ASIC), or a microprocessor.

The program code (e.g., 3930) may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language. Program code may also include user code and privileged code such as an operating system and hypervisor.

One or more aspects of at least one embodiment may be implemented by representative instructions stored on a machine-readable medium which represents various logic within the processor, which when read by a machine causes the machine to fabricate logic to perform the one or more of the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the present disclosure also include non-transitory, tangible machine-readable media containing instructions or containing design data, such as Hardware Description Language (HDL), which defines structures, circuits, apparatuses, processors and/or system features described herein. Such embodiments may also be referred to as program products.

The computing system depicted in FIG. 39 is a schematic illustration of a computing system that may be utilized to implement various embodiments discussed herein. It will be appreciated that various components of the system depicted in FIG. 39 may be combined in a system-on-a-chip (SoC) architecture or in any other suitable configuration capable of achieving the functionality and features of examples and implementations provided herein.

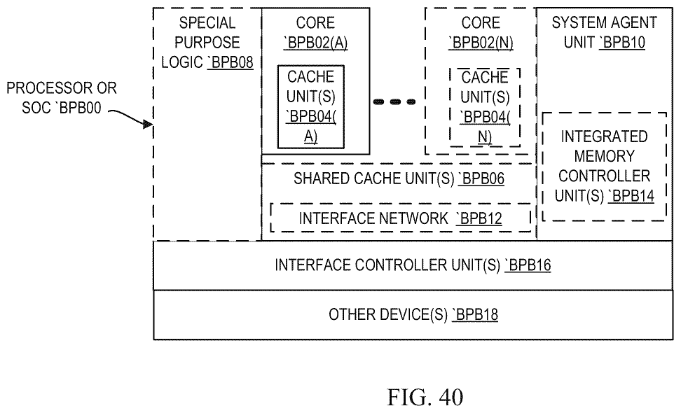

FIG. 40 is a block diagram of a processor 4000 that may have more than one core, may have an integrated memory controller, and may have integrated graphics according to one or more embodiments of this disclosure. Processor 4000 is an example of a type of hardware device that can be used in connection with the implementations shown and described herein (e.g., processors 140 and 2240, processors of computing system 2500 and 3100, processors on hardware platform 1930 and 3300). The solid lined boxes in FIG. 40 illustrate a processor 4000 with a single core 4002A, a system agent unit 4010, a set of one or more interface (e.g., bus) controller units 4016, while the optional addition of the dashed lined boxes illustrates an alternative processor 4000 with multiple cores 4002A-N, a set of one or more integrated memory controller unit(s) 4014 in the system agent unit 4010, and special purpose logic 4008. Processor 4000 and its components (e.g., cores 4002A-N, cache unit(s) 4004A-N, shared cache unit(s) 4006, etc.) represent example architecture that could be used to implement processors of embodiments shown and described herein (e.g., processors 140 and 2240, processors of computing system 2500 and 3100, processors on hardware platform 1930 and 3300) and at least some of its respective components.

Thus, different implementations of the processor 4000 may include: 1) a CPU with the special purpose logic 4008 being integrated graphics and/or scientific (throughput) logic (which may include one or more cores), and the cores 4002A-N being one or more general purpose cores (e.g., general purpose in-order cores, general purpose out-of-order cores, a combination of the two); 2) a coprocessor with the cores 4002A-N being a large number of special purpose cores intended primarily for graphics and/or scientific (throughput); and 3) a coprocessor with the cores 4002A-N being a large number of general purpose in-order cores. Thus, the processor 4000 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 4000 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 4006, and external memory (not shown) coupled to the set of integrated memory controller units 4014. The set of shared cache units 4006 may include one or more mid-level caches, such as level 2 (L2), level 3 (L3), level 4 (L4), or other levels of cache, a last level cache (LLC), and/or combinations thereof. While in one embodiment a ring based interconnect unit 4012 interconnects the integrated graphics logic 4008, the set of shared cache units 4006, and the system agent unit 4010/integrated memory controller unit(s) 4014, alternative embodiments may use any number of well-known techniques for interconnecting such units. In one embodiment, coherency is maintained between one or more cache units 4006 and cores 4002A-N.

In some embodiments, one or more of the cores 4002A-N are capable of multithreading. The system agent 4010 includes those components coordinating and operating cores 4002A-N. The system agent unit 4010 may include for example a power control unit (PCU) and a display unit. The PCU may be or include logic and components needed for regulating the power state of the cores 4002A-N and the integrated graphics logic 4008. The display unit is for driving one or more externally connected displays.

The cores 4002A-N may be homogenous or heterogeneous in terms of architecture instruction set; that is, two or more of the cores 4002A-N may be capable of executing the same instruction set, while others may be capable of executing only a subset of that instruction set or a different instruction set.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

FIG. 40 illustrates a block diagram of an example processor and/or SoC 4000 that may have one or more cores and an integrated memory controller. The solid lined boxes illustrate a processor 4000 with a single core 4002(A), system agent unit circuitry 4010, and a set of one or more interface controller unit(s) circuitry 4016, while the optional addition of the dashed lined boxes illustrates an alternative processor 4000 with multiple cores 4002(A)-(N), a set of one or more integrated memory controller unit(s) circuitry 4014 in the system agent unit circuitry 4010, and special purpose logic 4008, as well as a set of one or more interface controller units circuitry 4016. Note that the processor 4000 may be one of the processors 3970 or 3980, or co-processor 3938 or 3915 of FIG. 39.

Thus, different implementations of the processor 4000 may include: 1) a CPU with the special purpose logic 4008 being integrated graphics and/or scientific (throughput) logic (which may include one or more cores, not shown), and the cores 4002(A)-(N) being one or more general purpose cores (e.g., general purpose in-order cores, general purpose out-of-order cores, or a combination of the two); 2) a coprocessor with the cores 4002(A)-(N) being a large number of special purpose cores intended primarily for graphics and/or scientific (throughput); and 3) a coprocessor with the cores 4002(A)-(N) being a large number of general purpose in-order cores. Thus, the processor 4000 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 4000 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 4004(A)-(N) within the cores 4002(A)-(N), a set of one or more shared cache unit(s) circuitry 4006, and external memory (not shown) coupled to the set of integrated memory controller unit(s) circuitry 4014. The set of one or more shared cache unit(s) circuitry 4006 may include one or more mid-level caches, such as level 2 (L2), level 3 (L3), level 4 (L4), or other levels of cache, such as a last level cache (LLC), and/or combinations thereof. While in some examples interface network circuitry 4012 (e.g., a ring interconnect) interfaces the special purpose logic 4008 (e.g., integrated graphics logic), the set of shared cache unit(s) circuitry 4006, and the system agent unit circuitry 4010, alternative examples use any number of well-known techniques for interfacing such units. In some examples, coherency is maintained between one or more of the shared cache unit(s) circuitry 4006 and cores 4002(A)-(N). In some examples, interface controller units circuitry 4016 couple the cores 4002 to one or more other devices 4018 such as one or more I/O devices, storage, one or more communication devices (e.g., wireless networking, wired networking, etc.), etc.

In some examples, one or more of the cores 4002(A)-(N) are capable of multithreading. The system agent unit circuitry 4010 includes those components coordinating and operating cores 4002(A)-(N). The system agent unit circuitry 4010 may include, for example, power control unit (PCU) circuitry and/or display unit circuitry (not shown). The PCU may be or may include logic and components needed for regulating the power state of the cores 4002(A)-(N) and/or the special purpose logic 4008 (e.g., integrated graphics logic). The display unit circuitry is for driving one or more externally connected displays.

The cores 4002(A)-(N) may be homogenous in terms of instruction set architecture (ISA). Alternatively, the cores 4002(A)-(N) may be heterogeneous in terms of ISA; that is, a subset of the cores 4002(A)-(N) may be capable of executing an ISA, while other cores may be capable of executing only a subset of that ISA or another ISA.

### Example Core Architectures-In-Order and Out-of-Order Core Block Diagram

FIG. 41A is a block diagram illustrating both an example in-order pipeline and an example register renaming, out-of-order issue/execution pipeline according to examples. FIG. 41B is a block diagram illustrating both an example in-order architecture core and an example register renaming, out-of-order issue/execution architecture core to be included in a processor according to examples. The solid lined boxes in FIGS. 41A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 41A, a processor pipeline 4100 includes a fetch stage 4102, an optional length decoding stage 4104, a decode stage 4106, an optional allocation (Alloc) stage 4108, an optional renaming stage 4110, a schedule (also known as a dispatch or issue) stage 4112, an optional register read/memory read stage 4114, an execute stage 4116, a write back/memory write stage 4118, an optional exception handling stage 4122, and an optional commit stage 4124. One or more operations can be performed in each of these processor pipeline stages. For example, during the fetch stage 4102, one or more instructions are fetched from instruction memory, and during the decode stage 4106, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 4106 and the register read/memory read stage 4114 may be combined into one pipeline stage. In one example, during the execute stage 4116, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 41B may implement the pipeline 4100 as follows: 1) the instruction fetch circuitry 4138 performs the fetch and length decoding stages 4102 and 4104; 2) the decode circuitry 4140 performs the decode stage 4106; 3) the rename/allocator unit circuitry 4152 performs the allocation stage 4108 and renaming stage 4110; 4) the scheduler(s) circuitry 4156 performs the schedule stage 4112; 5) the physical register file(s) circuitry 4158 and the memory unit circuitry 4170 perform the register read/memory read stage 4114; the execution cluster(s) 4160 perform the execute stage 4116; 6) the memory unit circuitry 4170 and the physical register file(s) circuitry 4158 perform the write back/memory write stage 4118; 7) various circuitry may be involved in the exception handling stage 4122; and 8) the retirement unit circuitry 4154 and the physical register file(s) circuitry 4158 perform the commit stage 4124.

FIG. 41B shows a processor core 4190 including front-end unit circuitry 4130 coupled to execution engine circuitry 4150, and both are coupled to memory unit circuitry 4170. The core 4190 may be a reduced instruction set architecture computing (RISC) core, a complex instruction set architecture computing (CISC) core, a very long instruction word (VLIW) core, or a hybrid or alternative core type. As yet another option, the core 4190 may be a special-purpose core, such as, for example, a network or communication core, compression engine, coprocessor core, general purpose computing graphics processing unit (GPGPU) core, graphics core, or the like.

The front-end unit circuitry 4130 may include branch prediction circuitry 4132 coupled to instruction cache circuitry 4134, which is coupled to an instruction translation lookaside buffer (TLB) 4136, which is coupled to instruction fetch circuitry 4138, which is coupled to decode circuitry 4140. In one example, the instruction cache circuitry 4134 is included in the memory unit circuitry 4170 rather than the front-end circuitry 4130. The decode circuitry 4140 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 4140 may further include address generation unit (AGU, not shown) circuitry. In one example, the AGU generates an LSU address using forwarded register ports, and may further perform branch forwarding (e.g., immediate offset branch forwarding. LR register branch forwarding, etc.). The decode circuitry 4140 may be implemented using various different mechanisms. Examples of suitable mechanisms include, but are not limited to, look-up tables, hardware implementations, programmable logic arrays (PLAs), microcode read only memories (ROMs), etc. In one example, the core 4190 includes a microcode ROM (not shown) or other medium that stores microcode for certain macroinstructions (e.g., in decode circuitry 4140 or otherwise within the front-end circuitry 4130). In one example, the decode circuitry 4140 includes a micro-operation (micro-op) or operation cache (not shown) to hold/cache decoded operations, micro-tags, or micro-operations generated during the decode or other stages of the processor pipeline 4100. The decode circuitry 4140 may be coupled to rename/allocator unit circuitry 4152 in the execution engine circuitry 4150.

The execution engine circuitry 4150 includes the rename/allocator unit circuitry 4152 coupled to retirement unit circuitry 4154 and a set of one or more scheduler(s) circuitry 4156. The scheduler(s) circuitry 4156 represents any number of different schedulers, including reservations stations, central instruction window, etc. In some examples, the scheduler(s) circuitry 4156 can include arithmetic logic unit (ALU) scheduler/scheduling circuitry, ALU queues, address generation unit (AGU) scheduler/scheduling circuitry, AGU queues, etc. The scheduler(s) circuitry 4156 is coupled to the physical register file(s) circuitry 4158. Each of the physical register file(s) circuitry 4158 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 4158 includes vector registers unit circuitry, writemask registers unit circuitry, and scalar register unit circuitry. These register units may provide architectural vector registers, vector mask registers, general-purpose registers, etc. The physical register file(s) circuitry 4158 is coupled to the retirement unit circuitry 4154 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 4154 and the physical register file(s) circuitry 4158 are coupled to the execution cluster(s) 4160. The execution cluster(s) 4160 includes a set of one or more execution unit(s) circuitry 4162 and a set of one or more memory access circuitry 4164.

The execution cluster(s) 4160 includes a set of one or more execution units 4162 and a set of one or more memory access units 4164. Additionally, memory protection circuitry 4165 may be coupled to memory access unit(s) 1664 in one or more embodiments. Memory protection circuitry 4165 may be the same or similar to memory protection circuitry (e.g., 160, 1860, 1932, 2260, 2560, 3160, 3360) previously described herein to enable various embodiments of multi-key memory encryption. The execution unit(s) circuitry 4162 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions.

The scheduler(s) circuitry 4156, physical register file(s) circuitry 4158, and execution cluster(s) 4160 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 4164). It should also be understood that where separate pipelines are used, one or more of these pipelines may be out-of-order issue/execution and the rest in-order.

In some examples, the execution engine circuitry 4150 may perform load store unit (LSU) address/data pipelining to an Advanced Microcontroller Bus (AMB) interface (not shown), and address phase and writeback, data phase load, store, and branches.

The set of memory access circuitry 4164 is coupled to the memory unit circuitry 4170, which includes data TLB circuitry 4172 coupled to data cache circuitry 4174 coupled to level 2 (L2) cache circuitry 4176. In one example, the memory access circuitry 4164 may include load unit circuitry, store address unit circuitry, and store data unit circuitry, each of which is coupled to the data TLB circuitry 4172 in the memory unit circuitry 4170. The instruction cache circuitry 4134 is further coupled to the level 2 (L2) cache circuitry 4176 in the memory unit circuitry 4170. In one example, the instruction cache 4134 and the data cache 4174 are combined into a single instruction and data cache (not shown) in L2 cache circuitry 4176, level 3 (L3) cache circuitry (not shown), and/or main memory. The L2 cache circuitry 4176 is coupled to one or more other levels of cache and eventually to a main memory.

The core 4190 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 4190 includes logic to support a packed data instruction set architecture extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

### Example Execution Unit(s) Circuitry

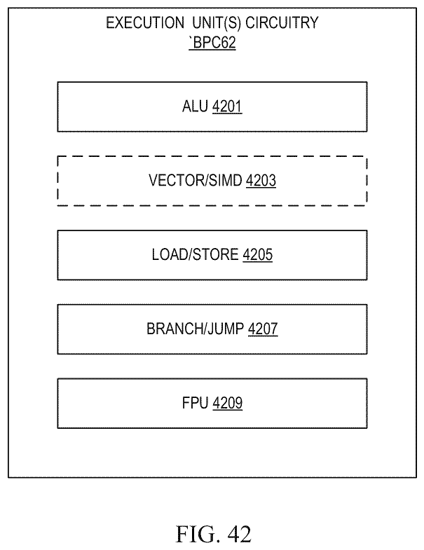

FIG. 42 illustrates examples of execution unit(s) circuitry, such as execution unit(s) circuitry 4162 of FIG. 41B. As illustrated, execution unit(s) circuitry 4162 may include one or more ALU circuits 4201, optional vector/single instruction multiple data (SIMD) circuits 4203, load/store circuits 4205, branch/jump circuits 4207, and/or Floating-point unit (FPU) circuits 4209. ALU circuits 4201 perform integer arithmetic and/or Boolean operations. Vector/SIMD circuits 4203 perform vector/SIMD operations on packed data (such as SIMD/vector registers). Load/store circuits 4205 execute load and store instructions to load data from memory into registers or store from registers to memory. Load/store circuits 4205 may also generate addresses. Branch/jump circuits 4207 cause a branch or jump to a memory address depending on the instruction. FPU circuits 4209 perform floating-point arithmetic. The width of the execution unit(s) circuitry 4162 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture

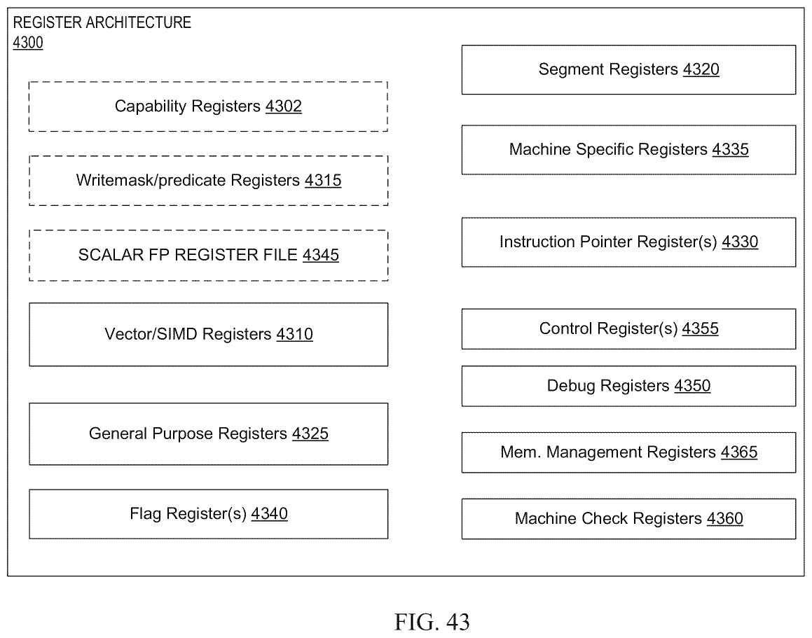

FIG. 43 is a block diagram of a register architecture 4300 according to some examples. As illustrated, the register architecture 4300 includes vector/SIMD registers 4310 that vary from 128-bit to 1,024 bits width. In some examples, the vector/SIMD registers 4310 are physically 512-bits and, depending upon the mapping, only some of the lower bits are used. For example, in some examples, the vector/SIMD registers 4310 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 4300 includes writemask/predicate registers 4315. For example, in some examples, there are 8 writemask/predicate registers (sometimes called k0 through k7) that are each 16-bit, 32-bit, 64-bit, or 128-bit in size. Writemask/predicate registers 4315 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 4315 corresponds to a data element position of the destination. In other examples, the writemask/predicate registers 4315 are scalable and consists of a set number of enable bits for a given vector element (e.g., 8 enable bits per 64-bit vector element).

The register architecture 4300 includes a plurality of general-purpose registers 4325. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 4300 includes scalar floating-point (FP) register file 4345 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 4340 (e.g., EFLAGS, RFLAGS, etc.) store status and control information for arithmetic, compare, and system operations. For example, the one or more flag registers 4340 may store condition code information such as carry, parity, auxiliary carry, zero, sign, and overflow. In some examples, the one or more flag registers 4340 are called program status and control registers.

Segment registers 4320 contain segment points for use in accessing memory. In some examples, these registers are referenced by the names CS, DS, SS, ES, FS, and GS.

Machine specific registers (MSRs) 4335 control and report on processor performance. Most MSRs 4335 handle system-related functions and are not accessible to an application program. Machine check registers 4360 consist of control, status, and error reporting MSRs that are used to detect and report on hardware errors.

One or more instruction pointer register(s) 4330 store an instruction pointer value. Control register(s) 4355 (e.g., CR0-CR4) determine the operating mode of a processor (e.g., processor 3970, 3980, 3938, 3915, and/or 4000) and the characteristics of a currently executing task. Debug registers 4350 control and allow for the monitoring of a processor or core's debugging operations.

Memory (mem) management registers 4365 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 4300 may, for example, be used in register file/memory 3608, or physical register file(s) circuitry 4158.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

FIG. 44 illustrates examples of an instruction format. As illustrated, an instruction may include multiple components including, but not limited to, one or more fields for: one or more prefixes 4401, an opcode 4403, addressing information 4405 (e.g., register identifiers, memory addressing information, etc.), a displacement value 4407, and/or an immediate value 4409. Note that some instructions utilize some or all the fields of the format whereas others may only use the field for the opcode 4403. In some examples, the order illustrated is the order in which these fields are to be encoded, however, it should be appreciated that in other examples these fields may be encoded in a different order, combined, etc.

The prefix(es) field(s) 4401, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 4403 is used to at least partially define the operation to be performed upon a decoding of the instruction. In some examples, a primary opcode encoded in the opcode field 4403 is one, two, or three bytes in length. In other examples, a primary opcode can be a different length. An additional 3-bit opcode field is sometimes encoded in another field.

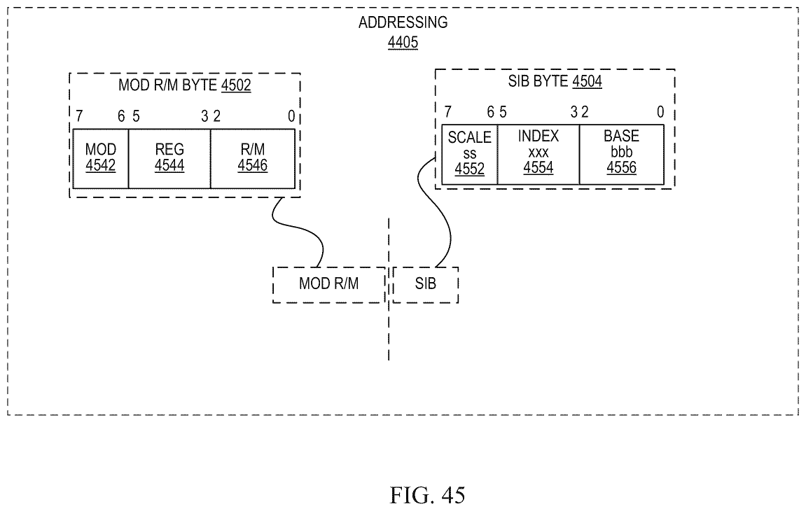

The addressing information field 4405 is used to address one or more operands of the instruction, such as a location in memory or one or more registers. FIG. 45 illustrates examples of the addressing information field 4405. In this illustration, an optional MOD R/M byte 4502 and an optional Scale, Index, Base (SIB) byte 4504 are shown. The MOD R/M byte 4502 and the SIB byte 4504 are used to encode up to two operands of an instruction, each of which is a direct register or effective memory address. Note that both of these fields are optional in that not all instructions include one or more of these fields. The MOD R/M byte 4502 includes a MOD field 4542, a register (reg) field 4544, and R/M field 4546.

The content of the MOD field 4542 distinguishes between memory access and non-memory access modes. In some examples, when the MOD field 4542 has a binary value of 11 (11b), a register-direct addressing mode is utilized, and otherwise a register-indirect addressing mode is used.

The register field 4544 may encode either the destination register operand or a source register operand or may encode an opcode extension and not be used to encode any instruction operand. The content of register field 4544, directly or through address generation, specifies the locations of a source or destination operand (either in a register or in memory). In some examples, the register field 4544 is supplemented with an additional bit from a prefix (e.g., prefix 4401) to allow for greater addressing.

The R/M field 4546 may be used to encode an instruction operand that references a memory address or may be used to encode either the destination register operand or a source register operand. Note the R/M field 4546 may be combined with the MOD field 4542 to dictate an addressing mode in some examples.

The SIB byte 4504 includes a scale field 4552, an index field 4554, and a base field 4556 to be used in the generation of an address. The scale field 4552 indicates a scaling factor. The index field 4554 specifies an index register to use. In some examples, the index field 4554 is supplemented with an additional bit from a prefix (e.g., prefix 4401) to allow for greater addressing. The base field 4556 specifies a base register to use. In some examples, the base field 4556 is supplemented with an additional bit from a prefix (e.g., prefix 4401) to allow for greater addressing. In practice, the content of the scale field 4552 allows for the scaling of the content of the index field 4554 for memory address generation (e.g., for address generation that uses 2scale*index+base).

Some addressing forms utilize a displacement value to generate a memory address. For example, a memory address may be generated according to 2scale*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 4407 provides this value. Additionally, in some examples, a displacement factor usage is encoded in the MOD field of the addressing information field 4405 that indicates a compressed displacement scheme for which a displacement value is calculated and stored in the displacement field 4407.

In some examples, the immediate value field 4409 specifies an immediate value for the instruction. An immediate value may be encoded as a 1-byte value, a 2-byte value, a 4-byte value, etc.

FIG. 46 illustrates examples of a first prefix 4401(A). In some examples, the first prefix 4401(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 4401(A) may specify up to three registers using 3-bit fields depending on the format: 1) using the reg field 4544 and the R/M field 4546 of the MOD R/M byte 4502; 2) using the MOD R/M byte 4502 with the SIB byte 4504 including using the reg field 4544 and the base field 4556 and index field 4554; or 3) using the register field of an opcode.

In the first prefix 4401(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 4544 and MOD R/M R/M field 4546 alone can each only address 8 registers.

In the first prefix 4401(A), bit position 2 (R) may be an extension of the MOD R/M reg field 4544 and may be used to modify the MOD R/M reg field 4544 when that field encodes a general-purpose register, a 64-bit packed data register (e.g., a SSE register), or a control or debug register. R is ignored when MOD R/M byte 4502 specifies other registers or defines an extended opcode.

Bit position 1 (X) may modify the SIB byte index field 4554.

Bit position 0 (B) may modify the base in the MOD R/M R/M field 4546 or the SIB byte base field 4556; or it may modify the opcode register field used for accessing general purpose registers (e.g., general purpose registers 4325).

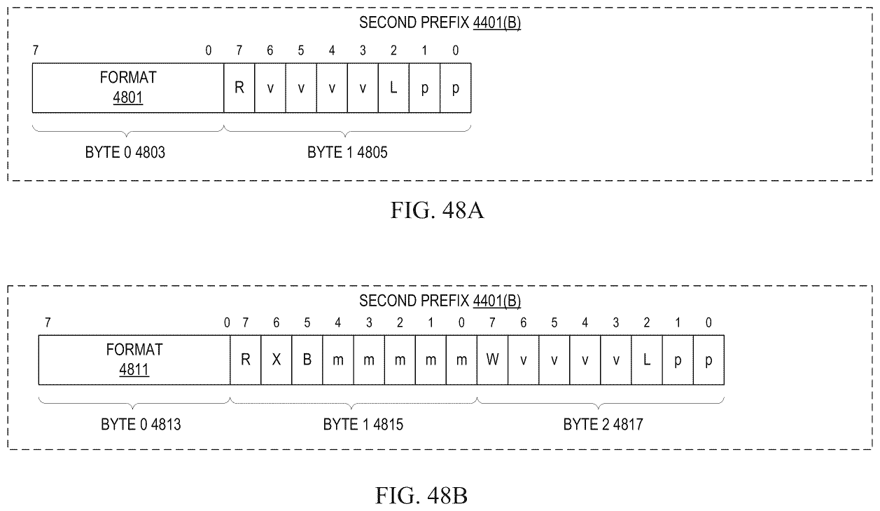

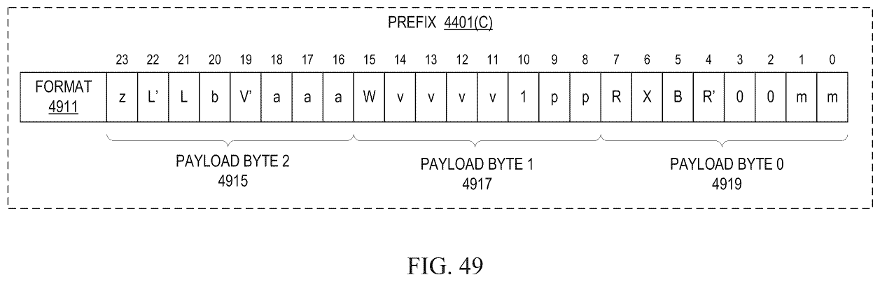

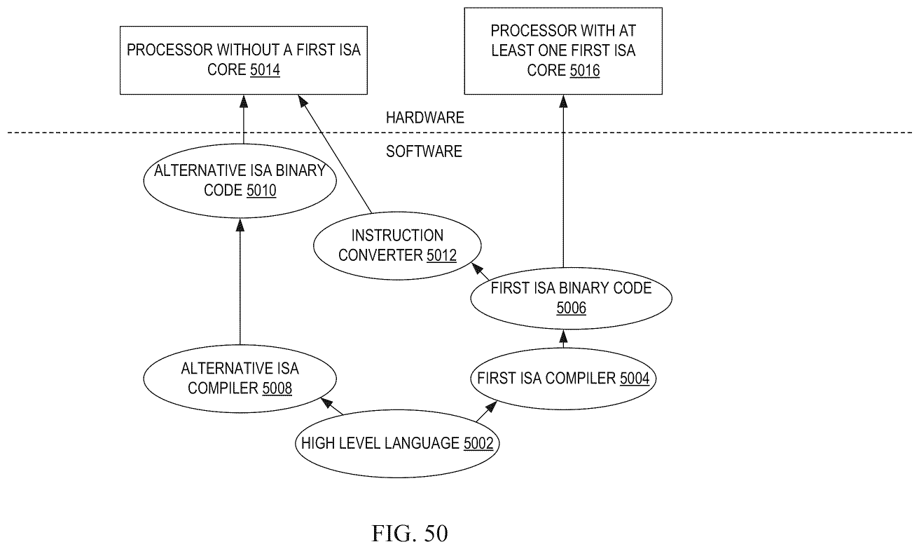

FIGS. 47A-D illustrate examples of how the R. X, and B fields of the first prefix 4401(A) are used. FIG. 47A illustrates R and B from the first prefix 4401(A) being used to extend the reg field 4544 and R/M field 4546 of the MOD R/M byte 4502 when the SIB byte 4504 is not used for memory addressing. FIG. 47B illustrates R and B from the first prefix 4401(A) being used to extend the reg field 4544 and R/M field 4546 of the MOD R/M byte 4502 when the SIB byte 4504 is not used (register-register addressing). FIG. 47C illustrates R, X, and B from the first prefix 4401(A) being used to extend the reg field 4544 of the MOD R/M byte 4502 and the index field 4554 and base field 4556 when the SIB byte 4504 being used for memory addressing. FIG. 47D illustrates B from the first prefix 4401(A) being used to extend the reg field 4544 of the MOD R/M byte 4502 when a register is encoded in the opcode 4403.

FIGS. 47A-B illustrate examples of a second prefix 4401(B). In some examples, the second prefix 4401(B) is an example of a VEX prefix. The second prefix 4401(B) encoding allows instructions to have more than two operands, and allows SIMD vector registers (e.g., vector/SIMD registers 4310) to be longer than 64-bits (e.g., 128-bit and 256-bit). The use of the second prefix 4401(B) provides for three-operand (or more) syntax. For example, previous two-operand instructions performed operations such as A=A+B, which overwrites a source operand. The use of the second prefix 4401(B) enables operands to perform nondestructive operations such as A=B+C.

In some examples, the second prefix 4401(B) comes in two forms—a two-byte form and a three-byte form. The two-byte second prefix 4401(B) is used mainly for 128-bit, scalar, and some 256-bit instructions; while the three-byte second prefix 4401(B) provides a compact replacement of the first prefix 4401(A) and 3-byte opcode instructions.

FIG. 48A illustrates examples of a two-byte form of the second prefix 4401(B). In one example, a format field 4801 (byte 0 4803) contains the value C5H. In one example, byte 1 4805 includes an “R” value in bit[7]. This value is the complement of the “R” value of the first prefix 4401(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 4546 to encode the instruction operand that references a memory address or encode either the destination register operand or a source register operand.

Instructions that use this prefix may use the MOD R/M reg field 4544 to encode either the destination register operand or a source register operand, or to be treated as an opcode extension and not used to encode any instruction operand.

For instruction syntax that support four operands, vvvv, the MOD R/M R/M field 4546 and the MOD R/M reg field 4544 encode three of the four operands. Bits[7:4] of the immediate value field 4409 are then used to encode the third source register operand.

FIG. 48B illustrates examples of a three-byte form of the second prefix 4401(B). In one example, a format field 4811 (byte 0 4813) contains the value C4H. Byte 1 4815 includes in bits [7:5] “R,” “X,” and “B” which are the complements of the same values of the first prefix 4401(A). Bits[4:0] of byte 1 4815 (shown as mmmmm) include content to encode, as need, one or more implied leading opcode bytes. For example, 00001 implies a OFH leading opcode, 00010 implies a OF38H leading opcode, 00011 implies a OF3AH leading opcode, etc.

Bit[7] of byte 2 4817 is used similar to W of the first prefix 4401(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 4546 to encode the instruction operand that references a memory address or encode either the destination register operand or a source register operand.

Instructions that use this prefix may use the MOD R/M reg field 4544 to encode either the destination register operand or a source register operand, or to be treated as an opcode extension and not used to encode any instruction operand.

For instruction syntax that support four operands, vvvv, the MOD R/M R/M field 4546, and the MOD R/M reg field 4544 encode three of the four operands. Bits[7:4] of the immediate value field 4409 are then used to encode the third source register operand.

FIG. 49 illustrates examples of a third prefix 4401(C). In some examples, the third prefix 4401(C) is an example of an EVEX prefix. The third prefix 4401(C) is a four-byte prefix.

The third prefix 4401(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 43) or predication utilize this prefix. Opmask register allow for conditional processing or selection control. Opmask instructions, whose source/destination operands are opmask registers and treat the content of an opmask register as a single value, are encoded using the second prefix 4401(B).

The third prefix 4401(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 4401(C) is a format field 4911 that has a value, in one example, of 62H. Subsequent bytes are referred to as payload bytes 4915-4919 and collectively form a 24-bit value of P[23:0] providing specific capability in the form of one or more fields (detailed herein).

In some examples, P[1:0] of payload byte 4919 are identical to the low two mm bits. P[3:2] are reserved in some examples. Bit P[4] (R′) allows access to the high 16 vector register set when combined with P[7] and the MOD R/M reg field 4544. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 4544 and MOD R/M R/M field 4546. P[9:8] provide opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is similar to W of the first prefix 4401(A) and second prefix 4411(B) and may serve as an opcode extension bit or operand size promotion.

P[18:16] specify the index of a register in the opmask (writemask) registers (e.g., writemask/predicate registers 4315). In one example, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Examples of encoding of registers in instructions using the third prefix 4401(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | MOD R/M | GPR, Vector | Destination or Source |
| | | | reg | | |
| VVVV | V′ | vvvv | | GPR, Vector | 2nd Source or |
| | | | | | Destination |
| RM | X | B | MOD R/M | GPR, Vector | 1st Source or |
| | | | R/M | | Destination |
| BASE | 0 | B | MOD R/M | GPR | Memory addressing |
| | | | R/M | | |
| INDEX | 0 | X | SIB.index | GPR | Memory addressing |
| VIDX | V′ | X | SIB.index | Vector | VSIB memory |
| | | | | | addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

### Emulation (Including Binary Translation, Code Morphing, Etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

FIG. 50 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 50 shows a program in a high-level language 5002 may be compiled using a first ISA compiler 5004 to generate first ISA binary code 5006 that may be natively executed by a processor with at least one first ISA core 5016. The processor with at least one first ISA core 5016 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 5004 represents a compiler that is operable to generate first ISA binary code 5006 (e.g., object code) that can, with or without additional linkage processing, be executed on the processor with at least one first ISA core 5016. Similarly, FIG. 50 shows the program in the high-level language 5002 may be compiled using an alternative ISA compiler 5008 to generate alternative ISA binary code 5010 that may be natively executed by a processor without a first ISA core 5014. The instruction converter 5012 is used to convert the first ISA binary code 5006 into code that may be natively executed by the processor without a first ISA core 5014. This converted code is not necessarily to be the same as the alternative ISA binary code 5010; however, the converted code will accomplish the general operation and be made up of instructions from the alternative ISA. Thus, the instruction converter 5012 represents software, firmware, hardware, or a combination thereof that, through emulation, simulation or any other process, allows a processor or other electronic device that does not have a first ISA processor or core to execute the first ISA binary code 5006.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

With regard to this specification generally, unless expressly stated to the contrary, disjunctive language such as ‘at least one of’ or ‘and/or’ or ‘one or more of’ refers to any combination of the named items, elements, conditions, activities, messages, entries, paging structures, components, register, devices, memories, etc. For example, ‘at least one of X, Y, and Z’ and ‘one or more of X, Y, and Z’ is intended to mean any of the following: 1) at least one X, but not Y and not Z; 2) at least one Y, but not X and not Z; 3) at least one Z, but not X and not Y; 4) at least one X and at least one Y, but not Z; 5) at least one X and at least one Z, but not Y; 6) at least one Y and at least one Z, but not X; or 7) at least one X, at least one Y, and at least one Z.

Additionally, unless expressly stated to the contrary, the terms ‘first’, ‘second’, ‘third’, etc., are intended to distinguish the particular items (e.g., element, condition, module, activity, operation, claim element, messages, protocols, interfaces, devices etc.) they modify, but are not intended to indicate any type of order, rank, importance, temporal sequence, or hierarchy. For example, ‘first X’ and ‘second X’ are intended to designate two separate X elements that are not necessarily limited by any order, rank, importance, temporal sequence, or hierarchy of the two elements, unless specifically stated to the contrary.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of “embodiment” and other exemplarily language does not necessarily refer to the same embodiment or the same example, but may refer to different and distinct embodiments, as well as potentially the same embodiment.

Embodiments of the mechanisms disclosed herein may be implemented in hardware, software, firmware, or a combination of such implementation approaches. Embodiments of this disclosure may be implemented, at least partially, as computer programs or program code executing on programmable systems comprising at least one processor, a storage system (including volatile and non-volatile memory and/or storage elements), at least one input device, and at least one output device.

The architectures presented herein are provided by way of example only and are intended to be non-exclusive and non-limiting. Furthermore, the various parts disclosed are intended to be logical divisions only and need not necessarily represent physically separate hardware and/or software components. Certain computing systems may provide memory elements in a single physical memory device, and in other cases, memory elements may be functionally distributed across many physical devices. In the case of virtual machine managers or hypervisors, all or part of a function may be provided in the form of software or firmware running over a virtualization layer to provide the disclosed logical function.

It is also important to note that the operations in the preceding flowcharts and diagrams illustrating interactions, illustrate only some of the possible activities that may be executed by, or within, computing systems using the approaches disclosed herein for providing various embodiments of multi-key memory encryption. Some of these operations may be deleted or removed where appropriate, or these operations may be modified or changed considerably without departing from the scope of the present disclosure. In addition, the timing of these operations may be altered considerably. For example, the timing and/or sequence of certain operations may be changed relative to other operations to be performed before, after, or in parallel to the other operations, or based on any suitable combination thereof. The preceding operational flows have been offered for purposes of example and discussion. Substantial flexibility is provided by embodiments described herein in that any suitable arrangements, chronologies, configurations, and timing mechanisms may be provided without departing from the teachings of the present disclosure.

### Other Notes and Examples

The following examples pertain to embodiments in accordance with this specification. The system, apparatus, method, and machine readable storage medium embodiments can include one or a combination of the following examples.

Example AS1 provides a system including a memory and a processor communicatively coupled to the memory. The processor includes a first core and memory controller circuitry communicatively coupled to the first core. The first core includes a first hardware thread register and is configured to support a first hardware thread of a process. The first core is to select a first key identifier stored in the first hardware thread register in response to receiving a first memory access request associated with the first hardware thread. The memory controller circuitry is to obtain a first encryption key associated with the first key identifier.

Example AA1 provides a processor including a first core including a first hardware thread register. The first core is to: select a first key identifier stored in the first hardware thread register in response to receiving a first memory access request associated with a first hardware thread of a process. The processor further includes memory controller circuitry communicatively coupled to the first core. The memory controller circuitry is to obtain a first encryption key associated with the first key identifier.

Example AA2 comprises the subject matter of Example AA1 or AS1, and the first core is further to select the first key identifier stored in the first hardware thread register based, at least in part, on a first portion of a pointer of the first memory access request.

Example AA3 comprises the subject matter of Example AA2, and to select the first key identifier is to include determining that the first portion of the pointer includes a first value stored in a plurality of bits corresponding to a first group selector stored in the first hardware thread register, and obtaining the first key identifier that is mapped to the first group selector in the first hardware thread register.

Example AA4 comprises the subject matter of Example AA3, and a first mapping of the first group selector to the first key identifier is stored in the first hardware thread register.

Example AA5 comprises the subject matter of Example AA4, and based on the first key identifier being assigned to the first hardware thread for a private memory region in a process address space of the process, the first mapping is to be stored only in the first hardware thread register of a plurality of hardware thread registers associated respectively with a plurality of hardware threads of the process.

Example AA6 comprises the subject matter of Example AA4, and based on the first key identifier being assigned to the first hardware thread and one or more other hardware threads of the process for a shared memory region in a process address space of the process, the first mapping is to be stored in the first hardware thread register and one or more other hardware thread registers associated respectively with the one or more other hardware threads of the process.

Example AA7 comprises the subject matter of Example AA2, and the first portion of the pointer includes at least one bit containing a value that indicates whether a memory type of a memory location referenced by the pointer is private or shared.

Example AA8 comprises the subject matter of any one of Examples AA2-AA7, and the memory controller circuitry is further to append the first key identifier selected from the first hardware thread register to a physical address translated from a linear address at least partially included in the pointer.

Example AA9 comprises the subject matter of Example AA8, and further comprises a buffer including a translation of the linear address to the physical address, and the first key identifier is omitted from the physical address stored in the buffer.

Example AA10 comprises the subject matter of any one of Examples AA8-AA9, and the memory controller circuitry is further to translate, prior to appending the first key identifier selected from the first hardware thread register to the physical address, and the linear address to the physical address is based on a translation of the linear address to the physical address stored in a buffer.

Example AA11 comprises the subject matter of any one of Examples AA1-AA10 or AS1, and the first core is further to determine that one or more implicit policies are to be evaluated to identify which hardware thread register of a plurality of hardware thread registers of the first core is to be used for the first memory access request.

Example AA12 comprises the subject matter of Example AA11, and the first core is further to invoke a first policy to identify the first hardware thread register based, at least in part, on a first memory indicator of a physical page mapped to a first linear address of the first memory access request.

Example AA13 comprises the subject matter of any one of Examples AA1-AA12 or AS1, and further comprises a second core including a second hardware thread register. The second core is to select a second key identifier stored in the second hardware thread register in response to receiving a second memory access request associated with a second hardware thread of the process, and the memory controller circuitry is further coupled to the second core and is to obtain a second encryption key associated with the second key identifier.

Example AA14 comprises the subject matter of Example AA13, and a physical memory page associated with the first memory access request and the second memory access request is to include a first cache line containing first data or first code that is encrypted based on the first encryption key associated with the first key identifier, and a second cache line containing second data or second that is encrypted based on the second encryption key associated with the second key identifier.

Example AA15 comprises the subject matter of any one of Examples AA1-AA14 or AS1, and the first memory access request corresponds to one of a first instruction to load data from memory, a second instruction to store data in the memory, or a third instruction to fetch code to be executed from the memory.

Example AM1 provides a method including storing, in a first hardware thread register of a first core of a processor, a first key identifier assigned to a first hardware thread of a process, receiving a first memory access request associated with the first hardware thread, selecting the first key identifier stored in the first hardware thread register in response to receiving the first memory access request, and obtaining a first encryption key associated with the first key identifier.

Example AM2 comprises the subject matter of Example AM1, and further comprises selecting the first key identifier stored in the first hardware thread register based, at least in part, on a first portion of a pointer of the first memory access request.

Example AM3 comprises the subject matter of Example AM2, and the selecting the first key identifier includes determining that the first portion of the pointer includes a first value stored in a plurality of bits corresponding to a first group selector stored in the first hardware thread register, and obtaining the first key identifier that is mapped to the first group selector in the first hardware thread register.

Example AM4 comprises the subject matter of Example AM3, and a first mapping of the first group selector to the first key identifier is stored in the first hardware thread register, and the first hardware thread register is one of a plurality of hardware thread registers associated respectively with a plurality of hardware threads of the process.

Example AM5 comprises the subject matter of Example AM4, and further comprises assigning the first key identifier to the first hardware thread for a private memory region in a process address space of the process, and in response to the assigning the first key identifier to the first hardware thread register for the private memory region, storing the first mapping only in the first hardware thread register of the plurality of hardware thread registers.

Example AM6 comprises the subject matter of Example AM4, and further comprises assigning the first key identifier to the first hardware thread for a shared memory region in a process address space of the process, and in response to the assigning the first key identifier to the first hardware thread register for the shared memory region, storing the first mapping in the first hardware thread register and one or more other hardware thread registers of the plurality of hardware thread registers.

Example AM7 comprises the subject matter of Example AM2, and further comprises determining whether a memory type of a memory location referenced by the pointer is private or shared based on a first value stored in at least one bit of the first portion of the pointer, and obtaining the first key identifier based on the determined memory type.

Example AM8 comprises the subject matter of any one of Examples AM2-AM7, and further comprises appending the first key identifier selected from the first hardware thread register to a physical address translated from a linear address at least partially included in the pointer.

Example AM9 comprises the subject matter of Example AM8, and further comprises omitting the first key identifier from the physical address stored in a translation lookaside buffer.

Example AM10 comprises the subject matter of any one of Examples AM8-AM9, and further comprises translating, prior to appending the first key identifier selected from the first hardware thread register to the physical address, the linear address to the physical address based on a translation of the linear address to the physical address stored in a translation lookaside buffer.

Example AM11 comprises the subject matter of any one of Examples AM1-AM10, and selecting the first key identifier includes determining that one or more implicit policies are to be evaluated to identify which hardware thread register of a plurality of hardware thread registers of the first core is to be used for the first memory access request.

Example AM12 comprises the subject matter of Example AM11, and further comprises invoking a first policy to identify the first hardware thread register based, at least in part, on a first memory indicator of a physical page mapped to a first linear address of the first memory access request.

Example AM13 comprises the subject matter of any one of Examples AM1-AM12, and further comprises storing, in a second hardware thread register, a second key identifier assigned to a second hardware thread of the process, receiving a second memory access request associated with the second hardware thread, selecting the second key identifier stored in the second hardware thread register, and obtaining a second encryption key associated with the second key identifier.

Example AM14 comprises the subject matter of Example AM13, and a physical memory page associated with the first memory access request and the second memory access request includes a first cache line containing first data or first code that is encrypted based on the first encryption key associated with the first key identifier, and a second cache line containing second data or second that is encrypted based on the second encryption key associated with the second key identifier.

Example AM15 comprises the subject matter of any one of Examples AM1-AM14, and the first memory access request corresponds to one of a first instruction to load data from memory, a second instruction to store data in the memory, or a third instruction to fetch code to be executed from the memory.

Example AC1 provides one or more machine readable media including instructions stored thereon that, when executed by a processor, cause the processor to perform operations comprising receiving a first memory access request associated with a first hardware thread of a process and the first hardware thread is provided on a first core, selecting a first key identifier stored in a first hardware thread register in the first core, the first hardware thread register associated with the first hardware thread, and obtaining a first encryption key associated with the first key identifier.

Example AC2 comprises the subject matter of Example AC1, and when executed by the processor, the instructions cause the processor to perform further operations comprising selecting the first key identifier stored in the first hardware thread register based, at least in part, on a first portion of a pointer of the first memory access request.

Example AC3 comprises the subject matter of Example AC2, and the selecting the first key identifier is to include determining that the first portion of the pointer includes a first value stored in a plurality of bits corresponding to a first group selector stored in the first hardware thread register, and obtaining the first key identifier that is mapped to the first group selector in the first hardware thread register.

Example AC4 comprises the subject matter of Example AC3, and a first mapping of the first group selector to the first key identifier is stored in the first hardware thread register.

Example AC5 comprises the subject matter of Example AC4, and based on the first key identifier being assigned to the first hardware thread for a private memory region in a process address space of the process, the first mapping is to be stored only in the first hardware thread register of a plurality of hardware thread registers associated respectively with a plurality of hardware threads of the process.

Example AC6 comprises the subject matter of Example AC4, and based on the first key identifier being assigned to the first hardware thread and one or more other hardware threads of the process for a shared memory region in a process address space of the process, the first mapping is to be stored in the first hardware thread register and one or more other hardware thread registers associated respectively with the one or more other hardware threads of the process.

Example AC7 comprises the subject matter of Example AC2, and the first portion of the pointer includes at least one bit containing a value that indicates whether a memory type of a memory location referenced by the pointer is private or shared.

Example AC8 comprises the subject matter of any one of Examples AC2-AC7, and when executed by the processor, the instructions cause the processor to perform further operations comprising appending the first key identifier selected from the first hardware thread register to a physical address translated from a linear address at least partially included in the pointer.

Example AC9 comprises the subject matter of Example AC8, and when executed by the processor, the instructions cause the processor to perform further operations comprising omitting the first key identifier from the physical address stored in a translation lookaside buffer.

Example AC10 comprises the subject matter of any one of Examples AC8-AC9, and when executed by the processor, the instructions cause the processor to perform further operations comprising translating, prior to appending the first key identifier selected from the first hardware thread register to the physical address, the linear address to the physical address based on a translation of the linear address to the physical address stored in a translation lookaside buffer.

Example AC11 comprises the subject matter of any one of Examples AC1-AC10, and when executed by the processor, the instructions cause the processor to perform further operations comprising determining that one or more implicit policies are to be evaluated to identify which hardware thread register of a plurality of hardware thread registers of the first core is to be used for the first memory access request.

Example AC12 comprises the subject matter of Example AC11, and selecting the first key identifier is to include invoking a first policy to identify the first hardware thread register based, at least in part, on a first memory indicator of a physical page mapped to a first linear address of the first memory access request.

Example AC13 comprises the subject matter of any one of Examples AC1-AC12, and when executed by the processor, the instructions cause the processor to perform further operations comprising receiving a second memory access request associated with a second hardware thread of the process, selecting a second key identifier stored in a second hardware thread register associated with the second hardware thread, and obtaining a second encryption key associated with the second key identifier.

Example AC14 comprises the subject matter of Example AC13, and a physical memory page associated with the first memory access request and the second memory access request includes a first cache line containing first data or first code that is encrypted based on the first encryption key associated with the first key identifier, and a second cache line containing second data or second that is encrypted based on the second encryption key associated with the second key identifier.

Example AC15 comprises the subject matter of any one of Examples AC1-AC14, and the first memory access request corresponds to one of a first instruction to load data from memory, a second instruction to store data in the memory, or a third instruction to fetch code to be executed from the memory.

Example BS1 provides a system including a memory and a processor communicatively coupled to the memory. The processor includes a first core, and the first core includes a first hardware thread register and is configured to support a first hardware thread of a process. The first core is to determine that a first policy is to be invoked for a first memory access request associated with the first hardware thread, and select a first key identifier stored in the first hardware thread register based on the first policy. The processor further includes memory controller circuitry communicatively coupled to the first core, and the memory controller circuitry is to obtain a first encryption key associated with the first key identifier.

Example BA1 provides a processor comprising a first core including a first hardware thread register. The first core is to determine that a first policy is to be invoked for a first memory access request associated with a first hardware thread of a process and select a first key identifier stored in the first hardware thread register based on the first policy. The processor further comprises memory controller circuitry communicatively coupled to the first core, and the memory controller circuitry is to obtain a first encryption key associated with the first key identifier.

Example BA2 comprises the subject matter of Example BA1 or BS1, and the first policy is to be invoked based, at least in part, on a first memory indicator of a physical page corresponding to a linear address of the first memory access request in a process address space of the process.

Example BA3 comprises the subject matter of Example BA2, and to determine that the first policy is to be invoked is to include determining that the first memory indicator indicates that the physical page is noncacheable.

Example BA4 comprises the subject matter of Example BA2, and to determine that the first policy is to be invoked is to include determining that the first memory indicator indicates that the physical page is a supervisor page mapped to the linear address in a kernel memory range in the process address space.

Example BA5 comprises the subject matter of Example BA2, and to determine that the first policy is to be invoked is to include determining that the first memory indicator indicates that the physical page is a user page mapped to the linear address in a user memory range in the process address space and determining that a second memory indicator indicates that the physical page contains executable code.

Example BA6 comprises the subject matter of Example BA2, and to determine that the first policy is to be invoked is to include determining that the first memory indicator indicates that the physical page is a user page mapped to the linear address in a user memory range in the process address space and determining that a second memory indicator indicates that the physical page is to be used for interprocess communication.

Example BA7 comprises the subject matter of Example BA1 or BS1, and the first policy is to be invoked based, at least in part, on a first portion of a first pointer of the first memory access request to a linear address in a process address space of the process.

Example BA8 comprises the subject matter of Example BA7, and to determine that the first policy is to be invoked is to include determining that the linear address is located in a private memory region of the first hardware thread in the process address space.

Example BA9 comprises the subject matter of Example BA7, and to determine that the first policy is to be invoked is to include determining that the first portion of the first pointer contains a value indicating that the linear address is located in a shared memory region of the process address space, and two or more hardware threads of the process are allowed to access the shared memory region.

Example BA10 comprises the subject matter of any one of Examples BA1-BA9 or BS1, and the memory controller circuitry is further to append the first key identifier selected from the first hardware thread register to a physical address translated from a linear address at least partially contained in a pointer used by the first memory access request.

Example BA11 comprises the subject matter of Example BA10, and further comprises a buffer including a translation of the linear address to the physical address, and the first key identifier is omitted from the physical address stored in the buffer.

Example BA12 comprises the subject matter of Example BA11, and the first core is further to translate, prior to appending the first key identifier selected from the first hardware thread register to the physical address, the linear address to the physical address based on the translation of the linear address to the physical address stored in the buffer.

Example BA13 comprises the subject matter of any one of Examples BA1-BA12 or BS1, and further comprises a second core including a second hardware thread register, and the second core is to determine that a second policy is to be invoked for a second memory access request of the second hardware thread register, select a second key identifier stored in the second hardware thread register based on the second policy, and obtain a second encryption key associated with the second key identifier.

Example BA14 comprises the subject matter of Example BA13, and a physical page associated with the first memory access request and the second memory access request is to include a first cache line containing first data or first code that is encrypted based on the first encryption key associated with the first key identifier and a second cache line containing second data or second that is encrypted based on the second encryption key associated with the second key identifier.

Example BA15 comprises the subject matter of any one of Examples BA1-BA14 or BS1, and the first memory access request corresponds to one of a first instruction to load data from memory, a second instruction to store data in the memory, or a third instruction to fetch code to be executed from the memory.

Example BM1 provides a method comprising storing, in a first hardware thread register of a first core of a processor, a first key identifier assigned to a first hardware thread of a process, determining that a first policy is to be invoked for a first memory access request associated with the first hardware thread, selecting the first key identifier stored in the first hardware thread register based on the first policy, and obtaining a first encryption key associated with the first key identifier.

Example BM2 comprises the subject matter of Example BM1, and the first policy is to be invoked based, at least in part, on a first memory indicator of a physical page corresponding to a linear address of the first memory access request in a process address space of the process.

Example BM3 comprises the subject matter of Example BM2, and the determining that the first policy is to be invoked includes determining that the first memory indicator indicates that the physical page is noncacheable.

Example BM4 comprises the subject matter of Example BM2, and the determining that the first policy is to be invoked includes determining that the first memory indicator indicates that the physical page is a supervisor page mapped to the linear address in a kernel memory range in the process address space.

Example BM5 comprises the subject matter of Example BM2, and the determining that the first policy is to be invoked includes determining that the first memory indicator indicates that the physical page is a user page mapped to the linear address in a user memory range in the process address space and determining that a second memory indicator indicates that the physical page contains executable code.

Example BM6 comprises the subject matter of Example BM2, and the determining that the first policy is to be invoked includes determining that the first memory indicator indicates that the physical page is a user page mapped to the linear address in a user memory range in the process address space and determining that a second memory indicator indicates that the physical page is to be used for interprocess communication.

Example BM7 comprises the subject matter of Example BM1, and the first policy is invoked based, at least in part, on a first portion of a first pointer of the first memory access request to a linear address in a process address space of the process.

Example BM8 comprises the subject matter of Example BM7, and the determining that the first policy is to be invoked includes determining that the linear address is located in a private memory region of the first hardware thread in the process address space.

Example BM9 comprises the subject matter of Example BM7, and the determining that the first policy is to be invoked includes determining that the first portion of the first pointer contains a value indicating that the linear address is located in a shared memory region of the process address space, and two or more hardware threads of the process are allowed to access the shared memory region.

Example BM10 comprises the subject matter of any one of Examples BM1-BM9, and further comprises appending the first key identifier selected from the first hardware thread register to a physical address translated from the linear address.

Example BM11 comprises the subject matter of Example BM10, and a buffer includes a translation of the linear address to the physical address, and the first key identifier is omitted from the physical address stored in the buffer.

Example BM12 comprises the subject matter of Example BM11, and further comprises translating, prior to appending the first key identifier selected from the first hardware thread register to the physical address, the linear address to the physical address based on the translation of the linear address to the physical address stored in the buffer.

Example BM13 comprises the subject matter of any one of Examples BM1-BM12, and further comprises storing, in a second hardware thread register of a second core of the processor, a second key identifier assigned to a second hardware thread of the process, determining that a second policy is to be invoked for a second memory access request associated with the second hardware thread, selecting the second key identifier stored in the second hardware thread register based on the second policy, and obtaining a second encryption key associated with the second key identifier.

Example BM14 comprises the subject matter of Example BM13, and a physical page associated with the first memory access request and the second memory access request includes a first cache line containing first data or first code that is encrypted based on the first encryption key associated with the first key identifier and a second cache line containing second data or second that is encrypted based on the second encryption key associated with the second key identifier.

Example BM15 comprises the subject matter of any one of Examples BM1-BM14, and the first memory access request corresponds to one of a first instruction to load data from memory, a second instruction to store data in the memory, or a third instruction to fetch code to be executed from the memory.

Example CS1 provides a system including a memory to store instructions and a processor communicatively coupled to the memory. The processor is to execute the instructions to cause the processor to perform operations comprising generating a first mapping for address translation paging structures associated with a process address space of a process, and the first mapping is to translate a first linear address in a first memory allocation for a first software thread of the process to a physical address of a physical page in memory, assigning, in the first mapping, a first key identifier to the physical page, generating a second mapping for the address translation paging structures of the process, and the second mapping is to translate a second linear address in a second memory allocation for a second software thread of the process to the physical address of the physical page, and assigning, in the second mapping, a second key identifier to the physical page.

Example CA1 provides an apparatus comprising a processor configured to be communicatively coupled to a memory, the processor to execute instructions received from the memory to perform operations to generate a first mapping for address translation paging structures associated with a process address space of a process, the first mapping to translate a first linear address in a first memory allocation for a first software thread of the process to a physical address of a physical page in memory, assign, in the first mapping, a first key identifier to the physical page, generate a second mapping for the address translation paging structures of the process, the second mapping to translate a second linear address in a second memory allocation for a second software thread of the process to the physical address of the physical page, and assign, in the second mapping, a second key identifier to the physical page.

Example CA2 comprises the subject matter of Example CA1 or CS1, and the address translation paging structures include a plurality of mappings, and the plurality of mappings either translate a plurality of linear addresses to a plurality of physical addresses of respective physical pages or translate a plurality of guest linear addresses to the plurality of physical addresses of respective physical pages of a host machine.

Example CA3 comprises the subject matter of any one of Examples CA1-CA2 or CS1, and to assign the first key identifier to the physical page is to include encoding the first key identifier in the physical address stored in a first page table entry of the first mapping.

Example CA4 comprises the subject matter of Example CA3, and to assign the second key identifier to the physical page is to include encoding the second key identifier in the physical address stored in a second page table entry of the second mapping.

Example CA5 comprises the subject matter of Example CA4, and the processor is to execute the instructions to perform further operations to, prior to encoding the first key identifier in the physical address stored in the first page table entry, retrieve the first key identifier from a first thread control block of the first software thread, and prior to encoding the second key identifier in the physical address stored in the second page table entry, retrieve the second key identifier from a second thread control block of the second software thread.

Example CA6 comprises the subject matter of any one of Examples CA1-CA5 or CS1, and the processor is to execute the instructions to perform further operations to store the first key identifier in a first thread control block of the first software thread and store the second key identifier in a second thread control block of the second software thread.

Example CA7 comprises the subject matter of Example CA6, and the processor is to execute the instructions to perform further operations to program the first key identifier for a first private data region of the first software thread, the first private data region to include the first memory allocation and program the second key identifier for a second private data region of the second software thread, and the second private data region is to include the second memory allocation.

Example CA8 comprises the subject matter of Example CA7, and the first private data region includes a first portion of heap memory of the process address space, and the second private data region includes a second portion of the heap memory of the process address space.

Example CA9 comprises the subject matter of any one of Examples CA1-CA8 or CS1, and the processor is to execute the instructions to perform further operations to associate a first cryptographic key to the first key identifier and associate a second cryptographic key to the second key identifier.

Example CA10 comprises the subject matter of Example CA9, and the first cryptographic key is to be used to perform cryptographic operations on first data stored in a first portion of the physical page, and the second cryptographic key is to be used to perform the cryptographic operations on second data stored in a second portion of the physical page.

Example CA11 comprises the subject matter of any one of Examples CA1-CA10 or CS1, and the first memory allocation is contained in a first linear page of the process address space.

Example CA12 comprises the subject matter of Example CA11, and the second memory allocation is contained in a second linear page of the process address space.

Example CA13 comprises the subject matter of Example CA11, and the second memory allocation is contained in the first linear page of the process address space.

Example CA14 comprises the subject matter of Example CA13, and the processor is to execute the instructions to perform further operations to encode a first pointer to the first memory allocation with the first key identifier and encode a second pointer to the second memory allocation with the second key identifier.

Example CA15 comprises the subject matter of any one of Examples CA1-CA14 or CS1, and the processor is to execute the instructions to perform further operations to generate a third mapping for the address translation paging structures, the third mapping to translate a third linear address of a shared memory region in the process address space to the physical address of the physical page and assign, in the third mapping, a third key identifier to the physical page.

Example CM1 provides a method comprising generating a first mapping for address translation paging structures associated with a process address space of a process, the first mapping to translate a first linear address in a first memory allocation for a first software thread of the process to a physical address of a physical page in memory, assigning, in the first mapping, a first key identifier to the physical page, generating a second mapping for the address translation paging structures of the process, the second mapping to translate a second linear address in a second memory allocation for a second software thread of the process to the physical address of the physical page, and assigning in the second mapping a second key identifier to the physical page.

Example CM2 comprises the subject matter of Example CM1, and the address translation paging structures include a plurality of mappings, and the plurality of mappings either translate a plurality of linear addresses to a plurality of physical addresses of respective physical pages or translate a plurality of guest linear addresses to the plurality of physical addresses of respective physical pages of a host machine.

Example CM3 comprises the subject matter of any one of Examples CM1-CM2, and the assigning the first key identifier to the physical page includes encoding the first key identifier in the physical address stored in a first page table entry of the first mapping.

Example CM4 comprises the subject matter of Example CM3, and the assigning the second key identifier to the physical page includes encoding the second key identifier in the physical address stored in a second page table entry of the second mapping.

Example CM5 comprises the subject matter of Example CM4, and further comprises, prior to encoding the first key identifier in the physical address stored in the first page table entry, retrieving the first key identifier from a first thread control block of the first software thread and prior to encoding the second key identifier in the physical address stored in the second page table entry, retrieving the second key identifier from a second thread control block of the second software thread.

Example CM6 comprises the subject matter of any one of Examples CM1-CM5, and further comprises storing the first key identifier in a first thread control block of the first software thread and storing the second key identifier in a second thread control block of the second software thread.

Example CM7 comprises the subject matter of Example CM6, and further comprises programming the first key identifier for a first private data region of the first software thread, the first private data region including the first memory allocation and programming the second key identifier for a second private data region of the second software thread, the second private data region including the second memory allocation.

Example CM8 comprises the subject matter of Example CM7, and the first private data region includes a first portion of heap memory of the process address space, and the second private data region includes a second portion of the heap memory of the process address space.

Example CM9 comprises the subject matter of any one of Examples CM1-CM8, and further comprises associating a first cryptographic key to the first key identifier and associating a second cryptographic key to the second key identifier.

Example CM10 comprises the subject matter of Example CM9, and further comprises using the first cryptographic key to perform cryptographic operations on first data stored in a first portion of the physical page and using the second cryptographic key to perform the cryptographic operations on second data stored in a second portion of the physical page.

Example CM11 comprises the subject matter of any one of Examples CM1-CM10, and the first memory allocation is contained in a first linear page of the process address space.

Example CM12 comprises the subject matter of Example CM11, and the second memory allocation is contained in a second linear page of the process address space.

Example CM13 comprises the subject matter of Example CM11, and the second memory allocation is contained in the first linear page of the process address space.

Example CM14 comprises the subject matter of Example CM13, and further comprises encoding a first pointer to the first memory allocation with the first key identifier and encoding a second pointer to the second memory allocation with the second key identifier.

Example CM15 comprises the subject matter of any one of Examples CM1-CM14, and further comprises generating a third mapping for the address translation paging structures, the third mapping to translate a third linear address of a shared memory region in the process address space to the physical address of the physical page, and assigning, in the third mapping, a third key identifier to the physical page.

Example CC1 provides one or more machine readable media including instructions stored thereon that, when executed by a processor, cause the processor to perform operations comprising generating a first mapping for address translation paging structures associated with a process address space of a process, the first mapping to translate a first linear address in a first memory allocation for a first software thread of the process to a physical address of a physical page in memory, assigning in the first mapping a first key identifier to the physical page, generating a second mapping for the address translation paging structures of the process, the second mapping to translate a second linear address in a second memory allocation for a second software thread of the process to the physical address of the physical page, and assigning, in the second mapping, a second key identifier to the physical page.

Example CC2 comprises the subject matter of Example CC1, and the address translation paging structures include a plurality of mappings, and the plurality of mappings translate a plurality of linear addresses to a plurality of physical addresses of respective physical pages, or the plurality of mappings translate a plurality of guest linear addresses to the plurality of physical addresses of a host machine.

Example CC3 comprises the subject matter of any one of Examples CC1-CC2, and the assigning the first key identifier to the physical page is to include encoding the first key identifier in the physical address stored in a first page table entry of the first mapping.

Example CC4 comprises the subject matter of Example CC3, and the assigning the second key identifier to the physical page is to include encoding the second key identifier in the physical address stored in a second page table entry of the second mapping.

Example CC5 comprises the subject matter of Example CC4, and when executed by the processor, the instructions cause the processor to perform further operations comprising, prior to encoding the first key identifier in the physical address stored in the first page table entry, retrieving the first key identifier from a first thread control block of the first software thread and prior to encoding the second key identifier in the physical address stored in the second page table entry, retrieving the second key identifier from a second thread control block of the second software thread.

Example CC6 comprises the subject matter of any one of Examples CC1-CC5, and when executed by the processor, the instructions cause the processor to perform further operations comprising storing the first key identifier in a first thread control block of the first software thread and storing the second key identifier in a second thread control block of the second software thread.

Example CC7 comprises the subject matter of Example CC6, and, when executed by the processor, the instructions cause the processor to perform further operations comprising programming the first key identifier for a first private data region of the first software thread, the first private data region to include the first memory allocation and programming the second key identifier for a second private data region of the second software thread, the second private data region to include the second memory allocation.

Example CC8 comprises the subject matter of Example CC7, and the first private data region includes a first portion of heap memory of the process address space, and the second private data region includes a second portion of the heap memory of the process address space.

Example CC9 comprises the subject matter of any one of Examples CC1-CC8, and, when executed by the processor, the instructions cause the processor to perform further operations comprising associating a first cryptographic key to the first key identifier and associating a second cryptographic key to the second key identifier.

Example CC10 comprises the subject matter of Example CC9, and the first cryptographic key is to be used to perform cryptographic operations on first data stored in a first portion of the physical page, and the second cryptographic key is to be used to perform the cryptographic operations on second data stored in a second portion of the physical page.

Example CC11 comprises the subject matter of any one of Examples CC1-CC10, and the first memory allocation is contained in a first linear page of the process address space.

Example CC12 comprises the subject matter of Example CC11, and the second memory allocation is contained in a second linear page of the process address space.

Example CC13 comprises the subject matter of Example CC11, and the second memory allocation is contained in the first linear page of the process address space.

Example CC14 comprises the subject matter of Example CC13, and when executed by the processor, the instructions cause the processor to perform further operations comprising using the first key identifier to encode a first pointer to the first memory allocation with the first key identifier and using the second key identifier to encode the second key identifier in a second pointer to the second memory allocation.

Example CC15 comprises the subject matter of any one of Examples CC1-CC14, and when executed by the processor, the instructions cause the processor to perform further operations comprising generating a third mapping for the address translation paging structures, the third mapping to translate a third linear address of a shared memory region in the process address space to the physical address of the physical page and assigning, in the third mapping, a third key identifier to the physical page.

Example DS1 provides a system comprising a memory to store instructions and a processor communicatively coupled to the memory, and the processor is to execute the instructions to cause the processor to perform operations comprising: assigning, in first paging structures of a first software thread configured to run on a first hardware thread of a process, a first private key identifier to a first physical page in physical memory, the first physical page mapped to a first private data region allocated to the first software thread in a guest linear address (GLA) space of the process; and assigning, in second paging structures of a second software thread configured to run on a second hardware thread of the process, a second private key identifier to the first physical page, the first physical page further mapped to a second private data region allocated to the second software thread in the GLA space of the process.

Example DA1 provides an apparatus comprising a processor configured to be communicatively coupled to a memory, and the processor is to execute instructions received from the memory to perform operations comprising: assigning, in first paging structures of a first software thread configured to run on a first hardware thread of a process, a first private key identifier to a first physical page in physical memory, the first physical page mapped to a first private data region allocated to the first software thread in a guest linear address (GLA) space of the process; and assigning, in second paging structures of a second software thread configured to run on a second hardware thread of the process, a second private key identifier to the first physical page, the first physical page further mapped to a second private data region allocated to the second software thread in the GLA space of the process.

Example DA2 comprises the subject matter of Example DA1 or DS1, and the processor is to execute the instructions to perform further operations comprising: creating, in guest linear address translation (GLAT) paging structures, a first mapping from the first private data region to a first guest physical address (GPA) in a guest physical address space of the process; and creating, in the first paging structures of the first software thread, a second mapping from the first GPA to a first host physical address (HPA) of the first physical page.

Example DA3 comprises the subject matter of Example DA2, and the processor is to execute the instructions to perform further operations comprising storing the first HPA in a first page table entry of a first page table of the first paging structures; and storing the first private key identifier in a number of bits in the first HPA stored in the first page table entry.

Example DA4 comprises the subject matter of any one of Examples DA2-DA3, and the processor is to execute the instructions to perform further operations comprising creating, in the GLAT paging structures, a third mapping from the second private data region to the first GPA in the guest physical address space of the process; and creating, in the second paging structures of the second software thread, a fourth mapping from the first GPA to the first HPA of the first physical page.

Example DA5 comprises the subject matter of Example DA4, and the processor is to execute the instructions to perform further operations comprising storing the first HPA in a second page table entry of a second page table of the second paging structures; and storing the second private key identifier in a number of bits in the first HPA stored in the second page table entry of the second paging structures.

Example DA6 comprises the subject matter of any one of Examples DA2-DA5 or DS1, and the processor is to execute the instructions to perform further operations comprising storing the first GPA in a third page table entry of a third page table in the GLAT paging structures.

Example DA7 comprises the subject matter of Example DA2, and the first software thread is to use the GLAT paging structures and the first paging structures to access a first location in the first physical page mapped to the first private data region, and the second software thread is to use the GLAT paging structures and the second paging structures to access a second location in the first physical page mapped to the second private data region.

Example DA8 comprises the subject matter of any one of Examples DA1-DA7 or DS1, and the first paging structures represent first extended page table (EPT) paging structures, and the second paging structures represent second EPT paging structures.

Example DA9 comprises the subject matter of any one of Examples DA1-DA8 or DS1, and the processor is to execute the instructions to perform further operations comprising programming the first private key identifier for the first private data region; and programming the second private key identifier for the second private data region.

Example DA10 comprises the subject matter of any one of Examples DA1-DA9 or DS1, and the first private key identifier is to be associated with a first cryptographic key, and the second private key identifier is to be associated with a second cryptographic key.

Example DA11 comprises the subject matter of any one of Examples DA1-DA10 or DS1, and the processor is to execute the instructions to perform further operations comprising assigning, via a fourth page table entry in a fourth page table, a shared key identifier to a second physical page in the physical memory, the second physical page corresponding to a first shared data region in the GLA space of the process.

Example DA12 comprises the subject matter of Example DA11, and the processor is to execute the instructions to perform further operations comprising storing, in the fourth page table entry, a second HPA of the second physical page; creating, in guest linear address translation (GLAT) paging structures, a fifth mapping from the first shared data region to a second GPA in guest physical address space of the process; and storing the shared key identifier in a number of bits of the second HPA stored in the fourth page table entry.

Example DA13 comprises the subject matter of Example DA12, and the processor is to execute the instructions to perform further operations comprising, in response to determining that the first software thread is authorized to access the first shared data region, creating a sixth mapping in the first paging structures from the second GPA to the second HPA in the fourth page table entry.

Example DA14 comprises the subject matter of any one of Examples DA12-DA13, and the processor is to execute the instructions to perform further operations comprising, in response to determining that the second software thread is authorized to access the first shared data region, creating a seventh mapping in the second paging structures from the second GPA to the second HPA in the fourth page table entry.

Example DA15 comprises the subject matter of any one of Examples DA12-DA13, and a mapping in the second paging structures from the second GPA to the second HPA is to be omitted based on the second software thread not being authorized to access the first shared data region.

Example DM1 provides a method comprising: assigning, in first paging structures of a first software thread configured to run on a first hardware thread of a process, a first private key identifier to a first physical page in physical memory, the first physical page mapped to a first private data region allocated to the first software thread in a guest linear address (GLA) space of the process; and assigning, in second paging structures of a second software thread configured to run on a second hardware thread of the process, a second private key identifier to the first physical page, the first physical page further mapped to a second private data region allocated to the second software thread in the GLA space of the process.

Example DM2 comprises the subject matter of Example DM1, and further comprises creating, in guest linear address translation (GLAT) paging structures, a first mapping from the first private data region to a first guest physical address (GPA) in a guest physical address space of the process; and creating, in the first paging structures of the first software thread, a second mapping from the first GPA to a first host physical address (HPA) of the first physical page.

Example DM3 comprises the subject matter of Example DM2, and further comprises storing the first HPA in a first page table entry of a first page table of the first paging structures and storing the first private key identifier in a number of bits in the first HPA stored in the first page table entry.

Example DM4 comprises the subject matter of any one of Examples DM2-DM3, and further comprises creating, in the GLAT paging structures, a third mapping from the second private data region to the first GPA in the guest physical address space of the process; and creating, in the second paging structures of the second software thread, a fourth mapping from the first GPA to the first HPA of the first physical page.

Example DM5 comprises the subject matter of Example DM4, and further comprises storing the first HPA in a second page table entry of a second page table of the second paging structures and storing the second private key identifier in a number of bits in the first HPA stored in the second page table entry of the second paging structures.

Example DM6 comprises the subject matter of any one of Examples DM2-DM5, and further comprises storing the first GPA in a third page table entry of a third page table in the GLAT paging structures.

Example DM7 comprises the subject matter of Example DM2, and the first software thread uses the GLAT paging structures and the first paging structures to access a first location in the first physical page mapped to the first private data region, and the second software thread uses the GLAT paging structures and the second paging structures to access a second location in the first physical page mapped to the second private data region.

Example DM8 comprises the subject matter of any one of Examples DM1-DM7, and the first paging structures represent first extended page table (EPT) paging structures, and the second paging structures represent second EPT paging structures.

Example DM9 comprises the subject matter of any one of Examples DM1-DM8, and further comprises programming the first private key identifier for the first private data region and programming the second private key identifier for the second private data region.

Example DM10 comprises the subject matter of any one of Examples DM1-DM9, and the first private key identifier is associated with a first cryptographic key, and the second private key identifier is associated with a second cryptographic key.

Example DM11 comprises the subject matter of any one of Examples DM1-DM10, and further comprises assigning, via a fourth page table entry in a fourth page table, a shared key identifier to a second physical page in the physical memory, the second physical page corresponding to a first shared data region in the GLA space of the process.

Example DM12 comprises the subject matter of Example DM11, and further comprises storing, in the fourth page table entry, a second HPA of the second physical page; creating, in guest linear address translation (GLAT) paging structures, a fifth mapping from the first shared data region to a second GPA in guest physical address space of the process; and storing the shared key identifier in a number of bits of the second HPA stored in the fourth page table entry.

Example DM13 comprises the subject matter of Example DM12, and further comprises, in response to determining that the first software thread is authorized to access the first shared data region, creating a sixth mapping in the first paging structures from the second GPA to the second HPA in the fourth page table entry.

Example DM14 comprises the subject matter of any one of Examples DM12-DM13, and further comprises, in response to determining that the second software thread is authorized to access the first shared data region, creating a seventh mapping in the second paging structures from the second GPA to the second HPA in the fourth page table entry.

Example DM15 comprises the subject matter of any one of Examples DM12-DM13, and a mapping in the second paging structures from the second GPA to the second HPA is omitted based on the second software thread not being authorized to access the first shared data region.

Example ES1 provides a system comprising a memory to store data and code of a process, a processor including at least a first core to support a first hardware thread of the process, and memory controller circuitry coupled to the first core and the memory, and the memory controller circuitry is to obtain a first key identifier assigned to a first memory region targeted by a first memory access request associated with the first hardware thread, generate a first combination identifier based, at least in part, on the first key identifier and a first hardware thread identifier assigned to the first hardware thread, and obtain a first cryptographic key based on the first combination identifier.

Example EA1 provides a processor comprising a first core to support a first hardware thread of a process, and memory controller circuitry coupled to the first core, and the memory controller circuitry is to obtain a first key identifier assigned to a first memory region targeted by a first memory access request associated with the first hardware thread, generate a first combination identifier based, at least in part, on the first key identifier and a first hardware thread identifier assigned to the first hardware thread, and obtain a first cryptographic key based on the first combination identifier.

Example EA2 comprises the subject matter of Example EA1 or ES1, and to generate the first combination identifier is to include concatenating the first key identifier with the first hardware thread identifier.

Example EA3 comprises the subject matter of any one of Examples EA1-EA2 or ES1, and the memory controller circuitry is further to search a key mapping table based on the first combination identifier, identify a key mapping containing the first combination identifier, and obtain the first cryptographic key from the identified key mapping.

Example EA4 comprises the subject matter of Example EA3, and the memory controller circuitry is further to use paging structures created for an address space of the process to translate a linear address associated with the first memory access request to a physical address in a physical page of memory.

Example EA5 comprises the subject matter of Example EA4, and the first key identifier is to be obtained from selected bits of the physical address stored in a page table entry in a page table of the paging structures.

Example EA6 comprises the subject matter of any one of Examples EA1-EA5 or ES1, and the first memory region and a second memory region are separate private memory regions in a single address space of the process.

Example EA7 comprises the subject matter of Example EA6, and further comprises a second core to support a second hardware thread of the process, and the memory controller circuitry is further to obtain a second key identifier assigned to the second memory region targeted by a second memory access request from the second hardware thread. generate a second combination identifier based, at least in part, on the second key identifier and a second hardware thread identifier assigned to the second hardware thread, and obtain a second cryptographic key based on the second combination identifier.

Example EA8 comprises the subject matter of any one of Examples EA1-EA7 or ES1, and further comprises a third core to support a third hardware thread of the process, and the first memory region is shared by at least the first hardware thread and the third hardware thread.

Example EA9 comprises the subject matter of Example EA8, and the memory controller circuitry is further to obtain the first key identifier assigned to the first memory region targeted by a third memory access request from the third hardware thread, generate a third combination identifier based, at least in part, on the first key identifier and a third hardware thread identifier assigned to the third hardware thread, and obtain the first cryptographic key based on the third combination identifier.

Example EA10 comprises the subject matter of any one of Examples EA1-EA9 or ES1, and the memory controller circuitry is further to in response to a new software thread being scheduled on the first hardware thread, remove from a key mapping table one or more key mappings containing one or more respective combination identifiers that include the first hardware thread identifier, and add to the key mapping table one or more new key mappings containing one or more respective new combination identifiers that include the first hardware thread identifier and one or more respective key identifiers assigned to one or more memory regions the new software thread is allowed to access.

Example EA11 comprises the subject matter of any one of Examples EA1-EA10 or ES1, and the memory controller circuitry is further to determine whether the first key identifier is active for the first hardware thread.

Example EA12 comprises the subject matter of Example EA11, and the memory controller circuitry is further to decode an encoded pointer of the first memory access request to obtain a linear address, and determining whether the first key identifier is active for the first hardware thread is to be performed prior to translating the linear address to a physical address in a physical page of memory.

Example EA13 comprises the subject matter of Example EA11, and the memory controller circuitry is further to decode an encoded pointer of the first memory access request to obtain a linear address, and determining whether the first key identifier is active for the first hardware thread is to be performed subsequent to translating the linear address to a physical address in a physical page of memory and prior to the first memory access request being ready to be issued from the first hardware thread to a cache.

Example EA14 comprises the subject matter of Example EA11, and determining whether the first key identifier is active for the first hardware thread is to be performed subsequent to the first memory access request being ready to be issued from the first hardware thread to a cache and prior to the first memory access request being issued from the first hardware thread to the cache.

Example EA15 comprises the subject matter of any one of Examples EA1-EA14 or ES1, and to determine whether the first key identifier is active for the first hardware thread is to include checking one or more bits corresponding to the first key identifier in a bitmask created for the first hardware thread.

Example EM1 provides a method comprising obtaining a first key identifier assigned to a first memory region targeted by a first memory access request associated with a first hardware thread of a process, and the first hardware thread is supported on a first core of a processor, generating a first combination identifier based, at least in part, on the first key identifier and a first hardware thread identifier assigned to the first hardware thread, and obtaining a first cryptographic key based on the first combination identifier.

Example EM2 comprises the subject matter of Example EM1, and generating the first combination identifier includes concatenating the first key identifier with the first hardware thread identifier.

Example EM3 comprises the subject matter of any one of Examples EM1-EM2, and further comprises searching a key mapping table based on the first combination identifier, identifying a key mapping containing the first combination identifier, and obtaining the first cryptographic key from the identified key mapping.

Example EM4 comprises the subject matter of Example EM3, and further comprises using paging structures created for an address space of the process to translate a linear address associated with the first memory access request to a physical address in a physical page of memory.

Example EM5 comprises the subject matter of Example EM4, and the first key identifier is obtained from selected bits of the physical address stored in a page table entry in a page table of the paging structures.

Example EM6 comprises the subject matter of any one of Examples EM1-EM5, and the first memory region and a second memory region are separate private memory regions in a single address space of the process.

Example EM7 comprises the subject matter of Example EM6, and further comprises obtaining a second key identifier assigned to the second memory region targeted by a second memory access request associated with a second hardware thread of the process, and the second hardware thread is supported by a second core of the processor, generating a second combination identifier based, at least in part, on the second key identifier and a second hardware thread identifier assigned to the second hardware thread, and obtaining a second cryptographic key based on the second combination identifier.

Example EM8 comprises the subject matter of any one of Examples EM1-EM7, and further comprises obtaining the first key identifier assigned to the first memory region targeted by a third memory access request associated with a third hardware thread of the process, generating a third combination identifier based, at least in part, on the first key identifier and a third hardware thread identifier assigned to the third hardware thread, and obtaining the first cryptographic key based on the third combination identifier.

Example EM9 comprises the subject matter of Example EM8, and the third hardware thread is supported by a third core of the processor.

Example EM10 comprises the subject matter of any one of Examples EM1-EM9, and further comprises, in response to a new software thread being scheduled on the first hardware thread, removing from a key mapping table one or more key mappings containing one or more respective combination identifiers that include the first hardware thread identifier, and adding to the key mapping table one or more new key mappings containing one or more respective new combination identifiers that include the first hardware thread identifier and one or more respective key identifiers assigned to one or more memory regions the new software thread is allowed to access.

Example EM11 comprises the subject matter of any one of Examples EM1-EM10, and further comprises determining whether the first key identifier is active for the first hardware thread.

Example EM12 comprises the subject matter of Example EM11, and further comprises decoding an encoded pointer of the first memory access request to obtain a linear address, and the determining whether the first key identifier is active for the first hardware thread is performed prior to translating the linear address to a physical address in a physical page of memory.

Example EM13 comprises the subject matter of Example EM11, and further comprises decoding an encoded pointer of the first memory access request to obtain a linear address, and the determining whether the first key identifier is active for the first hardware thread is performed subsequent to translating the linear address to a physical address in a physical page of memory and prior to the first memory access request being ready to be issued from the first hardware thread to a cache.

Example EM14 comprises the subject matter of Example EM11, and the determining whether the first key identifier is active for the first hardware thread is performed subsequent to the first memory access request being ready to be issued from the first hardware thread to a cache and prior to the first memory access request being issued from the first hardware thread to the cache.

Example EM15 comprises the subject matter of any one of Examples EM1-EM14, and the determining whether the first key identifier is active for the first hardware thread includes checking one or more bits corresponding to the first key identifier in a bitmask created for the first hardware thread.

Example FS1 provides a system comprising a memory to store data and code of a process, a processor including at least a first core to run a first software thread of the process, and memory controller circuitry coupled to the first core and the memory, and the memory controller circuitry is to obtain a first protection key that marks a first private data region associated with a first memory access request from the first software thread, determine a first key identifier associated with the first protection key, and obtain a first cryptographic key based on the first key identifier.

Example FA1 provides a processor comprising a first core to run a first software thread of a process, and memory controller circuitry coupled to the first core, and the memory controller circuitry is to obtain a first protection key that marks a first private data region associated with a first memory access request from the first software thread, determine a first key identifier associated with the first protection key, and obtain a first cryptographic key based on the first key identifier.

Example FA2 comprises the subject matter of Example FA1 or FS1, and further comprises a protection key mapping register in which a mapping of the first protection key to the first key identifier is stored.

Example FA3 comprises the subject matter of Example FA2, and to determine the first key identifier is to include searching the protection key mapping register based on the first protection key, identifying a first mapping containing the first protection key, and obtaining the first cryptographic key from the first mapping.

Example FA4 comprises the subject matter of Example FA3, and the first mapping is to be updated with a second key identifier for a second private data region when a new software thread of the process is scheduled for execution.

Example FA5 comprises the subject matter of any one of Examples FA1-FA4 or FS1, and the memory controller circuitry is further to determine whether the first software thread has permission to load or store data in the first private data region based on the first protection key and corresponding bits in a protection key register of a first hardware thread on which the first software thread is to run.

Example FA6 comprises the subject matter of any one of Examples FA1-FA5 or FS1, and to obtain the first protection key is to include translating a first linear address, associated with the first memory access request, to a host physical address of a physical memory page, the physical memory page including at least a portion of the first private data region.

Example FA7 comprises the subject matter of Example FA6, and the first protection key is obtained from selected bits of the host physical address.

Example FA8 comprises the subject matter of any one of Examples FA6-FA7, and the host physical address is stored in a page table entry in a page table of paging structures created for an address space of the process.

Example FA9 comprises the subject matter of any one of Examples FA1-FA8 or FS1, and further comprises a second core to run a second software thread of the process on a second hardware thread, and a first mapping for the first private data region of the first software thread is to be updated in response to the second software thread being scheduled to run on the second hardware thread of the second core.

Example FA10 comprises the subject matter of Example FA9, and the memory controller circuitry is coupled to the second core and is further to obtain the first protection key from a second host physical address associated with a second memory access request from the second software thread, and the first protection key in the second host physical address marks a second private data region.

Example FA11 comprises the subject matter of Example FA10, and the memory controller circuitry is further to determine a second key identifier associated with the first protection key obtained from the second host physical address, and obtain a second cryptographic key based on the second key identifier.

Example FA12 comprises the subject matter of any one of Examples FA1-FA11 or FS1, and the memory controller circuitry is further to obtain a second protection key that marks a first shared data region associated with a third memory access request from the first software thread, determine a third key identifier associated with the second protection key, and obtain a third cryptographic key based on the third key identifier.

Example FM1 provides a method comprising obtaining, by memory controller circuitry coupled to a first core of a processor, a first protection key that marks a first private data region associated with a first memory access request from a first software thread of a process when the first software thread is running on the first core, determining a first key identifier associated with the first protection key, and obtaining a first cryptographic key based on the first key identifier.

Example FM2 comprises the subject matter of Example FM1, and a mapping of the first protection key to the first key identifier is stored in a protection key mapping register.

Example FM3 comprises the subject matter of Example FM2, and the determining the first key identifier includes searching the protection key mapping register based on the first protection key, identifying a first mapping containing the first protection key, and obtaining the first cryptographic key from the first mapping.

Example FM4 comprises the subject matter of Example FM3, and the first mapping is updated with a second key identifier for a second private data region when a new software thread of the process is scheduled for execution.

Example FM5 comprises the subject matter of any one of Examples FM1-FM4, and further comprises determining whether the first software thread has permission to load or store data in the first private data region based on the first protection key and corresponding bits in a protection key register of a first hardware thread on which the first software thread is to run.

Example FM6 comprises the subject matter of any one of Examples FM1-FM5, and the obtaining the first protection key includes translating a first linear address, associated with the first memory access request, to a host physical address of a physical memory page, the physical memory page including at least a portion the first private data region.

Example FM7 comprises the subject matter of Example FM6, and the first protection key is obtained from selected bits of the host physical address.

Example FM8 comprises the subject matter of any one of Examples FM6-FM7, and the host physical address is stored in a page table entry in a page table of paging structures created for an address space of the process.

Example FM9 comprises the subject matter of any one of Examples FM1-FM8, and a first mapping for the first private data region of the first software thread is updated in response to a second software thread of the process being scheduled to run on a second hardware thread of a second core.

Example FM10 comprises the subject matter of Example FM9, and further comprises obtaining the first protection key from a second host physical address associated with a second memory access request from the second software thread of the process, and the first protection key in the second host physical address marks a second private data region.

Example FM11 comprises the subject matter of Example FM10, and further comprises determining a second key identifier associated with the first protection key obtained from the second host physical address and obtaining a second cryptographic key based on the second key identifier.

Example FM12 comprises the subject matter of any one of Examples FM1-FM11, and further comprises obtaining a second protection key that marks a first shared data region associated with a third memory access request from the first software thread, determining a third key identifier associated with the second protection key, and obtaining a third cryptographic key based on the third key identifier.

Example GS1 provides a system comprising memory to store an instruction and a processor coupled to the memory, and the processor includes: decoder circuitry to decode the instruction, the instruction to include a first field for a first identifier of a first source operand another field for an opcode, the opcode to indicate execution circuitry is to initialize a first capability register with a code capability associated with the first source operand, update a first key register with a code key indicator obtained based on the code capability, initialize a second capability register with a data capability, and update a second key register with a data key indicator obtained based on the data capability; and execution circuitry to execute the decoded instruction according to the opcode to initialize the first capability register with the code capability, update the first key register with the code key indicator obtained based on the code capability, initialize the second capability register with the data capability, and update the second key register with the data key indicator obtained based on the data capability.

Example GA1 provides an apparatus that comprises: decoder circuitry to decode an instruction, the instruction to include a first field for a first identifier of a first source operand another field for an opcode, the opcode to indicate that execution circuitry is to initialize a first capability register with a code capability associated with the first source operand, update a first key register with a code key indicator obtained based on the code capability, initialize a second capability register with a data capability, and update a second key register with a data key indicator obtained based on the data capability; and execution circuitry to execute the decoded instruction according to the opcode to initialize the first capability register with the code capability, update the first key register with the code key indicator obtained based on the code capability, initialize the second capability register with the data capability, and update the second key register with the data key indicator obtained based on the data capability.

Example GA2 comprises the subject matter of Example GAL or GS1, and the instruction is to further include a second field for a second identifier of a second source operand associated with the data capability.

Example GA3 comprises the subject matter of Example GA2, and the code capability is to reference a code address range of code in a compartment in memory, and the data capability is to reference a data address range of data in the compartment in the memory.

Example GA4 comprises the subject matter of Example GA3, and further comprises capability management circuitry to: check the code capability for a memory access request, the code capability comprising a first address field and a first bounds field that is to indicate a first lower bound and a first upper bound of the code address range to which the code capability authorizes access; and check the data capability for the memory access request, the data capability comprising a second address field and a second bounds field that is to indicate a second lower bound and a second upper bound of the data address range to which the data capability authorizes access.

Example GA5 comprises the subject matter of any one of Examples GA2-GA4, and the first field for the first identifier of the first source operand is to identify a code capability register containing the code capability.

Example GA6 comprises the subject matter of any one of Examples GA2-GA5, and the second field for the second identifier of the second source operand is to identify a data capability register containing the data capability.

Example GA7 comprises the subject matter of any one of Examples GA2-GA6, and the first field for the first identifier of the first source operand is to identify a first memory location of the code capability.

Example GA8 comprises the subject matter of any one of Examples GA2-GA4 or GA7, and the second field for the second identifier of the second source operand is to identify a second memory location of the data capability.

Example GA9 comprises the subject matter of any one of Examples GA1-GA8 or GS1, and the code key indicator is one of a first cryptographic key or a first key identifier associated with the first cryptographic key, and the data key indicator is one of a second cryptographic key or a second key identifier associated with the second cryptographic key.

Example GA10 comprises the subject matter of Example GA9, and the first key identifier is to be mapped to a first group selector in the first key register, and the second key identifier is to be mapped to a second group selector in the second key register.

Example GA11 comprises the subject matter of Example GA1 or GS1, and the first field for the first identifier of the first source operand is to identify a compartment descriptor capability to a compartment descriptor in memory, and the compartment descriptor specifies the code capability to a code address range in a compartment in the memory, and the compartment descriptor further specifies the data capability to a data address range in the compartment in the memory.

Example GA12 comprises the subject matter of Example GA11, and further comprises capability management circuitry, and the opcode is to further indicate that the execution circuitry is to: load the code capability from the compartment descriptor of the memory into a first register to enable the capability management circuitry to determine whether a first bounds field of the code capability authorizes access to a code element in the compartment of the memory; and load the data capability from the compartment descriptor of the memory into a second register to enable the capability management circuitry to determine that a second bounds field of the data capability authorizes access to a data element in the compartment of the memory

Example GA13 comprises the subject matter of any one of Examples GA11-GA12, and the first field for the first identifier of the first source operand is to identify a register containing the compartment descriptor capability.

Example GA14 comprises the subject matter of any one of Examples GA11-GA12, and the first field for the first identifier of the first source operand is to identify a first memory location of the compartment descriptor capability or the compartment descriptor.

Example GM1 provides a method that comprises: decoding, by decoder circuitry of a processor, an instruction into a decoded instruction, the decoded instruction including a first field for a first identifier of a first source operand another field for an opcode, and the opcode indicating that execution circuitry is to initialize a first capability register with a code capability associated with the first source operand, update a first key register with a code key indicator obtained based on the code capability, initialize a second capability register with a data capability, and update a second key register with a data key indicator obtained based on the data capability; and executing, by execution circuitry, the decoded instruction according to the opcode to initialize the first capability register with the code capability, update the first key register with the code key indicator obtained based on the code capability, initialize the second capability register with the data capability, and update the second key register with the data key indicator obtained based on the data capability.

Example GM2 comprises the subject matter of Example GM1, and the instruction further includes a second field for a second identifier of a second source operand associated with the data capability.

Example GM3 comprises the subject matter of Example GM2, and the code capability is to reference a code address range of code in a compartment in memory, and the data capability references a data address range of data in the compartment in the memory.

Example GM4 comprises the subject matter of Example GM3, and further comprises checking, by capability management circuitry of the processor, the code capability for a memory access request, the code capability comprising a first address field and a first bounds field that is to indicate a first lower bound and a first upper bound of the code address range to which the code capability authorizes access; and checking, by the capability management circuitry, the data capability for the memory access request, the data capability comprising a second address field and a second bounds field that is to indicate a second lower bound and a second upper bound of the data address range to which the data capability authorizes access.

Example GM5 comprises the subject matter of any one of Examples GM2-GM4, and the first field for the first identifier of the first source operand identifies a code capability register containing the code capability.

Example GM6 comprises the subject matter of any one of Examples GM2-GM5, and the second field for the second identifier of the second source operand identifies a data capability register containing the data capability.

Example GM7 comprises the subject matter of any one of Examples GM2-GM6, and the first field for the first identifier of the first source operand identifies a first memory location of the code capability.

Example GM8 comprises the subject matter of any one of Examples GM2-GM4 or GM7, and the second field for the second identifier of the second source operand identifies a second memory location of the data capability.

Example GM9 comprises the subject matter of any one of Examples GM1-GM8, and the code key indicator is one of a first cryptographic key or a first key identifier associated with the first cryptographic key, and the data key indicator is one of a second cryptographic key or a second key identifier associated with the second cryptographic key.

Example GM10 comprises the subject matter of Example GM9, and the first key identifier is mapped to a first group selector in the first key register, and the second key identifier is mapped to a second group selector in the second key register.

Example GM11 comprises the subject matter of Example GM1, and the first field for the first identifier of the first source operand identifies a compartment descriptor capability to a compartment descriptor in memory, and the compartment descriptor specifies the code capability to a code address range in a compartment in the memory, and the compartment descriptor further specifies the data capability to a data address range in the compartment in the memory.

Example GM12 comprises the subject matter of Example GM11, and further comprises loading the code capability from the compartment descriptor of the memory into a first register to enable a first determination of whether a first bounds field of the code capability authorizes an access to a code element in the compartment of the memory and loading the data capability from the compartment descriptor of the memory into a second register to enable a second determination of whether a second bounds field of the data capability authorizes access to a data element in the compartment of the memory.

Example GM13 comprises the subject matter of any one of Examples GM11-GM12, and the first field for the first identifier of the first source operand identifies a register containing the compartment descriptor capability.

Example GM14 comprises the subject matter of any one of Examples GM11-GM12, and the first field for the first identifier of the first source operand identifies a first memory location of the compartment descriptor capability or the compartment descriptor.

Example GC1 provides one or more machine readable media including an instruction stored thereon that, when executed by a processor, causes the processor to perform operations comprising initializing a first capability register with a code capability, updating a first key register with a code key indicator obtained based on the code capability, initializing a second capability register with a data capability, and updating a second key register with a data key indicator obtained based on the data capability.

Example GC2 comprises the subject matter of Example GC1, and the instruction includes a first field for a first identifier of a first source operand, a second field for a second identifier of a second source operand associated with the data capability, and a third field for an opcode.

Example GC3 comprises the subject matter of Example GC2, and the code capability is to reference a code address range of code in a compartment in memory, and the data capability is to reference a data address range of data in the compartment in the memory.

Example GC4 comprises the subject matter of Example GC3, and the instructions, when executed by the processor, cause the processor to perform further operations comprising checking the code capability for a memory access request, the code capability to include a first address field and a first bounds field that is to indicate a first lower bound and a first upper bound of the code address range to which the code capability authorizes access, and checking the data capability for the memory access request, the data capability to include a second address field and a second bounds field that is to indicate a second lower bound and a second upper bound of the data address range to which the data capability authorizes access.

Example GC5 comprises the subject matter of any one of Examples GC2-GC4, and the first field for the first identifier of the first source operand is to identify a code capability register containing the code capability.

Example GC6 comprises the subject matter of any one of Examples GC2-GC5, and the second field for the second identifier of the second source operand is to identify a data capability register containing the data capability.

Example GC7 comprises the subject matter of any one of Examples GC2-GC6, and the first field for the first identifier of the first source operand is to identify a first memory location of the code capability.

Example GC8 comprises the subject matter of any one of Examples GC2-GC4 or GC7, and the second field for the second identifier of the second source operand is to identify a second memory location of the data capability.

Example GC9 comprises the subject matter of any one of Examples GC1-GC8, and the code key indicator is one of a first cryptographic key or a first key identifier associated with the first cryptographic key, and the data key indicator is one of a second cryptographic key or a second key identifier associated with the second cryptographic key.

Example GC10 comprises the subject matter of Example GC9, and the first key identifier is to be mapped to a first group selector in the first key register, and the second key identifier is to be mapped to a second group selector in the second key register.

Example GC11 comprises the subject matter of Example GC1, and the instruction includes a first field for a first identifier of a first source operand and another field for an opcode, and the first field for the first identifier of the first source operand is to identify a compartment descriptor capability to a compartment descriptor in memory, and the compartment descriptor is to specify the code capability to a code address range in a compartment in the memory, and the compartment descriptor is to further specify the data capability to a data address range in the compartment in the memory.

Example GC12 comprises the subject matter of Example GC11, and the instructions, when executed by the processor, cause the processor to perform further operations comprising: loading the code capability from the compartment descriptor of the memory into a first register to enable a first determination of whether a first bounds field of the code capability authorizes an access to a code element in the compartment of the memory; and loading the data capability from the compartment descriptor of the memory into a second register to enable a second determination of whether a second bounds field of the data capability authorizes access to a data element in the compartment of the memory.

Example GC13 comprises the subject matter of any one of Examples GC11-GC12, and the first field for the first identifier of the first source operand is to identify a register containing the compartment descriptor capability.

Example GC14 comprises the subject matter of any one of Examples GC11-GC12, and the first field for the first identifier of the first source operand is to identify a first memory location of the compartment descriptor capability or the compartment descriptor.

Example X1 provides an apparatus, the apparatus comprising means for performing one or more elements of the method of any one Example of Examples AM1-AM15, BM1-BM15, CM1-CM15, DM1-DM15, EM1-EM15, FM1-FM12, and GM1-GM14.

Example X2 comprises the subject matter of Example X1 can optionally include that the means for performing the method comprises at least one processor and at least one memory element.

Example X3 comprises the subject matter of Example X2 can optionally include that the at least one memory element comprises machine readable instructions that when executed, cause the apparatus to perform the method of any one Example of the Examples AM1-AM15, BM1-BM15, CM1-CM15, DM1-DM15, EM1-EM15, FM1-FM12, and GM1-GM14.

Example X4 comprises the subject matter of any one of Examples X1-X3 can optionally include that the apparatus is one of a computing system, a processing element, or a system-on-a-chip.

Example Y1 includes at least one machine readable storage medium comprising instructions stored thereon, and the instructions when executed by one or more processors realize an apparatus of any one Example of Examples AA1-AA15, BA1-BA15, CA1-CA15, DA1-DA15, EA1-EA15, FA1-FA12, and GA1-GA14, realize a system of any one Example of Examples AA1-AA15, AS1, BA1-BA15, BS1, CA1-CA15, CS1, DA1-DA15, DS1, EA1-EA15, ES1, FA1-FA12, FS1, GA1-GA14, and GS1, or implement a method as in any one Example of Examples AM1-AM15, BM1-BM15, CM1-CM15, DM1-DM15, EM1-EM15, FM1-FM12, GM1-GM14, and X1-X4.

Example Y2 includes an apparatus comprising the features of any one of Examples AA1-AA15, any one of Examples BA1-BA15, any one of Examples CA1-CA15, any one of Examples DA1-DA15, any one of Examples EA1-EA15, any one of Examples FA1-FA12, and GA1-GA14, or any combination thereof (as far as those features are not redundant).

Example Y3 includes a method comprising the features of any one of Examples AM1-AM15, any one of Examples BM1-BM15, any one of Examples CM1-CM15, any one of Examples DM1-DM15, any one of Examples EM1-EM15, any one of Examples FM1-FM12, and any one of Examples GM1-GM14, or any combination thereof (as far as those features are not redundant).

Example Y4 includes a computer program comprising instructions, wherein execution of the program by a processing element is to cause the processing element to carry out the method, techniques, or process as described in or related to any one Example of Examples AM1-AM15, BM1-BM15, CM1-CM15, DM1-DM15, EM1-EM15, FM1-FM12, and GM1-GM14, or portions thereof.

1. A processor comprising:
a first core including a first hardware thread register, the first core to:
select a first key identifier stored in the first hardware thread register in response to receiving a first memory access request associated with a first hardware thread of a process; and
memory controller circuitry coupled to the first core, the memory controller circuitry to:
obtain a first encryption key associated with the first key identifier.

2. The processor of claim 1, wherein the first core is further to:
select the first key identifier stored in the first hardware thread register based, at least in part, on a first portion of a pointer of the first memory access request.

3. The processor of claim 2, wherein to select the first key identifier is to include:
determining that the first portion of the pointer includes a first value stored in a plurality of bits corresponding to a first group selector stored in the first hardware thread register; and
obtaining the first key identifier that is mapped to the first group selector in the first hardware thread register.

4. The processor of claim 3, wherein a first mapping of the first group selector to the first key identifier is stored in the first hardware thread register.

5. The processor of claim 4, wherein, based on the first key identifier being assigned to the first hardware thread for a private memory region in a process address space of the process, the first mapping is to be stored only in the first hardware thread register of a plurality of hardware thread registers associated respectively with a plurality of hardware threads of the process.

6. The processor of claim 4, wherein, based on the first key identifier being assigned to the first hardware thread and one or more other hardware threads of the process for a shared memory region in a process address space of the process, the first mapping is to be stored in the first hardware thread register and one or more other hardware thread registers associated respectively with the one or more other hardware threads of the process.

7. The processor of claim 2, wherein the first portion of the pointer includes at least one bit containing a value that indicates whether a memory type of a memory location referenced by the pointer is private or shared.

8. The processor of claim 2, wherein the memory controller circuitry is further to:
append the first key identifier selected from the first hardware thread register to a physical address translated from a linear address at least partially included in the pointer.

9. The processor of claim 8, further comprising:
a buffer including a translation of the linear address to the physical address, wherein the first key identifier is omitted from the physical address stored in the buffer.

10. The processor of claim 8, wherein the memory controller circuitry is further to:
translate, prior to appending the first key identifier selected from the first hardware thread register to the physical address, the linear address to the physical address based on a translation of the linear address to the physical address stored in a buffer.

11. The processor of claim 1, wherein the first core is further to:
determine that one or more implicit policies are to be evaluated to identify which hardware thread register of a plurality of hardware thread registers of the first core is to be used for the first memory access request.

12. The processor of claim 11, wherein the first core is further to:
invoke a first policy to identify the first hardware thread register based, at least in part, on a first memory indicator of a physical page mapped to a first linear address of the first memory access request.

13. The processor of claim 1, further comprising:
a second core including a second hardware thread register, the second core to:
select a second key identifier stored in the second hardware thread register in response to receiving a second memory access request associated with a second hardware thread of the process, wherein the memory controller circuitry is further coupled to the second core and is to obtain a second encryption key associated with the second key identifier.

14. The processor of claim 13, wherein a physical memory page associated with the first memory access request and the second memory access request is to include:
a first cache line containing first data or first code that is encrypted based on the first encryption key associated with the first key identifier; and
a second cache line containing second data or second that is encrypted based on the second encryption key associated with the second key identifier.

15. The processor of claim 1, wherein the first memory access request corresponds to one of a first instruction to load data from memory, a second instruction to store data in the memory, or a third instruction to fetch code to be executed from the memory.

16. A system comprising:
a processor including at least a first core, wherein the first core includes a first hardware thread register to store a first key identifier assigned to a first hardware thread of a process, the first core to:
select the first key identifier from the first hardware thread register in response to receiving a first memory access request associated with the first hardware thread; and
memory controller circuitry coupled to the first core, the memory controller circuitry to:
obtain a first encryption key associated with the first key identifier.

17. The system of claim 16, wherein the first core is further to:
select the first key identifier stored in the first hardware thread register based, at least in part, on a first portion of a pointer of the first memory access request.

18. A method comprising:
storing, in a first hardware thread register of a first core of a processor, a first key identifier assigned to a first hardware thread of a process;
receiving a first memory access request associated with the first hardware thread;
selecting the first key identifier stored in the first hardware thread register in response to receiving the first memory access request; and
obtaining a first encryption key associated with the first key identifier.

19. The method of claim 18, further comprising:
storing, in a second hardware thread register, a second key identifier assigned to a second hardware thread of the process;
receiving a second memory access request associated with the second hardware thread;
selecting the second key identifier stored in the second hardware thread register; and
obtaining a second encryption key associated with the second key identifier.

20. One or more machine readable media including instructions stored thereon that, when executed by a processor, cause the processor to perform operations comprising:
receiving a first memory access request associated with a first hardware thread of a process, the first hardware thread provided on a first core;
selecting a first key identifier stored in a first hardware thread register in the first core, the first hardware thread register associated with the first hardware thread; and
obtaining a first encryption key associated with the first key identifier.

21. The one or more machine readable media of claim 20, wherein, when executed by the processor, the instructions cause the processor to perform further operations comprising:
selecting the first key identifier stored in the first hardware thread register based, at least in part, on a first portion of a pointer of the first memory access request; and
appending the first key identifier selected from the first hardware thread register to a physical address translated from a linear address at least partially included in the pointer.
